(19) United States
(12) Patent Application Publication
(10) Pub. No.: US 2026/0219903 A1
(43) Pub. Date: Jul. 30, 2026

(54) CUSTOMIZED USER INTERFACES AND MEDIA CONTENT EXPERIENCES

(71) Applicant: Roku, Inc., San Jose, CA (US)

(72) Inventors: Shashank Merchant, Sunnyvale, CA (US); Erich K. Woo, San Francisco, CA (US); Sarah Friant, Exton, PA (US); Matthieu Chamik, Sebastopol, CA (US); Margret Schmidt, Redwood City, CA (US); Michael Bruza, Los Gatos, CA (US); Ryan Terry, Tucson, AZ (US)

(21) Appl. No.: 19/279,741

(22) Filed: Jul. 24, 2025

Related U.S. Application Data
(60) Provisional application No. 63/749,854, filed on Jan. 27, 2025.

(51) Int. Cl. G06F 9/451

(52) U.S. Cl. CPC G06F 9/451

(57) ABSTRACT

System, apparatus, article of manufacture, method and/or computer program embodiments are provided for customizing user interfaces (UIs) and profiles based on themes and content. An example method can include identifying a user associated with a UI of an application; selecting visual attributes of the UI, the visual attributes being selected based on a theme of the UI and/or a respective selection parameter associated with each of a set of content items of the UI, the respective selection parameter defining a content preference, priority, metric, and/or a relevance to a date associated with a presentation of the UI, the user, the application, and/or a topic; generating, via an AI model, a profile image of the user customized based on the visual attributes; and providing the profile image of the user to the UI and/or a device associated with the user.

### CROSS-REFERENCE TO RELATED APPLICATIONS

This application claims the benefit of, and priority to, U.S. Provisional Application No. 63/749,854 filed on Jan. 27, 2025, the contents of which are incorporated herein by reference in their entirety and for all purposes. This application is also related to U.S. Non-Provisional patent application Ser. No. 19/279,419, filed on Jul. 24, 2025; and U.S. Non-Provisional patent application Ser. No. ______, filed on Jul. 24, 2025; which are expressly incorporated by reference herein in their entirety and for all purposes.

### BACKGROUND

### Field

This disclosure is generally directed to media content and user interfaces and, more specifically, theme-based user interfaces and avatars and profiles customized based on presence detection results.

### SUMMARY

Provided herein are system, apparatus, article of manufacture, method and/or computer program product embodiments (and/or combinations and/or sub-combinations thereof) for generating customized user interfaces, profiles, profile images, and immersive experiences. In some aspects, a method is provided for generating profiles and profile images for user interfaces. An example method can include identifying a user associated with a user interface (UI) of an application; selecting one or more visual attributes from a set of visual attributes of the UI, the one or more visual attributes being selected based on a theme of the UI and/or a respective selection parameter associated with each content item from a set of content items of the UI, the respective selection parameter defining a content preference, a content priority, a content metric, and/or a content relevance to a date associated with a presentation of the UI, the user, the application, and/or content topic; generating, via an artificial intelligence (AI) model, a profile image of the user customized based on the one or more visual attributes of the UI; and providing the profile image of the user to at least one of the UI and a device associated with the user.

In some aspects, a system is provided for generating profiles and profile images for user interfaces. The system can include one or more computing and/or media devices such as, for example, a television, a media player, a server, a computer, a set-top box, an Internet-of-Things (IoT) device, a peripheral device, a mobile device (e.g., a smartphone, etc.), a wearable computing device (e.g., a smartwatch, smartglasses, a head-mounted display (HMD), an extended reality (e.g., virtual reality, augmented reality, mixed reality, virtual reality with video passthrough, etc.) glasses, etc.) system, a single-board computer (SBC) or system-on-chip (SoC) device, a video game console, and/or a smart device, among others.

The system can include memory used to store data, such as computing instructions, and one or more processors coupled to the memory and configured to perform operations including identifying a user associated with a user interface (UI) of an application; selecting one or more visual attributes from a set of visual attributes of the UI, the one or more visual attributes being selected based on a theme of the UI and/or a respective selection parameter associated with each content item from a set of content items of the UI, the respective selection parameter defining a content preference, a content priority, a content metric, and/or a content relevance to a date associated with a presentation of the UI, the user, the application, and/or content topic; generating, via an artificial intelligence (AI) model, a profile image of the user customized based on the one or more visual attributes of the UI; and providing the profile image of the user to at least one of the UI and a device associated with the user.

In some aspects, a non-transitory computer-readable medium is provided for generating profiles and profile images for user interfaces. In some cases, the non-transitory computer-readable medium can have instructions stored thereon that, when executed by one or more processors, cause the one or more processors to perform operations including identifying a user associated with a user interface (UI) of an application; selecting one or more visual attributes from a set of visual attributes of the UI, the one or more visual attributes being selected based on a theme of the UI and/or a respective selection parameter associated with each content item from a set of content items of the UI, the respective selection parameter defining a content preference, a content priority, a content metric, and/or a content relevance to a date associated with a presentation of the UI, the user, the application, and/or content topic; generating, via an artificial intelligence (AI) model, a profile image of the user customized based on the one or more visual attributes of the UI; and providing the profile image to at least one of the UI and a device associated with the user.

### BRIEF DESCRIPTION OF THE FIGURES

The accompanying drawings are incorporated herein and form a part of the specification.

FIG. 1 is a block diagram illustrating an example multimedia environment, according to some examples of the present disclosure.

FIG. 2 is a block diagram illustrating an example media device, according to some examples of the present disclosure.

FIGS. 3A and 3B are diagrams illustrating examples of customized user interfaces implementing themes and associated content, according to some examples of the present disclosure.

FIG. 4 illustrates another example of a user interface configured with a theme, according to some examples of the present disclosure.

FIGS. 5A through 5D illustrate example user interfaces customized based on a theme(s), according to some examples of the present disclosure.

FIGS. 6A and 6B illustrate example user interfaces customized according to a theme(s) and configured to provide immersive experiences, according to some examples of the present disclosure.

FIG. 7A illustrates an example user interface with a user interface container and a customized theme, according to some examples of the present disclosure.

FIG. 7B illustrates an example user interface with an example user interface container generated based on a user interface element selected by a user, according to some examples of the present disclosure.

FIG. 8A illustrates an example user interface container customized to include a combination of themes, according to some examples of the present disclosure.

FIG. 8B illustrates an example user interface that includes an example user interface container customized with a combination of themes, according to some examples of the present disclosure.

FIG. 8C illustrates an example user interface customized based on a combination of themes and including multiple user interface containers, according to some examples of the present disclosure.

FIG. 9 is a diagram illustrating an example system process for customizing user interfaces, according to some examples of the present disclosure.

FIG. 10A 10B are diagrams illustrating example scenes with users viewing user interfaces customized based on profiles, according to some examples of the present disclosure.

FIGS. 11 and 12 are flowcharts illustrating example methods for customizing user interfaces, avatars and experiences based on themes, according to some examples of the present disclosure.

FIG. 13 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users can access and consume media content using media devices such as, for example and without limitation, mobile phones (e.g., smartphones), set-top boxes, computers (e.g., desktop computers, laptop computers, tablet computers, etc.), televisions (TVs), Internet Protocol television (IPTV) devices or receivers, media players, displays or monitors, projectors, video game consoles, smart wearable devices (e.g., smartwatches, smartglasses, head-mounted displays (HMDs), extended reality devices (e.g., virtual reality glasses, augmented reality glasses, mixed reality glasses, virtual reality devices with video passthrough, etc.), single-board computers (SBCs) or system-on-chip (SoC) devices, and Internet-of-Things (IoT) devices, among other devices. The media content can include or encompass digital formats and/or assets such as, for example and without limitation, videos (e.g., live videos, pre-recorded or on-demand videos, streamed videos, TV shows, movies, animated videos, motion graphics videos, live action recordings, video clips, any sequence of video frames or graphics, etc.), video games, audio, text (e.g., closed captions, subtitles, onscreen text, intertitles, superimposed text, and/or any other text content), graphics, video and/or application channels, and/or images, among other types.

For example, a user can use a media device to watch a video available through a content platform. The content platform can include a software application, infrastructure, and/or environment associated with (e.g., that includes, hosts, provides, implements, runs on, corresponds to, can be accessed via, etc.) a streaming service, set-top box, set-top box application/environment, online content delivery network, video game system, media application, media player, video sharing application, web browser, TV (and/or, TV application, operating system, and/or platform), entertainment system, online media content service, media channel, content provider, media broadcast system, podcast system, linear content system, media receiver, and/or the like. The video can include, for example, a video (e.g., movie, TV show, podcast, livestream, video stream or feed, video broadcast, video recording, video clip, animated video, etc.), broadcast, video game, video conference, video podcast, etc. The media device can access or stream the video from the content platform or a web browser, access the video from storage, or obtain the video from another device. The media device can display the video on a display of the media device and/or a separate/external display. The user can use the media device, a remote control, and/or an application to manage any settings of the video (e.g., volume, closed caption settings, subtitles, resolution, color settings, brightness levels, etc.), navigate to and/or access other content, control a behavior or functionality of the video (e.g., playback, pause, stop, rewind, record, forward, etc.), etc. The media device can include, obtain, and/or manage content (e.g., videos, images, audio, etc.), channels, applications, settings, input and/or output devices, media functionalities, and/or other features/components, which the user can access via the media device.

The media device can display media content via a user interface. The user can use the user interface to access and consume (e.g., view/watch, play/replay, etc.) content, interact with content, select content, navigate content, manage a behavior of content, adjust content settings, engage in content experiences, etc. The user interface, as well as the user interface configuration and attributes, can affect the user experience. For example, the configuration of the user interface can affect the level of difficulty for the user to find/discover or identify/navigate content and features/functionalities, search or access content, interact with the user interface or content available through the user interface, navigate the user interface, understand the user interface layout, explore the user interface, etc. A poorly designed user interface can frustrate the content experience of a user, cause a user to lose interest in a content experience and/or an associated content platform, frustrate the ability of a user to navigate or explore the user interface and its content, frustrate the ability of a user to learn or discover features and functionalities available through the user interface, discourage or deter a user from engaging with the user interface and/or associated content, etc.

For example, a user interface that is cumbersome, unorganized, confusing, unengaging, or visually unappealing may frustrate a user's experience when using the user interface, cause the user to lose interest in content or experiences available through the user interface, negatively impact the user's view or impression of an application or platform associated with the user interface, discourage or deter the user from using the user interface and an associated application or platform, impede the user's ability to find/discover content and features/functionalities available through the user interface, etc. By contrast, a user interface that is organized, engaging, user friendly, visually appealing, immersive, easy to navigate, and easy to understand can provide numerous advantages, such as drawing users to an application/platform (and associated content and experiences) associated with the user interface, increasing a userbase and user retention, evoking positive feelings from users towards the user interface and an associated application/platform, improving user experiences, etc. However, it can be very difficult to create a well-designed user interface that captures these (and other) advantages. The design of a user interface can be further complicated as the amount and type of content or experiences provided by the user interface increase.

Provided herein are system, apparatus, device, method (also referred to as a process) and/or computer program product embodiments, combinations and/or sub-combinations thereof (also referred to as “systems and techniques” hereinafter) for customized and immersive user interfaces and associated content, themes, features, and experiences. In some examples, the systems and techniques described herein can be used to generate customized user interfaces for accessing media content (e.g., playing media content, interacting with media content, engaging with media content, etc.), navigating media content and associated features (e.g., searching and finding content and features, discovering content and features, etc.), engaging in customized and/or immersive content experiences, etc. The user interfaces can be intelligently designed (e.g., customized, organized, etc.) and can be engaging, appealing, immersive, user friendly (e.g., easy to navigate, easy to understand, etc.) and configured to increase user interest, draw and retain users, increase or maximize user and content experiences, evoke positive feelings from users, improve user experiences, etc. The user interfaces can optionally implement customized or intelligently-selected user profiles, avatars, and/or associated content/experiences.

In some cases, a customized user interface can implement a selected theme, display selective/tailored content, a tailored look and feel, a user or group-specific configuration (e.g., a configuration tailored to or selected for a user or group), a device-specific configuration (e.g., a configuration tailored or selected for a device), a customized user avatar or profile image, a customized user/group profile, a customized experience(s), etc. In some examples, the user interface can be customized based on user preferences or characteristics, temporally relevant topics (e.g., events, people, content, announcements, contexts, environments, activities, preferences, etc., relevant to a current or specific event, trend, context, activity, interaction, condition, preference, user, group, device, setting, environment, etc.), featured content (e.g., highlighted or promoted content, recommended content, tailored content, preferred content, etc.), a theme, a performance goal, a design preference, a user history, a trend, a customization criteria, and/or any other factor.

For example, a user interface (and/or aspects thereof) can be customized based on a relevant event (e.g., a current or trending event) such as a competition (e.g., the Olympics, World Cup, World Series, Superbowl, a game show, etc.). The user interface can implement, present, promote, and/or highlight content selected based on the relevant event (e.g., the current or trending event), immersive and/or interactive experiences related to the event, a theme and/or visual appearance based on the event, attributes based on the event, and/or other customization details. The user interface can optionally invite users to interact with content or features related to the event, steer users to certain content or features, help the user explore or discover content and features, and even teach the user certain features or functionalities of the user interface.

To illustrate, on the day of a football championship that has a broad user interest in some regions and can represent a trending event, the user interface presented to users in such regions (and/or users identified as having a potential interest in football and the football championship) or all users can include a football theme or a theme based on the football championship. The theme can include or implement attributes related to football and/or the football championship, such as artwork, images, videos, animations, content, experiences, audio, visual attributes (e.g., visual aesthetics, patterns, etc.), interface elements, customized features (e.g., avatars or profile images, profiles, etc.), and/or design characteristics depicting and/or related to football, the football championship, a football team(s) such as a team or both teams in the football championship, a half-time show of the football championship, a trending advertisement from the football championship, a player(s) in the football championship, a stadium where the football championship is played, a trophy for the winner of the football championship, a football or championship history/statistic, a preferred football team or player, etc. When certain (or all) users access the user interface, the users can correlate the user interface with the football or football championship and interact or engage with content related to football and/or the football championship. The user interface can remind users or convey to users that the football championship is a current/trending event and remind users that the football championship is played today (or within a timeframe), highlight or promote content and/or experiences (e.g., activities, interactions, features, etc.) relevant to football, and even evoke feelings associated with football.

As another example, on a particular holiday, the user interface presented to users (and/or certain users) can include, depict, and/or incorporate features selected based on the holiday, attributes correlated with the holiday, promoted or highlighted content related to the holiday, experiences (e.g., activities, interactions, features, behaviors, etc.) associated with the holiday, a look and feel customized based on the holiday, avatars or profile images customized based on the holiday, profiles customized based on the holiday, etc. The user interface can additionally or alternatively include and/or depict any details or content customized for a specific user or group.

To illustrate, referring back to the example of the user interface presented on the day of the football championship, if a user is a fan of a particular football team participating in the football championship, the user interface can include a theme based on that particular football team, such as the colors of the football team, any symbols or logos associated with that football team, a mascot of the football team, a city and/or state associated with the football team, a player(s) associated with the football team, etc. The user interface can be customized for the user and selected theme based on a user preference(s) of the user (e.g., the user's preference for the football team), information from a user profile, a user input (e.g., an input providing relevant information, an input request or selection, etc.), a user history (e.g., a content consumption history, a user preference history, a user purchasing history, etc.), social media information associated with the user (e.g., social media posts or content, a social media profile, social media connections, social media likes or interactions, etc.), user photos and/or a photo library of the user made available by the user, previous user interactions and/or activity, customization weights or criteria, and/or any other information.

In some cases, the user interface can provide, highlight, promote, prioritize, and/or recommend information, features, and/or experiences (e.g., content, interactions, destinations, products, etc.) associated with the football team. For example, the user interface can display information about the football team, such as team statistics or a team history, promote merchandise associated with the football team, highlight videos associated with the football team (e.g., previous games, game highlights, team reels, player highlights, historical highlights, etc.), offer an immersive experience or interactive activity associated with the football team (e.g., an offer to bet on the football team, an activity to create a preferred starting lineup, an activity to predict or select a particular play during the game, a video game including that football team, an interaction with other users involving the football team, a prediction of player or game statistics, etc.), customize an avatar or profile image of the user to depict any details associated with the football team, customize a user profile based on the football team (e.g., to provide, recommend, or promote content, features, and/or experiences associated with football and/or the football team, etc.), etc.

A theme implemented by a user interface can optionally continue or evolve across user interface spaces (e.g., pages, screens, windows, frames, regions, instances, etc.), user sessions, days of use, etc. For example, a theme implemented by a user interface on a particular day can continue user interface screens, components, pages, sections, experiences, and/or spaces on that day (or a timespan including multiple days) and/or session (or multiple sessions), and can optionally evolve during the user session, experience, or interaction with the user interface. To illustrate, if the user interface implements a theme related to a trending event in social media, the user interface may first incorporate the theme in a particular page (e.g., home page, landing or welcome page, etc.). If the user navigates to a different page or a different section of the user interface, the different page or section of the user interface can also incorporate the theme (and/or aspects thereof). As the user interacts with the user interface, the user interface can persist the theme (and/or aspects thereof) and can optionally evolve the theme by adjusting or updating the theme at certain points.

If the user wants the user interface to stop implementing the theme or switch to a different theme, the user can optionally request so or can trigger the user interface to stop implementing the theme or implement a different theme. When the user accesses the user interface on a different day, the user interface may continue with the same theme or may implement another theme. For example, if another event is temporally relevant to that day, has a higher relevance score, or is otherwise selected based on certain data (e.g., rules, inputs, weights, criteria, preferences, promotions, etc.), the user interface can incorporate a different theme on that day, such as a theme that is based on an event that has a higher relevance score or is more temporally on that day. This way, the user interface can adapt to user interests/preferences, temporal events, changes, content experiences, locations, information, devices, etc.

In some cases, the systems and techniques described herein can implement profiles used to manage aspects of the user interface. The profiles can customize the user interface and/or associated content, features, experiences, etc., for a user or a group of users. The systems and techniques described herein can customize a profile for a particular user and can create shared profiles customized for a group of users, such as users in a household, party, event, etc. A shared profile of a group of users can be generated or configured by merging the profiles of the users in the group or combining selected aspects (e.g., content, features, themes, experiences, recommendations, interface attributes, behaviors, settings, appearance parameters, etc.) from various profiles associated with users in the group. In some cases, the shared profile (or a portion of the shared profile) can be configured to include aspects selected for the shared profile (and/or the group) based on the profiles of the users in the group (and/or aspects thereof). The selected aspects can be extracted from the profiles of the users in the group and/or can be calculated based on information from the profiles of the users in the group. The selected aspects can be calculated based on one or more shared profile rules, requirements, policies, preferences, details, and/or cues, and/or information about each individual in the group (e.g., user preferences, user history, user policies, user characteristics, user constraints, user controls such as parental controls, user information or demographics, user statistics, user inputs, etc.).

For example, if the group includes an adult and a child. The profile of the adult may be configured to prioritize, promote, or implement content unsuitable for minors and the profile of the adult may be configured to prioritize, promote, or implement content for children of a certain age range that may be of little interest to the adult. In this case, merging the profiles can result in the shared profile including content inappropriate for the child. Thus, instead of merging the profiles, the systems and techniques described herein can create a shared profile that excludes any content that is filtered for a particular user, such as content that is inappropriate for the child and a category of content blacklisted or blocked by the adult. The shared profile can include the unfiltered portions of the adult and child profiles, and/or can include aspects that are not included in either of the adult or child profiles but is calculated based on information about such profiles and/or associated users.

To illustrate, perhaps neither the adult profile nor the child profile includes family content. Thus, individually, the child profile customized for the child does not include family content as the child may be more interested in other content (e.g., content for children, such as cartoons) when consuming content without the adult, and the adult profile customized for the adult also does not include family content as the adult may typically be more interested in adult content when consuming content without the child. While the child and the adult may not prefer family content when consuming content individually, the adult and child may have a higher interest in family content when consuming content together, as the family content may include content that is suitable for both the child and the parent and may represent the best match for the child and parent combined based on information about the child (and/or child profile) and the adult (and/or adult profile).

For example, assume that the adult has (or is estimated to have) a preference or affinity for adult comedies and the child has (or is estimated to have) an interest in (or a preference or affinity for) comedic content rated for children of certain ages. Here, the child may not be allowed to consume adult comedies and the adult may not be interested in content rated for children of such ages. However, the adult and child are both estimated to have an interest in comedy and the child may be allowed to consume comedies that are not rated for adults. While the adult may not be interested in content that is rated for children of a certain age, when consuming content with the child, the adult may enjoy comedies rated as family content suitable for children when accompanied by the child even if such content is not a preferred content when the adult consumes content without the child (e.g., and thus such content is likely not implemented by the adult profile). Moreover, while the child may not be allowed to consume adult comedies, the child may be allowed to consume comedies rated as family content and may enjoy such content when accompanied by the adult even if such content is not preferred by the child when the child is not accompanied by the adult (e.g., and thus such content is likely not implemented by the child profile).

Accordingly, while the comedies rated as family content may not be included or promoted in the adult profile or the child profile and may not be preferred or prioritized by the adult when not accompanied by the child or the child when not accompanied by the adult, such content may be more suitable for the shared profile of the adult and child and more likely enjoyed by (and suitable for) the adult and child when consuming content together. Therefore, the shared profile may include or promote comedies rated as family content given an overlap in interests of the adult and child and an estimated suitability for the adult and child when the adult and child are together, even though such content may not be recommend, promoted, or included in the individual profiles of the adult and child and less of interest to the adult and child when not together but more of interest to them when together. Thus, the shared profile can include or be customized based on content and/or preferences associated with multiple profiles and users, but in some cases may not include content or attributes from any of the profiles of the users associated with the shared profile and instead include content or attributes that are suitable or selected for the group that would not be otherwise selected or used for the individual profiles of the users in the group.

In some cases, the systems and techniques described herein can detect a presence of one or more users in a scene that includes a media device (or within a proximity of the media device) and automatically implement a profile at the media device for the one or more users. For example, the systems and techniques described herein can use one or more sensors (e.g., one or more camera sensors, ranging sensors such as radio detection and ranging (RADAR) sensors and/or light detection and ranging (RADAR) sensors, ultrasound sensors, infrared sensors, etc.) and/or data about a behavior of the one or more users in the scene (e.g., a navigation behavior, a usage behavior of a remote control, a usage behavior of the media device, a motion or pattern of motion, user activity, etc.), user inputs, and/or user characteristics to detect the one or more users in the scene (or within a proximity of the media device. In some cases, the systems and techniques described herein can additionally or alternatively detect the one or more users based on wireless signals associated with certain devices, such as wireless (e.g., WIFI, Bluetooth, etc.) signals indicating a presence of one or more mobile devices of the one or more users, an active connection of such devices with a network associated with the scene, or notifications (e.g., messages, instructions, beacons, signals, etc.) from such devices. In response to detecting the one or more users, the media device can automatically implement a user profile customized for the one or more users.

In some cases, the one or more users can use the one or more mobile devices to scan a visual element depicted by a display, such as a quick response (QR) code depicted by a display of the media device or coupled to the media device, and trigger the one or more mobile devices to send a notification to the media device that the one or more users are present (e.g., within a proximity). The media device can then implement the user profile customized for the one or more users. The one or more mobile devices can optionally provide information to the media device used to customize the user profile for the one or more users, such as device data, user data, user history data, user activity, user preferences, user patterns, user inputs, user profile information, etc. In some cases, each of the one or more mobile devices can include an application that can communicate information to the media device used to customize the user profile, trigger implementation of the user profile, trigger the user profile to be timed-out or terminated/closed, or enable any user to interact with the media device or the user profile.

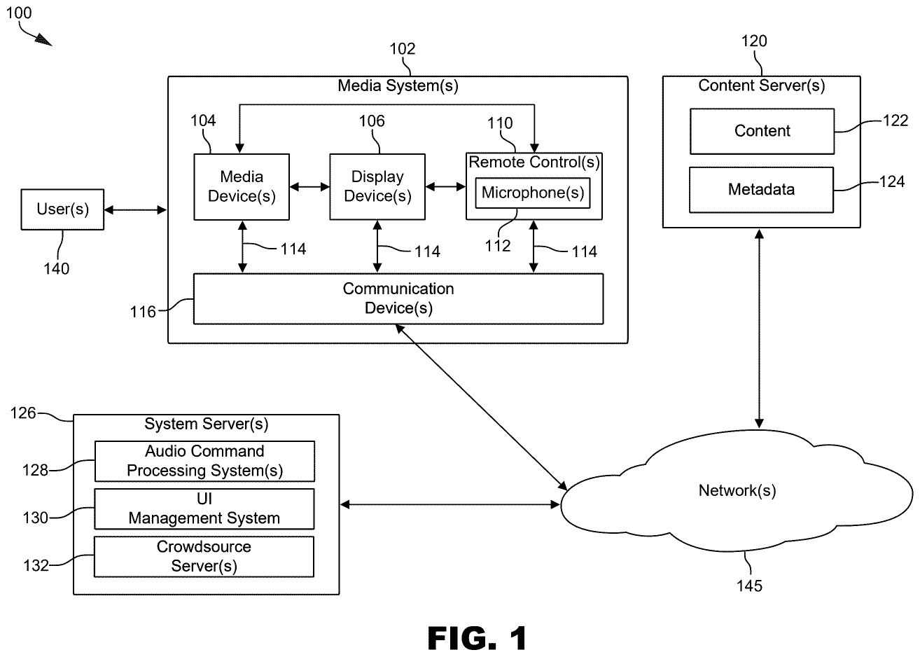

Various embodiments and aspects of this disclosure may be implemented using, and/or may be part of, multimedia environment 100 shown in FIG. 1. It is noted, however, that the multimedia environment 100 is provided for illustrative purposes and is not limiting. Examples and embodiments of this disclosure may be implemented using, and/or may be part of, environments that are different from and/or in addition to the multimedia environment 100, as will be appreciated by persons skilled in the relevant art(s) based on the teachings contained herein. An example of the multimedia environment 100 shall now be described.

### Example Multimedia Environment

FIG. 1 illustrates a block diagram of an example multimedia environment 100. In a non-limiting example, multimedia environment 100 may be directed to media content. However, this disclosure is applicable to any type of content (instead of or in addition to media content), as well as any mechanism, means, protocol, method and/or process for distributing content (e.g., media content, etc.), interacting with media content, and/or interacting with media devices.

The multimedia environment 100 may include a media system(s) 102. Media system(s) 102 can include one or more media systems, and each media system can include and/or represent a scene or environment and/or one or more devices in a scene or environment. The scene or environment can include, for example and without limitation, a family room, a kitchen, a backyard, a home theater, a school classroom, a library, a car, a boat, a bus, a plane, a movie theater, a stadium, an auditorium, a park, a bar, a conference room, a home, an entertainment room, a restaurant, an office, or any other location or space where it is desired to receive and play media content, such as streaming content. A user(s) 140 may operate media system(s) 102 (and/or one or more devices associated with media system(s) 102) to select/access content (e.g., videos, images, audio, text, user interfaces, application content, etc.), consume content (e.g., watch/view content, play or replay content, interact with content, engage with content, play video game content, etc.), stream content, engage in content interactions or activities, etc. The user(s) 140 can include or represent one or more users in multimedia environment 100. The content can include, for example and without limitation, visual content (e.g., movies, television shows and/or programs, images, graphics, visual animations, videos, etc.), audio content (e.g., music, speech or dialogue, sounds, noise, etc.), text content (e.g., subtitles, closed captions, superimposed text or supers, overlaid text, scene text, etc.), metadata, podcasts, application content (e.g., content depicted and/or available via an application, application pages, application menus, etc.), user interfaces and/or user interface content, etc.

Media system(s) 102 may include media device(s) 104, display device(s) 106, remote control(s) 110, communication device(s) 116, and optionally any other device(s). Media device(s) 104 can be coupled to display device(s) 106 and/or can include a display device used to display digital content. Media device(s) 104 can include one or more media devices, and each media device can be coupled to or include a display device (or multiple display devices). It is noted that terms such as “coupled,” “connected to,” “attached,” “linked,” “combined” and similar terms may refer to physical, electrical, magnetic, logical, direct, wired, wireless, etc., connections, unless otherwise specified herein. The one or more media devices can include, for example, one or more streaming devices, DVD or BLU-RAY devices, audio/video playback devices, cable boxes, gaming systems or consoles, televisions, head-mounted displays (HMDs), set-top boxes, video display devices, computers (e.g., laptop computers, desktop computers, tablet computers, etc.), mobile phones (e.g., smartphones), smart wearable devices (e.g., smartwatches, smart glasses, etc.), screens, appliances, internet-of-things (IoT) devices, monitors, single-board computers (SBCs), system-on-chip (SoC) devices, projectors, extended reality (XR) devices (e.g., augmented reality (AR) devices, virtual reality (VR) devices, mixed reality (MR) devices, video-passthrough devices, etc.), and/or digital video recording devices, to name just a few non-limiting examples.

Media device(s) 104 (and/or each media device of media device(s) 104) can include and/or implement and/or can be part of, integrated with, operatively coupled to, and/or connected to one or more display devices, such as display device(s) 106 and/or a separate display. Media device(s) 104 may be configured to communicate with network 145 via communication device(s) 116. Communication device(s) 116 may include, for example, a cable modem, a satellite television (TV) transceiver, a router, an access point, a network device, an antenna, a gateway, a network switch, a cellular communication device or interface, etc. For example, in some cases, communication device(s) 116 can include or represent a network device, such as a router, switch, gateway, access point, etc. Media device(s) 104 may communicate with communication device(s) 116 over a link. The link may include a wireless connection(s) (e.g., WiFi, Bluetooth, cellular, etc.) and/or wired connection(s).

Network 145 can include, for example and without limitation, a public and/or private network, a cloud network, a wired network, and/or a wireless network. For example, network 145 can include the Internet, an intranet, an extranet, a cellular network, a Bluetooth network, an infrared network, a wide area network (WAN), a backbone network, an internet service provider (ISP) network, a network segment, a local area network (LAN), a wireless LAN (e.g., a WIFI network, etc.), an on-premises network, a public and/or private cloud network, and/or any other short range, long range, local, regional, global communications mechanism, means, approach, protocol and/or network, or any combination(s) thereof.

Display device(s) 106 can include one or more display devices and each display device can include one or more displays, screens, monitors, televisions, projectors, HMDs, XR devices, heads-up devices, any other display and/or presentation devices, and/or the like. In some cases, display device(s) 106 can include one or more media devices and each media device can be coupled to or include a display (or multiple displays). In some examples, display device(s) 106 may include, represent, implement, and/or be part of and/or coupled to one or more monitors, televisions (TVs), displays, screens, computers (e.g., desktop computers, laptop computers, tablet computers, etc.), mobile phones (e.g., smartphones), smart wearable devices (e.g., smart glasses, HMDs, etc.), appliances, IoT devices, SBCs, SoCs, XR devices, set-top boxes, video game consoles, digital media players, home entertainment systems, video display devices, electronic ink (eInk) devices or displays, and/or projectors, to name a few non-limiting examples.

Remote control(s) 110 can include, implement, represent, or be part of any component, apparatus, and/or software for controlling media device(s) 104 and/or display device(s) 106, such as a remote control, a computer with remote control software and/or with or coupled to remote control hardware (e.g., a tablet computer, laptop computer, desktop computer, tablet computer, etc.), a mobile phone with remote control software and/or with or coupled to remote control hardware, a smart wearable device with remote control software and/or with or coupled to remote control hardware, on-screen control, integrated control button, audio control, input device, peripheral device, touch screen, or any combination thereof, to name a few examples. In some examples, remote control(s) 110 can communicate with media device(s) 104 and/or display device(s) 106 using any wireless and/or wired communication link, technology, and/or protocol such as, for example, cellular, Bluetooth, infrared, WIFI, WIFI direct, etc., or any combination thereof.

For example, remote control(s) 110 can communicate with media device(s) 104 and/or display device(s) 106 via a wireless connection and/or wireless signals such as a Bluetooth connection and/or signal, a WIFI connection and/or signal, a WIFI direct connection and/or signal, a cellular connection and/or signal, an infrared connection and/or signal, any other wireless connection or signal, or any combination thereof. In some cases, remote control(s) 110 may optionally include a microphone(s) 112. Microphone(s) 112 can record audio such as speech commands, voice commands, dialogue, and/or utterances used to interact with, control, and/or transmit commands and/or data to media device(s) 104 and/or display device(s) 106. Microphone(s) 112 can optionally record other audio as well such as noise, sounds, music, etc. In some cases, microphone(s) 112 can include a hardware and/or software feature (e.g., button, setting, functionality, etc.) that the user(s) 140 can use to activate the recording functionality of microphone(s) 112 to record audio, such as audio commands, questions, dialogue, etc.

The multimedia environment 100 may include content server(s) 120 (e.g., content provider(s), channel(s), source(s), platform(s), storage, system, etc.). Content server(s) 120 can include, implement, and/or represent one or more content servers, storage systems, content delivery services, distributed storage systems, content streaming and/or broadcasting systems, etc. Although only one content server is shown in FIG. 1, in practice, the multimedia environment 100 may include any number of content servers. Content server(s) 120 may be configured to communicate with network 145. Content server(s) 120 may store content 122 and metadata 124. Content 122 may include any type of content and/or combination of content such as music, videos, movies, video games, television (TV) programs, multimedia content, TV shows, images or still pictures, text, graphics, video games, gaming applications, advertisements, programming content, public service content, government content, channels, applications, local community content, data, user interface data/content, user profiles, user avatars, templates, content items, audio content, files, targeted media content, software, and/or any other content or data objects in electronic form.

Metadata 124 can include data about content 122. For example, metadata 124 may include information about content 122, ancillary information indicating or related to writer, director, producer, composer, artist, actor, summary, chapters, production, settings, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 100 may also include system server(s) 126. system server(s) 126 may operate to support media device(s) 104 and/or display device(s) 106 from a remote location and/or network, such as a cloud network, a backend network, a datacenter, etc. It is noted that the structural and functional aspects of system server(s) 126 may wholly or partially exist in the same or different system servers.

In some examples, system server(s) 126 may include, host, operate, and/or implement audio command processing system(s) 128, user interface (UI) management system 130, and/or crowdsource server(s) 132. Audio command processing system(s) 128 can process audio data such as speech/voice inputs and/or commands, audio/speech in videos, etc. For example, as noted above, remote control(s) 110 may include a microphone(s) 112 that can receive audio data from user(s) 140 (and/or other sources such as media device(s) 104, display device(s) 106, etc.). In some examples, media device(s) 104 may be audio responsive, and the audio data may represent verbal commands from the user(s) 140 to control media device(s) 104 and/or any other components in media system(s) 102, such as display device(s) 106.

In some cases, the audio data recorded by microphone(s) 112 can be transferred to media device(s) 104, which can forward the audio data (with or without first processing the audio data) to audio command processing system(s) 128. Audio command processing system(s) 128 may operate to process and analyze the received audio data to recognize the verbal commands of the user(s) 140. Audio command processing system(s) 128 may forward the verbal commands back to media device(s) 104 for processing.

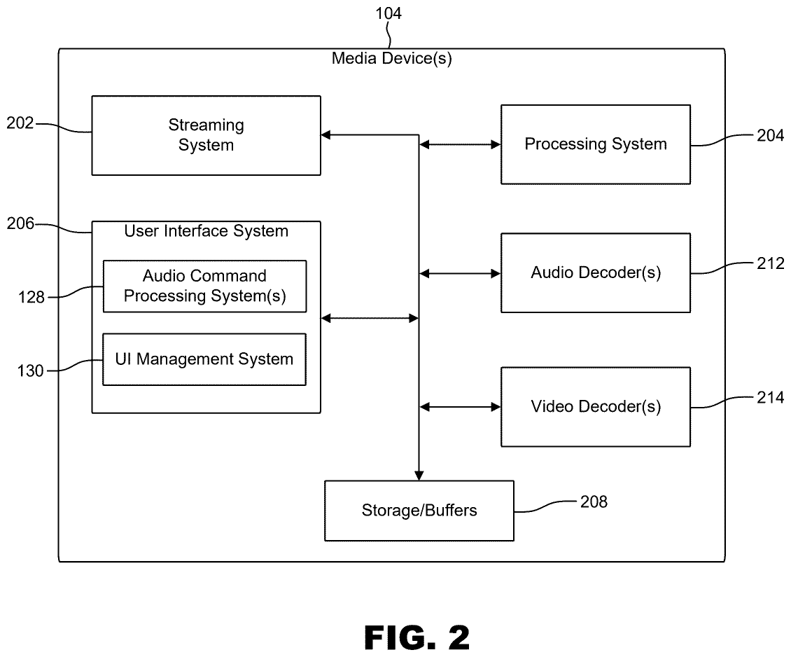

In some cases, the audio data may be alternatively or additionally processed and analyzed by a copy or version of audio command processing system(s) 128 in media device(s) 104 (see FIG. 2). Media device(s) 104 and system server(s) 126 may cooperate to pick any of the verbal commands for processing (either the verbal command recognized by audio command processing system(s) 128 in system server(s) 126, or the verbal command recognized by the copy or version of audio command processing system(s) 128 in media device(s) 104). In some cases, audio command processing system(s) 128 can include, perform, or implement automatic speech recognition (ASR), natural language processing (NLP), natural language understanding (NLU), natural language generation (NLG), text-to-speech generation, etc.

UI management system 130 can select, configure, generate, manage, deliver, and/or provision user interfaces and/or associated content, settings, behaviors, customizations, designs, themes, and/or experiences. The user interfaces can be provided to, and/or rendered/displayed by media device(s) 104 and/or display device(s) 106. The user interface content can include any type of content, data, and/or metadata, such as media content (and any other content) from the content 122 and/or metadata from the metadata 124 at content server(s) 120. UI management system 130 can select content and/or metadata for presentation to the user(s) 140 via media device(s) 104 and/or display device(s) 106. For example, UI management system 130 can generate, render, configure, manage, and/or provide a user interface(s) for display by media device(s) 104 and/or display device(s) 106.

UI management system 130 can additionally or alternatively generate, configure, and/or provide user interface data that media device(s) 104 and/or display device(s) 106 can use to render, display, generate, configure, and/or implement a user interface(s). The user interface(s) can include and/or can be used to access and/or engage/interact with content, content settings, application content, controls, menus, content experiences, metadata, user profiles, user avatars or profile images, media, and/or content services. For example, UI management system 130 can provide (and/or render) a user interface(s) or interface data (e.g., data used to render, display, generate, and/or configure a user interface) to media device(s) 104 and/or display device(s) 106 for presentation to user(s) 140. The user(s) 140 can use the user interface(s) to access, navigate, view, control, engage with, and/or interact with content (e.g., videos, images, advertisements, animations, graphics, text, movies, TV shows and/or programming content, audio, podcasts, video games, application content, etc.), content experiences, content settings, controls, metadata, user profiles, user avatars or profile images, content services, menus, and/or the like.

UI management system 130 can configure the user interface(s) and/or a content, behavior, setting, design, theme, artwork, experience, functionality, and/or feature of the user interface(s) and/or data thereof. The user interface(s) can include or implement a dynamic, static, customized, and/or shared user interface, user interface experience, user interface theme, user interface configuration, user interface behavior, user interface experience, and/or user interface, as further described herein. For example, UI management system 130 can configure, adjust, generate, select, and/or customize any content, pages, screens, windows, themes, appearances (e.g., look and feel, etc.), designs, content experiences, user profiles, user avatars or profile images, recommended content, interface elements, content and/or interface attributes, content and/or user interface visualization, and/or content and/or user interface settings displayed on a user interface(s) for the user(s) 140 by media device(s) 104 and/or display device(s) 106.

In some cases, UI management system 130 can configure, adjust, generate, select, and/or customize such content, pages, screens, windows, themes, appearances, content, and/or attributes, the content and/or user interface visualization, and/or the content and/or user interface settings based on one or more signals. The one or more signals can include, for example, profile data, profile detection signals, user interactions, user history, event data (e.g., content release events, current events, promotion events, trending events, cultural events, user/device events, sporting events, content events, social events, etc.), group data, content activity, content interactions, user and/or device location information, user preferences, user inputs, social media signals (e.g., connections, posts, content, feedback, etc.), user statistics, trends (e.g., social media trends, user ratings, consumption trends, activity trends, current trends, regional trends, etc.), time information (e.g., a time of day, a day of a week, a time/day of the year, a time period, etc.), temporal events (e.g., a current event, a trending event, a media content trend, a current context, a current situation, a current condition, a time-of-year, a content release or release day/date, a current activity or competition, etc.), sensor information, a device associated with the user(s) 140, context information, a content or promotion campaign, a content consumption context, historical information, usage patterns, user data, group data, promoted content, content statistics, user interactions, etc.

UI management system 130 can implement, host, include, execute, represent, and/or be part of one or more algorithms, neural networks, software applications, interfaces (e.g., application programming interfaces (APIs), etc.), software models (e.g., artificial intelligence (AI) and/or machine learning (ML) models, etc.), code, servers, application services, software containers, virtual machines, software engines, software logic, hardware and/or software resources, etc. For example, UI management system 130 can include an interface, such as an API, used to obtain or retrieve data from content server(s) 120 and/or provide data to user devices, software such as an algorithm and/or model (e.g., an AI/ML model(s), etc.) configured to generate, customize, modify, update, render, manage, and/or configure a user interface(s) (and/or associated data, behaviors, experiences, settings, etc.), such as a user interface(s) of a content platform or application. The user interface(s) (and/or content and/or features thereof) can include, depict, or implement a certain visual and/or content experience, such as a theme-based visual and/or content experience, an immersive experience, a profile or profile-based experience, a user avatar or profile image, a tailored experience (tailored for a user and/or a group of users), etc. In some cases, UI management system 130 can configure the user interface(s) to provide theme-based, immersive, and/or interactive experiences for the user(s) 140 (and any other users), such as interactive games, interactive or immersive activities, theme-based content and experiences, etc. In some examples, the content and/or interactive/immersive experiences can allow the user(s) 140 to interact with the user interface(s) and/or content presented by and/or available through the user interface(s) at media device(s) 104 and/or display device(s) 106.

In some cases, the crowdsource server(s) 132 in system server(s) 126 can operate to cause closed captioning to be turned on and/or off during streaming of a media content item, such as a movie. For example, using information received from media device(s) 104 in media system(s) 102 (e.g., in thousands or millions of media systems), the crowdsource server(s) 132 may identify similarities and overlaps between closed captioning requests issued by different users watching a movie. Based on such information, the crowdsource server(s) 132 may determine that turning closed captioning on may enhance the users'viewing experience at particular portions of the movie (e.g., when the soundtrack of the movie is difficult to hear), and turning closed captioning off may enhance the users'viewing experience at other portions of the movie (for example, when displaying closed captioning obstructs important or relevant visual aspects of the movie). Accordingly, the crowdsource server(s) 132 may operate to cause closed captioning to be automatically turned on and/or off during future streamings of the movie.

In some cases, audio command processing system(s) 128, UI management system 130, and/or crowdsource server(s) 132 can be part of, hosted at, and/or implemented by a same server (or a same set of servers) from system server(s) 126 or different/separate servers from system server(s) 126. In other cases, UI management system 130 can be part of, hosted at, and/or implemented by a server (or a set of servers) that is (or are) separate from a server(s) that includes, implements, and/or hosts audio command processing system(s) 128 and/or the crowdsource server(s) 132. In other cases, audio command processing system(s) 128, UI management system 130, and/or the crowdsource server(s) 132 can be distributed across multiple and/or different servers.

In some cases, media device(s) 104 can include, implement, and/or host a copy or version of audio command processing system(s) 128 and/or UI management system 130 as shown in FIG. 2. Moreover, audio command processing system(s) 128, UI management system 130, and the crowdsource server(s) 132 can each include, implement, be part of, and/or host one or more servers, computers, models and/or neural networks, models (e.g., AI/ML models, statistical models, etc.), algorithms, applications, software engines or modules, code/logic, software components, processors and/or processing circuitry (e.g., central processing units (CPUs), compute resources, application services, software containers, virtual machines, microservices, digital signal processors (DSPs), graphics processing units (GPUs), image signal processors (ISPs), processor cores, system-on-chip (SOC) devices, application-specific integrated circuits (ASICs), field-programmable gate arrays (FPGAs), integrated circuits, etc.), software and/or hardware elements, software platforms, and/or any hardware and/or software components.

FIG. 2 illustrates a block diagram of an example of media device(s) 104. For illustration and explanation purposes, in FIG. 2, media device(s) 104 represents a single media device. However, media device(s) 104 can include multiple media devices, as previously explained. Media device(s) 104 in FIG. 2 may include a streaming system 202, processing system 204, storage/buffers 208, user interface system 206, audio decoder(s) 212, and video decoder(s) 214. The user interface system 206 may optionally include a copy or version of audio command processing system(s) 128 to perform some or all of the operations, tasks, functions, and/or actions of audio command processing system(s) 128. Additionally or alternatively, the user interface system 206 may optionally include a copy or version of UI management system 130 to perform some or all of the operations, tasks, functions, and/or actions of UI management system 130.

For example, media device(s) 104 may include a copy or version of audio command processing system(s) 128 and/or UI management system 130 to allow media device(s) 104 to respectively perform any of the tasks, operations, functions, actions, etc., described herein with respect to audio command processing system(s) 128 and/or UI management system 130 (e.g., in addition to or instead of any of such tasks, operations, functions, etc. (or portions thereof), performed by audio command processing system(s) 128 and/or UI management system 130 in/from system server(s) 126 shown in FIG. 1).

In some examples, audio command processing system(s) 128 and/or UI management system 130 can be optionally included in, implemented by, and/or part of the user interface system 206. Alternatively, audio command processing system(s) 128 and/or UI management system 130 can be optionally included in, implemented by, hosted at, and/or part of media device(s) 104, such as the processing system 204, or represent one or more separate components.

In some cases, audio command processing system(s) 128 optionally included in media device(s) 104 can be the same as audio command processing system(s) 128 in/from system server(s) 126 in the multimedia environment 100 shown in FIG. 1. In other cases, audio command processing system(s) 128 optionally included in media device(s) 104 in FIG. 2 can be a version of audio command processing system(s) 128 in/from system server(s) 126 in the multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of audio command processing system(s) 128 in/from system server(s) 126 in FIG. 1.

In some cases, UI management system 130 optionally included in media device(s) 104 in FIG. 2 can be the same as UI management system 130 in/from system server(s) 126 in the multimedia environment 100 shown in FIG. 1. In other cases, UI management system 130 optionally included in media device(s) 104 in FIG. 2 can be a version of UI management system 130 in/from system server(s) 126 in the multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of UI management system 130 in/from system server(s) 126 in FIG. 1.

As shown in FIG. 2, media device(s) 104 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. Media device(s) 104 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name some examples.

### Customized User Interfaces, Avatars, and Content Experiences

Referring again to FIGS. 1 and 2, UI management system 130 (e.g., at system server(s) 126 and/or media device(s) 104) can generate, render, and/or provide customized, theme-based, interactive, dynamic, and/or immersive user interfaces and associated content experiences. The user interfaces can be used to access content (e.g., media content from content server(s) 120 and/or any other source), navigate content, search/find content, play and/or interact with content, engage in content experiences, participate in content activities or immersive interactions, access and/or adjust associated settings, access and/or manage user data such as profiles and/or avatars, etc. UI management system 130 can design, generate, configure, and/or customize an organization, behavior, visual appearance, design, theme, user profile, content experience, user avatar or profile image, and/or settings of the user interfaces and associated content. The user interfaces can be organized, engaging, visually appealing, immersive, user friendly, relevant, and/or customized in order to increase user interest and retention, draw new users to an associated content platform or application, increase and/or maximize content experiences, evoke positive feelings from users towards a content and/or platform associated with the user interfaces, and/or improve an overall user experience.

UI management system 130 can customize, configure, and/or adjust any aspect of a user interface. For example, UI management system 130 can customize a user interface, configure the user interface (and/or associated content and/or experiences) to implement a particular theme(s), display specific content (and/or categories of content), organize content in a particular way, provide a tailored look and feel, implement a particular design and/or configuration (e.g., a configuration and/or design selected for and/or tailored to a user, group of users, device, group of devices, context, topic, etc.), etc. In some examples, UI management system 130 can customize the design (e.g., the theme, content, organization, look and feel, style, settings, appearance, etc.) of the user interface according to user preferences and/or characteristics (e.g., of a user or a group of users), temporally relevant features (e.g., based on a current event, context, activity, interaction, condition, topic, etc.), trending and/or temporally relevant topics, featured content (e.g., highlighted content, promoted content, relevant content, preferred content, etc.), theme, performance goals and/or characteristics, design preferences, and/or any other factors.

For example, UI management system 130 can customize the user interface for different users based on a topic, such as a topic associated with an event, context, trend, etc. In some examples, UI management system 130 can customize the user interface for users based on a current or upcoming competition, such as a sports competition, a game show competition, an awards ceremony/competition, etc. The user interface can present, promote, and/or highlight content related to a customized theme and/or topic (e.g., a current or trending event, a current context, a content release event, a user preference, etc.), provide immersive and/or interactive content experiences, incorporate a particular visual appearance and/or attributes, invite users to interact with certain content and/or features, provide animations used to engage the user and/or help the user discover and/or understand any features and/or content available via the user interface, content and/or features associated with a user profile, customized avatars or profile images, etc.

To illustrate, if UI management system 130 determines that a trending or anticipated movie is being released on a particular day, UI management system 130 can customize the user interface presented to all or certain users on that day (or an associated timeframe) based on the movie being released on that day. The user interface can include a theme related to the movie. The theme can promote merchandise related to the movie, highlight/promote and/or prioritize the movie and/or related content, offer users an option to engage in an interactive activity related to the movie, customize a user avatar or profile image based on the movie, customize a user/group profile based on the movie, offer a content experience associated with the movie, etc. For example, the user interface can implement a theme that includes attributes related to the movie (e.g., movie characters, imagery, visualizations such as colors and/or patterns, logos, thumbnails, symbols, backgrounds, etc.), content related to the movie (e.g., images, videos, thumbnails, text, audio, etc.), visual aesthetics/patterns based on the movie, interface elements related to and/or based on the movie, design characteristics depicting and/or related to the movie (e.g., related to the content of the movie, a character(s) of the movie, a plot of the movie, a landmark in the movie, a scene in the movie, an activity in the movie, a condition in the movie, visual attributes of the movie, a condition in the movie, an object in the movie, a context of the movie, etc.), hidden messages associated with the movie, artwork based on the movie, a background or backdrop based on the movie, animations based on the movie, avatars or profile images customized based on the movie, and/or any other settings/content associated with the movie.

In this example, when users access the user interface, the users can correlate the user interface (and/or the theme) with the movie, access the movie or content promoted or recommended based on the movie, interact with content from the movie and/or related to the movie, engage in an immersive experience generated based on the movie, etc. The user interface can convey that the movie is a current/trending event and/or was or is being released, highlight or provide content and/or activities/interactions relevant to the movie, promote merchandise associated with the movie, invoke feelings or a mood based on the movie, etc.

As another example, if a topic is trending (e.g., in social media, in the news, in current events, etc.) and/or is being promoted by an application/platform associated with the user interface, UI management system 130 can customize the user interface to incorporate content and/or features associated with that topic, tailor a theme of the user interface based on that topic, include attributes associated with that topic, promote or highlight content associated with that topic, provide activities and/or interactions associated with that topic, customize an appearance of the user interface based on that topic, customize a theme of the user interface based on the topic, etc. To illustrate, if the topic is basketball, UI management system 130 can customize the user interface to implement a basketball theme. The user interface can depict basketball content and/or artwork, implement attributes related to basketball, promote basketball-related content and/or merchandise, display information about basketball, prioritize and/or suggest content related to basketball (e.g., basketball games, basketball media/TV channels, basketball applications, basketball movies, basketball social media content or posts, basketball documentaries, basketball videos, etc.), provide interactive content and/or activities related to basketball, display colors and/or imagery related to one or more basketball teams, provide access to basketball events or betting options, configure an interface element to depict or mirror basketball content (e.g., a scoreboard, a basketball, etc.), etc.

The user interface can additionally or alternatively incorporate a theme and/or features customized for a user. For example, referring back to the example of the user interface customized for a basketball theme, if a user is a fan of a basketball team, the user interface can include a theme based on that basketball team, such as the colors of the basketball team, any symbols or logos associated with that basketball team, a mascot of the basketball team, a city and/or state associated with the basketball team, a player(s) associated with the basketball team, a jersey associated with the basketball team, etc. UI management system 130 can obtain information about a user preference for that team from a user profile, a user input (e.g., an input providing such information, etc.), a user history, a user request, social media information associated with the user (e.g., social media posts, a social media profile, etc.), user photos and/or a photo library of the user made available by the user, previous user interactions and/or activity, stored user preferences, content (e.g., channels, shows, videos, etc.) and/or content categories (e.g., sports, basketball, etc.) designated as a favorite(s) by the user, and/or any other source of such information.

In some cases, UI management system 130 can configure the user interface to provide, highlight, promote, prioritize, and/or recommend information, content, interactions, and/or any activity associated with the basketball team of the user. For example, UI management system 130 can configure the user interface to display information about the basketball team, such as team statistics or a team history, promote content and/or merchandise associated with the basketball team, highlight videos associated with the basketball team (e.g., previous games, game highlights, team reels, player highlights, historical highlights, etc.), offer an interactive activity associated with the basketball team (e.g., an offer to bet on the basketball team, an activity to create a starting lineup, an activity to predict or select a particular play during the game such as a dunk, a video game including that basketball team, an interaction with other users involving the basketball team, a prediction of a player statistics, etc.), etc.

In some aspects, UI management system 130 can configure a user interface to continue to implement a theme across user sessions, interface pages and/or spaces, user interface experiences, etc. For example, UI management system 130 can configure the user interface to implement a theme on a particular day and continue implementing the theme on that particular day (and optionally on one or more subsequent days) across user interface screens, content, pages, sections, sessions, experiences, etc., until a user session (or multiple user sessions) ends, until a timeframe ends, until another theme is selected/implemented, etc. To illustrate, if UI management system 130 configures the user interface to implement a theme related to a trending game show, the user interface can incorporate that theme in a home, landing, and/or welcome page of the user interface. If the user navigates to a different page or section of the user interface, the different page or section of the user interface can also incorporate the theme (and/or aspects thereof) or an updated version of the theme. As the user interacts with the user interface, the user interface can persist the theme (and/or aspects thereof) across the user interactions or update the theme to depict a continuous and/or progressively changing theme. If the user wants the user interface to stop implementing the theme or switch to a different theme, the user can optionally provide a user input requesting that the user interface switches to a different theme or configured to change the theme. When the user accesses the user interface on a different day, if there is a different theme selected on that day (e.g., based on a topic that is temporally relevant on that day, being promoted on that day, selected for that day, etc.), the user interface can incorporate a different theme on that day. This way, the user interface can adapt to user interests/preferences, temporal information, events, contexts, trends, content experiences, locations, etc.

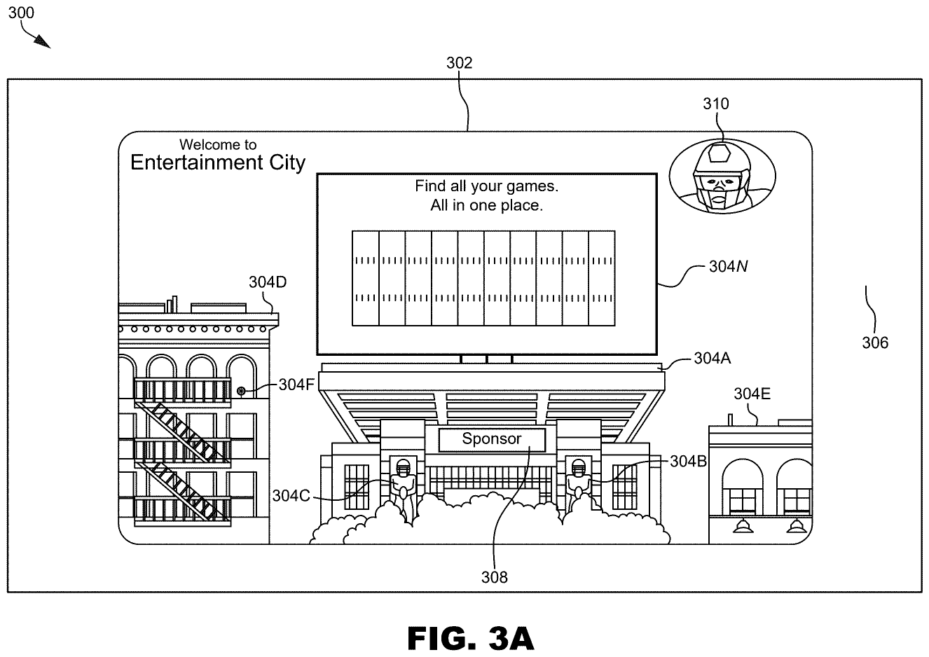

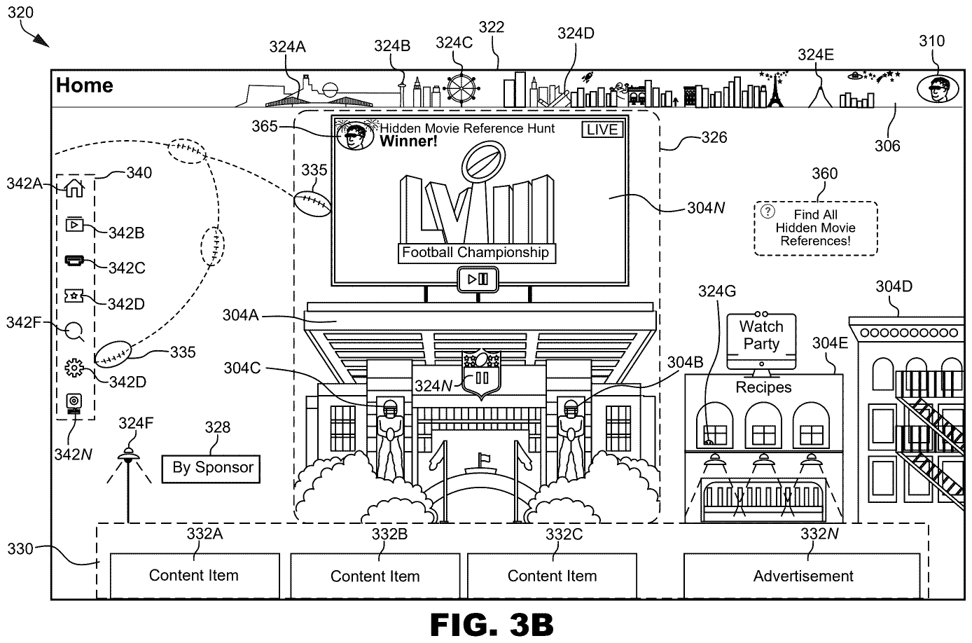

FIG. 3A illustrates an example of a user interface 300 (UI 300) customized based on a selected theme. UI 300 can be used to access, navigate (e.g., search, find, browse, etc.), consume (e.g., watch/view, play, stream, display, etc.), interact with, and manage content (e.g., media content, etc.), access and engage in media content experiences, etc. UI 300 can display and/or include content (e.g., media content, interactive content, interface content, etc.) and a theme selected for UI 300, as further described herein. UI 300 can also include a backdrop 306, such as a background, wallpaper, a page with visualizations/artwork, and/or screensaver, which may or may not be animated (and/or include animated content). The backdrop 306 can be theme-based (e.g., can implement a theme and/or features selected and/or configured based on a theme).

UI 300 can display, include, and/or represent an interface page, window, screen, section, area, library, and/or section that includes and/or displays content, features, activities, interface elements, visual elements, etc. In some examples, UI 300 can be used to access and/or navigate content (e.g., media content, interactive content, immersive content, static content, dynamic content, etc.), access content experiences/activities (e.g., interactive experiences, games, interactive experiences, etc.), etc. The content included in, displayed by, and/or available from UI 300 can include, for example and without limitation, one or more movies, TV shows, podcasts, videos, broadcasts, live content (e.g., live TV, livestreams, live video feeds, etc.), content channels, audio content, media content applications, artwork, content libraries and/or catalogs, video games, interactive content, dynamic content, suggested content, application content, and/or any other content. UI 300 can also include and/or depict a scene or a representation of a scene, which may or may not be based on a theme or incorporate one or more aspects of a theme. For example, in FIG. 3A, UI 300 includes an interface section 302 that includes, depicts, and/or represents a city scene associated with a media platform or application corresponding to UI 300.

UI 300 can be part of, implemented by, rendered by/for, and/or associated with a media platform. The media platform can include a software application/platform used to access, interact with, stream, navigate (e.g., search, find, browse, etc.), engage with, load, and/or consume (e.g., view, play, etc.) content, such as media content, and/or content experiences. For example, the media platform can include a streaming platform or application, a media player application, a media center application, a home theater application, a media/entertainment application, a media content service application or platform, a media library, a media portal, a video game application, a digital set-top box or player, a television software or framework, a media content suite, an electronic programming guide (EPG) portal, a multimedia software interface, etc.

In some cases, UI 300 can include, represent, and/or display a page of a media platform/application associated with UI 300. As shown, UI 300 and/or backdrop 306 can implement a theme(s). The theme(s) can be selected, generated, customized, and/or configured based on one or more topics selected based on one or more signals. The one or more signals can include a user preference, an event, a context (e.g., a user/device context, content experience, streaming context, date and/or time, location, season, environment, activity, etc.), a user and/or group characteristic (e.g., demographic, location, history, etc.), group data (e.g., group preferences, statistics, trends, etc.), a trend (e.g., social media trend, regional trend, cultural trend, etc.), social media data, content statistics, historical data (e.g., consumption data, historical inputs, historical interactions, etc.), patterns (e.g., content, usage, etc.), promotional data (e.g., promotional preferences, campaigns, priorities, rankings, content, etc.), sessions data, temporal information, device data, etc.

The theme(s) can include, depict, and/or implement visual elements 304A-N (collectively referred to as “visual elements 304” hereinafter) and the backdrop 306. The visual elements 304 and/or the backdrop 306 can be selected, customized, generated, and/or configured based on the theme(s). For example, the visual elements 304 and/or the backdrop 306 can be related and/or relevant to (e.g., having a threshold relevance to) the theme(s) and/or designed to convey the theme(s) and/or aspects of thereof. To illustrate, the visual elements 304 and/or the backdrop 306 can include, depict, provide, and/or represent content and/or a content experience(s) associated with the theme(s), such as artwork (e.g., imagery, visualizations, representations, etc.), a design, a color(s), a pattern(s), an object(s), a video(s), a character(s), an image(s), an icon(s) and/or thumbnail(s), an option(s), an interface element(s), a content item(s), a content behavior(s), a content tile(s), a design element(s), an animation(s), a game(s), an activity/activities, text, audio, and/or any other text, audio, and/or visual content associated with the theme(s).

As previously noted, in FIG. 3, UI 300 and backdrop 306 include a city theme. UI 300 also includes a sports theme, which in FIG. 3 is a football theme. The city theme and football theme are depicted or conveyed through the visual elements 304 (and optionally through the backdrop 306). For example, the visual elements 304 can include artwork, text, objects, interface elements, content experiences, animations, and/or visual elements (e.g., objects, buildings, imagery, characters, structures, landmarks/landscapes, designs, views, etc.) depicting city, a city environment, a portion and/or view of a city, football imagery, football players or characters, football buildings/structures (e.g., a stadium, a field, etc.), football objects, football symbols, football teams, football information, football team colors, etc.

In some examples, the visual elements 304 together can convey the theme(s) (e.g., the city and football themes), such as visual elements associated with the theme(s), an associated mood, an associated scene and/or atmosphere (e.g., a city and/or football scene and/or atmosphere). To illustrate, the visual element 304A depicts a football stadium, the visual elements 304B-C depict football players or characters (e.g., images of one or more real football players, fake or computer-generated football players, football player avatars, football player icons, football player characters, football player representations, etc.), the visual elements 304D-E depict city buildings, and the visual element 304N depicts a display (e.g., a television, a projection, a screen, a billboard, a display surface, etc.) depicting football-related content, such as a football field, a football image, a football video, a football game, a football promotion, a football trailer, a football thumbnail, football artwork, a football game, interactive football content, etc.

UI 300 and/or backdrop 306 can optionally include one or more promotional content items, such as promotional content, merchandise, a sponsor, etc. For example, in FIG. 3A, UI 300 includes a promotional content item 308 identifying a sponsor and/or content associated with a sponsor (e.g., a logo, a sign, an advertisement, a trademark, etc.), such as a sponsor of the backdrop 306, a sponsor of a content of any of the visual elements 304, a sponsor of the display depicted by the visual element 304N, a content of UI 300, and/or content accessible via UI 300. In some cases, the promotional content item 308 can include an interactive content item, such as a button or link to content or a product(s) associated with the promotional content item, an interactive element that the user(s) 140 can use to access an item associated with the sponsor (e.g., a page, merchandise, a product or service, information, an activity, a game, etc.), a content experience sponsored by the sponsor, content associated with the sponsor, etc. In some cases, UI 300 and/or the backdrop 306 can include hidden messages (also referred to as “easter eggs” herein), such as references from or clues about a content item (e.g., a movie, TV show, video game, application, channel, etc.) and/or a feature of the content item (e.g., an activity, an object, a character, a building, an animal, an animation, a scene, etc.), content (e.g., artwork, images, animations, icons, visual elements, etc.) depicting or conveying a message or a reference/clue associated with a content item (e.g., an object, a building, a landscape, a scene, a character, a symbol, a background, a view, a structure, an environment, a condition, etc.). etc.

For example, in FIG. 3A, the visual element 304D includes a city building from a particular movie. Thus, the visual element 304D is a reference to or clue about the city building from that movie. A window of the city building (visual element 304D) includes a visual element 304F that depicts a graphic representing a reference to or clue from another movie. Some users may recognize the city building depicted by the visual element 304D as a specific city building from the particular movie, and the graphic depicted by the visual element 304F in the window of the city building as a graphic (e.g., object, character, etc.) from the other movie. Thus, the visual elements 304D and 304F represent hidden messages, clues, or references to the movies associated with the city building and the graphic.

Similarly, the visual element 304E depicts a building representing a barbershop from a movie, which some users may recognize as the barbershop in that movie. Accordingly, the visual element 304E represents a hidden message, clue, or reference to the barbershop from that movie.

The visual element 304A depicts a football stadium. In some cases, the football stadium can represent a reference to a football stadium from a particular content item (e.g., movie, TV show, game, video game, image, animation, etc.), which some users may recognize as the football stadium from that particular content item. The visual elements 304B-C can depict football players or characters. The football players or characters can be fictitious football players or characters, real football players or characters, or football players or characters from a content item (e.g., references to football players from a content item).

In some cases, the backdrop 306 can include one or more interactive interface elements that the user(s) 140 can use to interact with content or access dynamic content. For example, the display depicted by the visual element 304N can include an interactive image or video that the user(s) 140 can select or click to initiate a football video, trailer, and/or interactive experience such as a football activity, interactive game, video game, etc. In some examples, the interactive experience can include a game such as a trivia game or an animated game or activity.

In some cases, UI 300 may enable the user(s) 140 to interact with content or engage in interactive experiences provided by any content and/or elements of UI 300, such as the visual element 304N. For example, when the visual element 304N is selected/activated, the visual element 304N can initiate a video that the user(s) 140 can interact with or that is part of an interactive experience. To illustrate, the display depicted by the visual element 304N can play a video such as a trailer, movie, livestream, a game, a hidden message/clue within the video or a portion thereof, activity, etc. The user(s) 140 can optionally engage with the content of the video. In some examples, the user(s) 140 can also engage in an interactive experience where the user(s) 140 can look for a hidden message/clue in the video, such as a hidden reference to a movie or TV show. If the user(s) 140 finds the hidden message/clue, the user(s) 140 can optionally submit an input identifying the hidden message/clue or indicating that the user(s) 140 found the hidden message/clue. In response to finding the hidden message/clue, the user(s) 140 can optionally receive a benefit (e.g., a credit, a discount, a subscription or subscription reward, a point redeemable in some way, a digital trophy, recognition, an award, a monetary benefit, a score, an add-on, a rank, a recognition within user interfaces displayed on other user devices, etc.) or UI 300 can provide additional content or modify the user experience associated with the video (e.g., show additional portions of the video, show an additional video, customize the video accordingly, overlay content such as a recognition over the video, add more clues in the video or increase the difficulty of clues, etc.).

In some examples, an interface element(s) optionally included in UI 300 and/or backdrop 306 can include a personalized element. For example, if UI 300 and/or backdrop 306 incorporates a football theme, the football theme can be personalized to include content from the user(s) 140 (e.g., a video, a social media post, etc.), content representing or showing the user(s) 140 (e.g., the visual representation or avatar), content of interest to the user(s) 140 (e.g., content showing a team of the user(s) 140), content showing the user(s) 140 in an activity (e.g., playing football, etc.). This way, UI 300 and/or backdrop 306 can incorporate a football theme that is further personalized for the user(s) 140.

The football theme can be based on a topic (e.g., a football topic) selected for UI 300 and/or the backdrop 306. The topic (and thus the football theme) can be selected based on one or more signals. For example, the topic can include a football topic selected based on a relevance, popularity, and/or preference associated with the football topic with respect to a temporal (e.g., date, timeframe, season, etc.) cue (e.g., a relationship between a current or specific date and/or time a date of a football game, event, topic, content item, etc.), a context (e.g., a user context, a device context, a location, an environment or scene, a condition, a situation, etc.), an event (e.g., a current event, a release of content associated with football, a football game, a football championship, a football-related news event, etc.), a trend (e.g., a trending football topic, a trending football activity, a trending football game, trending football content, etc.), a user and/or group preference, a user location and/or characteristic, a location and/or device type of a device used to display UI 300, a user statistic and/or history (e.g., a content consumption history, a content preference history, etc.), a content pattern (e.g., a content pattern of a user or group, a content pattern associated with football content, etc.), calendar data, social media connections, platform data (e.g., a promotion, a weight associated with the football topic/theme, a rank or priority for the football topic/theme, an input from a user or device associated with the platform, business preferences, etc.), a rule or filter, a user input, and/or any other cue(s).

For example, assume that UI 300 is displayed on a day of a football game/championship, a day within a football season, within a timeframe with respect to a football game/championship or event (e.g., within a time period relative to a football game, within a football championship week, within a college or professional football season or playoffs, etc.), on football Sunday or Monday, on a day that football is trending (e.g., based on posts in social media, etc.), a release date of a football video (e.g., movie, documentary, show, etc.), or on a particular day associated with football and/or a football event. Accordingly, based on such information, UI management system 130 may determine that football is a temporally relevant or trending topic. UI management system 130 can select the football theme based on the determination that football is a temporally relevant or trending topic when UI 300 is displayed. UI management system 130 can then configure UI 300 and/or backdrop 306 to implement the football theme.

UI 300 and/or the backdrop 306 can optionally include other interface elements. For example, UI 300 and/or backdrop 306 can optionally include a user avatar 310 representing, resembling, depicting, and/or associated with the user(s) 140. The user avatar 310 can include a real or fake image or visual representation of the user(s) 140. The user avatar 310 can include or can be used as a profile image of the user(s) 140 (e.g., of a profile of the user(s) 140). In some cases, the user avatar 310 can include or be based on an image of the user(s) 140, such as a photograph of the user(s) 140 uploaded by the user(s) 140, selected by the user(s) 140, and/or shared by the user(s) 140. For example, the user avatar 310 can include an image of the user(s) 140 customized by UI management system 130 (e.g., by an AI/ML model of UI management system 130 such as a generative AI model) or an image generated by UI management system 130 (e.g., via the AI/ML model) based on information associated with the user(s) 140, such as an image of the user(s) 140, a description of the user(s) 140, etc.

An avatar (e.g., a user avatar, a group avatar, etc.) can include any visual representation of a user or group of users associated with the avatar (e.g., a real picture, an image generated by an AI/ML model(s) of UI management system 130 such as a synthetic image, an image generated by the AI/ML model(s) of UI management system 130 based on a real picture such as a real picture modified by the AI/ML model(s), a graphic representing or depicting the user or group such as a cartoonized image of the user or group, etc.). Moreover, an avatar can include or be used as a profile image. For example, if the user(s) 140 has a user profile associated with UI 300, the user avatar 310 can include or be used as a profile image of the user(s) 140 associated with the user profile. Accordingly, an avatar or user avatar of a user/group profile can include or refer to a profile image associated with the profile (e.g., correlated to the profile, used as a profile image of/for the profile, etc.), and can include an image (e.g., a real image, a computer-generated image, or a computer-modified image) or graphic representation of the user/group associated with the profile. If a group of users has a group/shared profile as further described herein, the group/shared profile can include a user avatar of the users, which can include or be used as a profile image for the group/shared profile. The profile image can include any visual representation of a user or group, as previously noted with respect to an avatar.

In some cases, UI management system 130 can customize the user avatar 310 (e.g., an image of the user(s) 140 used for the user avatar 310 and/or generated as a representation of the user(s) 140 for the user avatar 310) to implement or depict features, attributes, and/or visual content associated with a theme(s) of UI 300 and/or backdrop 306. For example, UI 300 in FIG. 3A includes a football theme, as previously explained. Moreover, the user avatar 310 in FIG. 3A includes an image or representation of the user(s) 140 customized based on the football theme. As shown, the user avatar 310 is depicted with a football helmet and a football jersey with shoulder pads. In some cases, the user avatar 310 can be implemented in an XR experience (e.g., AR, VR, MR, etc.) provided by UI 300. For example, the user avatar 310 can include a three-dimensional (3D) or VR avatar generated for an XR experience.

In some cases, UI management system 130 can stylize user avatar 310 (e.g., a visual representation of the user(s) 140) based on visual attributes of UI 300, a theme(s) of UI 300, a content of UI 300, and/or any other attributes. For example, the user(s) 140 can upload, select, or share (e.g., grant access to) an image of the user(s) 140 (e.g., a real picture, a synthetic image, or any visual representation). UI management system 130 can use the image of the user(s) 140 to generate an image used for the user avatar 310. In some examples, UI management system 130 (e.g., via an AI/ML model) can stylize the image of the user(s) 140 based on the theme(s) of UI 300 and/or visual attributes of the theme(s), UI 300, a content or content item associated with UI 300, a UI experience(s) associated with UI 300, and/or any other aspect of UI 300.

To illustrate, UI management system 130 (e.g., via an AI/ML model) can modify the image of the user(s) 140 to apply or transfer a theme(s) (or visual attributes of a theme(s)) of UI 300 (or aspects thereof) to the image of the user(s) 140, such as a color or color scheme(s), a background, a garment or shirt, an outfit, a head cover (e.g., hat, helmet, crown, etc.), an accessory, an object, a scene, and/or any other attribute. The modified image can be used as or depicted in/by the user avatar 310. As another example, UI management system 130 can additionally or alternatively modify the image of the user(s) 140 to depict any visual attributes of (and/or related to) UI 300, a content of UI 300, an animation of UI 300, a UI experience(s) associated with UI 300, etc., and use the modified image as the user avatar 310 (or display it in the user avatar 310). For example, if UI 300 includes a background, UI management system 130 can transfer the background to the image of the user(s) 140 used for the user avatar 310, or apply a modified version of the background to the image of the user(s) 140 used for the user avatar 310.

If UI 300 promotes a space movie or includes a space theme, UI management system 130 can modify an image of the user(s) 140 (e.g., a real picture, a fake or synthetic image such as an AI-generated image, a graphic representation, etc.) to include space-related visual attributes, such as a space background or scene, a spacesuit, a spaceship, visual attributes from an image of an alien (e.g., to give the user depiction an alien look) such as a conehead from an alien depiction (e.g., an alien depicted in the space movie or another source) with a conehead or a green color from a green-colored alien depiction (e.g., an alien depicted in the space movie or another source), etc. If a UI experience(s) provided by UI 300, such as a game, includes a trivia game, UI management system 130 can modify the image of the user(s) 140 used for the user avatar 310 to apply visual attributes of a trivia game contestant, such as a Jeopardy game contestant, to give the user depiction in the user avatar 310 an appearance of or related to a trivia game contestant. If UI 300 or a TV show promoted in UI 300 depicts a barbershop scene, UI management system 130 can modify the image of the user(s) 140 used for the user avatar 310 to include visual attributes from the barbershop scene (or any barbershop scene such as a generic barbershop scene), such as modifying the image to show the user(s) 140 (or a depiction of the user(s) 140) sitting on a barbershop chair with a barbershop mirror and/or barber's pole in the background.

The user avatar 310 can additionally or alternatively be stylized based on profile data (e.g., preferences, content history, etc.). For example, if a watch history in a user profile of the user(s) 140 indicates that the user(s) 140 has watched various cowboy movies, UI management system 130 (e.g., via an AI/ML model) can generate or modify an image of the user(s) 140 such that the user(s) 140 is depicted with a cowboy hat and/or riding a horse. If a user preference in the user profile indicates that the user(s) 140 has a preference for a particular football team, UI management system 130 can generate or modify an image of the user(s) 140 such that the user(s) 140 is depicted with a jersey and/or helmet of the football team, with a background that includes the team colors or logo, in a scene showing a football stadium or locker room of that team, etc. In some cases, UI management system 130 can generate the visual attributes of the user avatar 310 based on any aspect of UI 300 as previously noted, such as a theme(s), a content item, a UI experience, etc. UI management system 130 can additionally or alternatively transfer visual attributes from anything in UI 300, such as the theme(s), a visual element, a background, an image, a content item, etc.

In some cases, the user avatar 310 (and/or aspects thereof) can change (or changes can be suggested) based on content and/or content experiences accessed by the user(s) 140, a user interface destination (e.g., zone, page, section, area, etc.) accessed by the user(s) 140, a viewing history of the user(s) 140, a promotion associated with the platform, and/or a user input from the user(s) 140 (e.g., a question or survey answered by the user, a user request, etc.). For example, the user avatar 310 can be configured to depict aspects of a sports theme based on a determination that a watching history of the user(s) 140, a content or interface destination accessed by the user(s) 140, a question answered by the user(s) 140, a preference of the user(s) 140, and/or a promotion of a media platform associated with UI 300 relates to football or football content. To illustrate, if the user(s) 140 is determined to have a preference for a particular football team, watches more content or games involving that football team or at a higher frequency than content or games involving other football teams, has accessed a page associated with or including content associated with that football team, or if that football team is being highlighted or promoted by the media platform associated with UI 300, the user avatar 300 can be customized to include visual attributes associated with that football team, such as a football helmet, logo, jersey, and/or indicia associated with that football team. Similarly, if UI 300 displays a prompt requesting information from the user(s) 140 and the user(s) 140 provides information indicating a preference for that football team, the user avatar 310 can be customized to depict one or more visual attributes associated with that football team.

The user avatar 310 can be depicted within the backdrop 306, the section 302, or any other area of UI 300. In some examples, the user avatar 310 can be displayed within the city depicted in UI 300 based on the city theme. The user avatar 310 can be customized to have a more prominent appearance within the city (or any other theme-based depiction) based on a factor(s), such as an activity or status of the user(s) 140, a performance of the user(s) 140 in a game or activity (e.g., a performance of the user(s) 140 in a game or activity relative to other users, etc.), a characteristic of the user avatar 310, an add-on obtained by the user(s) 140, a number of hidden clues or references found/identified by the user(s) 140 within UI 300, etc.

For example, assume that UI 300 is displayed for or based on a group profile of multiple users consuming content on the device depicting UI 300 and UI 300 depicts user avatar for the multiple users associated with the group profile. If the user(s) 140 is winning a game or activity with respect to the other users associated with the group profile or has more points or a higher score in a media platform associated with UI 300, the user avatar of the user(s) 140 can be more prominently displayed within UI 300 (e.g., within the city depicted by the city theme). The user avatar can be more visually prominent based on a color(s) of the user avatar, a pattern of the user avatar, a size of the user avatar, a position of the user avatar, a contrast of the user avatar relative to one or more surrounding areas, a brightness of the user avatar, and/or any other visual attributes of the user avatar.

In some examples, the user(s) 140 can navigate away from UI 300 to access another user interface page, window, screen, area, or section, such as an interface page where the user(s) 140 can access content or content experiences to watch or interact with, such as movies, TV shows, live feeds, broadcasts, TV channels, video games, interactive content, etc. In some cases, if the user(s) 140 navigates to another destination (e.g., user interface page, window, screen, area, or section), the other destination can implement a different theme(s) and/or can retain any theme (or aspects thereof) of UI 300 to maintain a consistent theme and navigation experience across different destinations/experiences.

For example, if the user(s) 140 navigates to the page shown in FIG. 3B, the page 322 can incorporate attributes (e.g., artwork, colors, patterns, content, etc.) of the theme(s) associated with UI 300 (e.g., football theme and/or city theme). In some examples, if the page 322 (or any other section/page) incorporates a theme(s), such as the football theme (or aspects thereof), the page 322 can optionally include, highlight, prioritize, recommend, and/or promote content related to the theme(s) (e.g., of the football theme or a different theme) such as, for example and without limitation, videos, movies, shows, channels, games, advertisements, interactive content, games, and/or any other content associated with the theme(s).

FIG. 3B illustrates another example of a customized user interface 320 (UI 320) implementing a theme and associated content. In this example, UI 320 depicts and/or represents a page 322 of a media platform. The page 322 can be displayed when the media platform associated with UI 320 is loaded or after another user interface associated with the media platform, such as after UI 300 shown in FIG. 3A. For example, the user(s) 140 can transition from UI 300 shown in FIG. 3A to UI 320 displaying the page 322.

In some cases, UI 320 and/or page 322 can implement a theme(s) and/or retain a theme(s) associated with UI 300 shown in FIG. 3A. For example, UI 320 can include visual attributes (e.g., artwork, color, color scheme, pattern, appearance, visual elements, content, interface elements, design, style, etc.), a topic (e.g., sports, football, a holiday, an event, etc.), a content experience (e.g., content interaction, animation, activity, game, etc.), a content item(s), a behavior, and/or any features associated with the football theme and/or city theme of UI 300 shown in FIG. 3A. In some examples, a user interface theme, content experience, and/or appearance can vary or remain consistent (e.g., same or with a threshold similarity or relevance) across user interfaces, interface pages, interface spaces, interface sections, content areas, etc. For example, UI 320 and/or page 322 can include a football theme like UI 300 in FIG. 3A. UI 320 and/or page 322 can additionally or alternatively maintain a similar or consistent appearance (e.g., a consistent color, color theme, background/backdrop, artwork, visual elements, etc.) as UI 300 in FIG. 3A.

UI 320 can include a backdrop 306. The backdrop 306 can include visual attributes such as a background color, a color scheme or pattern, artwork, imagery, content, objects, interface elements, visual elements, etc. The visual attributes can optionally be based on one or more themes associated with UI 320, such as the football theme and/or the city theme.

As shown in this example, UI 320 and page 322 include a football theme and a city theme. The football and city themes are depicted or conveyed in the page 322 via visual elements 304A-E and optionally via additional visual elements 324A-N (collectively referred to as “visual elements 324” hereinafter). To convey the football and city themes, the visual elements 304A-E can include artwork, images, content, hidden references or clues, animations, content, interface elements, and/or visual attributes associated with the football and city themes. Additionally, some or all of the visual elements 324 can optionally include, depict, or convey aspects of the football theme and/or the city theme. In some cases, some or all of the visual elements 324 can include hidden messages, such as hidden references to one or more respective content items (e.g., movies, TV shows, etc.).

For example, the visual elements 324 can be part of the city theme and/or the football theme implemented by UI 320. The visual elements that are part of the city theme can include city elements such as city buildings, city bridges, city structures, a cityscape, a city landmark, etc. The visual elements that are part of the football theme can include football-related elements such as football artwork, images, content, colors, logos, etc. In some cases, any of the visual elements 324 can include a reference from a content item, such as a movie or TV show, and can represent a hidden message or clue associated with the content item. For example, visual element 324A depicts a bridge from a movie and is part of the city theme, visual element 324B depicts a building from a movie and is part of the city theme, visual element 324C depicts a Ferris wheel from a movie and is part of the city theme, visual element 324D depicts a sinking boat from a movie and is part of the city theme, visual element 324E depicts a volcano from a movie and is part of the city theme, visual element 324F depicts a lamp post from a movie and is part of the city theme, visual element 324G depicts a graphic from a movie and is part of the city theme, visual element 324N depicts a football logo and is part of the football theme, visual elements 304A-C depict football-related items and are part of the football theme, visual element 304D depicts a building from a movie, visual element 304E depicts a barbershop from a movie, and visual element 304N depicts a display with football content.

The visual elements depicting content from a content item (e.g., the bridge depicted by visual element 324A, the building depicted by visual element 324B, the Ferris wheel depicted by visual element 324C, the sinking boat depicted by visual element 324D, the volcano depicted by visual element 324E, the lamp post depicted by visual element 324F, the graphic depicted by visual element 324G, the building depicted by visual element 304D, the barbershop depicted by visual element 304E) can include references to respective content items (e.g., movies, TV shows, etc.) that represent hidden messages or clues associated with the respective content items. The hidden messages or clues can engage the user(s) 140 and help provide a more immersive and/or delightful experience for the user(s) 140. For example, the user(s) 140 can try to find the hidden messages or clues as a fun challenge or game, as part of an interactive experience such as a scavenger hunt, or any other activity, game, or content experience.

In some cases where hidden messages or clues in UI 320 are gamified, if the user(s) 140 finds the hidden messages or clues (or a subset thereof) and identifies the sources/references associated with such hidden messages or clues, the user(s) 140 can provide an input via UI 320 identifying the hidden messages or clues, and can obtain a benefit for accurately identifying the hidden messages or clues (e.g., identifying all hidden messages or clues in UI 320 or a threshold number or percentage) such as an add-on to the user avatar 310, a content credit, a free content item, a subscription or upgrade, a promotion of the user(s) 140 in other user interfaces associated with the media platform displayed by other user devices, a recognition of the user(s) 140 with respect to other users, a recognition of the user(s) 140 or inclusion of a representation of the user(s) 140 in other user interfaces and/or themes (and/or within the city theme or the football theme depicted by UI 320), a discount or coupon, points, an option to select or suggest a theme or content implemented or promoted/highlighted in user interfaces presented to other users, and/or any other reward or benefit. For example, UI 320 can include a prompt 360 challenging the user(s) 140 to find all the hidden movie references in UI 320. The user(s) 140 can provide an input identifying any hidden movie references found by the user(s) 140. In some cases, the user(s) 140 can click on the prompt 360 to input the hidden movie references found by the user(s) 140.

In some cases, a hidden message or clue (e.g., a hidden reference to a content item) can be placed somewhere within UI 320 intended to drive the user to explore that portion of UI 320 and/or any content or features associated with that portion of UI 320. For example, a hidden message or clue can be placed or hidden on, within, or adjacent to a content item that the media platform associated with UI 320 wants to promote to the user(s) 140 (e.g., wants the user(s) 140 to explore or watch), a content section that the media platform wants to drive the user(s) 140 to explore, a feature such as a control/setting or functionality that the media platform wants the user(s) 140 to explore or learn, etc. This way, hidden messages can be used to steer the user(s) 140 to or incentivize the user(s) 140 to learn and/or explore certain content, features, functionalities, controls/settings, content sections, etc.

UI 320 can include an interactive section 326. In this example, the interactive section 326 includes a display depicted by interface element 304N that is used to show content related to a theme (e.g., related to the football theme). The content can include, for example, a video, a video game, an image, a content experience, an XR experience, an activity, a link to content or a content experience, etc. In some cases, the user(s) 140 can select the display depicted by the visual element 304N to watch football content, such as a football game. The display depicted by the interface element 304N can optionally display other content. For example, the display depicted by the interface element 304N can display a message notifying the user(s) 140 that UI 320 includes a scavenger hunt with hidden movie references or identifying the user(s) 140 as the winner of the scavenger hunt. In some cases, the display depicted by the interface element 304N can include a customized user avatar 365 depicting a representation of the user(s) 140. The user avatar 365 can be depicted in the display shown in UI 320 presented to the user(s) 140 and optionally the display show in the user interface presented to other users, to recognize the user(s) 140 as the winner of the scavenger hunt.

In some cases, the football theme can be carried over from UI 300 and/or backdrop 306 in FIG. 3A to the page 322. The football theme can be selected for UI 300 and page 322 based on one or more signals, such as a temporal signal, a context, an event, a trend, a user preference, a group preference, a location, a business preference, a rule or filter, a user profile, a user history, content statistics, a promotion or campaign, a user input, a weight(s) defined by the media platform, a priority, a calendar, social media data, news data, etc. For example, if the page 322 is displayed on a day or week (or any other time window) of a football championship, the page 322 can include a football or football championship theme given a temporal relevance, popularity, trending statistic, and/or promotion of the football championship (and thus football) when the page 322 is displayed.

The page 322 can include or depict any other content. For example, the page 322 can include an advertisement 328. The page 322 can include a content section 330 that includes content items 332A-N (collectively “332” hereinafter) such as movies, TV shows, channels, media applications, video games, videos, advertisements, podcasts, images, audio or music items, audiobooks, etc. In some examples, the content items 332 can include content items from a particular category, such as recommended content, recently-accessed content, content of a certain genre, content from a certain producer, content of a certain type, content of a certain popularity or rating, content personalized for the user(s) 140, etc. In some cases, the user(s) 140 can navigate the content section 330 for specific content, content categories, content libraries, content channels, content applications, etc.

In some cases, the content section 330 can highlight, prioritize, promote, and/or include content related to a theme(s) or topic(s) associated with the page 322. For example, if the page 322 includes a football theme, the content section 330 can highlight, prioritize, and/or promote content related to football. The content section 330 can optionally include other content, content categories, topics, libraries, etc.

Page 322 can optionally include menu 340. The menu 340 can include menu items 342A-N, such as a navigation menu that the user(s) 140 can use to navigate to specific content and/or spaces (e.g., sections, interfaces, pages, destinations, etc.), a menu for certain content and/or content categories, a settings menu, a search menu, a display menu, a tools menu, etc.

In some examples, UI 320 can display animated content used to increase a user appeal, steer the user(s) 140 to certain items (e.g., content, spaces, features, tools, menus, etc.), incentivize the user(s) 140 to explore certain items, help the user discover certain items, and/or teach the user(s) 140 certain features. The animated content can relate to a theme of UI 320 or can be separate from any theme of UI 320. For example, in FIG. 3B, UI 320 depicts an animation of a football 335. In this example, the animation of the football 335 relates to the football theme. The animation of the football 335 can show the football 335 moving towards and landing or crashing into something that the media platform wants to promote to the user(s) 140, steer the user(s) 140 to, drive the user(s) 140 to explore or discover, or teach the user(s) 140. For example, the football 335 can move across a portion of UI 320 and land or crash on the display depicted by the visual element 304N in order to bring the attention of the user(s) 140 to the content available via the display or steer the user(s) 140 to such content. As another example, the football 335 can move about a portion of UI 320 and land or crash on menu item 342D to steer the user(s) 140 to the menu item 342D in order to promote the menu item 342D, drive the user(s) 140 to explore the menu item 342D, or drive the user(s) 140 to select the menu item 342D to teach the user(s) 140 a feature(s) accessible through the menu item 342D or how to use or configure the menu item 342D.

UI 320 can also optionally include the user avatar 310. In some examples, the user avatar 310 depicted in UI 320 can be customized, personalized, and/or configured to depict certain visual attributes based on a theme, content, and/or experience associated with UI 320.

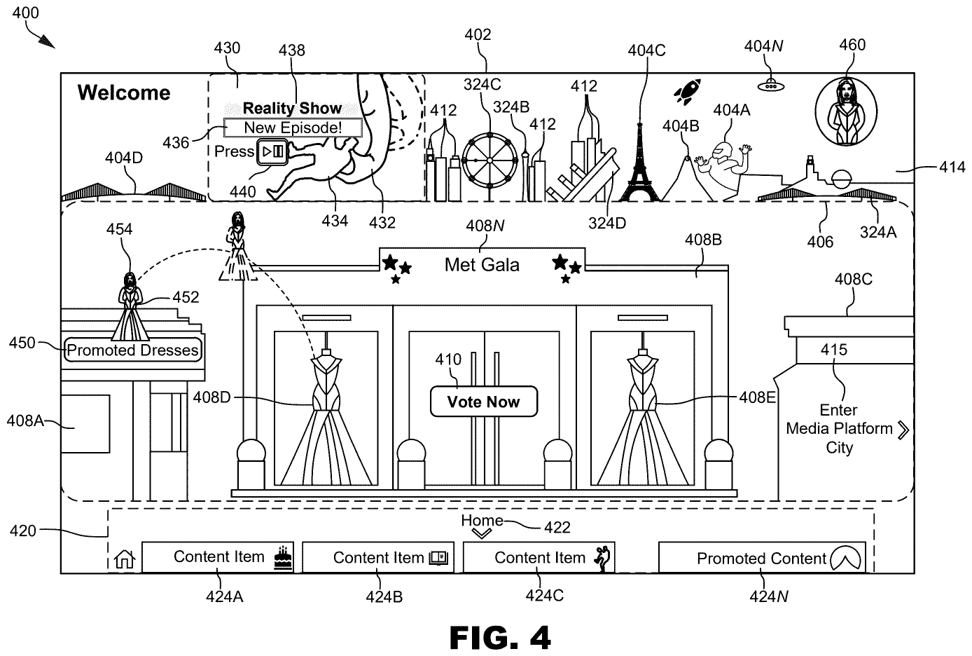

FIG. 4 illustrates another example of a user interface 400 (UI 400) configured with a theme. UI 400 can display a page 402 used to display content associated with a content platform. The content platform can be associated with or can include, host, and/or implement a software application(s), infrastructure(s), and/or environment associated with one or more media content services, TVs (and/or TV platforms, operating systems, applications, environments, etc.), media players, content servers, media entertainment systems, streaming services, content providers, media channels, set-top boxes, online media services or platforms, media receivers, broadcast receivers, linear content services/channels, digital media devices, and/or any other media content application, source, and/or software. The user(s) 140 can use UI 400 to consume (e.g., view/watch, access, play/replay, stream, display/render, etc.), navigate, interact with, and/or engage with any content, content experience, and/or features associated with the page 402 and the content platform.

The page 402 can include a section 406 of content. The content can include static content, dynamic content, animated content, image content, video content, theme-based content, video game content, interactive content, visual elements, interface elements, and/or any other content. The page 402 can optionally include one or more other sections, as further described herein.

The page 402 can include a background 414. The background 414 can include features such as one or more images, videos, colors, color schemes, patterns, interface elements, content items, visualizations, visual effects, attributes, animations, content item references, screensavers, etc. For example, the background 414 can include a backdrop, screensaver, background image, artwork, color, color pattern, graphics content, animation(s), pattern(s), logo(s), visual element(s), visual effect(s), content item(s), and/or any other content and/or attribute.

UI 400, page 402 and/or background 414 can include, depict, and/or be customized based on a theme(s). The theme(s) can be associated with a topic(s). For example, the theme(s) can be selected or determined based on one or more topics. The topic(s) used to determine or select the theme(s) can be selected/determined based on one or more signals. UI 400 and/or background 414 can be configured based on a same or different theme(s) (e.g., can implement a same or different theme(s) or aspects thereof). In FIG. 4, the theme(s) includes a city theme and a Met Gala theme. The city theme is at least partly implemented and/or depicted via visual elements 412. The visual elements 412 can depict features from a city, such as city buildings and other city elements (e.g., other elements of one or more specific cities and/or one or more general cities), and thus convey and/or form part of the city theme. The theme(s) can optionally include or depict one or more other themes.

The Met Gala theme includes a theme selected based on a topic associated with a content item (e.g., TV show, movie, video game, etc.) and/or event about, related to, and/or associated with a Met Gala, such as a Met Gala show. The Met Gala theme in this example is at least partly implemented and/or depicted via visual elements 408A-N (collectively “visual elements 408” hereinafter). The visual elements 408 depict features of, from, and/or associated with the Met Gala topic and/or event, and thus convey and/or form part of the Met Gala theme. The features of, from, and/or associated with the Met Gala topic and/or event depicted by the visual elements 408 and used to convey and/or implement the Met Gala theme (or aspects thereof) can include, depict, and/or represent one or more content items, colors, interface elements, visualizations, visualization effects, background elements, animations, attributes, items, graphics, objects, characters, images, renderings, buildings, artwork, and/or details associated with the Met Gala topic, event, and/or theme. Thus, the visual elements 408 can be part of and/or can convey, depict, and/or be configured according to the Met Gala theme.

For example, the visual elements 408A-N can depict, convey, and/or represent one or more buildings, dresses, symbols, messages, graphics, backgrounds, characters, attributes, colors, symbols, visualizations, visual effects, interface elements, promotions, content items, details, and/or artwork associated with the Met Gala topic, event, and/or TV show. In FIG. 4, the visual elements 408A-C depict or represent buildings from or associated with a Met Gala TV show, visual elements 408D-E depict or represent dresses from or associated with the Met Gala TV show (e.g., Met Gala dresses and/or dresses selected for the Met Gala theme), and visual element 408N displays the message “Met Gala”, which is used to promote the Met Gala topic and/or TV show and/or indicate that the building depicted or represented by the visual element 408B is a Met Gala building, a building from or associated with the Met Gala TV show, or a building named Met Gala.

Any of the buildings depicted or represented by the visual elements 408A-C can be used to depict one or more features associated with any of the themes of UI 400. For example, in FIG. 4, the building depicted or represented by the visual element 408A includes a content item 450 promoting dresses associated with the Met Gala topic and/or theme, such as Met Gala dresses promoted for sale, and the building depicted or represented by the visual element 408B includes the visual element 408N associated with the Met Gala theme, which as previously explained displays the “Met Gala” message, and an interface element 410 associated with the Met Gala theme. The interface element 410 can include a visual element, static element, interactive element, dynamic element, theme-based element, navigation element, input element, object, link, and/or any other element associated with the Met Gala theme.

In FIG. 4, the interface element 410 includes an input or interactive element that the user(s) 140 can select or activate to submit a vote associated with the Met Gala theme, such as a vote for a content item, character, dress, object, participant, TV show, TV episode, personality, movie, feature, promotion, activity, scene, and/or item associated with the Met Gala theme. For example, the user(s) 140 can select the interface element 410 to vote on clothing (e.g., a dress, an outfit, etc.), a participant, a character, an object, an activity (e.g., a challenge), a participant question, a participant challenge, or an episode of a Met Gala TV show associated with the Met Gala theme (and/or any other associated content).

The user(s) 140 can select the interface element 410 (and/or another interface element on UI 400) to access, load/initiate, play, or interact with content and/or a content experience associated with the Met Gala theme. For example, the interface element 410 can include an interactive/selectable element (e.g., a button, link, anchor, control, etc.) that the user(s) 140 can use to (e.g., via an input selecting or activating the interface element 410) to play or stream a content item associated with the Met Gala theme (e.g., a Met Gala content item such as a Met Gala movie, TV show, video game, etc.), purchase a product (e.g., a dress, ticket, subscription, content, object, etc.) associated with the Met Gala theme (e.g., a Met Gala product), access Met Gala content, access information about a Met Gala event or content (e.g., Met Gala products, episodes, participants, statistics, history, etc.), access an activity or interaction related to the Met Gala theme (e.g., a bet, game, content experience, etc.), display a visual rendering associated with the Met Gala theme, perform a transaction associated with the Met Gala theme, etc.

In some cases, any of the buildings depicted or represented by the visual elements 408A-C can additionally or alternatively include, promote, initiate, trigger, and/or convey other content, features, and/or themes. For example, the building depicted or represented by the visual element 408C can include a navigation element 415. The user(s) 140 can use the navigation element 415 (e.g., by selecting or activating the navigation element 415) to navigate to another destination, which may or may not include or relate to a theme(s) of UI 400, such as another interface, space, scene, experience, screen, location, content, etc. To illustrate, in the example shown in FIG. 4, when the navigation element 415 is selected or activated, UI 400 can transition to a destination that includes, represents, mimics, mirrors, depicts, and/or conveys a city theme (e.g., the city theme of user interface 400, a different city theme, a version of the city theme of user interface 400 such as a modified or updated version, and/or a similar city theme). The destination can include another interface, space, scene, experience, screen, page, and/or rendering, such as a page depicting or representing a content city associated with a content platform (e.g., a content platform associated with UI 400).

As previously noted, the Met Gala theme of UI 400 can be determined and/or selected based on a Met Gala topic. The Met Gala theme of UI 400 can be selected or implemented based on a determination that the Met Gala topic is a relevant topic (e.g., temporally relevant, contextually relevant, relevant to the user(s) 140, relevant to an event, relevant to preference of the user(s) 140 (or a preference of a user group, a business, a sponsor, or a content platform associated with UI 400), relevant to a content release date or event, relevant to a business or sponsor, relevant to a content platform associated with UI 400, relevant to a cue or condition, relevant to a trend or statistic, relevant to a content or an advertisement campaign, relevant to a promotion, relevant to a region or culture, etc.), a prioritized or promoted topic, a preferred topic (e.g., preferred by the user(s) 140, a user group, a business, a sponsor, a content platform associated with UI 400, etc.), a sponsored topic, a topic associated with a paid sponsor, a topic matching a rule or criterion, etc.

In some cases, the Met Gala topic can be associated with a Met Gala content item (e.g., TV show, movie, etc.) or event determined to be relevant (e.g., have a threshold relevance to the user(s) 140, a user group, a business or sponsor, a content platform, an event, a date, a condition, a campaign, a trend, a cue, a region or culture, a promotion, a context, a location, etc.) or selected as the basis for a theme of UI 400. For example, the Met Gala topic can be selected based on a determination that the Met Gala content item or event has a threshold relevance when UI 400 is presented (e.g., contextually relevant, temporally relevant, thematically relevant, etc.), is a promoted content item or event when UI 400, is assigned a threshold priority when UI 400 (e.g., is prioritized on a date or in a period of time including a day when UI 400 is displayed), is trending when UI 400 (e.g., is associated with a threshold trend metric), is preferred by the user(s) 140 (and/or by a user group, business or sponsor, content platform, etc.), matches one or more preferences (e.g., a user preference, business preference, sponsor preference, group preference, etc.), is associated with a content statistic, is associated with a popularity metric, etc.

For example, the Met Gala Show or event can include a show or event released and/or promoted when UI 400 is displayed (and/or within a period that includes a day when user interface 400 is displayed, within a period prior to user interface 400 being displayed, within a period after user interface 400 is displayed, etc.). As another example, the Met Gala topic used to select the Met Gala theme can be determined or selected based on a determination that the Met Gala event or content item is a trending event or content item, scheduled to occur or be released/televised on a day when UI 400 is presented (or within a time frame relative to when UI 400 is presented), a promoted event, an event of interest to the user(s) 140 (and/or to a group of users including the user(s) 140, a business or sponsor, a content platform, etc.), is temporally relevant, is geographically relevant (e.g., taking place in a same region, such as a same city or state, as the location of the user(s) 140 and/or a device used to display UI 400), is contextually relevant, is selected to be highlighted, etc.

To illustrate, if the Met Gala event occurs annually on a particular day, the Met Gala event may be a relevant and/or trending event and topic on that day (or a period of time that includes that day or relative to that day). Accordingly, the Met Gala topic can be used to select the Met Gala theme for UI 400 on that day (or period of time). When the user(s) 140 accesses UI 400 (e.g., via media device(s) 104) on that day, since the Met Gala topic/event has a threshold relevance on that day, UI 400, when presented on that day, can be customized based on the Met Gala theme. In some cases, UI 400 can dynamically incorporate (or change) thematic features (e.g., content, imagery, attributes, artwork, colors, etc.) and/or any other features associated with a topic, such as the Met Gala topic. If another topic is selected (e.g., because it is more relevant or has a higher relevance score, is promoted or has a higher promotion score, is trending or associated with a higher trending metric, etc.) on another day, the theme of UI 400 can change according to the other topic when presented on the other day (or within a timeframe). If the Met Gala topic is still the selected topic for the user interface theme on that other day, UI 400 can optionally continue implementing the Met Gala theme and/or retain any aspect of the Met Gala theme (e.g., in addition to or instead of any aspect of the other theme). Alternatively, UI 400 may remove or change any aspect of the Met Gala theme or only include a certain aspect(s) of the Met Gala theme.

UI 400 can additionally or alternatively include any other visual elements. Any of the visual elements of UI 400 can represent and/or provide a reference (e.g., hidden message or clue) to a respective content item (e.g., movie, TV show or episode, video game, etc.) and/or a feature associated with the respective content item (e.g., an object, character, building, scene, logo, symbol, vehicle, landmark, structure, graphic, activity, device, location, content, or any other feature from, depicted in, corresponding to, and/or related to the respective content item). For example, a visual element of UI 400 can be configured to depict or represent a reference to a content item and/or feature associated with the content item.

Each visual element may or may not be part of or configured based on a theme(s) of UI 400. For example, each visual element may or may not be configured or selected based on the city and/or Met Gala theme of UI 400, configured to depict a feature(s) of the city and/or Met Gala theme of UI 400 (e.g., to form part of such theme and/or convey any aspect(s) of such theme), etc. To illustrate, UI 400 in FIG. 4 includes visual elements 324A-D and 404A-N. Any of the visual elements 324A-D and 404A-N can include, depict, and/or convey a feature of a theme(s) of UI 400, such as a content, graphic, image, interface element, background, color(s), artwork, animation, object, character, logo, message, scene, structure, landmark, visualization, visual effect, visual content, and/or any other feature that depicts, conveys, and/or is part of any portion or aspect of the city and/or Met Gala theme of UI 400. Moreover, any visual element from the visual elements 324A-D and/or the visual elements 404A-N may depict, include, and/or represent a reference to a feature (e.g., object, character, building, structure, landmark, content or item from a scene, symbol, graphic, etc.) associated with (e.g., in, from, corresponding to, etc.) a content item (e.g., movie, TV show, video game, etc.), such as a content item from a content platform associated with UI 400, a content item being released, or any other content item.

In some cases, the reference to the feature associated with the content item can represent a hidden message or clue associated with the content item. Moreover, the reference to the feature associated with the content item can optionally relate to or be based on a theme(s), such as the theme(s) of UI 400. Accordingly, any of the visual elements 324A-D and/or 404A-N can be associated with a theme(s), such as the city theme and/or Met Gala theme of UI 400. For example, in FIG. 4, the visual elements 324A-C and 404B-D are associated with the city theme of UI 400. Here, each visual element depicts theme-based content, such as content depicting or representing a city element (e.g., a city building, scene, landmark, background, object, image, infrastructure item, road, sign, structure, name, etc.). To illustrate, visual element 324A depicts a city bridge, visual element 324B depicts a city building, visual element 324C depicts a Ferris wheel, visual element 404B depicts a volcano in a city, visual element 404C depicts the Eiffel tower from Paris, and visual element 404D depicts another city bridge. Thus, the visual elements 324A-C and 404B-D in this example can be part of and/or help convey/implement the city theme.

As previously noted, a visual element can additionally or alternatively represent a content item reference (e.g., a hidden message or clue from a content item) that depicts or includes a feature(s) included in, depicted in, and/or correlated to the content item. For example, the visual elements 404A-N depict references to features (e.g., objects, characters, buildings, structures, landmarks, content or items from a scene(s), symbols, graphics, etc.) from one or more respective content items and can optionally represent hidden messages or clues associated with the one or more respective content items. To illustrate, in FIG. 4, visual element 404A depicts a character from a movie and thus represents a reference to that movie (and/or the character from that movie), visual element 404B depicts a volcano from a movie and thus represents a reference to that movie (and/or the volcano from that movie), visual element 404C depicts a representation of the Eiffel Tower from a movie and thus represents a reference to that movie (and/or the Eiffel Tower representation from that movie), visual element 404D depicts a bridge from a movie and thus represents a reference to that movie (and/or the bridge from that movie), and visual element 404N depicts a spaceship from a TV show and thus represents a reference to that TV show (and/or the spaceship from that TV show).

In some cases, the topic(s) used to determine or select the theme(s) associated with UI 400 and/or background 414 can be based on a topic(s), such as a topic(s) related to, describing, representing, indicating, matching (or having a threshold similarity to), selected based on, and/or otherwise associated with an event, content, sport, category, context, rule, content category, social media data (e.g., posts, subscriptions, connections, messages, activity, trends, statistics, content, inputs, communications, profiles, etc.), genre, action or activity, location, venue and/or landmark, campaign, sponsor, product, brand, calendar, date or season, relevance metric (e.g., a score representing or measuring a temporal relevance, contextual relevance, user and/or group relevance, content consumption or statistical relevance, relevance to a business preference and/or subject, a combination thereof, etc.), input, user and/or group profile, content statistic, content history, scene or environment, preference, request, promotion, a combination thereof, and/or any other factor. As previously noted, the topic(s) associated with the theme(s) of UI 400 can be based on a signal(s).

The signal(s) can include, describe, identify, and/or correspond to a context, event, calendar data, preferences (e.g., user/group preferences, business/platform/sponsor preferences, promotion preferences, etc.), weights, rules, factors selected by an AI/ML model, filters, temporal cues, profile data (e.g., user, group, content, and/or device profile), history (e.g., content, session, input, preference, recommendation, user, group/household, social media, business/platform, event, etc.), cue (e.g., topical cue indicating a topic trend, metric, weight, relevance, priority, rank, promotion score, etc.), campaign, date, cultural/regional data (e.g., trend, preference, tradition, language, event, etc.), trend/popularity data (e.g., score/statistic associated with a topic, event, content, pattern, context, date, etc.), scene, inputs, interactions, session data, statistics, user/group attributes (e.g., demographics, social media connections, content and/or social media subscriptions, content “likes” or “dislikes”, feedback, etc.), activity, topic and/or content attributes, etc.

In some cases, UI 400, page 402, background 414, and/or theme(s) of UI 400, page 402, and/or background 414 can be customized for or based on the user(s) 140, another user, a household or group of users, a device, a group of devices, a context, a preference, an event, a situation, a condition, a rule or filter, a weight, a user input, a business preference, a business decision, a trend, a content pattern, historical data, social media data, an activity, etc. In some examples, the background 414, page 402, and/or theme(s) can be based on a configuration of UI 400, a date and/or context in which UI 400 is presented, a characteristic or profile of the user(s) 140 associated with UI 400, the device used to display UI 400, a content platform(s) or service(s) associated with UI 400, etc. In some examples, the background 414 and/or theme(s) can change or can be implemented (e.g., can remain the same or maintain a common attribute(s) or threshold similarity) across spaces (e.g., screens, interfaces, windows, pages, sections, etc.), sessions, etc. For example, the background 414 and/or theme(s) can remain the same or thematically consistent throughout a content or navigation experience, across interfaces/spaces, etc.

UI 400 can optionally include content section 420. Content section 420 can include content items 424A-N (and/or links to content items or categories of content items), such as movies, TV shows, TV channels, applications, video games, podcasts, audiobooks, videos, content catalogs, promoted content, advertisements, content categories, etc. In some cases, one or more of the content items 424A-N in content section 420 can be associated with (e.g., can relate to, can depict, can be selected based on, etc.) the Met Gala theme, such as a video of a current or previous Met Gala event, a Met Gala movie (and/or any characters, clothing articles, brands, or items associated with a Met Gala movie), a live stream or broadcast of a Met Gala event, a TV channel showing or scheduled to show Met Gala content, a documentary of a Met Gala event, a highlight reel from Met Gala events, videos of participants in one or more Met Gala events, etc. The content section 420 can additionally or alternatively include other media content items.

In some cases, the content section 420 may highlight, promote, or prioritize content items associated with the Met Gala theme, but may also or instead include other content. The content section 420 can include a navigation element 422 that the user(s) 140 can use (e.g., select or activate) to navigate content in content section 420 and/or access or navigate to other spaces (e.g., sections, pages, portions, interfaces, etc.). For example, the navigation element 422 can include a selectable element which, when selected, causes UI 400 to expand the content section 420 to display other content items, sections, portions, pages, etc.

In some cases, the content section 420 can include or represent a bottom sheet. The bottom sheet can show content anchored to a bottom of the screen of UI 400. The user(s) 140 can select or activate the navigation element 422 to expand or enlarge the bottom sheet to display content as previously explained, navigate to content items in the bottom sheet, increase a size or prominence of the bottom sheet relative to other portions of UI 400, load an enlarged or expanded view of the bottom sheet, load an additional portion of the bottom sheet, or otherwise load a page associated with the bottom sheet containing content items associated with the bottom sheet (e.g., content items that are not visible within UI 400 until the user(s) 140 selects or activates the navigation element 422).

In some cases, UI 400 can include an animation(s). The animation(s) can be used to entertain users, provide an immersive experience, and/or promote/teach or draw attention to certain content, features, functionalities, etc. For example, in FIG. 4, UI 400 displays an animated arm 432 that is surfaced from a portion of UI 400, such as a border, and can extend to a region of UI 400 and can remain static for a period or disappear (e.g., can be removed, can move out of the screen, etc.) based on a trigger, such as a timeout, a time period, an input, an interaction, etc. As shown, the animated arm 432 is depicted holding a character 434. The character 434 is also holding a message 430 promoting a new episode of a reality show 438. The message 430 can identify the new episode of the reality show 438, and can optionally include a playback control 440 that the user(s) 140 can select to play or stream the new episode of the reality show 438 and/or any other information associated with the reality show 438 and/or the new episode.

The animated arm 432, the character 434, the message 430, and the reality show 438 are merely illustrative examples provided for explanation purposes. In other examples, UI 400 can display a different animated or static graphic (e.g., a different body part, an object, an animal, a logo or symbol, a character, a pattern, a vehicle, an image, an avatar, a creature, a system, etc.), which can hold the character 434 or hold or provide a different graphic (e.g., different character, an object, an animal, a vehicle, an image, a creature, a logo, a system, a person, etc.) and/or can include a different message or any other content (e.g., a video, a game, an XR experience, an image, a video game, a prompt, a content experience, etc.).

For example, in FIG. 4, UI 400 also depicts an animated character 454 associated with the Met Gala theme. In some cases, the animated character 454 can include a participant in a Met Gala event, a Met Gala model, a visual depiction of the user(s) 140 customized to include an attribute(s) associated with the Met Gala theme (e.g., a dress or outfit, etc.), etc. In this example, the animated character 454 includes a dress depicted by the visual elements 408D-E associated with the Met Gala theme. This way, the animated character 454 can be relevant to the Met Gala theme and/or depict an aspect thereof. The animated character 454 in this example is surfaced from the dress depicted by the visual element 408D and moves within UI 400 towards a content item 450. The animated character 454 can be placed on/near the content item 450 or crash against the content item 450 to draw the attention of the user(s) 140 to the content item 450 or otherwise highlight/promote the content item 450. In this example, the content item 450 includes a button or link to content associated with promoted dresses, such as an advertisement of promoted dresses, an illustration of promoted dresses, a virtual fitting of promoted dresses, a page of promoted dresses available for purchase, a page of virtual dresses promoted as interface or avatar add-ons, a content depicting promoted dresses, an activity or experience associated with promoted dresses, etc.

UI 400 can optionally display a user avatar 460 configured, customized, and/or generated for the user(s) 140. The user avatar 460 can depict the user(s) 140 or a representation of the user(s) 140. The user avatar 460 can include an image of the user(s) 140, can be generated based on an image of the user(s) 140, can be uploaded or provided by the user(s) 140, and/or can depict a virtual, animated, cartoon, or graphical representation of the user(s) 140. The user avatar 460 can optionally be customized based on a theme(s) associated with UI 400. For example, in FIG. 4, the user avatar 460 is customized based on the Met Gala theme associated with section 406 of UI 400. As shown, the user avatar 460 includes a dress, such as a Met Gala dress, and can optionally depict a hairstyle selected based on the Met Gala theme.

In some cases, the user avatar 460 can indicate what profile is active, used, selected for, or implemented by UI 400. For example, if the user avatar 460 depicts the user(s) 140 (or a representation of the user(s) 140) or corresponds to the user(s) 140, the user avatar 460 can indicate that the profile of the user(s) 140 is active, used, selected for, or implemented by UI 400. If the user avatar 460 depicts another user or a group of users (or a representation of the other user or group of users) or corresponds to the other user or group of users, the user avatar 460 would indicate that a profile associated with UI 400 is a profile of the other user or the group of users.

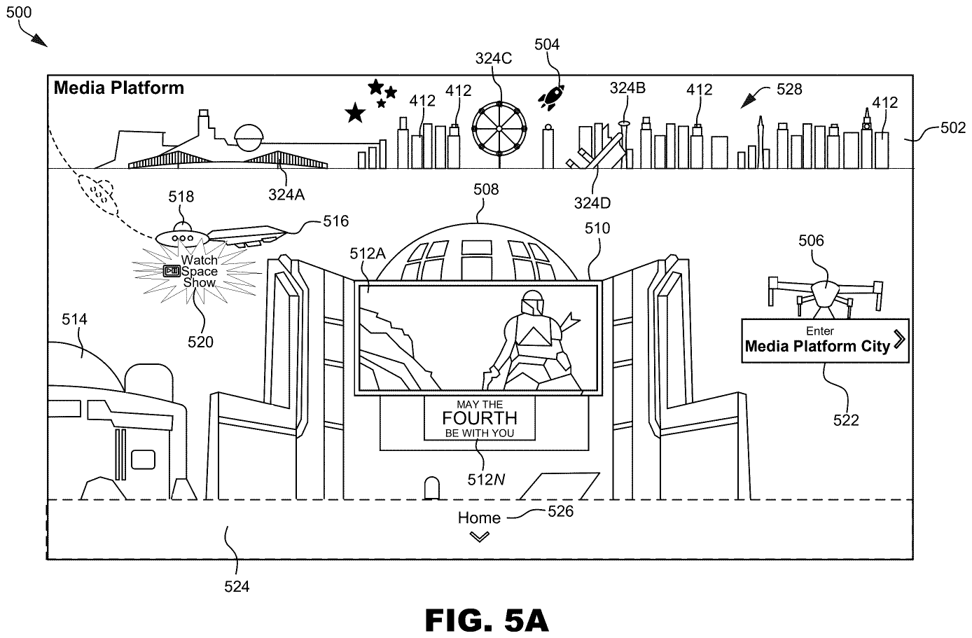

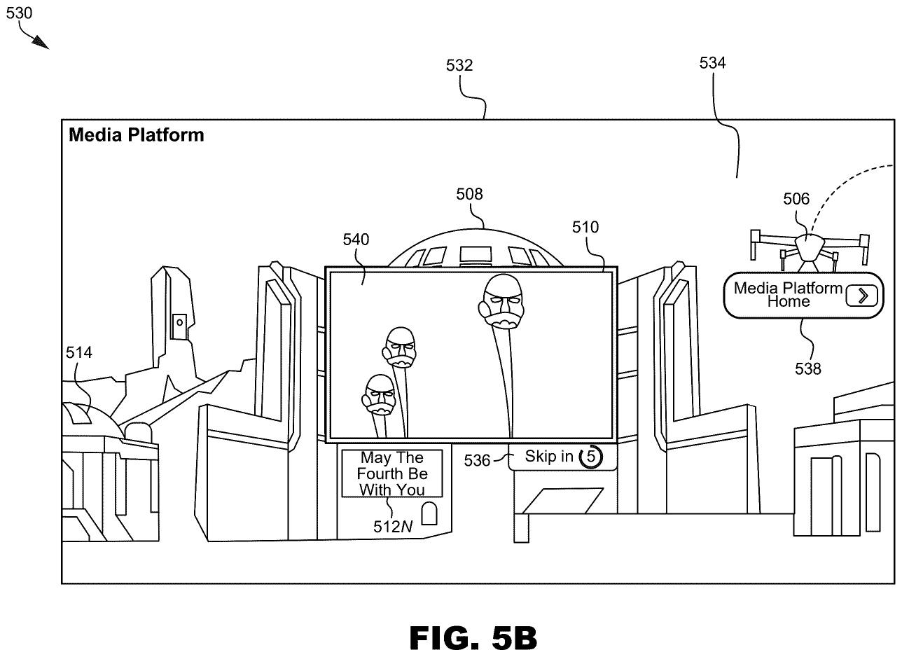

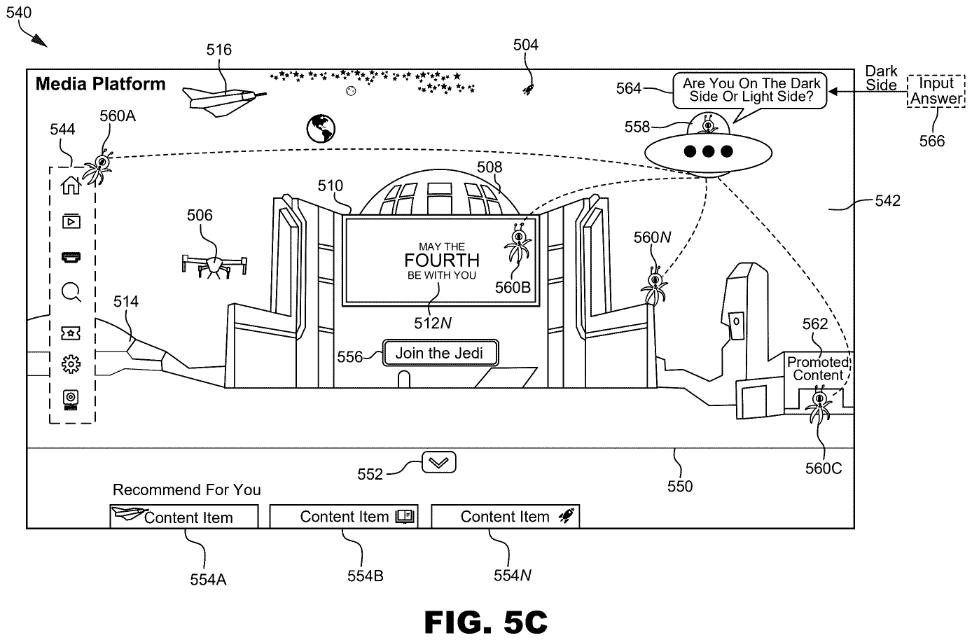

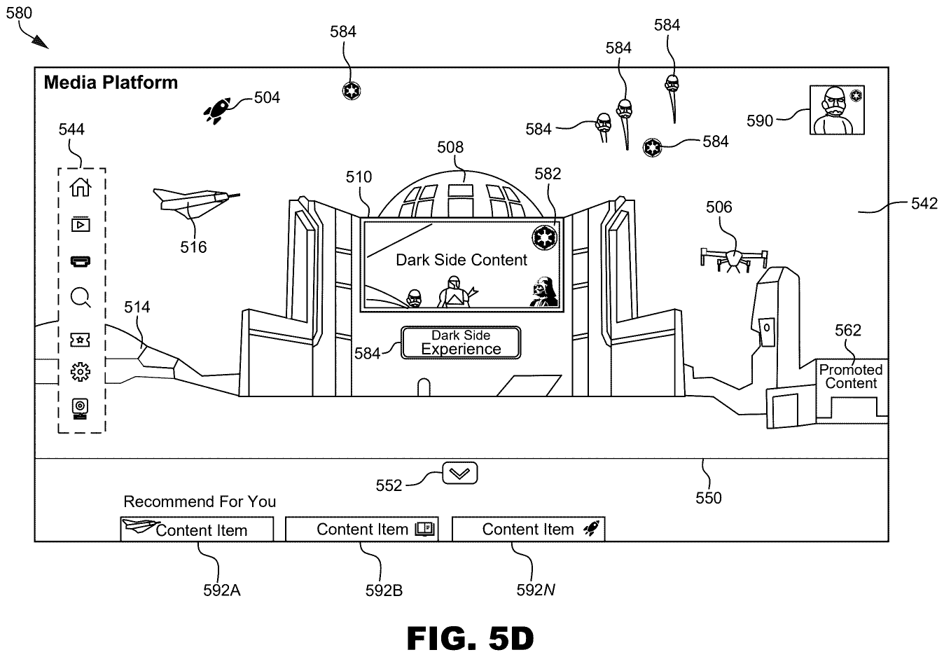

FIG. 5A illustrates another example of a user interface 500 (UI 500) configured to provide customized themes and/or content experiences. UI 500 can include a graphical user interface (GUI) of a content platform, device, operating system, media application, streaming service, media library, media channel, media entertainment system, video game system, set-top box, media broadcast player or receiver, etc. In some cases, UI 500 can represent or depict a landing or welcome page presented when UI 500 is launched or initiated and/or when an associated platform, application, service, channel, and/or library is launched, triggered, executed, etc. In other cases, UI 500 can depict or represent any other interface or page.

For example, UI 500 can provide an entry point for the user(s) 140 to access content, access or start a content experience, access or navigate a content platform, channel, service, and/or the like. UI 500 can be customized based on a theme(s) selected for UI 500. The theme(s) can be selected based on a signal(s) such as, for example and without limitation, a context signal (e.g., a device location, a current time or date, a season, an environment of the user(s) 140 and/or an associated device, a circumstance, a condition, etc.), a preferences (e.g., user preference, household or user group preference, business or platform preference, sponsor preference, etc.), an event signal (e.g., a current event, trending event, release event, calendar event, competition, sports event, TV event, content event, regional event, etc.), a statistic signal (e.g., a trend metric, a content statistic, etc.), a temporal signal (e.g., a season, date, time period, holiday, month, week, etc.), a relevance signal (e.g., a signal identifying a topic, event, location, context, activity, and/or feature that is relevant to a date, time, period, context, user preference, statistic, trend, content, etc.), a data signal (e.g., statistics, historical data, input data, a data pattern, user data, content information, event data, context data, temporal data, profile data, preference data, etc.), a signal associated with an interaction or behavior (e.g., a user interface interaction, a trending user interaction, a user input, a user response and/or reaction to certain content and/or features, a content access and/or navigation pattern, a purchasing pattern, a content behavior, etc.), and/or any other signal.

In FIG. 5A, UI 500 is customized based on a theme associated with a “May The Fourth Be With You” topic or event (e.g., a “May The Fourth Be With You” theme). “May The Fourth Be With You” is or represents an event (e.g., a cultural or popular event) that is associated with and celebrates a space show (e.g., a space movie, TV show, video game, media franchise, and/or other media content). The event is celebrated on May 4^{th} by certain people, such as fans of the space show, to commemorate, recognize, and/or celebrate the space show. The theme can be selected based on one or more signals, such as one or more signals indicating that “May The Fourth Be With You” is a relevant topic with respect to a date/day/time/period when UI 500 is presented, relevant to a context associated with the user(s) 140 and/or media device(s) 104, a relevant or trending event, a preferred event (e.g., based on a user/group preference, business/platform preference, sponsor preference, etc.), and/or a topic or event selected or promoted based on selection data (e.g., a user (and/or group) profile, a user and/or business input or profile, a user or group preference, a business or platform preference, etc.), a condition, an activity, a content item, a rule, a calendar, a statistic, social media data, etc.

For example, UI 500 can be displayed to the user(s) 140 (and any other users) on May 4^{th} and customized to include a “May The Fourth Be With You” theme. The “May The Fourth Be With You” theme can depict or include space-related features (e.g., content, attributes, interface elements, styles, designs, visual elements, graphics, artwork a background, an experience, etc.) and/or features associated with the “May The Fourth Be With You” event or topic. In some cases, the theme can be selected based on a determination that “May The Fourth Be With You” is a trending or relevant topic or event on May 4^{th}. Thus, when presenting UI 500 on May 4^{th}, UI 500 can be customized to include the theme associated with “May The Fourth Be With You”. In some examples, the theme of UI 500 can additionally or alternatively be selected based on one or more signals including and/or identifying a decision of a business or platform associated with UI 500 to promote or highlight the “May The Fourth Be With You” topic or event (and thus a “May The Fourth Be With You” theme) when UI 500 is presented, a respective weight associated with one or more topic candidates including the theme of user interface 500, a content history of the user(s) 140 or a group, a user or group preference, a rule, a calendar, a profile, a content history, content statistic, a trend, social media data, etc.

In some cases, the theme can be implemented on May 4^{th} based on a relevance, popularity, and/or history of the topic or event associated with the theme on that day. The theme can include or depict features (e.g., an appearance, content, style, color, color scheme, object, experience, animation, attribute, background, etc.) associated with or customized for or based on the “May The Fourth Be With You” topic or event. For example, the theme can depict one or more content items, experiences, attributes, graphics, artwork, background, objects, characters, animations, etc., related to a space show associated with “May The Fourth Be With You” based on a relevance of the “May The Fourth Be With You” event on May 4^{th} and/or the space show associated with such event. When the user(s) 140 accesses UI 500 (e.g., via media device(s) 104) on May 4^{th}, UI 500 displayed on that day can be customized as shown in FIG. 5A to include, incorporate, and/or depict a theme associated with “May The Fourth Be With You” and/or the associated space show. This way, UI 500 can provide the user(s) 140 a content and experience that relates to a relevant event and/or dynamically or selectively correlates to or conveys a relevant theme.

UI 500 can include a background 502 and visual elements 504-522 related to the “May The Fourth Be With You” theme, and thus conveying such theme. The visual elements 504-522 can include, for example, one or more images, colors, patterns, attributes, objects, color schemes, content experiences, characters, content items, information, styles, shapes, designs, characteristics, buildings, artwork, videos, features, interface elements, animations, background attributes, interface attributes, details, and/or other features that create or convey a theme associated with “May The Fourth Be With You”.

For example, in FIG. 5A, the visual elements 504 and 516 depict or represent spaceships, the visual element 506 depicts or represents a flying vehicle, the visual elements 508 and 514 depict or represent space or alien city structures (e.g., buildings, infrastructure, objects, and/or other visuals thematically relevant to the theme), and the visual element 510 depicts or represents a display showing content 512A-512N from or associated with a “May The Fourth Be With You” theme and/or a space show theme associated with “May The Fourth Be With You”. In this example, the content 512A can include a content item (e.g., an image, video, animation, graphic, game, etc.) and the content 512N can include a message associated with “May The Fourth Be With You”. Thus, the visual elements 504-522 can implement a theme and create an experience that relates to “May The Fourth Be With You” and/or an associated space show. Moreover, the visual elements 504-522 can immerse the user(s) 140 in an experience that relates to or is reminiscent of “May The Fourth Be With You” and/or the associated space show.

The background 502 can be selected, customized, and/or configured based on a theme(s). The theme(s) of the background 502 can include the “May The Fourth Be With You” theme associated with UI 500 and/or another theme. In FIG. 5A, the background 502 depicts a city theme. The city theme includes, depicts, and/or conveys a cityscape 528. The city scape 528 can include one or more structures, objects, attributes, elements, scenes, experiences, content items, and/or any other attributes of or associated with a city or urban area, such as a real city or urban area, a city or urban area included or depicted in one or more digital content items (e.g., one or more movies, TV shows, video games, animations, images, graphics, media channels, etc.), a city or urban area from or depicted/included in “May The Fourth Be With You” content (and/or related content), etc. For example, the cityscape 528 can include a cityscape or scene from a digital content item (e.g., a movie, TV show, video game, animation, video, image, etc.), a cityscape or scene from a physical content item (e.g., a painting, drawing, print or photograph, city landscape, etc.), a cityscape or scene from a real city or urban area, and/or physical aspects of a real city or urban area.

A theme(s) of UI 500 and/or background 502 can change across spaces (e.g., screens, interfaces, windows, screens, pages, sections, etc.) and/or experiences, or remain the same or maintain one or more theme features (e.g., with or without any variations or additional aspects) across spaces and/or experiences to maintain thematic and/or visual consistency throughout spaces and/or experiences and provide a common or related appearance and/or attribute across spaces and/or experiences. In some cases, the background 502 and/or visual elements 504-522 used to implement the “May The Fourth Be With You” and city themes can invoke a mood and/or thoughts/feelings associated with city and “May The Fourth Be With You” themes.

In some cases, the content 512A shown on the display depicted or represented by visual element 510 can include interactive content. For example, the content 512A can include a link to content, experience, game, movie, TV show, livestream, podcast, video, interactive content, etc., selectable to initiate an action, game, activity, experience, and/or content item, and/or any other content. To illustrate, the content 512A can include a link to a movie, video, game, product, or activity of the space show associated with the “May The Fourth Be With You” theme. When the user(s) 140 clicks on or selects the content 512A, the link can trigger/activate the movie (e.g., initiate playback), the video (e.g., initiate playback), the video game (e.g., start a video game session), a transaction associated with a product, the activity, the content item, etc. In some examples, the content 512A can additionally or alternatively include static content that displays content associated with the space show and the “May The Fourth Be With You” theme.

In some examples, UI 500 can include other interface sections, content, spaces, features, and/or elements such as interface elements for navigating to other interface spaces or sections, providing inputs, interacting with UI 500, engaging with content, initiating an activity, etc. For example, in FIG. 5A, UI 500 includes a navigation element 522 that the user(s) 140 can use/select to navigate to another interface space (e.g., page, section, window, category, library, screen, interface or interface region, etc.), such as a page or experience depicting a media platform city or implementing a media platform city theme. When the navigation element 522 is selected or activated, UI 500 can transition or navigate to another user interface or page, which can include, depict, or implement the media platform city theme. The navigation element 522 can be placed on any location of UI 500 and can optionally be animated. In this example, the navigation element 522 depicts a sign with a message indicating that the navigation element 522 can be used to enter the user interface or page depicting or implementing the media platform city or associated theme. The sign in this example is held by the flying vehicle depicted by the visual element 506. The visual element 506 can optionally move (e.g., fly) within UI 500 and carry the navigation element 522 as it moves to provide animation, draw the attention of the user(s) 140, delight the user(s) 140, etc.

UI 500 can optionally include a content section 524. The content section 524 can include content items (and/or associated links) or categories (and/or associated links) available through UI 500, such as movies, TV shows, channels, media platforms/applications/services, video games, podcasts, audiobooks, videos, content catalogs, etc. For example, the content section 524 can include one or more content items related to “May The Fourth Be With You” and/or the associated space show, such as a movie of the space show, a “May The Fourth Be With You” video, a live stream or broadcast of space show content, a TV channel showing or scheduled to show space show content, a space show or “May The Fourth Be With You” documentary, a space show highlight reel, a space show catalogue, etc. The content section 524 can additionally or alternatively include other content items.

The content section 524 can optionally include an interface element 526 used to navigate content in content section 524, expand content section 524 to show additional content, scroll content section 524, and/or access other spaces (e.g., sections, pages, frames, windows, interfaces, regions, etc.). For example, the interface element 526 can be selected to expand the content section 524 to display content such as recommended content, previously-accessed content, promoted content, content related to the theme of UI 500, a content experience or activity, etc. In some cases, the content section 524 can include or represent a bottom sheet used to show content anchored to a bottom of the screen of UI 500. The user(s) 140 can select or activate the navigation element 522 to expand or enlarge the bottom sheet to display content, navigate to content in the bottom sheet, increase a size or prominence of the bottom sheet relative to other portions of UI 500, load an enlarged or expanded view of the bottom sheet, load an additional portion of the bottom sheet, or otherwise load a page associated with the bottom sheet (e.g., depicting content items that are not visible within UI 500 until the user(s) 140 selects or activates the navigation element 522).

In some cases, content section 524 can include or be part of a home page of a content platform associated with user interface 500. The user(s) 140 can select the interface element 526 to navigate to, expand, display, or access the home page. For example, UI 500 can represent a page displayed when media device(s) 104 loads a media platform or application associated with UI 500. The page can include or depict a selected theme as shown in FIG. 5A. The theme can provide a content experience(s) to the user(s) 140 before the user(s) 140 navigates to another space (e.g., another page or interface) such user interface 530 shown in FIG. 5B or user interface 540 shown in FIG. 5C.

In some examples, UI 500 can depict an animation used to provide an experience to the user(s) 140, steer the user(s) 140 to a specific feature(s) (e.g., a content, content space, setting, menu, control, functionality, option, section, graphic, object, advertisement, link, experience, interface element, page, etc.), help the user(s) 140 discover a specific feature (e.g., a specific content item, setting, menu, functionality, object, link, advertisement, clue, message, interface element, experience, etc.), teach the user(s) 140 how to use a specific configuration/control feature (e.g., a menu, setting, control input, control or configuration parameter, etc.) and/or functionality, help the user(s) 140 explore UI 500, etc. For example, in FIG. 5A, UI 500 depicts an animated spaceship 518 crashing into the spaceship depicted by visual element 516. The crash between the animated spaceship 518 and the spaceship depicted by the visual element 516 can trigger UI 500 to depict a visual element 520 with a message promoting certain content. The visual element 520 can additionally or alternatively include or depict a link or interactive element (e.g., a button, a control, etc.) configured to load, navigate, initiate, play, interact with, and/or access the promoted content. The user(s) 140 can access the promoted content by selecting or activating such link or interactive element included or depicted by the visual element 520 that is shown in response to the crash.

The animated spaceship 518 and animated experience provided by the animated spaceship 518 can be selected based on a theme (e.g., “May The Fourth Be With You”) of UI 500 and can thus convey aspects of the theme and/or be relevant or related to the theme. In some cases, the content promoted by the visual element 520 can be selected based on the theme and/or can include content associated with the theme, such as a space movie, a space show, a space video game, a space documentary, a space experience, a space XR scene or environment, a space page, a content associated with “May The Fourth Be With You”, etc. The visual element 520 can additionally or alternatively promote any other content and/or can depict any other content, experience, animation, link, interface element, message, output, and/or any other feature.

For example, in FIG. 5A, the visual element 520 visually appears as, depicts, and/or represents an explosion (and/or aspects thereof) resulting from the crash between the spaceship depicted by the visual element 516 and the animated spaceship 518. The visual element 520 can depict the explosion using one or more features that convey an explosion from a crash, such as a shockwave, smoke, fire, debris, a message (e.g., “Boom”, “Bang”, “Crash”, “Explosion”, etc.), a structure or object collapsing (e.g., the spaceship depicted by the visual element 516 and/or the animated spaceship 518 collapsing), damage or disfigurement of a structure and/or object associated with the crash (e.g., the spaceship depicted by the visual element 516 and/or the animated spaceship 518), a shape representing or conveying an explosion (e.g., a shape that conveys the energy and/or radial nature of an explosion such as a sunburst shape, a starburst shape, a shape of a smoke cloud, etc.), a color(s) and/or texture(s) determined to convey an explosion (e.g., a color(s) and/or texture(s) used to simulate the visual intensity of an explosion such as any colors and textures having a threshold contrast and/or brightness), motion and/or speed used to capture the dynamic nature of an explosion (e.g., certain lines, streaks, patterns such as swirling patterns and/or any motion/animated pattern, imagery depicting or representing an explosion, etc.), etc. The object depict that depicts the content of the visual element 520, such as the promoted content and optionally any content link or control elements such as a playback or selection element.

In some cases, the crash can also include sound triggered by the crash, such as a crashing sound. Media device(s) 104 can output the sound via one or more speaker devices of media device(s) 104 or communicatively coupled to media device(s) 104 via a physical/wired and/or wireless connection.

FIG. 5B illustrates another example of a user interface 530 (UI 530) customized based on a selected theme. In this example, UI 530 is configured to provide an experience for the user(s) 140. For example, UI 530 can provide a content experience for the user(s) 140 displayed before or after the user(s) 140 navigates or accesses another page or interface of a content platform (e.g., a streaming platform, TV platform, media entertainment platform, media application, online media content service, media player, set-top box platform, media receiver, video game console platform, etc.) associated with UI 530 that displays and provides access to any content (e.g., movies, TV shows, channels, media applications or associated portals, video games, podcasts, content catalogs/collections/libraries, content sections, content features, etc.) and/or content experiences associated with the content platform, such as a home page or any content page or section.

UI 530 can implement and/or be customized based on a theme(s) associated with a topic(s) selected based on one or more signals, as previously explained. In this example, the theme(s) of UI 530 includes a theme(s) related to, associated with, depicting aspects of, and/or customized based on astronomical space (e.g., the three-dimensional (3D) cosmic expanse also known as the universe), the “May The Fourth Be With You” topic discussed in FIG. 5A, and/or features (e.g., attributes, content, artwork, etc.) associated with the “May The Fourth Be With You” topic and/or a space show associated with “May The Fourth Be With You”. As part of or based on such theme(s), UI 530 can depict a scene or environment associated with the theme, such as a space city 532 and/or any features representing, depicting, and/or associated with space city 532. The space city 532 (and associated features such as content, attributes, experiences, interface elements, settings, etc.) can be used to implement, depict, and/or convey the theme(s). The space city 532 can provide a customized, thematic experience for the user(s) 140 that depicts, conveys, and/or is associated with the theme(s) of UI 530.

In some cases, the theme(s) associated with the space city 532 can be selected based on, related to, configured based on, and/or continued from the theme(s) of UI 500 shown in FIG. 5A. For example, if the user(s) 140 navigates from UI 500 in FIG. 5A to UI 530 in FIG. 5B (or vice versa), the user interfaces displayed to the user(s) 140 when the user(s) 140 navigates from UI 500 to UI 530 (or vice versa) can maintain or persist a same theme(s) with or without any variations/adjustments in the presentation, features (e.g., content, attributes, settings, experiences, interface elements, designs, styles, configurations, customizations, etc.), and/or any other aspects of the theme(s).

To illustrate, if the user(s) 140 selects or activates the navigation element 522 displayed in UI 500 shown in FIG. 5A, the navigation element 522 can trigger UI 500 to transition to and/or load UI 530 depicting the space city 532 shown in FIG. 5B. UI management system 130 can select the theme(s) associated with UI 500 for UI 530, and customize UI 530 based on the selected theme(s) so UI 530 is customized with the theme(s) when the user(s) 140 transitions from UI 500 to UI 530. In some cases, UI management system 130 can customize UI 530 (or trigger or instruct another device, such as media device(s) 104 used to present UI 530 or content server(s) 120 hosting associated content, to customize UI 530) based on the theme(s), which in this example includes implementing or depicting the space city 532.

The theme(s) of UI 500 and UI 530 in FIGS. 5A and 5B, respectively, is/are an example(s) theme(s) provided for illustration and explanation purposes. One of ordinary skill in the art will recognize from the disclosure that the user interfaces can implement or include any other themes, which can be selected based on one or more signals as previously described and may or may not be the same or have any similar or common/shared feature(s). For example, while the example user interfaces shown in FIG. 5A and FIG. 5B include or maintain a same or consistent theme(s) (with or without any modifications/adjustments), one of ordinary skill in the art will recognize from the disclosure that, in other examples, the user interfaces 500 and 530 can additionally or alternatively implement a different theme(s) regardless of whether UI 530 is accessed, navigated, or transitioned from UI 500 (or vice versa) or a different user interface, or whether UI 500 and UI 530 are displayed on a same or different day and/or on or as part of a same or different session.

The space city 532 depicted in UI 530 can include and/or depict a background 534, visual elements 506-514, and visual elements 536-538. The background 534, visual elements 506-514, and visual elements 536-538 (or a subset thereof) can be based on, associated with, part of, customized for, and/or depict the theme(s) associated with UI 530 (and/or aspects thereof), which in FIG. 5B is associated with astronomical space, “May The Fourth Be With You”, and/or a space show associated with “May The Fourth Be With You”. The space city 532 can optionally include any other visual elements which may or may not relate to the theme(s) of UI 530 or the space city 532. The background 534, visual elements 506-514, and visual elements 536-538 (or a subset thereof) can display features (e.g., attributes, experiences, settings, behaviors, designs, styles, content, etc.) and provide/create an appearance of a city in space, related to the theme(s).

For example, background 534 can include a visual feature(s) (e.g., color(s), color scheme(s), visual pattern(s), message(s), animation(s), visual experience(s), visual style(s) and/or stylization(s), graphic(s), interface element(s), wallpaper, content, etc.) related to the theme(s) of UI 530, such as a wallpaper or screensaver depicting a representation of space (or features) and/or structures, characters, vehicles, objects, celestial bodies, interstellar or intergalactic elements, planets or planet systems, aliens or alien characters, alien objects, alien worlds, cosmic environments, and/or astronomic features depicted in, related to, associated with, similar to (e.g., having a threshold similarity, a same attribute(s), attributes having a threshold similarity, etc.), and/or created based on a space content or theme such as a space show, movie, video game, media franchise, documentary, animation, rendition, and/or video or theme.

In FIG. 5B, the screen depicted by visual element 510 displays a video 540 related to the theme(s) of UI 530, such as a space or “May The Fourth Be With You” related movie, show, animation, advertisement, game, etc. For example, when UI 530 is displayed, the screen depicted by the visual element 510 can show/play the video 540 related to the theme(s) (e.g., “May The Fourth Be With You”). The space city 532 can optionally include an interface element 536 for providing user input. For example, the interface element 536 can include a link, button, control, or interactive/selectable element that the user(s) 140 can select or activate to initiate or control a behavior (e.g., playback, etc.) of the video 540 in the screen depicted by the visual element 510. In FIG. 5B, the interface element 536 includes a button that the user(s) 140 can select to skip the video 540 or a portion of the video 540, such as an advertisement.

In some examples, UI 530 and/or space city 532 can include one or more animations used to delight the user(s) 140, draw an attention of the user(s) 140, steer the user(s) 140 to a specific feature(s), promote a specific feature(s), help the user(s) 140 navigate a specific feature(s) (and/or UI 530), help the user(s) 140 discover a specific feature(s), encourage the user(s) 140 to explore a specific feature(s), teach the user(s) 140 a specific feature(s) such as a setting or functionality, and/or otherwise promote anything in UI 530 and/or assist or delight the user(s) 140. For example, in FIG. 5B, the flying vehicle depicted by the visual element 506 can provide an animation to promote or draw an attention of the user(s) 140 to the navigation element 538 in order to steer the user(s) 140 to the destination associated with the navigation element 538 or help or encourage the user(s) 140 to explore other interface spaces, such as the destination associated with the navigation element 538.

As shown, the flying vehicle depicted by the visual element 506 can fly within UI 530. For example, the flying vehicle can appear from outside of the screen (e.g., can fly into UI 530 from outside of UI 530) and move within UI 530 while it holds or carries the navigation element 538. The flying vehicle can continue to fly around UI 530 holding or carrying the navigation element 538 or can park in an area within UI 530 and hold the navigation element 538 from the parked location. In some cases, the flying vehicle can throw or drop the navigation element 538 somewhere within UI 530 and optionally fly away. If the flying vehicle drops the navigation element 538, UI 530 can depict an animation showing the navigation element 538 falling and optionally crashing into an object, a ground level, or anything in UI 530. UI 530 can optionally animate such crash and show a visual depiction of the crash. In some cases, the crash can trigger a rendering of another object/content or animation by UI 530. For example, the crash can cause another object or content item, such as a promoted page or movie, to appear from the crash in an animated fashion. In some cases, the crash can trigger a sound such as a crashing sound. Media device(s) 104 can output the sound via one or more speakers, such as a speaker of media device(s) 104 and/or a speaker communicatively coupled to media device(s) 104 via a physical/wired and/or wireless connection.

The space city 532 can optionally include a navigation element 538 that the user(s) 140 can select or activate to access a page, interface, section, screen, or any other destination. The user(s) 140 can select the navigation element 538 to leave the space city 532 and UI 530 and access another user interface or screen, such as UI 540 shown in FIG. 5C.

While visual element 510 in space city 532 depicts a screen that displays a video 540, in other examples, the visual element 510 and/or the space city 532 can provide, depict, and/or include any other feature (e.g., content, attribute, object, animation, interface element, game, activity, experience, graphic, image, visual element, etc.) in addition to or instead of the visual element 510 and/or the space city 532. The video experience associated with the theme(s) of the space city 532 and visual element 510 in FIG. 5B is one illustrative example experience provided for illustration and explanation purposes. In other cases, the screen depicted by the visual element 510 in the space city 532 can include a video game that the user(s) 140 can play or participate in, an interactive or immersive experience related to the theme(s) associated with UI 530 (or any other topic/theme), etc. Moreover, the features and theme(s) in FIGS. 5A and 5B are non-limiting illustrative examples. One of ordinary skill in the art will recognize from the disclosure that UI 500 and/or UI 530 shown in FIGS. 5A and 5B, respectively, can include any other feature(s), theme(s), background(s), customization(s), etc., in addition to or instead of those shown in FIGS. 5A and/or 5B.

FIG. 5C illustrates another example of a user interface 540 (UI 540) customized based on one or more themes. UI 540 can be associated with a content platform(s). The content platform(s) can include, host, implement, and/or can be associated with a TV platform, a media application, a streaming service, an online media content provider, a media player, a media entertainment system, etc. In some examples, UI 540 can represent an interface of a content platform that hosts and/or provides (and can be used to access) content and content experiences, such as media content and media content experiences. In some cases, UI 540 can represent an interface of a media device, such as a smart TV or an entertainment system (e.g., a set-top box or media player, a digital media player plug-in stick such as a high definition multimedia interface (HDMI) media player plug-in stick, etc.), which can be used to access, navigate, interact with, view, manage, and/or search/find associated content, content applications, content channels, etc.

UI 540 can be customized based on (e.g., to implement) a theme(s) associated with a topic selected based on one or more signals, as previously described. In some examples, UI 540 can also include a background 542 (e.g., backdrop, wallpaper, screensaver, etc.), which may or may not be part of the theme(s) and/or a different theme(s). In FIG. 5C, the background 542 is also customized based on the theme(s) associated with UI 540 and/or is part of the theme(s) associated with UI 540. For example, the background 542 can implement or depict the “May The Fourth Be With You” theme.

In some cases, the background 542 can additionally or alternatively relate to or be based on one or more additional themes. For example, the background 542 can depict characteristics associated with (e.g., corresponding to, attributed to, relating to, designed by, used by, etc.) a content platform associated with UI 540 (and/or a brand, service, entity, etc.) such as a color(s), logo(s), pattern(s), design(s), aesthetic feature(s), advertisement(s), content, etc., associated with the content platform.

The user interfaces 500, 530, and 540 can implement a same them (with or without variations) or different themes. In the examples shown in FIGS. 5A-C, the “May The Fourth Be With You” theme is a continuous theme implemented across user interface 500 shown in FIG. 5A, user interface 530 shown in FIG. 5C, and user interface 540 shown in FIG. 5C. In some examples, the themes of the user interfaces 500, 530, and 540 can remain the same during a session(s), time period(s) (e.g., day, week, hour, another unit of time, a range of any unit of time, etc.), and/or experience(s) based on a match, similarity, relevance, and/or attributes of the topic(s) associated with the themes of the user interfaces 500, 530, and 540 (e.g., the topic(s) used to select the themes of the user interfaces 500, 530, and 540).

For example, if the user(s) 140 navigates or transitions between the user interfaces 500, 530, and 540, the user interfaces 500, 530, and 540 can maintain a same theme (e.g., with or without any variations or customizations) or aspects of a same theme. If the user interfaces 500, 530, and 540 are displayed within a specific time period or session associated with a theme (e.g., an hour, day, week, month, a unit of time, or a range of any unit of time), the user interfaces 500, 530, and 540 can maintain a same theme (with or without any variations or customizations) or aspects of a same theme. If the respective themes of the user interfaces 500, 530, and 540 are based on a same or similar (e.g., having a threshold similarity) topic, the themes implemented by the user interfaces 500, 530, and 540 can be the same or have a threshold similarity. This way, the user interfaces 500, 530, and 540 can maintain a same/consistent or similar/relevant (e.g., having a threshold similarity or relevance to each other) themes and thus provide the user(s) 140 an experience with thematic continuity (e.g., continuity in terms of a theme or aspects of a theme) or consistent customizations (e.g., customizations based on a same theme; customizations having a threshold similarity or relevance with respect to each other and/or an associated theme(s); etc.).

While the theme(s) of UI 540 is the same (with some variations, adjustments and/or customizations) as a respective theme implemented by UI 500 and UI 530, in other examples, UI 540 (or UI 500 and/or UI 530) can implement a different theme (in addition to or instead of a theme implemented by UI 500 and/or UI 530). For example, UI 540 may implement a different theme than UI 500 and/or UI 530 in addition to or instead of any theme implemented by UI 500 and/or UI 530. Moreover, in some cases, the background 542 of UI 540 can include or be part of a different theme than another theme of UI 540, a theme(s) of UI 500, and/or a theme(s) of UI 530.

The theme associated with UI 540 and background 542 can be based on a topic(s) selected based on one or more signals. The background 542 can include one or more features associated with the theme of the background 542 (e.g., the “May The Fourth Be With You” theme), such as a color(s), a color scheme(s), a visual pattern(s), a design(s) and/or style(s), an appearance(s), a content(s), an experience(s), an animation(s), a visual attribute(s), an image(s), a wallpaper, a characteristic(s), etc. The one or more features can be used to implement, convey, and/or depict the theme associated with the background 542.

Moreover, UI 540 can include visual elements 504-516 and 556-564 selected or configured based on the theme of UI 540 (e.g., the “May The Fourth Be With You” theme). The visual elements 504-516 and 556-564 can depict/convey the theme (or aspects thereof) of UI 540 and/or can include or depict features associated with the theme of UI 540. For example, the visual elements 504-516 and 556-564 can depict content items, interface elements, animations, images, colors, objects, visual attributes, characters, hidden messages or clues (e.g., content references, etc.), color schemes, videos, graphics, and/or any other features associated with the theme of UI 540, such as artwork and/or imagery depicting a space scene, a spaceship, a space city or station, a space structure, space aliens or creations, space animations, space content, space colors, and/or any other space or “May The Fourth Be With You” imagery or artwork.

To illustrate, visual element 504 depicts a rocket flying to space, visual element 506 depicts a flying aircraft, visual elements 508 and 514 depict space buildings (e.g., a space theater, home, center, dome, stadium, hospital, hotel, and/or any other space structure), visual element 510 depicts a screen (also referred to as the “screen 510”) showing a visual element 512N with a message associated with “May The Fourth Be With You”, visual element 556 depicts a control element that displays a message associated with “May The Fourth Be With You” (e.g., Join the Jedi) and/or a title of a content item associated with a space show and/or “May The Fourth Be With You” and optionally accessible via the visual element 556 (e.g., can be loaded, played, initiated, and/or rendered in response to an input selecting or activating the visual element 556 or a link or component thereof), and visual elements 558-564 depict and/or are part of an animation depicted by UI 540 that is associated with the theme of UI 540.

In some cases, visual element 556 can include an interactive element (also referred to as “interactive element 556”). When the interactive element 546 is selected, UI 540 can update a content in the screen 510 to display other content associated with the interactive element 556, such as content associated with the Jedi, which is a character from a popular space content franchise associated with the theme of UI 540 (e.g., “May The Fourth Be With You” theme), such as a movie or other video of the Jedi and/or related to the Jedi, a video game related to the Jedi, text such as a sign associated with “May The Fourth Be With You” or the Jedi, other content related to the Jedi, an immersive experience associated with the Jedi, a user interaction with a content and/or features associated with Jedi, etc. In some examples, when the user(s) 140 selects or activates the interactive element 546, the interactive element 546 can trigger the screen 510 to display certain content and/or change the content it displays, such as a movie or image related to the Jedi.

As another example, when the user(s) 140 selects or activates the interactive element 546, UI 540 can render an experience that appears as if the user(s) 140 is entering the space building depicted by the visual element 508 to access a user interface or interface space depicting a scene inside of the space building where the user(s) 140 can participate in or obtain a content experience associated with the Jedi (e.g., based on the interactive element 546 relating to the Jedi) and/or the message or content depicted by the screen 510 (e.g., “May The Fourth Be With You”). In some examples, the scene inside of the space building can include content and/or an environment based or depending on the type of space building and/or the theme associated with UI 540. For example, if the space building represents or depicts a space theater, the scene inside of the space building can include, depict, and/or represent a space theater showing content (or where the user(s) 140 can view/access content) related to the Jedi and/or “May The Fourth Be With You”, such as a Jedi movie or a space video or show. As another example, if the space building represents or depicts a space colosseum, the scene inside of the space building can include, depict, and/or represent a space colosseum showing content (or where the user(s) 140 can view/access content) depicting a fight scene or competition involving the Jedi or any other character from content or the franchise associated with the theme of UI 540 (e.g., the “May The Fourth Be With You” theme).

The visual elements on UI 540 (or a subset thereof) can provide, depict, or be part of an animation. For example, the visual element 558 depicts an alien spaceship, the visual elements 560A-N (collectively “visual elements 560” hereinafter) depict alien creatures (also referred to as “alien creatures 560” herein), and the visual element 564 depicts an interaction (e.g., a prompt, message, question, survey, communication, chat, etc.) from an alien creature in the alien spaceship depicted by the visual element 558 (also referred to as “alien spaceship 558” herein). The animation associated with the visual elements 558-564 depicts alien spaceship 558 flying around UI 540 or appearing within a view of UI 540 (e.g., appearing to fly into UI 540 from outside of UI 540) and dropping alien creatures 560 (e.g., dropping alien creatures 560 while or after alien spaceship 558 stops/parks within UI 540 or as/while alien spaceship 558 moves or continues to move about UI 540). Upon being dropped or released by alien spaceship 558, alien creatures 560 can fly, drop, land, move, hide, park, travel, or go to respective destinations on UI 540.

In FIG. 5C, the alien creature associated with the visual element 560A (also referred to as “alien creature 560A” herein) is depicted sitting on a toolbar 544 in UI 540 after being dropped/released from or exiting alien spaceship 558. The toolbar 544 can include, depict, or represent a menu toolbar with menu items. The menu items can include, for example and without limitation, a control menu for navigating to a certain destination such as a home page, a menu for accessing certain content (e.g., videos, music, movies, TV shows, podcasts, documentaries, audiobooks, images, animations, video games, promoted or promotional content, etc.), a display menu for configuring display settings (e.g., a display output setting or port, a rendering setting, a graphics setting, a visual attribute or parameter, a framerate, a resolution, an aspect ratio, etc.), a search tool, a menu for accessing a certain type of content (e.g., content of a certain content category, content of a certain genre, content associated with a certain type of content experience, video content, image content, audio content, video game content, interactive content, animated content, customized content, interactive content, XR content, movies, TV shows, video games, podcasts, VR and/or AR content experiences, and/or any other type of content), a menu for accessing a source of content or content associated with a feature (e.g., content from or with a certain topic, group, provider, producer, application, platform, channel, repository, collection, franchise, server, library, region, language, setting, etc.), a settings menu (e.g., for access settings such as content settings, device settings, interface settings, audio settings, video settings, language settings, display settings, etc.), an input or output (e.g., HDMI, etc.) source or setting, a controls menu for accessing certain controls (e.g., controls for a camera, microphone, display, content, interface, application, device, platform, etc.), and/or any other menu or menu item.

UI 540 can show the alien creature 560A going to the toolbar 544 and/or sitting (or being positioned) on the toolbar 544. Such animation can be used to engage the user(s) 140, delight the user(s) 140, provide an immersive experience, draw an attention of the user(s) 140 to the toolbar 544 (or an item thereof), promote the toolbar 544 (or an item thereof), help the user(s) 140 explore or discover/learn the toolbar 544 (or an item thereof), and/or as part of an animated experience used to guide the user(s) 140 through the toolbar 544 (or any item thereof), demonstrate a use or functionality of the toolbar 544 (or any item thereof), teach the user(s) 140 how to use the toolbar 544 (or any item/feature thereof), provide a clue to the user(s) 140 as part of an interactive or immersive game or activity, and/or provide an animated tutorial associated with the toolbar 544, and/or any other purpose.

Moreover, after being dropped/released from or exiting the alien spaceship 558, the alien creatures 560B-N in FIG. 5C are depicted going to and/or positioned at respective locations of, within, or within a proximity to the space building depicted by the visual element 508 (also referred to as “space building 508” or “alien building 508” herein). The alien creatures 560B-N can go to the respective locations associated with the space building 508 to provide an animated experience for the user(s) 140; help user(s) 140 discover, understand, or learn any features (e.g., content, functionalities, experiences, settings, etc.) available/accessible or depicted/provided at, from, or near (e.g., within a proximity, adjacent to, etc.) the respective locations associated with the space building 508; teach or guide the user(s) to access or use certain features accessible/available from, at, or near the respective locations associated with the space building 508; provide a clue(s) associated with a game or activity; incentivize the user(s) 140 to access any feature or explore a portion of UI 540 associated with the respective locations of the alien creatures 560B-N; demonstrate to user(s) 140 certain feature(s) associated with the respective locations of the alien creatures 560B-N; and/or for any other purpose.

For example, the alien creature 560B (also referred to as “alien creature 560B” herein) is shown on the screen 510. The alien creature 560B can drop or exit from the alien spaceship 558 to the screen 510 on the space building 508, and can be positioned on the screen 510 to draw attention to the screen 510 or content available via (or depicted/playing on) the screen 510, draw attention to the message depicted by the visual element 512N on the screen 510, incentivize or encourage the user(s) 140 to watch or play content on or via the screen 510, interact with the screen 510 or content on the screen 510, help the user(s) 140 discover content at or from the screen 510, etc.

The alien creature 560C (also referred to as “alien creature 560C” herein) is shown on a portion of the space building 508 that includes, displays, or provides access to promoted content 562. The alien creature 560C can be positioned by the promoted content 562 to steer the user(s) 140 to the promoted content 562, promote or highlight the promoted content 562, draw attention to the promoted content 562, incentivize or encourage the user(s) 140 to consume or access the promoted content 562, help the user(s) 140 discover or explore the promoted content 562, guide the user(s) 140 to the promoted content 562, teach the user(s) 140 how to access or anything else about the promoted content 562, and/or any other purpose. The promoted content 562 can include any content or type of content such as, for example and without limitation, a movie, a movie category or collection, a TV show, a TV show category or collection, a media application, a media channel, a video game, a video game category or collection, an advertisement, an interactive experience, an activity, an announcement, a page or interface, a brand, etc.

The visual element 564 in UI 540 can be part of the animation associated with the alien spaceship 558 and alien creatures 560. For example, the visual element 564 in FIG. 5C displays a message (also referred to as “message 564” herein) from alien spaceship 558. The message 564 can be part of a prompt, chat, question, survey, activity, game, experience, contest, challenge, promotion, campaign, tutorial, instruction, or any other message. The message 564 may or may not be part of, relevant to, or based on the theme(s) associated with UI 540. For example, the message 564 in FIG. 5C asks the user(s) 140 if the user(s) 140 is on “the dark side” or “the light side”, which are references to a space content/franchise associated with “May The Fourth Be With You”. In particular, “the dark side” refers to an evil or bad side (e.g., an evil or bad character, empire, show, etc.) from such space content/franchise and “the light side” refers to a good/righteous side or a side fighting against the bad side in such space content/franchise.

The question can be part of an experience, such as an interactive experience. For example, if the user(s) 140 provides input answer 566, input answer 566 can be used to trigger an experience, interact with a content or feature, further customize or personalize UI 540, customize/personalize or configure a content recommended/promoted or provided by UI 540, customize/personalize or configure a user profile associated with the user(s) 140, customize/personalize or configure a user avatar associated with the user(s) 140, etc. For example, the input answer 566 can be used to customize the user avatar 590 shown in FIG. 5D.

In some cases, UI 540 can include a content section 550. The content section 550 can include an interface element 552 that user(s) 140 can select to expand the content section 550 to display content (or more content) or increase the content section 550. The content in the content section 550 can relate to the theme of UI 540 (e.g., “May The Fourth Be With You” and/or associated content such as a space show or franchise), and/or any other topic. The content section 550 can include tiles 554A-N (collectively “tiles 554” hereinafter) representing content items. The user(s) 140 can use the tiles 554 (or respective links, controls, and/or interactive portions thereof) to access and/or interact with any of the content items associated with the tiles 554, watch/play or stream any of the content items (e.g., via any corresponding tiles from the tiles 554), navigate to any of the content items associated with the tiles 554, select any of the content items associated with the tiles 554, interact with any of the tiles 554 (and/or any corresponding content items), etc. The tiles 554 can represent or correspond to any type of content items (or combination of content items) such as movies, TV shows, podcasts, livestreams, videos, video games, animations, software applications, channels, advertisements, sponsored content, audiobooks, music, XR content, etc.

In some cases, the tiles 554 can include content items from one or more categories such as, for example, a recommended content category, a new release category, a live category, a genre or content category (e.g., action, comedy, horror, sports, reality TV, drama, documentaries, animation, etc.), a content type (e.g., movies, TV shows, video games, etc.), a category for a target audience (e.g., family, children, adults, etc.), a ratings category, a country category, a language category, a theme-based category (e.g., holiday category, vacation category, beach setting category, racing cars category, horseback riding category, nature category, sports category, etc.), a science category, a news category, a topic category, an experience or experience type category, etc. In some examples, the tiles 554 (or a subset thereof) can be organized, categorized, arranged, sorted, and/or grouped according to one or more factors, such as one or more factors associated with the corresponding content items, the theme of UI 540, the user(s) 140, a user preference or profile, a user avatar, a user input, a context, etc.

For example, the tiles 554 can be organized, categorized, sorted, and/or grouped according to, without limitation, a genre, year, content type, content source, channel, language, country, topic, actor or character associated with the content, content metadata (e.g., length, tag, ratings, title, etc.), history, statistics, relevance to a theme of user interface 540, content activity, promoted content or a promotion campaign, a content release date, a content award, a cost, a format, content settings, a compatibility with a device presenting UI 540, a relevance (e.g., relevance to the user(s) 140, a group of users, a household of the user(s) 140, a geographic location, a country or culture, a season, a context, an activity and/or context of the user(s) 140, an event, a trend, a topic, etc.), and/or any other factor.

FIG. 5D illustrate another example user interface 580 (UI 580) customized based on a theme(s). UI 580 can represent UI 530 in FIG. 5C with one or more updates, a version of UI 530 such as an updated version of user interface 530, a user interface navigated or transitioned from (and/or displayed after) UI 530, or a user interface generated based on (or partly based on) UI 530. For example, UI 580 can include or represent an example user interface presented to the user(s) 140 after UI 530 in FIG. 5C and/or in response to one or more user inputs provided to UI 530. In some cases, UI 580 can include, represent or provide an example of a user interface displayed after UI 530 in FIG. 5C, UI 530 updated based on one or more user inputs (and/or any other data), or a version of UI 530 further customized and/or modified based at least partly on the input answer 566 provided by the user(s) 140 in response to the message 564.

For example, the message 564 in the example shown in FIG. 5C asked the user(s) 140 whether the user(s) 140 is on “the dark side” or “the light side”, which are references to good and evil sides in a space content/franchise associated with “May The Fourth Be With You”, as previously explained. The input answer 566 from the user(s) 140 provided in response to the message 564 indicates, in the example shown in FIG. 5C, that the user(s) 140 is on “the dark side” or responded that the user(s) 140 is on “the dark side”. The input answer 566 can be used to update or modify the user interface or any aspect of the user interface. As shown in FIG. 5D, UI 580 is customized based on the same theme(s) as UI 530 in FIG. 5C and includes some (or all) of the features (e.g., theme elements, content, configuration, visual attributes, etc.) of UI 530 in FIG. 5C, but is further customized and/or modified based on the input answer 566 from the user(s) 140.

To illustrate, UI 580 in FIG. 5D includes or implements the same theme(s) as UI 530 in FIG. 5C, which in this example includes the theme pertaining to “May The Fourth Be With You” (and/or an associated space content/franchise). Moreover, the screen 510 in the space building 508 depicts content 582 associated with, selected based on (or for), and/or customized for or based on “the dark side”, such as a video (e.g., a movie, TV show, video clip, etc.), audio, music, video game, animation, and/or any other content associated with “the dark side” from “May The Fourth Be With You” (and/or an associated space content/franchise) and/or associated with or depicting a character(s), scene(s), empire(s), and/or any other aspect(s) associated with the “the dark side” from “May The Fourth Be With You” and/or the space content/franchise associated with “May The Fourth Be With You”.

UI 580 can additionally or alternatively include any other customization or modification implemented based on the input answer 566 in FIG. 5C. For example, in FIG. 5D, UI 580 additionally depicts an interface element 584 selected and/or rendered based on the input answer 566 selecting or specifying “the dark side”. The user(s) 140 can select or activate the interface element 584 to access or initiate an experience associated with “the dark side”, such as a video game, animation, movie, stream, channel, application, activity, content, and/or feature associated with “the dark side” (e.g., associated with a scene(s), character(s), location(s), landmark(s), activity, content, empire, and/or any other aspect of “the dark side”). In some cases, the experience accessed or initiated from the interface element 584 can be depicted within or by the screen 510 on the space building 508, a specific interface page/window/etc., a portion of UI 580, and/or any other user interface or user interface space/portion.

Moreover, the background 542 of UI 580 (and/or theme(s) of UI 580) depicts visual elements 584 associated with “the dark side” from the space content/franchise associated with “May The Fourth Be With You”. The visual elements 584 can depict, for example and without limitation, any character(s), scene(s), symbol(s), color(s), graphic(s), structure(s), object(s), artwork(s), vehicle(s), visual element(s), and/or any other feature(s) associated with “the dark side” or conveying a theme associated with “the dark side”.

In some examples, the input answer 566 can also be used to update and/or customize a content provided or recommended by or in UI 580, such as content associated with “the dark side” from the space content/franchise corresponding to the “May The Fourth Be With You” theme, an experience provided by UI 580, a user avatar associated with the user(s) 140 and depicted by UI 580, etc.

For example, in FIG. 5D, UI 580 displays a user avatar 590 associated with the user(s) 140. The user avatar 590 can depict the user(s) 140 (or a representation of the user(s) 140), can depict a graphic representing or depicting the user(s) 140 such as a user avatar graphic, and/or can include a photo or representation of the user(s) 140 (with or without modifications). In FIG. 5D, the user avatar 590 includes a photo (e.g., a real photo, a modified photo, an animated photo, a cartoon photo, a software-generated photo such as a generative-AI photo, etc.) or a representation of the user(s) 140 that is customized based on the “dark side” (e.g., to appear to be from “the dark side”, incorporate any feature(s) of “the dark side”, etc.). For example, the user avatar 590 can include a photo or visual representation of the user(s) 140 where the user(s) 140 is depicted with a helmet from certain characters corresponding to “the dark side”, such as storm trooper characters and/or the user avatar 590 is customized or modified to depict a background, scene, symbol, object, and/or attribute associated with “the dark side”.

If the input answer 566 had instead indicated that the user(s) 140 is on “the light side”, UI 580 (e.g., the user avatar 590, the content 582 shown in the screen 510, the interface element 584, the background 542, etc.) would have instead been customized or modified to display any other aspect associated with “the light side”. In this way, the input answer 566 from the user(s) 140 (and any other input from the user(s) 140) can be used to customize UI 580 and/or aspects thereof.

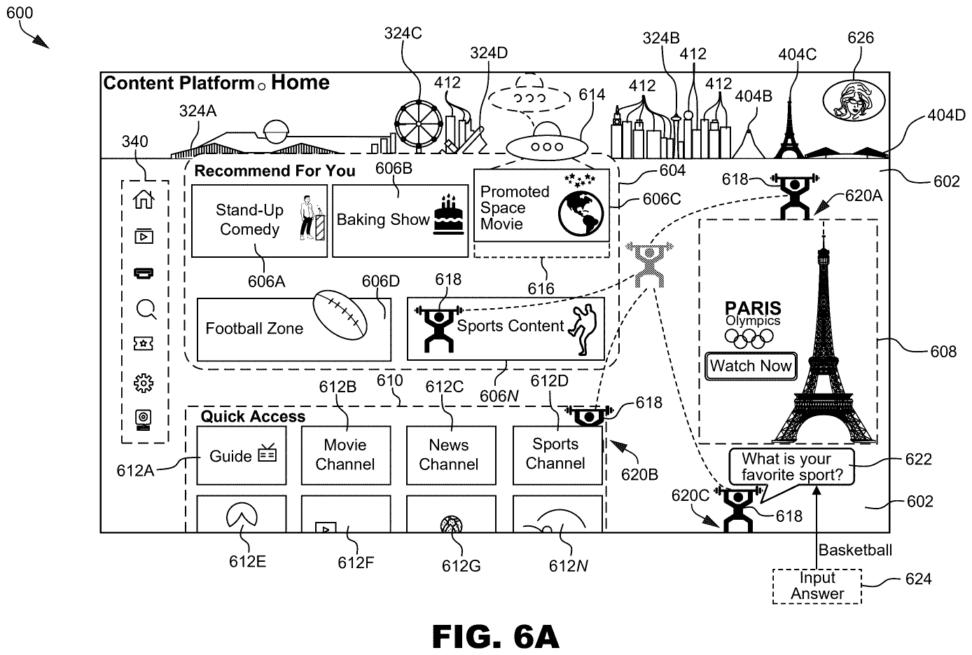

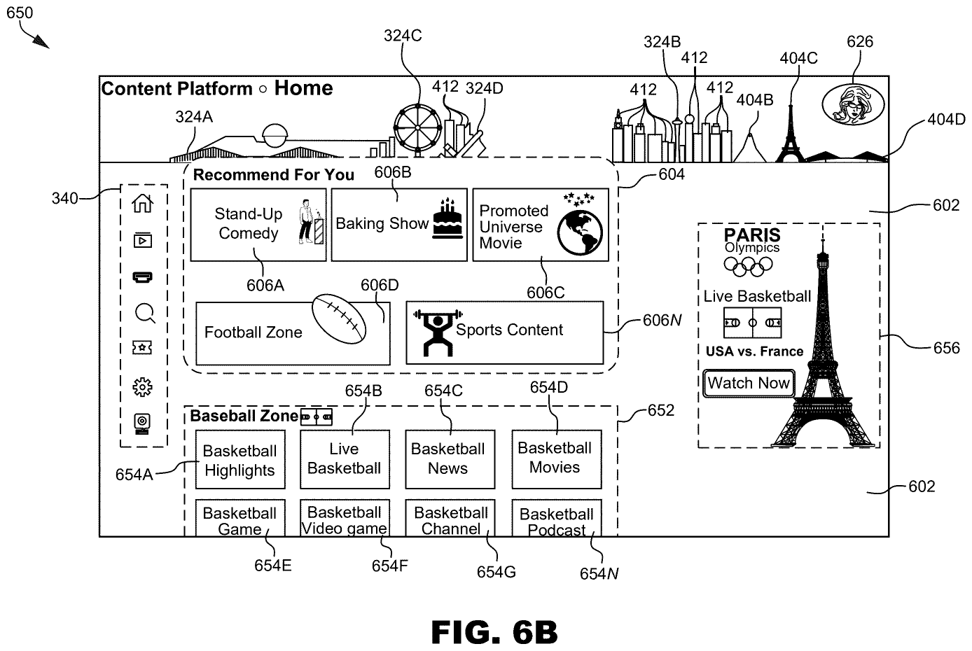

FIG. 6A illustrates another example of a user interface 600 (UI 600) customized according to a theme(s) and configured to provide immersive experiences. In this example, UI 600 includes a background 602, a content section 604, promoted content 608, a content section 610, and the menu 340. The background 602 can include background features such as background content, attributes, designs, objects, styles, etc. For example, the background 602 can include one or more images, colors, color schemes, patterns, attributes, objects, characters, content items, artwork, messages, logos, styles, shapes, designs, content item references (e.g., hidden messages or clues, etc.), visual elements, visualizations, visual effects, animations, interface elements, details, artwork, imagery, visual content, screensavers or backdrops, etc.

UI 600 can include, depict, implement, and/or can be customized and/or configured based on a theme(s). The background 602 can additionally or alternatively be configured or customized based on or according to a theme(s), such as a theme(s) of UI 600 and/or a different theme(s). For example, the background 602 can include one or more elements of a theme, such as one or more colors, attributes, content, artwork, imagery, color schemes, designs, styles, visual effects, visual elements, animations, and/or any other features of a theme of UI 600 (and/or a different theme). In FIG. 6A, the theme(s) of UI 600 and background 602 includes a city theme.

In some cases, the theme (or aspects thereof) of UI 600 and/or background 602 (e.g., the city theme) can be depicted, implemented, and/or configured using one or more visual elements, such as one or more colors, images, content items, animations, objects, graphics, artwork, interface elements, and/or any other theme elements/features. In FIG. 6A, the visual elements 324A-C, 412, and 404B-D depicted in UI 600 and background 602 are associated with the city theme. For example, the visual elements 324A-C, 412, and 404B-D can include, implement, provide, depict, convey, and/or incorporate the city theme (and/or aspects thereof), features of the city theme, and/or a look and/or experience associated with the city theme.

To illustrate, as previously explained, the visual elements 324A-C and 404B-D depict things associated with cities (and/or one or more specific cities), such as city bridges, buildings, structures (e.g., parks, benches, roads, garages, etc.), landmarks, cityscapes, scenes, vehicles, a Ferris Wheel, a volcano, etc. Any of the visual element depicted in UI 600 can optionally include or represent a reference to a respective content item. The reference to the respective content item can include or depict a feature (e.g., object, character, message, scene, landscape, landmark, activity, event, animal, graphic, building, structure, animation, content, etc.) associated with the respective content item (e.g., depicted in or within the respective content item, included in or within the respective content item, corresponding or correlated to the respective content item, etc.). In some examples, the reference to the respective content item can include or represent a hidden message or clue associated with the respective content item, such as a reference to something in the respective content item that is added to UI 600 as a hidden message or clue to entertain the user(s) 140 (e.g., by testing the ability of the user(s) 140 to recognize the visual element as a reference to the respective content item or associate the visual element with the respective content item, by providing the visual element as part of a game or activity such as a scavenger hunt or a trivia challenge, etc.).

A visual element configured as a reference, hidden message, or clue associated with a content item can include and/or depict anything from the content item such as, for example and without limitation, an object, character, scene, graphic, content item, building, structure, shape, animal, person, vehicle, logo, landmark, infrastructure, animation, element, symbol, pattern, device, and/or any other item associated with the content item. Some or all of the users who view the visual element may be able to associate the visual element with the content item and recognize the visual element as a reference to the content item. Such users can recognize the reference to the content item as part of an immersive/engaging experience with UI 600, as part of a game or activity provided by UI 600 (e.g., a scavenger hunt, a challenge, a trivia game, a questionnaire, a competition with other users, a test of the user's knowledge about the content item, etc.), as part of a challenge that allows users who successfully identify the reference associated with the visual element (and/or a certain number of references associated with a certain number of visual elements) to win benefits (e.g., points, credits, subscriptions, add-on features, discounts, opportunities to be promoted on UI 600 and/or other user interfaces, etc.) for identifying the reference (and/or the number of references), as part of any activity or event, and/or to simply entertain the user(s) 140.

As previously noted, in some cases, a visual element (or multiple visual elements) depicted in UI 600 can be associated with a theme(s), content, campaign, and/or promotion associated with UI 600. For example, in FIG. 6A, UI 600 includes promoted content 608 and the visual element 404C depicts the Eiffel Tower from Paris (or a representation thereof). The promoted content 608 in this example includes content related to the Paris Olympics, such as a video, stream, and/or recording of the Paris Olympics (or one or more events of the Paris Olympics. Like the Paris Olympics, the Eiffel Tower is also in Paris and thus similarly relates to Paris. Accordingly, the visual element 404C depicting the Eiffel Tower is also associated with or related to the promoted content 608 depicted in UI 600.

The background 602 (and/or a feature(s) of the background 602 such as a color, pattern, attribute, object, character, content, style, shape, visual effect, screensaver, visual element, interface element, design, animation, characteristic, detail, aesthetics, appearance, etc.) can be predetermined for UI 600 or selected when UI 600 is launched (e.g., dynamically or in real-time).

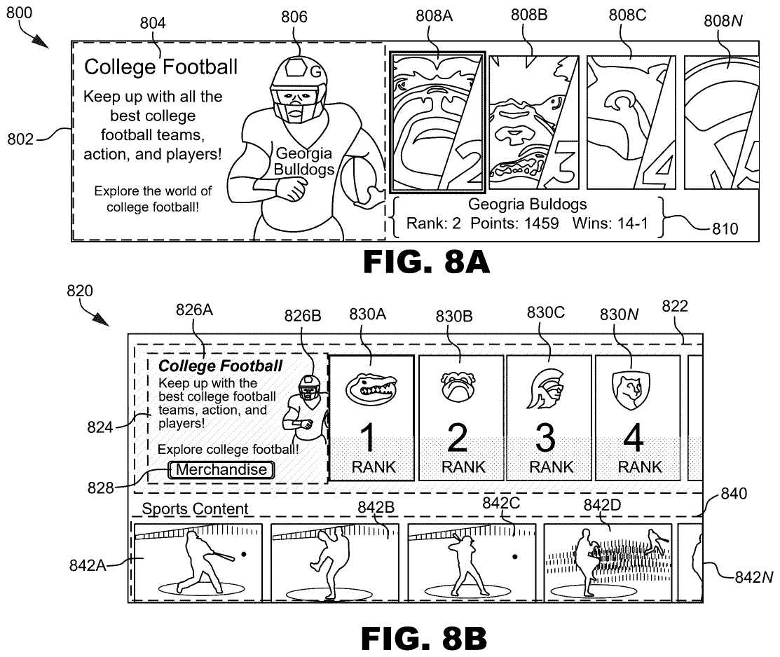

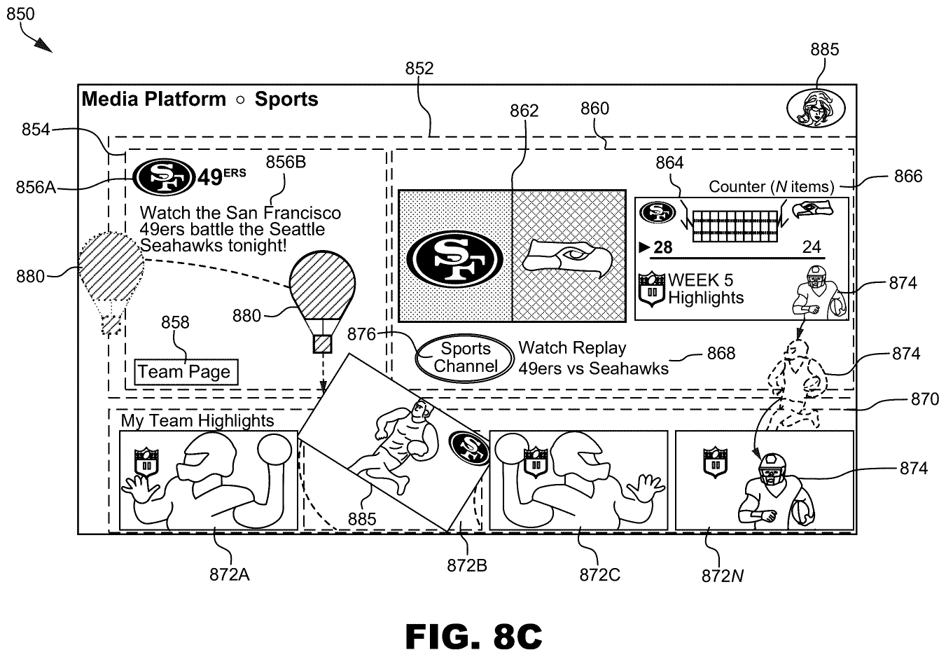

The content section 604 can include content of or accessible from UI 600. In FIG. 6A, the content section 604 includes content items 606A-N such as movies, TV shows, TV channel feeds, podcasts, video games, etc. The content items 606A-N can optionally be depicted and/or organized within tiles in the content section 604, such as any of the tiles described herein (see FIGS. 8A-C). Moreover, the content in the content section 604 may or may not be associated with the theme(s) of UI 600. For example, the content can include content selected for or based on the theme(s) of UI 600.

The content in the content section 604 can additionally or alternatively include prioritized content (e.g., prioritized by the user(s) 140, a user group, the content platform associated with UI 600, a business or sponsor, etc.), preferred content (e.g., preferred by or matching a preference of a user/group, business, content platform, sponsor, etc.), sponsored or promoted content, content associated with a user/group activity or statistic (e.g., content having a threshold statistic such as popularity or view/play counts, content previously started by a user or group of users, content selected based on a watch history of a user or group of users, content designated as a favorite or added to a list of content to watch by a user or group of users, etc.), trending content, recommended content (e.g., recommended to a user or group, etc.), contextually-relevant content, content matching a selection criteria, content associated with a weight or bias, etc.

For example, the content items 606A-N (collectively “content items 606” hereinafter) in the content section 604 can include content selected for the user(s) 140, content associated with a category (e.g., a new release category, a movies category, a TV shows category, a video games category, a genre category, a ratings category, etc.), content recommended for/to the user(s) 140 (and/or a group including user(s) 140), content recommended or suggested by UI management system 130 (and/or by a content platform associated with UI 600), content having a threshold popularity, content having a trend score, content having a threshold relevance to one or more signals/cues, content initiated by the user(s) 140 in a current or previous session (e.g., content that the user(s) 140 started watching but did not complete), and/or any other content items.

The promoted content 608 can include a content item(s) selected for promotion via UI 600, such as an advertisement, a promoted movie or TV show, etc. The promoted content 608 can additionally or alternatively include content associated with or selected based on a theme of UI 600, content associated with or selected based on a topic or event, a contextually-relevant content (e.g., content having a threshold relevance to a context), content personalized for and/or targeting the user(s) 140, and/or any other content. In some examples, the promoted content 608 can include content determined based on a context associated with the user(s) 140 (e.g., content having a threshold relevance to a context associated with the user(s) 140), a date (e.g., temporally-relevant content) when UI 600 is displayed, a calendar, a topic (e.g., a topic associated with a previous, current, and/or scheduled event, activity, promotion, trend, etc.), a location associated with the user(s) 140 and/or media device(s) 104 (e.g., the device used to display UI 600), and/or any other signal or combination of signals.

For example, if UI 600 is displayed during the Olympics, the promoted content 608 can include a video, channel, page, advertisement, feed, animation, video game, and/or any other content of or associated with the Olympics (or an Olympic event or competition). As another example, if UI 600 is presented on election day in the United States, the promoted content 608 presented to users in the United States on election day (and/or within a time period relative to election day) can include a video, channel, feed, page, animation, advertisement, and/or any other content related to the election. As another example, if a topic is trending on social media, the promoted content 608 presented while the topic is trending can include content associated with or related to the trending topic.

The content section 610 can also include content items 612A-N (collectively “content items 612” hereinafter). In FIG. 6A, the content section 610 includes a channels section. As such, the content items 612 in the content section 610 can include content channels, such as TV channels, movie channels, media streaming application channels, etc. For example, the content items 612 can include one or more channels that the user(s) 140 has access to, is subscribed to, has an account for, has accessed in a current and/or previous session, has previously watched, has added to a favorites list, has added to the content section 610, has interacted with, has requested, has a likelihood of interest in, etc.

UI 600 can optionally include the menu 340. As previously explained, the menu 340 can include one or more menu items such as toolbars or toolbar items, controls, options, content categories, links, etc. For example, the menu 340 can include, without limitation, a search tool, an input (e.g., HDMI, etc.) source setting, a settings menu, a home menu, a movies menu, a TV shows menu, a video camera menu, an input menu, an output menu, a display option, and/or any other menu item.

In some cases, UI 600 can include a user avatar 626. The user avatar 626 can include a picture of the user(s) 140 (with or without modification), an AI-generated image of the user(s) 140, an image of the user(s) 140 generated based on one or more photos of the user(s) 140 (e.g., uploaded by the user(s) 140, retrieved from a library of the user(s) 140 that includes the one or more photos, accessed from a source selected by and/or given access by the user(s) 140, etc.), and/or any other visual representation of the user(s) 140. For example, in some cases, the user(s) 140 can provide UI management system 130 (and/or a content platform associated with UI 600) access to a library that includes one or more photos of the user(s) 140 and/or upload the one or more photos to UI management system 130 (e.g., via UI 600 or another user interface) and/or an associated content platform. UI management system 130 can access a photo(s) of the user(s) 140 and use the photo(s) as the user avatar 626 and/or to generate the user avatar 626.

For example, the user(s) 140 can provide UI management system 130 (e.g., an AI/ML model of UI management system 130) access to the photo(s). UI management system 130 can use the photo(s) to generate user avatar 626. In some examples, UI management system 130 can generate a photo of the user(s) 140 using generative AI (e.g., via the AI/ML model). In some cases, UI management system 130 can generate the photo of the user(s) 140 by modifying a photo available to UI management system 130 (e.g., provided by the user(s) 140, stored in a storage or destination accessible to UI management system 130, etc.). UI management system 130 can use the generated photo as the user avatar 626 (or to generate user avatar 626). When modifying the user photo, UI management system 130 can add or change a visual effect(s) of the user photo, a photo background, a theme of the user photo, a content of the user photo, an attribute of the user photo (e.g., a resolution, a scale ratio, a color, a brightness, etc.), and/or anything else. To illustrate, UI management system 130 can apply a certain style or effect to a user photo, such as a cartoon style or effect, and use the modified photo as the user avatar 626.

In some cases, UI management system 130 can modify the user photo based on a theme of UI 600, a content depicted in UI 600, a user preference, a user input, a context, and/or any other signals. For example, if UI 600 includes a space theme, UI management system 130 can modify a user photo to add a space theme. UI management system 130 can add the space theme by adding a space background, dressing the user(s) 140 as depicted in the user photo in an astronaut suit, adding one or more features to the depiction of the user(s) 140 in the photo from the space theme (e.g., from one or more space-related content items, from one or more space-related characters, from one or more space-related people, etc.), modifying an appearance of the user(s) 140 in the user photo to include one or more characteristics associated with a space-related being (e.g., an alien or space creature, an astronaut from a media content item or a space entity such as a space agency, etc.), and/or applying any other space-related modifications.

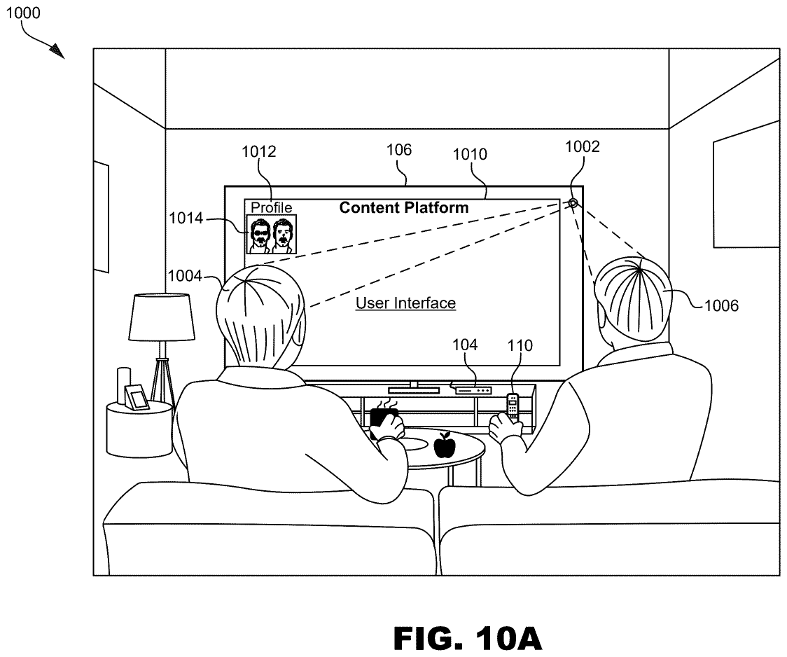

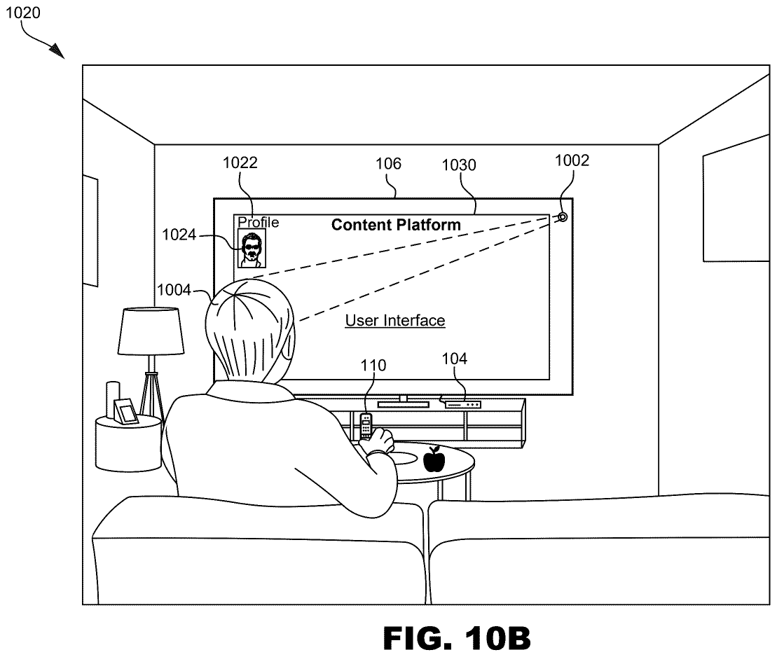

In some aspects, the user avatar 626 can be selected and displayed in UI 600 based on an availability of the user avatar 626, a user input/request, a type of content and/or session associated with UI 600, a user profile associated with UI 600, a pattern of activity (e.g., a content pattern, a pattern of interactions, etc.) detected by UI management system 130 and/or a content platform associated with UI 600 (e.g., during presentation of UI 600, during a session associated with UI 600, during one or more previous user sessions, during a time period, etc.), a prediction of a user accessing and/or viewing UI 600, and/or any other factors. For example, UI management system 130 that manages and/or configures UI 600 can detect a presence of the user(s) 140, as further described with respect to FIGS. 10A-B. Based on the detected presence of the user(s) 140, UI management system 130 can select a user profile of the user(s) 140 and activate the user profile for use when presenting/configuring UI 600 to/for the user(s) 140 and/or for use in a user session associated with UI 600. Based on the selection and activation of the user profile associated with the user(s) 140, UI management system 130 can select or generate the user avatar 626 associated with the user(s) 140 and display the user avatar 626 in UI 600.

In some case, UI management system 130 can correlate the user profile with a user avatar (e.g., user avatar 626), such as a user avatar available and identified as corresponding to the user profile (e.g., mapped to the user profile, included in the user profile, labeled or described as corresponding to the user profile and/or the user(s) 140, linked to the user profile, tagged with information used to correlate it to the user profile, associated with metadata used to correlate it to the user profile, etc.), etc. UI management system 130 can then display the user avatar correlated to the user profile on UI 600. In some cases, UI management system 130 can correlate the user profile with information used to generate the user avatar 626 for use with the user profile (e.g., for display in UI 600 when the user profile is selected/activated or as part of the content/session associated with the user profile). For example, UI management system 130 can use the user profile to identify information about the user(s) 140 associated with the user avatar 626, such as an identity of the user(s) 140, a characteristic of the user(s) 140, a user photo, a user attribute, etc. UI management system 130 can use such information to generate the user avatar 626 by creating a representation or image of the user(s) 140, modifying a photo of the user(s) 140, etc.

UI 600 can optionally provide one or more animations. The one or more animations may or may not relate to any theme of UI 600. The one or more animations can provide an immersive experience for user(s) 140, entertain user(s) 140, help user(s) 140 explore or discover content and/or features available on UI 600, educate user(s) 140 about a feature(s) and/or associated functionality, promote content and/or features to user(s) 140, interact with user(s) 140, etc. For example, UI 600 in FIG. 6A includes an animation used to bring the attention of the user(s) 140 to a content item 606C promoted by a content platform associated with UI 600. The promoted content item 606C can include a movie, TV show, advertisement, video game, or any other content. Moreover, the animation used to bring attention to the content item 606C may or may not relate to the content item 606C and/or a theme of the content item 606C.

For example, in FIG. 6A, the content item 606C being promoted includes a promoted space movie. The animation used to bring attention to the content item 606C includes a spaceship 614. Here, the spaceship 614 can appear in UI 600 while carrying the content item 606C. The spaceship 614 can move while carrying the content item 606C towards a content placement location 616 (e.g., a content slot, tile, destination, space, container, holder, etc.) within UI 600. The content placement location 616 in FIG. 6A is a location within the content section 604 for placing/presenting the content item 606C. When the spaceship 614 is above the content placement location 616, the spaceship 614 can release the content item 606C in order to drop the content item 606C on the content placement location 616. The content item 606C can fall from the spaceship 614 and land on the content placement location 616. The content item 606C can then be displayed at the content placement location 616 within the content section 604.

UI 600 in FIG. 6A displays another animation. The other animation can be part of an activity, such as a game (e.g., a scavenger hunt, a search game, etc.), and/or can be used to entertain the user(s) 140, draw the attention of the user(s) 140 to something in UI 600, and/or interact with the user(s) 140. For example, the content item 606N in the content section 604 is a sports content item with a cover, thumbnail, and/or representation that depicts an athlete 618. As part of the animation, the athlete 618 can appear to jump or climb out of the content item 606N and move to another portion/region of UI 600. In an illustrative example, the athlete 618 can move to a location 620A on top of the promoted content item 608 and appear to sit or stand on the promoted content item 608. This way, the athlete 618 and the animation of the athlete 618 can draw an attention of the user(s) 140 to the promoted content item 608, which may help highlight or promote the promoted content item 608 and/or draw the user(s) 140 to access the promoted content item 608.

In another example, athlete 618 can jump or climb out of content item 606N and move to location 620B in UI 600 to draw the attention of the user(s) 140 to location 620B. Here, the location 620B is behind content item 612D. The athlete 618 can hide behind content item 612D to draw the attention of the user(s) 140 to content item 612D (e.g., to promote or highlight content item 612D, etc.), drive the user(s) 140 to content item 612D, entertain the user(s) 140, or as part of a game or activity such as a scavenger hunt.

In another example, the athlete 618 can jump or climb out of the content item 606N and move to location 620C in UI 600. At location 620C, UI 600 can present a prompt 622 from the athlete 618 asking a question to the user(s) 140. In some examples, the question can be part of an activity, such as a game, provided to the user(s) 140, and/or an experience provided to the user(s) 140. The question can additionally or alternatively be used to seek information from the user(s) 140. Such information can be used to enhance a content experience of the user(s) 140, recommend content to the user(s) 140, customize the content depicted and/or provided via UI 600, modify or customize UI 600 (or any aspect thereof) for the user(s) 140, customize the user avatar 626, select a user profile associated with the user(s) 140, customize what content and/or features are provided to the user(s) 140 on UI 600, customize a theme of UI 600, test the user(s) 140 as part of a game or challenge, etc.

In FIG. 6A, prompt 622 includes a question asking user(s) 140 to identify a favorite sport. The user(s) 140 can provide an answer to the question. UI management system 130 can optionally use the answer from the user(s) 140 to customize an experience of the user(s) 140, gather information from the user(s) 140, interact with the user(s) 140, customize UI 600 (and/or any aspect thereof such as a content thereof, the user avatar 626, etc.), customize another page or user interface presented to the user(s) 140, etc. For example, the user(s) 140 can provide input answer 624 in response to the question in the prompt 622. In this example, input answer 624 indicates that basketball is the favorite sport of the user(s) 140.

UI management system 130 can use input answer 624 to modify or customize any aspect of UI 600, customize another user interface, customize a content experience for the user(s) 140, etc., as previously explained. For example, with reference to FIG. 6B, UI management system 130 can use input answer 624 to provide a personalized user interface 650 UI (650) to the user(s) 140. UI 650 in FIG. 6B can include or represent a version of UI 600 that is personalized to the user(s) 140 based on input answer 624.

As shown, UI 650 replaces content section 610 in FIG. 6A, which includes quick access content, with content section 652. The content section 652 is a section named “Basketball Zone” in FIG. 6B because it includes content items 654A-N (collectively “content items 654” hereinafter) associated with basketball (e.g., from a basketball category). The content items 654 can include, for example, basketball movies, TV shows, news, live games, video highlights, video games, documentaries, media channels, media applications, podcasts, XR experiences, and/or any other content items associated with basketball.

For example, in FIG. 6B, the content item 654A includes a basketball highlights video and/or a tile that the user(s) 140 can use to access basketball highlight videos, content item 654B includes a live basketball stream or a tile that the user(s) 140 can use to access live basketball streams, the content item 654C includes a basketball news feed and/or a tile that the user(s) 140 can use to access basketball news feeds, the content item 654D includes a basketball movie and/or a tile that the user(s) 140 can use to access basketball movies, the content item 654E includes a video of a basketball game, the content item 654F includes a basketball video game, the content item 654G includes a basketball channel (e.g., a channel that includes basketball content such as news, live streams, videos such as movies and TV shows, etc.), and the content item 654N includes a basketball podcast. As shown, the content items 654 are tailored to include basketball content based on input answer 624 indicating that the user(s) 140 favorite sport is basketball.

Input answer 624 can additionally or alternatively be used to personalize other aspects of UI 650. For example, in FIG. 6B, UI 650 includes another promoted content item 656. Like promoted content item 608 in user interface 600 shown in FIG. 6A, the promoted content item 656 in UI 650 also relates to the Paris Olympics. However, the promoted content item 656 in FIG. 6B is personalized based on input answer 624 to include basketball content. As shown, in this example, the promoted content item 656 includes a live basketball game from the Paris Olympics being promoted to the user(s) 140 such that the promoted content item 656 is more specifically tailored to include basketball content from the Olympics, instead of more generally relating to the Olympics.

Input answer 624 can additionally or alternatively be used to customize other aspects of UI 650, such as the background 602 of UI 650, the theme(s) of UI 650, the content section 604, the user avatar 626, and/or any other aspect of UI 650. For example, input answer 624 can be used to customize the user avatar 626. To illustrate, the user avatar 626 can be customized to depict the user(s) 140 (or the avatar representation of the user(s) 140) with a basketball jersey, a basketball headband, a basketball background, a basketball logo, a color(s) of a basketball team, etc.

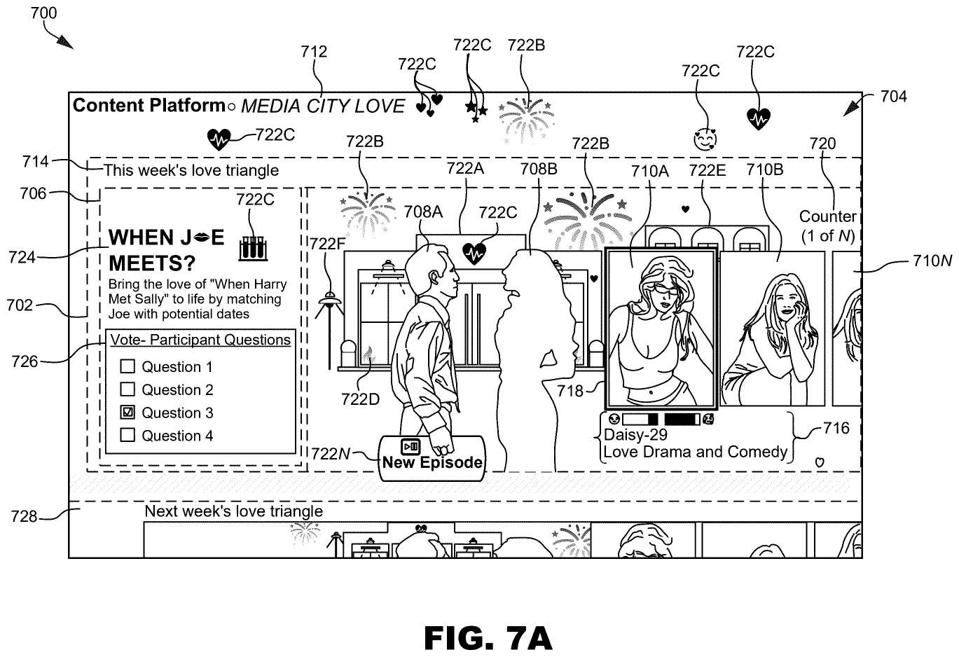

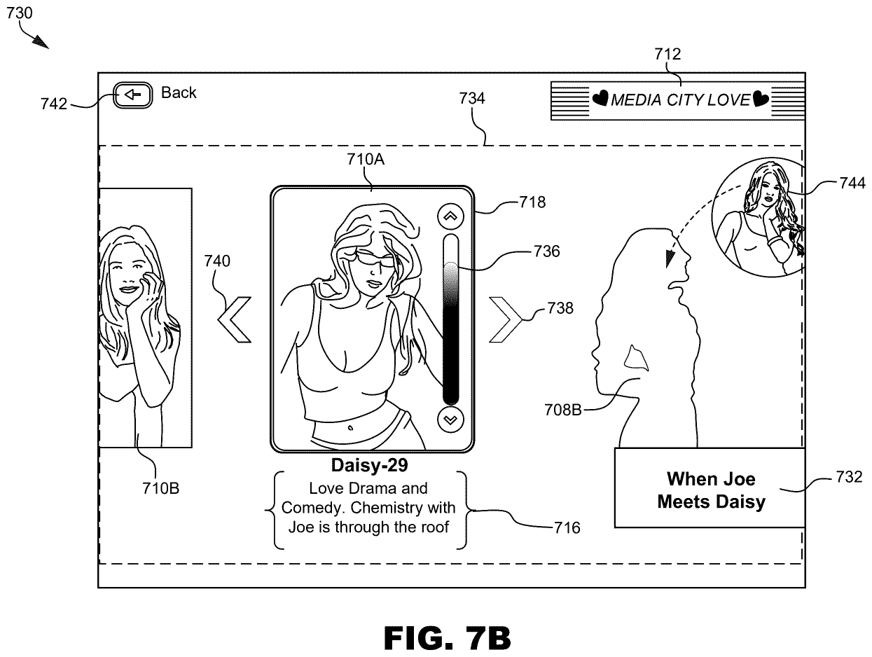

The user interfaces described herein can organize, display, arrange, and/or provide content, graphics, and/or UI elements (e.g., tiles, cards, buttons, controls, badges, sheets, sliders, menus, overlays, tabs, popups, textboxes, carousels, knobs, tooltips, input elements, links, boxes, scrollbars, contextual menus, pickers or selectors, checkboxes, dropdowns, navigation elements, snackbars, toggles, etc.) any UI element, design, and/or configuration. In some cases, a user interface described herein (e.g., any of the user interfaces described herein) can organize, display, arrange, and/or provide content, graphics, and/or UI elements (e.g., tiles, cards, etc.) within a UI row or column (e.g., frameless or with frames/borders), a UI container such as a UI banner or UI section container that includes content and/or UI elements (e.g., tiles, cards, etc.), an interface page, a window or inline frame (iframe), and/or any other UI element, design, and/or arrangement. For example, a user interface can organize, display, arrange, and/or provide content and/or UI elements such as tiles and/or cards in one or more rows, columns, or UI containers (e.g., UI banners, UI section containers, etc.) that are customized based on a theme(s), such as the UI containers displayed by the user interfaces illustrated in FIGS. 7A-8C.

A UI container can include a layout and/or container element used to group, organize, arrange, contain, provide, hold, and/or display items (e.g., content, UI and/or page elements, graphics, call-to-action components, etc.) within the user interface such as, for example and without limitation, a frame (e.g., a window, viewport, etc.) with or without a visible border, a section container that groups items into a section (e.g., a sidebar, a footer, a header, etc.), a UI banner with or without a visible border (e.g., frameless or with a visible frame), a grid container that arranges items into a grid layout, a card container configured to display items (e.g., text, graphics, UI elements, content, etc.) within a card-like design (e.g., within a square or rectangle card), a box (e.g., a horizontal box, a vertical box, etc.), a modal container containing or holding a modal window or dialog box, a scroll container with scrolling functionality, a panel container that includes a visual border or frame around items within the panel container, a tile, center container that contains items that are centered within the center container, a split container that divides a space into sections, and/or any other layout and/or container element.

In some cases, a UI container can include a UI banner. In some examples, a UI banner can include one or more rows or columns of content, animations, text, UI elements (e.g., cards, tiles, call-to-action elements, input elements, etc.), and/or any other features. The UI banner (or any other UI container) can include/contain one or more items, group and/or organize items, convey information, provide a content experience (e.g., an interactive or immersive experience, a game, an activity, a call-to-action, etc.), surface information, provide a customized experience, etc. The UI banner (or any other UI container) may or may not include, depict, and/or implement/incorporate a theme(s), such as a theme of the user interface and/or a different theme. In some cases, the UI banner (or any other UI container) can tailor an appearance, content, experience, feature(s), and/or attribute(s) of the UI banner (or the other UI container) or a presentation of items in the UI banner (or the other UI container) based on one or more factors. For example, a UI container such as a UI banner can be tailored to and/or configured based on a user, a group of users, a theme, an event, a topic, a context, a situation, a season, a date, an activity, a genre, a culture, a culturally-relevant event or topic, a location or region, a language, etc. A UI container, such as a UI banner, can be part of the design of the user interface, the appearance of the user interface, an organization of the user interface, an interactive or immersive experience provided by the user interface, a user interface structure, etc.

FIG. 7A illustrates an example of a user interface 700 (UI 700) that is customized based on a theme(s) and include a UI container 702. As shown, UI 700 includes a UI container 702. In this example, the UI container 702 is a UI banner. However, the UI banner is an illustrative example UI container provided for explanation purposes. One of ordinary skill in the art will recognize from the disclosure that the UI container 702 can include any other type of layout and/or container element such as, for example, a frame or iframe, a section container, a grid container, a card container, a box (e.g., a horizontal box, a vertical box, etc.), a modal container, a scroll container, a panel container, a tile, a split container, and the like.

UI 700 can optionally include a text portion 712 and/or a background 704. The text portion 712 can display any text content, such as a title of UI 700 (e.g., a title of a page displayed by UI 700), a text description of UI 700 (e.g., a text description of a page displayed by UI 700), a title or description of a theme(s) associated with UI 700 (e.g., associated with a page displayed by UI 700) and/or the UI container 702, a textual message, etc. The UI container 702 can include, depict, host, group, organize, and/or contain items such as content (e.g., text, visual content, content items, etc.), UI elements (e.g., UI cards, tiles, call-to-action elements, input elements, etc.), a content experience(s), and/or any other feature(s). The UI container 702 can optionally include a title 714. The title 714 can include a title of content in the UI container 702, a title or description of a theme of the UI container 702, a title or description of a content item (e.g., a TV show, movie, podcast, video game, livestream, etc.) associated with the UI container 702 and/or a theme of the UI container 702, a title or description of an episode of a content item associated with the UI container 702 and/or a theme of the UI container 702, and/or any other features of the UI container 702 and/or a theme of the UI container 702. The UI container 702 can additionally or alternatively include one or more content items (e.g., videos, images, video games, links, interface elements, audio content items, text content items, graphics content, interactive content, animated content, visual content, movies, TV shows, podcasts, etc.), content sections, UI elements, UI spaces, rows, grids, and/or the like.

In FIG. 7A, UI container 702 is a UI banner. The UI banner can have a static or dynamic shape, such as a static or dynamic banner width and/or height. The banner width can span the width of, or less than the width of, UI 700, and the banner height can span the height of UI 700 (e.g., if the banner width does not span the width of UI 700) or less than the height of UI 700. The banner width can represent a width of UI container 702. For example, the banner width can include a distance between a vertical edge (e.g., left or side border) of UI container 702 extending vertically (e.g., along a y or vertical plane) from a point on a horizontal axis (e.g., an x axis) and an opposite edge of UI container 702 extending vertically (parallel to the other vertical edge) from a different point on the horizontal axis. The banner height can represent a height of UI container 702. For example, the banner height can include a distance between a horizontal edge (e.g., top or bottom border) of the UI container 702 extending horizontally (e.g., along an x or horizontal plane) from a point on a vertical axis (e.g., y axis) and an opposite horizontal edge of the UI container 702 extending horizontally (parallel to the other horizontal edge) from a different point on the vertical axis.

UI container 702 can be placed, arranged, and/or depicted on or across a specific region(s) of UI 700. For example, UI container 702 can be located across a top portion of UI 700 such that a top edge of the UI container 702 (e.g., an edge along an x or horizontal plane) overlaps with a top edge of UI 700 and an opposite edge of the UI container 702 (e.g., a bottom edge of the UI container 702 that is opposite and parallel to the top edge of the UI container 702) is located away from the top edge of the UI container 702, in a direction towards a bottom edge of UI 700, by a distance that is equal to the banner height. In other cases, the UI container 702 can be located across a bottom portion of UI 700 such that a bottom edge of the UI container 702 along an x or horizontal plane overlaps with a bottom edge of UI 700 and a top edge (e.g., opposite/parallel to the bottom edge) of the UI container 702 is located away from the bottom edge of the UI container 702, in a direction towards a top edge of UI 700, by a distance that is equal to the banner height. In yet other cases, the UI container 702 can be located across another portion of UI 700 such as a middle portion or any other portion where the top edge of the UI container 702 is below the top edge of UI 700 and the bottom edge of the UI container 702 is above the bottom edge of UI 700.

In some cases, the UI container 702 can be shaped as a column (and/or contain items arranged as a column) and/or located within a column of UI 700. The column can have one edge along a vertical plane (e.g., a y plane) that overlaps with a left or right edge of UI 700 (e.g., along the vertical plane) and an opposite edge that extends towards an opposite edge of UI 700 by a distance that is equal to the banner width. In other cases, the column (or an edge thereof) of UI 700 may not overlap with a left or right edge of UI 700 (e.g., along the vertical plane).

The UI container 702 can be configured according to any size or geometric shape, such as a rectangular shape, a square shape, a column shape, a row shape, a grid shape, a circular or elliptical shape, and/or any other shape. While the UI container 702 in FIG. 7A is shaped as a rectangle and includes items arranged as a row, one of ordinary skill in the art will recognize from the disclosure that the UI container 702 can have any other shape and/or arrange items in the UI container 702 in any other grouping, arrangement, placement, and/or configuration. For example, the UI container 702 can be configured as (and any items in the UI container 702 can be arranged in) a column, cloud, square, table, grid, circle or ellipse, and/or any other arrangement, geometric shape, configuration, etc. The row configuration in FIG. 7A is merely one illustrative example provided for explanation purposes. Moreover, one of ordinary skill in the art will recognize from the disclosure that the UI container 702 can include any size (e.g., width, height, etc.), placement, design, and/or configuration not shown in FIG. 7A.

UI 700 and/or UI container 702 can include and/or be customized based on a theme(s). The theme(s) can be determined based on a topic(s). The topic(s) can be selected based on one or more signals, as previously explained. In FIG. 7A, UI 700 and UI container 702 include and are customized according to a romantic city theme. The romantic city theme is selected based on a topic of and/or that includes a dating reality show (e.g., a reality TV dating show). The reality TV dating show can include a show about or involving a dating or matchmaking competition. The reality TV dating show and/or romantic city theme in this example can be based on, have a threshold relevance to, associated with, inspired by, and/or targeted to viewers or fans of a popular romantic comedy film named “When Harry Met Sally”. The reality TV dating show includes contestants/participants who compete for a date, relationship, and/or romance with a main character (e.g., a bachelor) named Joe. The show starts with contestants/participants engaging in challenges (e.g., activities) and/or having dates with Joe in the hopes of being picked by Joe. At the end of each round, Joe selects one or more contestants to remain in the show and at least one contestant to be eliminated from the show. The show includes a number of such rounds where contestants/participants are selected to stay or leave (e.g., be eliminated) until a winner is selected.

The show may be selected as the source of the romantic city theme based on a relevance of the show (e.g., a relevance to a day when UI 700 is presented, a relevance to the user(s) 140 or a user preference, a relevance of a release date of the show to a date when UI 700 is presented, a relevance to a user group or demographic, a relevance given a trend/popularity metric associated with the show, a relevance given a statistic associated with the show, a relevance to a context associated with the user(s) 140, etc.). For example, if the show airs on the day when UI 700 is presented, the show may be identified as a relevant topic on that day. The topic associated with the show can be used to select the romantic city theme.

As another example, if UI management system 130 determines that the reality dating show is a trending topic (e.g., based on a threshold number of views, social media posts, references in other media content and/or a public discourse, purchases, subscriptions, votes for contestants, etc.), UI management system 130 may select the show as a topic used to determine a theme for UI 700 and/or UI container 702. UI management system 130 can use such topic to select the romantic city theme. The show is one example of a topic or a content item used as the basis of a topic used to select a theme for UI 700 and/or UI container 702, and the romantic city theme is one example theme implemented by UI 700 and UI container 702. In other examples, UI 700 and/or UI container 702 can implement a different theme, and the selected theme can be based on a different topic (e.g., a different event, content, condition, context, factor, etc.).

The UI container 702 can optionally promote certain content such as the reality TV dating show (or an episode or merchandise thereof), a sponsor content, an advertisement, and/or other content. Moreover, the configuration and/or design of UI 700 and UI container 702 (e.g., the content, layout, artwork, visual attributes, UI elements, shape, arrangement, content experiences, visual effects, visual elements, colors, color schemes, images/imagery, background, content elements, organization, style, and/or any other features) can be customized based on (e.g., can implement) the romantic city theme (e.g., can convey the theme), immerse users in the theme, engage users via the theme, etc. In some cases, as part of the romantic city theme, the UI container 702 can include content associated with the reality TV dating show, display information about the show, include interactive content (e.g., a game/activity) associated with the show, depict features (e.g., visual elements, artwork, colors, logos, patterns, designs, attributes, etc.) associated with the show, display a background associated with and/or based on the show, display characters and/or objects associated with the show, include visual content and/or interface elements associated with the show and/or the associated romantic city theme, etc.

To illustrate, if the reality TV dating show is associated with a certain background (e.g., because a content item used to promote the show includes that background, that background resembles a background depicted in the show or a scene of the show, that background matches or has a similarity to a background in an advertisement or other content or event of the show, etc.), UI 700 and/or UI container 702 can depict that background or a background configured based on that background (e.g., a background that has a threshold similarity and/or relevance to that background associated with the show, a background that has a particular color or color scheme of that background associated with the show, etc.). This way, the background used for the theme of the UI container 702 can be based on or have a correlation, relationship, similarity, and/or resemblance to a background associated with the show (e.g., the background of the UI container 702 can relate, convey, resemble, and/or be attributed or associated by users to the show).

As another example, if the show has previously depicted (or is known for depicting) contestants in a school yearbook format with a grid of thumbnails containing pictures of contestants, the UI container 702 may depict contestants (e.g., representations of contestants, content items depicting the contestants and/or representations thereof, etc.) of the show within the UI container 702 in a school yearbook format that includes a grid of thumbnails. This way, the theme of the UI container 702 can include a format/configuration that matches, relates to, resembles, correlates to, has a similarity to, and/or is attributed or associated by users to the show.

In FIG. 7A, UI 700 and UI container 702 include a background 704. The background 704 can optionally be based on, depict, include, and/or implement/incorporate a theme(s). The theme(s) may or may not include a theme(s) of UI 700 and/or UI container 702, such as the romantic city theme. For example, the background 704 can include content, a backdrop or background image, a screensaver, a scene (e.g., a landmark, a building, a house, a cityscape, etc.), one or more visual elements, one or more features (e.g., one or more colors, shapes, patterns, images, designs, color schemes, animations, videos, content items, interface elements, graphics, views, objects, artwork, etc.), a visual attribute(s), animated content, a background style(s), a background design(s), a background content organization/arrangement, content item references (and/or hidden messages or clues), and/or any other features which may or may not depict, include, and/or implement/incorporate the romantic city theme of UI 700 and UI container 702, and/or may or may not be associated with (e.g., from, of, inspired by, related to, based on, corresponding to, etc.) the reality TV dating show associated with the romantic city theme.

To illustrate, the background 704 may depict a house where the reality TV dating show (or any scene or portion thereof) takes place or is filmed, a house where contestants of the show live during the show, something from or depicted in the show (e.g., a house, a scene, an object, a character, a logo, a color scheme, a landmark, a view, a building, a structure, an animal, a vehicle, a view, a graphic, etc.), one or more features (e.g., one or more visual elements, colors, color schemes, attributes, objects, graphics, artwork, images, animations, content items, scenes, etc.) associated with the show, visual elements associated with the show, etc. The one or more features associated with the show can include features from the show, correlated to the show, selected based on the show, and/or designed to invoke or convey a mood, scene, and/or motif (e.g., a dating, romantic, night, and/or any other mood, scene, and/or motif) associated with (e.g., that matches, relates to, corresponds to, has a threshold relevance to, has a threshold similarity to, is based on, conveys, includes, etc.) a mood, scene, and/or motif of the show.

The background 704 can additionally or alternatively include a theme(s) that is different from a theme(s) of UI 700 and/or UI container 702. For example, the background 704 can include a theme(s) that is different from the romantic city theme of UI 700 and UI container 702. The background 704 can implement such theme(s) in addition to or instead of the romantic city theme.

UI 700 and/or UI container 702 can include visual elements 722A-N (collectively “visual elements 722” hereinafter). The visual elements 722 can be part of the theme of UI 700 and/or UI container 702 (e.g., the romantic city theme), selected based on such theme, associated with such theme, configured based on such theme, customized based on such theme, used to implement such theme, and/or configured to depict an aspect of such theme. For example, visual element 722A depicts a building from the reality dating show associated with the romantic city theme of UI 700, the visual elements 722B depict fireworks to convey a romantic mood, the visual elements 722C include romantic emojis (e.g., emojis determined to convey a romantic mood or motif such as heart emojis, star emojis, smiling face emojis, a chemistry emoji, etc.), the visual element 722 depicts a fireplace inside of the building associated with the visual element 722A which provides a romantic mood (e.g., is associated with a mood classified as a romantic mood) and represents a content item reference that relates to the romantic city theme (e.g., is a reference to a fireplace in a movie or TV show and can optionally represent a hidden message or clue associated with that movie or TV show), the visual element 722E depicts a building from a romantic movie and is part of the romantic city theme and represents a reference to the romantic movie (and optionally a hidden message or clue associated with the romantic movie), the visual element 722F depicts a lamp from a romantic city scene in a movie and is part of the romantic city theme (and can optionally represent a hidden message or clue associated with that movie), and visual element 722N depicts an object promoting an episode of the reality TV dating show associated with the romantic city theme.

The visual element 722N can optionally include a link or selectable object that the user(s) 140 can select or activate to access and/or watch the episode of the reality TV dating show promoted by the visual element 722N, play/stream the episode, navigate to a destination where the user(s) 140 can watch or play/stream the episode, load the episode, purchase the episode, subscribe to the episode (or a channel or application that has the episode and can be used to watch the episode), and/or access information and/or content associated with the episode.

In some cases, the UI container 702 can include one or more sections (e.g., one or more content sections, interface spaces, interface frames, etc.). For example, the UI container 702 can optionally include a section 706 that includes one or more features (e.g., content, UI elements, information, etc.) associated with the UI container 702, the theme of the UI container 702, and/or the reality TV dating show associated with the theme of the UI container 702. In FIG. 7A, the section 706 includes a text portion 724 and a UI element 726. The text portion 724 includes information about the reality TV dating show such as a title of the show, a summary or description of the show, a schedule of the show, information about an episode(s) of the show, information about a status of a competition associated with the show, sponsored content associated with the show, and/or any other content and/or information.

In some cases, UI element 726 can include content and/or a content experience, such as an interactive content or experience associated with the reality TV dating show (e.g., a game, challenge, survey, prompt, activity, animated interactive experience, XR experience, option to submit a vote associated with the show, etc.). In FIG. 7A, UI element 726 includes a prompt with a question. The prompt can allow the user(s) 140 to vote on a question that the main character (e.g., the bachelor) Joe in the reality TV dating show should ask the remaining participants of the show in a future round or challenge. In other cases, the prompt may additionally or alternatively include other voting options, such as options to vote for remaining participants from the show, options to vote on a predicted or preferred winner of the show, options to vote on activities or challenges for the remaining participants in the show, options to vote on outfits that Joe or any participant(s) can wear in a round or challenge/activity, and/or any other voting options.

In some cases, UI container 702 can additionally or alternatively include an image 708A of Joe, who is the main character (e.g., the bachelor) from the reality TV dating show. UI container 702 can optionally include a silhouette 708B depicting an outline of a participant of the show (e.g., a winner of the show or round, eliminated participant, participant with the highest or lowest votes, etc.) or an image of any participant. In some cases, the silhouette 708B may not initially depict a specific person but can be subsequently updated to display (e.g., to be filled in with an image of) a specific person (e.g., a participant, a user, etc.), such as a winner of the show or a winner of a round of the show such that the silhouette 708B initially depicts a representation of an unknown participant (e.g., depicts an outline of a non-specific person) but is later updated to depict a specific participant (e.g., once the participant is known or selected).

In some cases, the silhouette 708B may depict or be updated to depict a user, such as user(s) 140 or a winner of a game associated with UI 700. For example, the silhouette 708B can be updated to depict or be filled with an image of the user(s) 140 such as a real picture of the user(s) 140, an image of the user(s) 140 generated by UI management system 130 (e.g., via an AI/ML model), an image of the user(s) 140 customized by UI management system 130, an image of the user(s) 140 from an avatar of the user(s) 140 or a photo album of the user(s) 140, or any other representation of the user(s) 140. The silhouette 708B in FIG. 7A is depicted next to the image 708A of Joe. However, in other examples, the image 708A of Joe and the silhouette 708B can be displayed in another configuration or arrangement as desired (or excluded).

In some cases, the UI container 702 can include UI elements, such as tiles, cards, navigation elements, interactive elements, section elements, container elements, display elements, input elements, visual elements, and/or other elements. In FIG. 7A, UI container 702 includes tiles 710A-N (collectively “tiles 710” hereinafter). The tiles 710 in this example are associated with the reality dating show. The tiles 710 include images, thumbnails, or profiles of contestants (e.g., participants) in the show to depict the contestants of the show (e.g., contestants competing in a current or upcoming round of the show such as contestants who have not been eliminated). The tiles 710 can be static (e.g., not selectable or dynamic), dynamic, or interactive. For example, the tiles 710 (or a portion thereof) can be selectable to retrieve information about an associated contestant, interact with content associated with the associated contestant, provide an input associated with the contestant (e.g., vote for the contestant, submit a request for the contestant, purchase merchandise associated with the contestant, etc.), play/stream content associated with the contestant (e.g., videos with the contestant, highlights or video clips of the contestant, portions of the show that include the contestant, etc.), and/or initiate an activity associated with the contestant.

To illustrate, if the user(s) 140 selects the tile 710A corresponding to the contestant named “Daisy”, UI 700, the UI container 702, or the tile 710A can display or load content associated with Daisy (e.g., a page, tile, showcase banner, window, interface, inline frame, video, image, tile content, etc.) such as personal information about Daisy, historical data associated with Daisy, votes received by Daisy from voting users, statistics of Daisy, and/or any information. In another example where the tile 710A is selectable to initiate an interactive experience, if the user(s) 140 selects the tile 710A, UI 700, the UI container 702, or the tile 710A can load a game such as a reality game or a game with Daisy as a character (and/or themed according to the reality TV dating show). The user(s) 140 can participate in the game as Daisy or control (or request) actions of Daisy in the game. If the tiles 710 are configured to allow users to cast votes for corresponding contestants, the user(s) 140 can select the tile 710A to cast a vote for Daisy (or select any other tile to vote for any other contestant) and optionally view information about Daisy such as votes or a percentage of votes received by Daisy (e.g., relative to other contestants).

In some cases, UI container 702 can display other types of tiles. For example, UI container 702 can display tiles of content items that the user(s) 140 can access, watch, play, and/or interact with via such tiles. To illustrate, UI container 702 can display tiles of videos, movies, TV shows, live streams or broadcasts, applications, channels, etc., which may or may not relate to the reality TV dating show, any of the contestants of the reality TV dating show, and/or the romantic city theme. The tiles 710 in UI container 702 can include or correspond to contestants of the reality TV dating show. However, in some cases, the tiles 710 may correspond to other things. For example, the tiles 710 can correspond to content items available to the user(s) 140 through UI 700 and UI container 702, such as previous episodes of the show, recap or replay videos of episodes from the show, other shows (e.g., other matchmaking reality shows and/or any other type of reality shows), movies and/or TV shows (e.g., movies and/or TV shows related to a theme of the reality TV dating show, such as romance movies and/or TV shows), etc.

The UI container 702 can optionally display metadata associated with any of the tiles 710. The metadata of a tile can be displayed relative to that tile (e.g., under, next to, above, adjacent to, inside/within, etc.). For example, in FIG. 7A, the UI container 702 includes a metadata section 716 below the tile 710A of Daisy. The metadata section 716 can include information about Daisy and/or any associated information, UI elements, visual elements, etc., such as a voting meter, emojis, symbols, statistics, merchandise, a call-to-action (CTA), etc. In this example, the metadata section 716 includes a name and age of the contestant associated with the tile 710A (Daisy), information about the contestant (e.g., Daisy loves true crime and stand-up), and voting meters or bars indicating how many votes have been cast for and against the contestant. However, one of ordinary skill in the art will recognize from the disclosure that the metadata section 716 can include other information, in addition to or instead of what is shown in FIG. 7A.

In some cases, each of the tiles 710 can include its own metadata section. In other cases, only a subset of the tiles 710 may include a respective metadata section. For example, in FIG. 7A, only tile 710A includes a metadata section. The metadata section 716 is displayed for the tile 710A of Daisy because the tile 710A has been selected by the user(s) 140, as depicted by the outline 718 (or highlight) around the tile 710A. In other cases, the UI container 702 can include a respective metadata section for the tile corresponding to the contestant with the most votes (or the top n number of tiles corresponding to the top n number of contestants with the most votes) or the tile(s) corresponding to any other contestant(s) (e.g., a favorite or most popular contestant(s) to the user(s) 140 or an audience, a contestant(s) that has been selected to continue to a next round or eliminated from a next round, etc.). In some examples, when the user(s) 140 selects a tile, UI 700 can update a presentation of the tile to show that the tile has been selected. For example, in FIG. 7A, tile 710A includes an outline 718 to show that the tile 710A was selected.

In some cases, if the tiles contained/hosted in/by UI container 702 (e.g., the number of tiles included based on the number of participants or remaining participants in the show) do not fit within the display area of UI container 702, UI container 702 can be configured to allow users to scroll to other tiles to see the other tiles and/or change which tiles are shown within UI container 702. For example, in FIG. 7A, tile 710N does not fit entirely within a current view of UI 700 and is partially truncated. However, the UI container 702 may be scrollable to allow the user(s) 140 to scroll through the UI container 702 to bring the rest of the tile 710N (and, optionally, any other tiles that are not shown in FIG. 7A) within view (e.g., within a view of UI 700). In some cases, rather than truncating a tile that does not fit within UI 700 (e.g., instead of showing a partial tile), the UI container 702 may remove the tile from a current view of UI 700 such that the user(s) 140 would need to scroll the UI container 702 to see that tile.

In some cases, rather than truncating or excluding any tiles, UI 700 can resize any of the tiles 710 so the tiles 710 fit within a view of UI 700 and tile 710N is not truncated (partially shown). When resizing tiles, the overall size (e.g., the height and/or width) and/or aspect ratio of all or some of the tiles 710 can be increased or decreased. Moreover, the tiles 710 can have (e.g., can be displayed according to) a same size and/or aspect ratio, or different sizes and/or aspect ratios. For example, to highlight or promote a tile(s), the size and/or aspect ratio of that tile(s) can be adjusted (e.g., increased) relative to other tiles in order to convey/indicate that such tile(s) is highlighted or promoted.

The size and/or aspect ratio of the tiles 710 and/or the number of tiles to display within a view of the UI container 702 without requiring a user to scroll the UI container 702 can depend on one or more factors. The one or more factors can include, for example and without limitation, a size of a screen used to display UI 700, a resolution of the screen, a size of UI 700 (e.g., a window size or a height and width of UI 700), user preferences, a resolution of the tiles 710, a layout of the tiles 710 (e.g., landscape, portrait, etc.), an amount of space within the UI container 702 used by other content/elements in the UI container 702 (e.g., text section 706, image 708A, silhouette 708B, etc.), a type of device (and/or device characteristics) used to display UI 700 (e.g., a TV, computer display or monitor, smartphone screen, smart glasses, HMD, smartwatch display, etc.), and/or any other factors.

In some cases, each of the tiles 710 can have a same shape and/or layout. In other cases, the shape and/or layout of the tiles 710 (or some of the tiles 710) can vary. For example, the tiles 710 can all be depicted in a landscape or portrait layout. In other cases, one or more of the tiles 710 can be depicted in a particular layout and one or more other tiles can be depicted in a different layout. To illustrate, tiles 710B and 710N can be depicted in a portrait layout and tile 710A can be depicted in a landscape layout (or vice versa) because tile 710A is selected/highlighted (e.g., to show that tile 710A is selected/highlighted). The size and/or aspect ratio of any of the tiles 710, such as tile 710A, can be additionally or alternatively adjusted (e.g., increased, decreased) to convey information about such tile(s) and/or the other tile(s). For example, the size and/or aspect ratio of tile 710A can be increased relative to other tiles to show that tile 710A is selected/highlighted and/or to promote tile 710A.

In some cases, the user(s) 140 can optionally resize any of the tiles 710 or provide sizing information used to resize any of the tiles 710. When resizing tiles, there may be constraints limiting how much a tile can be resized (e.g., reduced or increased in size or aspect ratio). For example, the user(s) 140 or the device managing UI 700 (e.g., UI management system 130 and/or the device displaying UI 700) can provide rules specifying/setting a minimum tile size or aspect ratio to prevent tiles from being adjusted to a size below the minimum tile size or aspect ratio (e.g., to avoid tiles being reduced so much that users may have difficulty seeing such tiles or associated details) and/or specifying/setting a maximum tile size or aspect ratio to prevent tiles from being increased in size above the maximum tile size or aspect ratio.

The UI container 702 can optionally include a tile counter 720 that indicates the number of tiles in UI container 702. The tile counter 720 can allow a user determine whether any tiles in the UI container 702 are not visible within a current view of the UI container 702 (e.g., to indicate whether the user needs to scroll the UI container 702 to see other tiles). For example, if the tile counter 720 indicates there are eight tiles in the UI container 702 and only three tiles are shown in a current view of the UI container 702 (e.g., tile 710A, tile 710B, and partial tile 710N), a user can determine that there are five other tiles in the UI container 702 that are not currently shown/visible in the UI container 702 (e.g., that are not within the currently visible portion of the UI container 702). The other five tiles may not be visible because the eight tiles do not fit within the portion of the UI container 702 that is visible within a current view of the UI container 702, for example. In such cases, UI management system 130, the user(s) 140, or the device displaying UI 700 can determine whether to resize any tiles (or all tiles) so more tiles (or all tiles) fit and are visible within a view of the UI container 702 without scrolling the UI container 702.

For example, UI management system 130 can compare the user interface space available within the UI container 702 for placing tiles and/or the screen size of UI 700 with the number of tiles in the UI container 702 and/or the total size of the tiles in the UI container 702, to determine whether the tiles can be resized to fit within a visible portion of the UI container 702. In some cases, UI management system 130 can take into account a minimum tile size defined (if any) to determine whether the tiles fit within the visible portion of the UI container 702 without reducing the size of tiles below the minimum tile size. If UI management system 130 determines that all tiles do not fit within the visible portion of the UI container 702 without reducing the size of tiles below a minimum size, UI management system 130 can determine whether to reduce the overall size of tiles enough to fit all tiles within the visible portion of the UI container 702 (e.g., even if any tiles are reduced below the minimum tile size) or whether to reduce a subset of the tiles in a way that does not violate the minimum tile size requirement but increases the number of tiles that can fit (e.g., are visible) within a view of the UI container 702.

UI management system 130 (or the user(s) 140) can weigh whether to show all tiles within the visible portion of the UI container 702 (e.g., without requiring the user(s) 140 to scroll the UI container 702), which may require the tiles to be smaller than if some of the tiles are excluded or truncated, or show larger tiles, which may prevent all tiles from fitting within a visible portion of the UI container 702 (and thus require the user(s) 140 to scroll to see one or more of the tiles). For example, if UI management system 130 (or the user(s) 140) prioritizes showing all tiles within a visible portion of the UI container 702 to avoid requiring the user(s) 140 to scroll the UI container 702 over showing larger tiles and consequently requiring the user(s) 140 to scroll the UI container 702 to see some of the tiles, UI management system 130 (or the user(s) 140) can reduce the overall size of the tiles to allow all tiles to be displayed within a visible portion of the UI container 702 and avoid requiring the user(s) 140 to scroll the UI container 702.

Alternatively, if UI management system 130 (or user(s) 140) prioritizes showing larger tiles or avoiding reducing the size of the tiles (or any tile) below a certain size (e.g., even if that size is larger than the minimum tile size) over trying to fit all tiles within the visible portion of the UI container 702, UI management system 130 (or the user) can select to display a subset of tiles according to a larger tile size (e.g., for each tile or the overall subset of tiles) and place one or more remaining tiles outside of the visible portion of the UI container 702 such that the user(s) 140 would need to scroll the UI container 702 to see the one or more remaining tiles (e.g., to place them within the visible portion of the UI container 702).

In some cases, the tiles 710 can be configured, modified, or tailored based on the theme of UI container 702. For example, the tiles 710 in FIG. 7A depict participants of the reality dating show associated with the theme of UI container 702. The participants can be depicted with a background associated with the theme of the UI container 702. In other examples, the user(s) 140 can revise the tiles 710 and/or the content depicted by the tiles 710 (e.g., participants). For example, the user(s) 140 can specify how a participant of depicted in a tile should be shown or modified. UI 700 can modify the depiction of the participant associated with that tile to show the participant as specified by the user(s) 140. To illustrate, if the user(s) 140 specifies a dark or light theme for the tiles 710, UI 700 can depict the participants in the tiles 710 according to a dark or light theme. If the user(s) 140 specifies that the participant associated with the tile 710A be shown with an outfit from a previous episode, UI 700 can update the tile 710A to show the participant with such outfit.

In some examples, the UI container 702 can include other features (e.g., content, visual elements, interface elements, objects, etc.) that are not shown in FIG. 7A. For example, the UI container 702 can include one or more UI elements that allow the user(s) 140 to provide an input(s), such as a CTA (e.g., a button, link, control, etc.) that the user(s) 140 can select to initiate an action such as a purchase of merchandise related to the reality TV dating show, an element with a link to something such as a link to content, a website (e.g., a website of the reality show, a sponsor, associated merchandise, etc.), an application (e.g., an application related to the show, a dating application, a social media application, or any other application), a channel, and/or anything else.

In FIG. 7A, the UI container 702 (e.g., UI banner) is depicted without visible borders (e.g., frameless). In other examples, the UI banner can include one or more visible borders. UI 700 can optionally include other content sections. For example, UI 700 can include content section 728. Content section 728 is depicted outside of the UI container 702 (e.g., below the UI container 702 or at any other location within UI 700 and relative to the UI container 702). The content section 728 can include content, UI elements, visual elements, and/or any other features that may or may not be associated with the reality TV dating show or implement the romantic city theme. For example, the content section 728 can include content items related to the reality TV dating show (e.g., previous episodes, previous seasons, highlight videos, recap videos, preview videos or trailers, contestant videos, other images of one or more contestants, other images of Joe, etc.), related to other reality shows, related to a similar or relevant theme or genre (e.g., romance movies or shows, romance theme, etc.), unrelated to the show and/or theme (and/or to reality shows or romance), and/or any other content. The content section 728 can additionally or alternatively include other UI elements such as other tiles (e.g., of other contestants, other reality shows, other content, etc.), other content experiences, other graphics, other objects, other UI containers, etc.

In some examples, the content section 728 may include content, UI elements, visual elements, UI elements, objects, a section, a background, etc., related to the reality TV dating show and/or the UI container 702. For example, in FIG. 7A, the content section 728 includes a preview or representation related to a next episode of the reality TV dating show. Here, the content section 728 includes the image 708A of Joe, the silhouette 708B, and another UI container with UI elements (e.g., tiles) depicting certain contestants (e.g., other contestants, other arrangement of contestants, one or more contestants highlighted or promoted in a next episode of the show, etc.). The content section 728 can retain the theme of the UI container 702, a version of the theme, and/or a different theme. For example, the content section 728 can include or retain the theme (and/or any aspects thereof) of the UI container 702 or a version of the theme. To illustrate, if some or all of the items in the content section 728 relate to a next episode of the reality TV dating show and the next episode has a certain theme (e.g., an activity for the contestants of the show, an event depicted or promoted in the show, etc.), the content section 728 can implement a theme relevant to the reality TV dating show and similar to the theme of the UI container 702 but modified to include one or more aspects of the theme associated with the next episode.

In an illustrative example, if the content section 728 relates to a next episode of the reality TV dating show and a contestant in the show reveals a health condition in the next episode, the revelation of the health condition can be used to promote awareness to such condition. As such, the content section 728 can incorporate aspects of the theme of the show similar to the UI container 702 and/or aspects related to a theme of awareness to such condition.

UI 700 (or any portion of UI 700) can optionally be personalized for a user. For example, UI 700 can fill in the silhouette 708B with an image of user(s) 140 and show the image 708A of Joe along with an image of user(s) 140 depicted within the silhouette 708B. In some cases, the user(s) 140 can grant an application associated with UI 700 access to a picture(s) of the user(s) 140. The application can access the picture(s) to obtain an image of the user(s) 140 to place over (e.g., fit within, filled into, etc.) the silhouette 708B (e.g., with or without modifications) to show the user(s) 140 with Joe. UI 700 can adjust the silhouette 708B to match the image of the user(s) 140 (and/or the outline/contour of the image) or vice versa. In some cases, the user(s) 140 can select an image and place it over the silhouette 708B. UI 700 can adjust the silhouette 708B based on the image. In some cases, the user(s) 140 can grant the application access to a camera to capture an image of user(s) 140 to place over the silhouette 708B. In other cases, the application can use a generative AI/ML model to generate or modify an image of the user(s) 140 that the application can place on the silhouette 708B to fill the silhouette 708B with the generated image of the user(s) 140.

FIG. 7B illustrates an example user interface 730 (UI 730) depicting another UI container 734. In this example, the UI container 734 also includes a UI banner. However, as previously explained with respect to FIG. 7A, the UI container can include any other type of UI container. Moreover, in FIG. 7B, the UI banner depicted by the UI container 734 does not have visible borders (e.g., frameless). However, in other examples, the UI banner can include one or more visible borders.

In some cases, UI 730 can be displayed in response to an interaction with UI 700 in FIG. 7A, such as in response to the user(s) 140 selecting a tile included in the UI container 702. For example, when the user(s) 140 selects the tile 710A corresponding to Daisy, the selection of the tile 710A can trigger UI 730 with the UI container 734 to be loaded/displayed. User interface 730 in this example displays a scenario 732 generated based on the contestant associated with the selected tile (e.g., tile 710A), which in this case is Daisy. As shown, the scenario 732 can includes a scenario (e.g., theme, context, situation, etc.) titled “When Joe Meets Daisy”, which highlights the contestant Daisy associated with the tile 710A within the context of the reality TV dating show with Joe as the main character or bachelor.

The UI container 734 can include a UI banner generated for the scenario 732. As shown, in this example, the tile 710A associated with Daisy is highlighted, as indicated by the outline 718 around the tile 710A, and the metadata section 716 associated with the tile 710A has been expanded to include more information about Daisy (e.g., an indication of the chemistry between Daisy and Joe). The UI container 734 partially shows the tile 710B but does not show other tiles in this example, as it is focused on Daisy.

The tile 710A includes an object 736 representing a score for Daisy. The score can represent a chemistry between Daisy and Joe, a number of votes associated with Daisy, a probability that Daisy will win the contest or a next round, or any other metric. In some examples, the score can represent a number of votes that Daisy has received from users voting on contestants (e.g., voting on contestants favored to be selected by Joe to continue to the next round). In some cases, the object 736 can allow the user(s) 140 to vote for or against Daisy. For example, the object 736 can include an arrow pointing up in relation to the object 736 to indicate that the user(s) 140 can vote in favor of Daisy by selecting the up arrow to increase the votes for Daisy, and optionally an arrow pointing down in relation to the object 736 to indicate that the user(s) 140 can vote against Daisy by selecting the down arrow. The object 736 can additionally or alternatively include any other UI element. For example, the object 736 can include a button that the user(s) 140 can select to provide an input or specify how the user(s) 140 wants to vote.

UI container 734 can include one or more navigation elements, such as navigation elements 738 and 740 that the user(s) 140 can select or activate to navigate or scroll through tiles in the UI container 734. For example, the navigation element 738 in FIG. 7B can allow the user(s) 140 to scroll (e.g., by selecting or activating the navigation element 738) the UI container 734 in one direction (e.g., to scroll to another tile) and navigation element 740 can allow the user(s) 140 to scroll the UI container 734 (e.g., scroll to another tile) in a different direction. User interface 730 can include a back button 742 that allows the user(s) 140 to navigate back to UI 700 shown in FIG. 7A (e.g., by selecting or activating the back button 742).

In some cases, UI 730 can depict an image 744 within the silhouette 708B. User interface 730 can load the silhouette 708B with the image 744 or show the image 744 being added to the silhouette 708B (e.g., show the silhouette 708B being filled with the image 744). In some examples, UI 730 can depict an animation showing the image 744 being added to the silhouette 708B (e.g., showing the silhouette 708B being filled with the image 744). For example, UI 730 can display an animation that shows the image 744 appearing in UI 730 or entering UI 730 from outside of UI 730 (e.g., show a visual effect that depicts the image 744 entering the view of UI 730 from an edge/border of UI 730 such as the right border/edge of UI 730 as shown in FIG. 7B) and progressively filling the silhouette 708B or molding into a shape of the silhouette 708B and filling the shape of the silhouette 708B (or the silhouette 708B molding into a shape of the image 744 or both molding into a common shape).

The image 744 can include an image of a participant in the reality TV dating show, an image of the user(s) 140, or an image of any other person. For example, the image 744 can include an image of the user(s) 140. User interface 730 can display an animation where the image 744 of the user(s) 140 is moved into the silhouette 708B such that the silhouette 708B is filled with the image 744 to depict the user(s) 140 (e.g., the image 744) within the silhouette 708B. In some cases, the image 744 of the user(s) 140 can include a user avatar, an image used to generate a user avatar, an image depicted by a user avatar, a real picture of the user(s) 140, an image of the user(s) 140 generated based on a real picture of the user(s) 140, an image of the user(s) 140 generated or modified by an AI/ML model, or any other image used to depict the user(s) 140 or a representation of the user(s) 140 within the silhouette 708B. In some cases, the contour of the silhouette 708B can be matched or adjusted to the contour of the image 744 (or vice versa) so the image 744 and the silhouette 708B are aligned/overlapped to show the person (e.g., the user(s) 140, a contestant, etc.) depicted in the image 744 within the silhouette 708B.

The silhouette 708B can alternatively be filled with an image of another person, such as a contestant in the show or another user. In some cases, the image of the other user can include, for example and without limitation, an image of a user selected as a winner of a challenge associated with UI 730 or UI 700, such as a scavenger hunt competition or a trivia challenge, or a user selected to be promoted within UI 730 (e.g., a user with a highest score in an activity, a user with a highest votes, a user with a most number of watched content items within a period of time, a user with a highest watch/play count of content items available through a content platform associated with the user interfaces 700 and 730, a user with a certain number of credits associated with the content platform, a paid user, a random user of the content platform, a user selected from a pool of users who submitted requests to be added, a user who answered the highest number of questions related to the reality TV dating show correctly, a user being celebrated the day when UI 730 is displayed such as a user who won a contest or a user who got engaged within a specific time period, etc.).

In FIG. 7B, the silhouette 708B is shown to the right of UI container 734 (e.g., from the perspective of user(s) 140 viewing UI 730). Such arrangement is an illustrative example provided for explanation purposes to show that the arrangement of the showcase banner and other interface elements/spaces can be modified or rearranged (e.g., relative to another arrangement, such as the arrangement in UI 700 shown in FIG. 7A). In other examples, the UI container 734 can be placed to the right of (e.g., from the perspective of user(s) 140 viewing UI 730) the silhouette 708B and any other space/element in UI 730.

FIG. 8B illustrates an example user interface 820 (UI 820) that includes an example UI container 822 customized with a combination of themes. Like the UI container 800 in FIG. 8A, the UI container 822 includes a UI banner and implements multiple themes. In FIG. 8B, the UI container 822 includes a college football theme and a college football team theme.

The UI container 822 in this example includes tiles 830A-N (collectively “tiles 830” hereinafter) and content space 824 used to display other items in addition to the tiles. The content space 824 can implement one or more themes based on a topic(s). The topic(s) can be selected based on one or more signals. For example, the topic(s) can be selected based on a relevance (e.g., a threshold relevance) of the topic(s) on a time period (e.g., day, week, month, season, etc.) when UI container 822 is displayed.

The one or more signals used to select the topic(s) can include a trending metric or statistic of the topic(s) (e.g., a metric determined based on one or more social media posts, content viewership statistics/metrics, purchasing habits and/or statistics of users, a frequency in which the topic(s) is mentioned or discussed in one or more mediums such as the media, user or group preferences, business preferences, paid sponsorship, an increased or threshold availability or promotion of the topic by a content provider, a temporal relationship between a time period when the UI container 822 is displayed and the topic(s) (e.g., a temporal relationship between a release date or schedule of content or products associated with the topic(s) and a time period when the UI container 822 is displayed, a trend or popularity of the topic(s) is higher on that time period than other time periods, statistics of the topic(s) on that time period, popularity of the topic(s) on that time period, user trends with respect to the topic(s) on that time period, etc.), a relationship between the topic(s) and a location associated with the user(s) 140 and/or a device used to display the UI container 822 (e.g., based on a particular significance/popularity or history of the topic(s) with respect to that location, a specific relationship between the topic(s) and location, etc.), a context associated with the user(s) 140 and/or the device used to display the UI container 822 (e.g., a relationship between the context and the topic, a relevance metric between the topic and the context, etc.), and/or any other signals.

For example, if the UI container 822 is displayed on a day when college football games are scheduled, a college football topic can be determined to have a threshold relevance on that day and selected as the topic for selecting a theme. UI management system 130 can then select the college football theme based on the college football topic selected based on the threshold relevance of the topic to that day. If a particular college football team is scheduled to play or is trending on that day, the college football team can be selected as a topic used to identify a theme (e.g., a college football team theme) for the UI container 822. In FIG. 8B, the themes of the UI container 822 are thus selected based on a college football topic and a college football team topic. Thus, the UI container 822 can include a college football theme (e.g., based on the college football topic) and a team theme (e.g., based on the college football team topic).

The content space 824 in this example includes text 826A. The text 826A can include information about college football, a college football team, a college football schedule, etc. The content space 824 can also include artwork 826B associated with the theme(s) of the UI container 822, such as the college football theme and the college football team theme. In this example, the artwork 826B includes an image of a player of the college football team and a background color associated with the college football team. The content space 824 may additionally or alternatively display other content. For example, in FIG. 8B, the content space 824 includes a UI element 828. In this example, the UI element 828 includes a CTA, such as a button, link, or other UI element that the user(s) 140 can select or activate to access or interact with content associated with college football and/or the college football team associated with the team theme, purchase merchandise related to college football and/or the college football team, play a video or video game associated with college football or the college football team, etc. In some cases, the UI element 828 can include a link to a content or destination, or can be configured to trigger an action, such as loading or initiating a video, video game, activity, interaction, channel, application, etc.

The tiles 830 in the UI container 822 can be configured in any arrangement. For example, in FIG. 8B, the tiles 830 are arranged as a row of tiles corresponding to respective college football teams. The content in the content space 824 and the tiles 830 can relate to college football and a college football team and thus convey a college football theme and a college football team theme.

The tiles 830 can be ordered within the row of tiles according to a sorting scheme. For example, the tiles 830 can be ordered within the row of tiles according to the rankings of the college football teams (e.g., to show the rankings of such college football teams) corresponding to the tiles 830. In this example, the tiles 830 can be arranged in a sequence that is based on the rankings of the college football teams corresponding to the tiles 830. For example, as reflected in the order of the tiles 830, the Florida Gators associated with tile 830A are ranked first, the Georgia Bulldogs associated with tile 830B are ranked second, the University of Southern California (USC) trojans associated with tile 830C are ranked third, and the Pennsylvania State University (PSU) Nittany Lions associated with tile 830N are ranked fourth. Thus, tile 830A is first in the row of tiles, tile 830B is second (e.g., next to tile 830A) in the row of tiles, tile 830C is third (e.g., next to the 830B) in the row of tiles, and tile 830N is fourth (e.g., next to tile 830C) in the row of tiles.

In some cases, the order of the tiles 830 can reflect the rankings of the college football teams associated with the tiles 830. For example, the order of the tile 830A visually indicates that its corresponding team (Florida Gators) is ranked first, the order of the tile 830B visually indicates that its corresponding team (Georgia Bulldogs) is ranked second, the order of the tile 830C visually indicates that its corresponding team (USC Trojans) is ranked third, and the order of the tile 830N visually indicates that its corresponding team (PSU Nittany Lions) is ranked fourth. This way, the user(s) 140 can identify the rankings of the college football teams corresponding to the tiles 830 based on the order/arrangement of the tiles 830. Even in examples where the tiles 830 do not visually specify the rankings of their corresponding teams, the user(s) 140 may nevertheless potentially ascertain the rankings of the corresponding teams based on the order of the tiles 830 within the sequence of the row of tiles.

In some cases, the UI container 822 may include a metadata section for any of the tiles 830. The metadata section associated with a tile can display information associated with that tile and/or a content of the tile. The UI container 822 can include a metadata section below, above, next/adjacent to, within, or in association with any tile (e.g., one tile, multiple tiles, all tiles, etc.). For example, UI container 822 may include a metadata section with information about the Florida Gators. The metadata section can be positioned near the tile 830A (e.g., below, above, adjacent to, etc.) associated with the Florida Gators. The metadata section associated with the tile 830A and Florida Gators can be included because the Florida Gators are ranked first, the tile 830A is highlighted, the Florida Gators are playing on the day that (or within a time period when) user interface 820 is displayed, the user(s) 140 has a preference for or is a fan of the Florida Gators (e.g., as indicated by user data or preferences), the user(s) 140 requested such information for the Florida Gators or tile 830A (e.g., via a user input), or any other reason.

The metadata section displayed on UI container 822 can dynamically change in response to one or more events or triggers. For example, if UI container 822 includes a metadata section associated with tile 830A because tile 830A is highlighted by the user(s) 140 and the user(s) 140 subsequently provides an input configured to trigger another tile to be highlighted, UI container 822 can be updated to include a metadata section associated with that other tile (or the metadata section can be updated to provide information about the team corresponding to the other tile), which can include information about the team corresponding to that tile. When UI container 822 is updated to include the metadata section associated with the other tile, UI container 822 may or may not remove the metadata section associated with the previous tile.

UI 820 can include any other sections. For example, in FIG. 8B, user interface 820 also includes content section 840. Content section 840 can include other content items and/or UI elements linked to (e.g., used to view or access) other content items such as videos, movies, TV shows, livestreams, TV broadcasts, podcasts, highlight reels, recap videos, promoted content, media applications, media channels, and/or any other content. In some cases, the content section 840 can include UI elements containing content and/or used to access certain content, experiences, features, etc. For example, the content section 840 can include tiles 842A-N (collectively “tiles 842” hereinafter) associated with content items. The tiles 842 can be arranged in any configuration, such as a row, column, grid, cloud, etc.

In some cases, the tiles 842 can be linked to and provide access to associated content. For example, in FIG. 8B, the tiles 842 include, represent, or provide a link to sports content. The sports content in this example includes baseball videos. The user(s) 140 can select or activate any of the tiles 842 to watch/play a corresponding content item, such as a corresponding baseball clip. The tiles 842 can depict frames (e.g., keyframes, still images, etc.) or thumbnails of a scene, view, poster, and/or content from the corresponding content items, which allows the user(s) 140 to see what each of the tiles 842 pertains to and the content associated with (e.g., accessible/available through) the tiles 842. In other examples, the tiles 842 may depict other visual information or content (e.g., in addition to or instead of the frames or thumbnails) associated with the content of the tiles 842. For example, the tiles 842 can additionally or alternatively depict titles and/or descriptions of their corresponding content items to identify the content items (e.g., baseball clips) associated with the tiles 842 and/or what the content items associated with the tiles 842 are about.

The content associated with the tiles 842 may include sports content based on a relevance or relationship of the theme(s) of user interface 820 and the sports content. For example, user interface 820 includes a college football theme, as previously explained. Since the college football theme is more broadly a sports theme, the content associated with the tiles 842 relate to the college football theme in that both the college football theme and the sports content are broadly sports themes or related to a sports theme. In other cases, the content associated with the tiles 842 can additionally or alternatively include content that is part of or is more specifically related to the college football theme and/or content associated with any other theme. In FIG. 8B, the tiles 842 in the content section 840 and the content items associated with the tiles 842 relate to baseball. However, the tiles 842 (or any portion thereof) in the content section 840 and the content items associated with the tiles 842 (or any portion thereof) may or may not relate to a theme of the UI container 822, such as a specific theme (e.g., a college football and/or college football team theme) and/or a more general theme of the UI container 822 (e.g., sports in general).

For example, the tiles 842 (or any portion thereof) in the content section 840 and the content items associated with the tiles 842 (or any portion thereof) can relate to college football and/or any of the college football teams associated with the tiles 830. However, the tiles 842 (or any portion thereof) in the content section 840 and the content items associated with the tiles 842 (or any portion thereof) can additionally or alternatively relate to any other theme such as comedy, golf, etc. To illustrate, the tiles 842 and the content items associated with the tiles 842 can relate to sports in general or a particular sport(s) (e.g., college football). This way, the tiles 842 and the content items associated with the tiles 842 can implement or relate to a general and/or specific theme of the UI container 822. As previously noted, in FIG. 8B, the tiles 842 relate to sports content and are associated with sports content items such as baseball content items. Since the UI container 822 relates to a sport (college football) and the tiles 842 relate to sports, user interface 820, including the UI container 822 and the content section 840, includes an overall sports theme.

In other examples, the tiles 842 and the content items associated with the tiles 842 can relate to any other themes. For example, the tiles 842 can relate to movies (and/or any other type of content item) associated with a different sport, such as soccer, boxing, basketball, etc. In other cases, the tiles 842 can relate to movies (and/or any other type of content item) associated with any other topic, such as action movies, comedy shows, dramas, animated movies, etc.

FIG. 8C illustrates another example user interface 850 (UI 850) customized based on a combination of themes and including multiple UI containers. In this example, UI 850 includes UI container 852 and UI container 870. UI container 852 and UI container 870 include a football theme. UI container 852 also includes a football team theme, which in this example is a San Francisco 49ers theme. The team theme can be based on information indicating that the user(s) 140 has a threshold interest in the San Francisco 49ers, such as a user profile, a user input, a watch history of the user(s) 140, social media data associated with the user(s) 140 (e.g., social media posts, likes, connections, subscriptions, etc.). The team theme can be used to further personalize the UI container 852 (and UI 850) for the user(s) 140.

The UI container 852 in this example includes a UI banner. Moreover, the UI container 852 includes a section 854 with team content that is based on the San Francisco 49ers theme. For example, the section 854 includes imagery 856A related to the San Francisco 49ers, text content 856B providing information about the San Francisco 49ers, and a UI element 858. The UI element 858 can include a CTA. For example, in FIG. 8C, the UI element 858 includes a link to a team page of the San Francisco 49ers. The user(s) 140 can select the link to access the team page.

The UI container 852 also includes a section 860 with UI elements and content associated with the San Francisco 49ers. As shown, the section 860 includes a tile 862 promoting a game between the San Francisco 49ers and another team, which in this example is the Seatle Seahawks, and a tile 864 that provides a summary of the game and depicts details about the teams and the game. In some cases, the tile 862 can be selected or activated to watch a video associated with the game, such as a highlights reel or a replay video. The section 860 can optionally include a counter 866 specifying the number of tiles in the section 860.

The counter 866 can indicate whether the section 860 of the UI container 852 includes any tiles that are not visible in the current view of UI 850. The user(s) 140 can identify any number of remaining tiles based on the tiles 862-864 that are visible and the number of tiles indicated in the counter 866. The remaining tiles may not be visible in the UI container 852 because, for example, the UI container 852 cannot fit all the tiles or can only fit the tiles if some or all of the tiles are resized to a size that is smaller than a minimum tile size defined. In such cases, the UI container 852 may be scrollable to allow the user(s) 140 to scroll through tiles to view and/or access other tiles.

For example, the user(s) 140 can scroll UI container 852 (or the tiles in UI container 852) in any direction to view/access tiles that are not visible within a current view of UI container 852 but would become visible upon scrolling in that direction. As the user(s) 140 scrolls (e.g., via a scrolling input) through tiles in UI container 852, UI 850 can display a scrolling effect where tiles appear to move or rotate based on a scrolling direction, and tiles that were not visible prior to the scrolling may move into focus (e.g., become visible). In other words, when the user(s) 140 scrolls in a direction, UI 850 can update a view of UI container 852 or load a subsequent view of the UI container 852 to show one or more tiles move from the scrolling direction and become visible within the UI container 852. In some examples, the scrolling effect can include an animation that depicts any visible tiles moving away from the scrolling direction (e.g., moving towards an opposite direction) and depicts one or more tiles that were not previously visible (e.g., because the one or more tiles were previously outside of a visible portion of the UI container 852) moving into focus.

In some cases, when the user(s) 140 scrolls UI container 852 to shift the tiles shown in the view of UI container 852, UI 850 can load or update a view of UI container 852 that depicts the tiles that are visible after the scrolling. When shifting the row of tiles, UI 850 can move an end tile (e.g., previously located at an end of the UI container 852 that is opposite to the scrolling direction) out of view (unless that tile fits within the view as in cases where the scrolling has reached an end of the row or is near the end of the row) and move another tile (e.g., a tile that before the scrolling was located at an end of the UI container 852 towards the scrolling direction) within view. Alternatively, when the user(s) 140 scrolls the tiles in the UI container 852, UI 850 can update or load a view of the UI container 852 that replaces one or more tiles that were visible before the scrolling with one or more tiles that were not visible before the scrolling and were located adjacent to the visible area of the UI container 852 in the scrolling direction. In some cases, the UI container 852 can be configured to behave like a carousel when the user(s) 140 scrolls the UI container 852 such that the tiles in the UI container 852 appear to move and rotate as UI 850 displays a scrolling effect.

The section 860 in this example also includes a UI element 876 that the user(s) 140 can select or activate to watch the game (e.g., watch a replay of the game), and information 868 about the UI element 876 and/or the content available via the UI element 876. In this example, the game has already completed so the tile 864 and UI element 876 relate to a completed game and an associated replay of the game. In other examples, if the game has not been played, the UI element 876 can identify a source (e.g., channel) that will stream or televise the game, and the information 868 can provide information about the upcoming game and/or the UI element 876, such as a date/time when the game is scheduled, a description of the source of the game associated with the UI element 876, and/or any other information. In some cases, the UI element 876 can include a link to the channel, stream, broadcast, or signal that will provide the game, which the user(s) 140 can select or activate to watch the game. The information 868 can specify when the game is scheduled so the user(s) 140 knows when to select or activate the UI element 876 to watch the game. In such examples where the game has not completed, the tile 864 can include information about the game, information about another game, or a link or button to watch another game.

UI container 870 also includes a UI banner. The UI banner in this example is titled “My Team Highlights” and provides highlight content of a team of the user(s) 140, such as the San Francisco 49ers. The UI banner (UI container 870) in this example includes tiles 872A-N (collectively “tiles 872” hereinafter) that the user(s) 140 can select or activate to access highlight videos of the team. The tiles 872 can depict details about the respective highlight videos associated with the tiles 872. In some examples, the tiles 872 can include or depict keyframes from the highlight videos associated with the tiles 872, images or thumbnails associated with the highlight videos, image posters associated with the highlight videos, and/or any other information that can visually identify the highlight videos corresponding to the tiles 872, respectively. The theme and content of the UI container 870 are merely illustrative examples provided for explanation purposes. In other examples, the UI container 870 can include any other theme and/or content, which may or may not relate to the theme and/or content associated with the UI container 852.

In some examples, UI 850 can depict a user avatar 885 of the user(s) 140. The user avatar 885 may or may not be customized based on a theme(s) of UI 850. For example, since UI 850 includes a football theme, the user avatar 885 can be customized to add a football helmet or jersey to the user depicted in the user avatar 885. As another example, the user avatar 885 can include a background associated with the team theme of UI 850, such as a background with the colors and/or a logo of the San Francisco 49ers. In some cases, the user avatar 885 can be based on the user profile associated with UI 850, such as a user profile that is active at the device associated with UI 850 and/or during a session that includes UI 850. The user avatar 885 can thus identify the user profile being used to access UI 850 and any associated content.

In some cases, the user profile can be automatically selected based on the user(s) viewing UI 850 and/or content depicted by UI 850. In some cases, the user(s) may be automatically detected using presence detection. For example, a user within a proximity to the device presenting UI 850 can be automatically detected based on sensor data, usage patterns, user information, household information, device information, usage statistics, calendar data, user inputs, a detected voice, face recognition, and/or any other information and/or cues, as further described below. The user avatar 885 can be automatically selected/provided based on a presence detection result indicating that a user associated with the user avatar 885 is present.

In some examples, the topic(s) used to select the theme(s) associated with UI 850 can be determined based on have a threshold relevance of the topic(s), a context (e.g., a time, date, season, location, country, environment, weather, region, culture, society, household, situation, event, trend, topic, etc.), a user (or user group), a household, a community, a device (or group of devices), an event (e.g., news event, trending event, cultural event, holiday event, competition event, awards event, sports event, current event, social event, release event, etc.), an environment, a situation (e.g., a release date, an event outcome, an announcement, etc.), and/or related in any other way.

In some cases, a theme of UI container 852 and/or UI container 870 can vary by location such that devices in different locations may display versions of UI 850 with different themes selected for the different locations. Users in a particular location or geographic region may have a higher interest in or a higher likelihood of being interested in a particular theme. Accordingly, location information of a user or associated device can serve as a signal used to determine a theme(s) for UI 850 (and/or the UI container 852 and/or s870). For example, if UI 850 is displayed by media device(s) 104 when media device(s) 104 is in San Francisco, the location of media device(s) 104 can suggest a preference for or relevance of the San Francisco 49ers given that San Francisco may have a higher amount, percentage, or concentration of San Francisco 49ers fans or that the San Francisco 49ers team is the home team associated with that location. Similarly, if media device(s) 104 is located within a region that has a threshold number or proportion of San Francisco 49ers fans or content consumers, the location of media device(s) 104 can be used to select a San Francisco 49ers theme for user interfaces and UI containers displayed at media device(s) 104 (while media device(s) 104 is in that region or in general) since the location of media device(s) 104 can indicate a likelihood that the user(s) 140 associated with media device(s) 104 is a fan of the San Francisco 49ers or interested in content associated with the San Francisco 49ers.

In another example, if the location of media device(s) 104 changes from San Francisco to a new location, such as Paris, the new location can be used to select a new theme, such as a Paris theme, that may be more relevant to the user(s) 140 associated with media device(s) 104 than a San Francisco, as the new theme (e.g., Paris) is more temporally/contextually relevant to the new location of media device(s) 104 than the San Francisco 49ers theme. Thus, when media device(s) 104 is located in Paris, the UI container 852 and/or the UI container 870 may incorporate a theme related to Paris. For example, the UI container 852 and/or the UI container 870 may include a background that shows the Eiffel Tower and/or colors associated with Paris (or France), and the tiles 862-864 or the tiles 872 may include or correspond to content items associated with Paris, such as movies based in Paris, videos of the Paris Saint-Germain soccer team, and/or videos about or including a famous Parisian or landmark.

The number of UI containers in FIG. 8C is an illustrative example provided for explanation purposes. UI 850 may include more or less UI containers than shown in FIG. 8C. For example, while FIG. 8C illustrates two UI containers in UI 850, UI 850 may include more or less UI containers. In such examples, the UI container(s) may incorporate a same or similar theme as the UI container 852 and/or the UI container 870, and/or may incorporate one or more other themes such as a theme related to a different team, a theme related to a different topic (e.g., a topic associated with a trending metric, etc.), a theme related to an event that has a threshold temporal relevance when UI 850 is presented, etc.

While the tiles in UI container 870 are depicted in a row pattern/arrangement, the tiles can be positioned within UI container 870 in any other pattern or arrangement. For example, the tiles in a UI container can be arranged in a column, grid, cloud, circular, or any other shape or arrangement. Moreover, tiles in a UI container can have the same or different sizes, shapes, alignments, aspect ratios, resolutions, layouts, and/or other configuration/attributes. To illustrate, the tiles can have different sizes, layouts (e.g., landscape, portrait, etc.), resolutions, and/or shapes to convey different information about the tiles, highlight or promote certain tiles, fit the tiles within a user interface space, vary the visual configuration, etc.

In some cases, UI 850 can include one or more animations to enhance the user experience. For example, in FIG. 8C, tile 864 in UI container 852 depicts football player 874. As part of an animation, football player 874 can appear to leave or exit the tile 864 (e.g., can appear to jump and/or run out of the tile 864) and run to a destination. In this example, the destination is the tile 872N. Thus, football player 874 can appear to run to the tile 872N to entertain the user(s) 140, draw the attention of the user(s) 140 to that tile, promote that tile, encourage the user(s) 140 to view or play the content of that tile, help the user(s) 140 discover that tile, etc. In some cases, football player 874 can run to the tile 872N and stay by the tile 872N, perform an activity by the tile 872N such as jump on top of the tile 872N or catch a football above the tile 872N, can hide behind the tile 872N, or can jump into the tile 872N and appear to enter the tile 872N.

For example, if the tile 872N includes a link to a football video about football player 874, football player 874 can jump out of tile 864, run towards tile 872N, and jump into tile 872N such that football player 874 is subsequently depicted in tile 872N. This animation can draw the attention of the user(s) 140 to the tile 872N and visually indicate or suggest to the user(s) 140 that the tile 872N corresponds to a video about or including football player 874 that the user(s) 140 can access, play, watch, or stream via the tile 872N.

In another example, a balloon 880 can appear in UI 850 and float towards a tile slot for tile 872B in UI container 870. The balloon 880 can carry tile 885 as it floats towards the tile slot. When the balloon 880 reaches the tile slot, the balloon 880 can drop tile 885 so it falls into the tile slot. The tile 885 can be aligned with the tile slot and replace tile 872B. The tile 885 can depict certain content and can optionally include a link to associated content. For example, tile 885 can include a link to content, such as a promoted video, an advertisement, a different episode associated with the tile 872B, a video game, etc. In some examples, if the user(s) 140 completes watching a video associated with the tile 872B, the balloon 880 can appear and drop the tile 885 as previously described to replace the tile 872B associated with the video that the user(s) 140 watched, with the tile 885 corresponding to a different video that the user(s) 140 can watch.

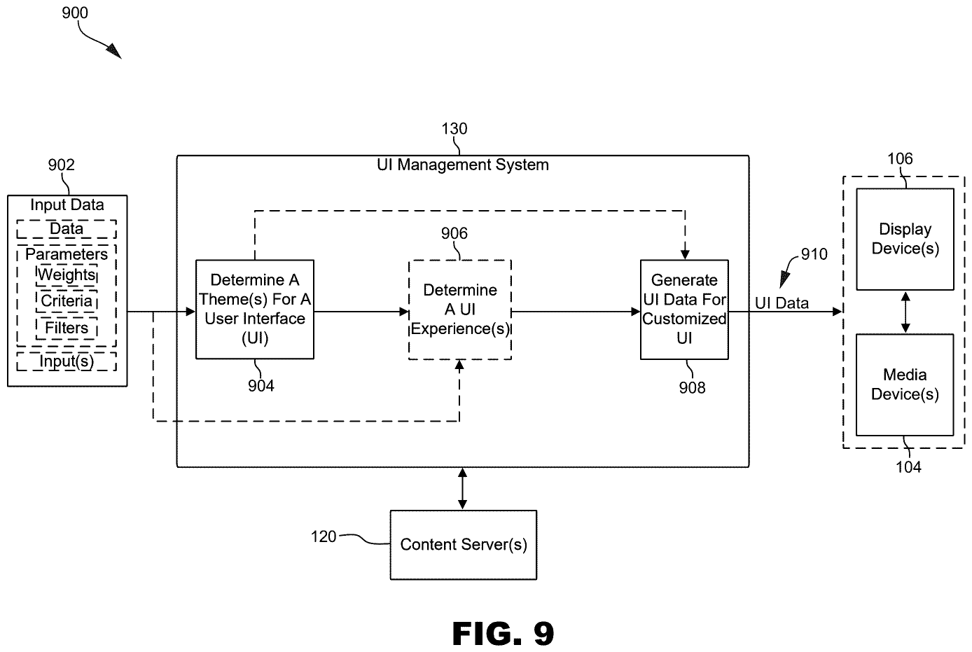

FIG. 9 is a diagram illustrating an example system process 900 for customizing user interfaces. The user interface can be displayed by a user device, such as media device(s) 104 or display device(s) 106. The user interface can provide the user(s) 140 a content experience. For example, the user interface can allow the user(s) 140 to access content, browse and/or navigate content, search content, interact with content, watch or play content, manage content, engage with content, etc.

UI management system 130 can determine configuration parameters of a user interface (e.g., one or more themes, structures, appearances, artwork items, behaviors, attributes, content items, UI elements, visual elements, UI containers, animations, configurations, menu items, styles, visual effects, input elements, controls, personalization parameters, promotions, features, etc.), configure the user interface, generate the user interface, trigger and/or instruct media device(s) 104 to display/render and/or generate the user interface, customize the user interface, generate data that media device(s) 104 can use to display/render and/or generate the user interface, etc.

Moreover, the user interface can be customized. For example, one or more aspects of the user interface (e.g., a theme, design, behavior, artwork, look/appearance, structure, arrangement, organization, attribute, configuration, visual effect, and/or characteristic) can be customized based on, or to include or convey a theme(s). The theme(s) can be selected based on a topic(s). The topic(s) can be selected based on one or more signals. UI management system 130 can be implemented by a device used to display the user interface, such as media device(s) 104 (e.g., see FIG. 2) or a remote server(s), such as system server(s) 126. For example, UI management system 130 can run locally (e.g., at the edge) on the device used to display (or manage) the user interface, and can locally configure the user interface. Alternatively or additionally, UI management system 130 can run remotely (e.g., at system server(s) 126) and remotely configure the user interface or generate interface configuration data used to configure, present, and/or render the user interface.

In other cases, UI management system 130 can be distributed or include instances on different devices. For example, UI management system 130 can be distributed across edge (e.g., media device(s) 104) and remote locations (e.g., system server(s) 126) and run one or more portions remotely (e.g., at system server(s) 126) and one or more portions locally (e.g., at media device(s) 104). In another example, UI management system 130 can include a remote instance (e.g., at system server(s) 126) and a local instance (e.g., media device(s) 104). The remote and local instances of UI management system 130 can perform respective tasks/operations or one of the instances (e.g., the remote or local instance) can function as a primary instance configured to perform the operations described herein while the other instance (e.g., the instance from the remote and local instances that is not set as the primary instance) can serve as a backup or load balancing system to assist and/or provide redundance for the primary instance.

In other cases, UI management system 130 can be distributed across devices on a backend (e.g., system server(s) 126) or distributed across edge devices (e.g., media device(s) 104, display device(s) 106, etc.). For example, UI management system 130 can be distributed across devices or resources on a cloud network. As another example, UI management system 130 can be distributed across edge devices, such as media device(s) 104, display device(s) 106, one or more IoT devices, and/or any other local device(s).

As shown in system process 900, UI management system 130 can obtain input data 902 and use input data 902 to determine how to configure the user interface. For example, UI management system 130 can use input data 902 to determine a theme(s) for the user interface, an animation(s) for the user interface, a content of the user interface, a content experience provided by the user interface, configuration parameters for the user interface, a background of the user interface, a customize or personalized organization of items in the user interface, UI containers to include (and/or a configuration thereof) in the user interface, visual elements for the user interface, UI elements of the user interface, a behavior of the user interface, etc.

UI management system 130 can obtain input data 902 from one or more sources such as content server(s) 120, media device(s) 104, display device(s) 106, one or more social media platforms/networks, one or more users (e.g., the user(s) 140), an AI/ML model (e.g., an AI/ML prediction model, a large language model (LLM), an object detection model, a recognition model such as a facial recognition model and/or a scene recognition model, a generative AI model, etc.), a content platform associated with the user interface (and/or a business associated with the content platform), the Internet, a news source(s), a database, a channel and/or program guide, client device(s) associated with the user(s), a group of devices associated with a group of users, a sponsor, a content provider, a sensor(s) device (e.g., an image sensor, ambient light sensor, humidity sensor, temperature sensor, gyroscope, accelerometer, touch sensor, load/weight sensor, motion sensor, proximity sensor, magnetometer, inertial measurement unit, capacitive sensor, etc.), a set of rules, a set of templates, a set of parameters, a set of weights, a set of filters, a blacklist, etc. For example, UI management system 130 can obtain input data 902 from an input(s) provided by user(s) 140, data and/or activity at media device(s) 104, content server(s) 120, the Internet, an AI/ML model, a database, a content release information source, an events store or source, a content platform associated with the user interface, an input(s) or decision(s) from a business associated with the content platform, a sensor device(s), etc.

Input data 902 can include a signal(s) that UI management system 130 can use to select a topic(s), which UI management system 130 can use to select a theme(s), and/or determine how to configure/customize the user interface. For example, input data 902 can include a signal(s) indicating one or more events, content items, conditions, subjects, activities, and/or other topics that have threshold temporal, relevance, priority, preference, trend, popularity, contextual, and/or user scores, priorities, weights, relationships, rankings, metrics, etc. In some examples, input data 902 can include content statistics, parameters (e.g., weights, filters, values, etc.), UI criteria, a blacklist, one or more filters, a user input(s), a preference/weight or decision from a business or content platform associated with the user interface, event information, content information, user information, device information, context information, sponsor preferences, user or device activity, social media data (e.g., social media posts, statistics, trends, connections, subscriptions, patterns, content, activity, etc.), campaign information, current event information, news information, etc.

The topic(s) can be used to select a theme(s) for the user interface, as previously described. The theme(s) can be used to configure any aspects of the user interface, such as one or more structures, designs, UI elements (e.g., input elements, navigation elements, display elements, buttons, toggles, menu items, controls, toolbars, etc.), visual elements, UI containers (e.g., UI banners, boxes, rows, columns, tiles, cards, sheets, etc.), images/imagery, attributes, behaviors, characteristics, organizations, appearances, artwork, and/or other features. For example, the signal(s) in input data 902 can include information used to identify a topic(s) for a theme(s), such as a theme(s) that is relevant to the user(s) 140 (and/or a household), a group of users, a device(s) associated with the user(s) 140 (e.g., media device(s) 104 and/or display device(s) 106), a context associated with the user(s) 104 and/or an associated device(s), a particular date(s), a location(s), a user preference(s) and/or interest(s), a trend, a topic(s), an event(s), etc.

In some cases, the one or more signals can include, describe, and/or identify a user/device location, a context associated with the user(s) 140 and/or media device(s) 104, user preferences and/or a user profile (e.g., a user preference and/or profile of user(s) 140), a user input(s), social media data (e.g., posts and/or metrics indicating a trending topic and/or event in social media, etc.), calendar/temporal data (e.g., a date, time, season, holiday, etc.), a schedule or scheduling data (e.g., a content release date, an event date or scheduled event date, a holiday calendar or date, a competition schedule or date, a programming schedule, a date of an announcement (an event announcement, product release announcement, an announcement of a winner of an award/competition, etc.), etc.), weather data, topic information (e.g., social media posts about a topic, references in social media to a topic, a topic trending or associated with a particular date(s), trending or popularity metrics of a topic, a description of a topic, a context of a topic, a rating/ranking of a topic, a relevance of a topic to the user(s) 140, etc.), a content/theme blacklist, a content/theme filter, content/theme selection rules and/or weights, a preference and/or decision/input from a business or content platform associated with the user interface, a candidate theme(s) for the user interface, cultural information, language information, UI templates, UI configuration parameters, and/or other information.

In some cases, input data 902 can include information about content at content server(s) 120 and/or scheduled to be available or released. For example, input data 902 can identify content items available at content server(s) 120 (and/or scheduled to be available at content server(s) 120), a programming guide including dates when any content items are or will be released or televised, a channel guide (e.g., a channel list, an indication of content items available from channels in the channels list, a schedule of content from channels in the channel list, etc.), content statistics (e.g., content views and/or viewing/consumption statistics, content ratings, streaming statistics of any content, trending or popularity metrics/statics calculated for any content, information about user interactions with any content, playback statistics of any content, etc.), social media data, content metadata (e.g., genres, actors, topics, viewership metrics, descriptions/summaries, subtitles or closed captions, depicted scenes, depicted contexts, depicted activities, depicted events, language information, location or region/country information, titles, information about characters in content items, release dates, programming dates/schedules, content sources, content producers or companies, content themes, content tags, etc.), and/or any other information.

At step 904, UI management system 130 can determine, based on input data 902, a theme(s) for a customized user interface (UI). The UI can be customized for the user(s) 140, a group of users including the user(s) 140, all users of a content platform associated with the UI, or any other user or number of users. UI management system 130 can analyze input data 902 and select a topic(s) of the theme(s) based on input data 902, and determine the theme(s) based on the topic(s) of the theme(s). For example, UI management system 130 can analyze context information, event information, activity information, temporal information, user information, content information, social media data, trends, popularity or ratings information, and/or any other information in input data 902 to select a topic(s) for the theme(s).

UI management system 130 can use the topic(s) to select the theme(s). For example, if the topic includes a comedy sitcom, UI management system 130 can select a comedy sitcom theme. The comedy sitcom theme can include any content, UI experience, UI appearance, UI design, UI element(s), UI container(s), visual element(s), UI organization(s), organization of items in the UI (e.g., UI elements, UI containers, content, etc.), UI and/or background color(s) and/or color scheme(s), UI attribute(s), UI animation(s), UI behavior(s), UI style(s), UI structure(s), UI object(s), UI artwork(s), UI imagery, and/or any other feature(s) about, related to, incorporating or including, depicting, associated with, and/or customized based on the comedy sitcom theme.

The topic(s) can include a topic that is relevant (or has a threshold relevance) in or to a date, context, location, environment, scenario, user, and/or device associated with the UI; a topic associated with a context, condition, event, activity, content, subject, trend, and/or category that has a threshold trend metric, relevance metric, temporal metric, popularity metric, user or group preference metric, user or group matching score, business or platform preference metric, priority metric, rank, content statistic, etc. For example, if input data 902 indicates that a finale of a tour of a popular celebrity is on a particular date, UI management system 130 can determine that the celebrity, content associated with the celebrity (e.g., music, movie, etc.), the tour of the celebrity, a genre of content of the celebrity, a topic or theme of the tour or a content of the celebrity, or any attribute associated with the celebrity and/or the tour has/have a threshold relevance on that date, has/have a threshold trend score on that date, is/are a threshold match for a topic/theme associated with that date, etc. UI management system 130 can determine select the celebrity, content associated with the celebrity (e.g., music, movie, etc.), the tour of the celebrity, a genre of content of the celebrity, a topic or theme of the tour or a content of the celebrity, and/or attribute associated with the celebrity and/or tour as a topic(s) for the theme(s) of the UI displayed on that date (or within a number of days or time increments from that date), and use the topic(s) to select a theme(s) for the UI, such as a theme(s) related to the topic(s) and/or conveying the topic(s) (and/or aspects thereof).

In some cases, input data 902 can include metrics used to determine a level of user interest or relevance, such as attendance and/or viewership statistics of shows in the celebrity tour, metrics associated with content from the celebrity (e.g., views, purchases, subscriptions, chart rankings, etc.), and/or other data associated with the celebrity and/or the tour. UI management system 130 can use such information to determine that the celebrity, content of the celebrity, and/or the tour of the celebrity has/have a threshold popularity, interest, consumption, priority, rank, relevance, match, and/or selection score. UI management system 130 can take such information into account when determining the topic and the theme(s).

In other words, in addition to selecting the celebrity, the celebrity's content, and/or the celebrity's tour as a topic(s) for the theme(s) based on a relationship (e.g., a match) between the current date and the date of the final show in the tour (e.g., a temporal relevance), UI management system 130 can analyze the other metrics, statistics, weights, filters, cues, scores, and/or information to determine a level of interest or popularity as another factor used to select the celebrity and/or tour topic for the theme(s). In such cases, the selected topic for the theme(s) may have a higher relevance score as it would not only have a temporal relevance but also a broader or higher user interest. For example, if UI management system 130 determines that the current date matches the end date of the tour as well as the date of a game, UI management system 130 can determine, based on such temporal cues, that both the tour and the game are relevant to the current date. UI management system 130 may select both topics as the topic(s) of the theme(s) or may pick one of the topics for the theme(s). To select between the topics, UI management system 130 may analyze other data, such as metrics, preferences, weights, filters, rules, etc.

For example, UI management system 130 can use metrics in input data 902 to compare a popularity of the game and a popularity of the tour. If the metrics indicate that the game has a lower popularity than the tour, UI management system 130 may select the tour as the topic for the theme(s) rather than the game. UI management system 130 may calculate a higher relevance or score for the tour than the game despite both being temporally relevant, as the relevance scores calculated by UI management system 130 can also account for user popularity. UI management system 130 can then use the tour as a topic of the theme(s). This way, the theme(s) may not only have a temporal relevance but also a popularity relevance that increases the overall relevance of the tour relative to the game.

By considering additional information, UI management system 130 can avoid selecting a theme that has a threshold temporal relevance but lower popularity or overall relevance given the lower popularity score. For example, if the teams in the game have a smaller fanbase than the celebrity and a lower viewership or user support than the tour, the game may have a lower relevance than the tour to many users even though the game is also temporally relevant. Thus, UI management system 130 may optionally forego selecting the game as a topic for the theme(s), or may select the game as a topic but select the tour as a higher priority, more prominent or highlighted, and/or higher-weighted topic for the theme(s). UI management system 130 can select the tour as the topic instead of the game, since it has a higher overall score given that the tour is not only temporally relevant but also has higher popularity metrics, or can attribute the tour topic a higher emphasis, focus, highlight, and/or prominence for the theme(s) than the game.

In some cases, UI management system 130 can use weights, rules, preferences, and/or blacklists to select between multiple topics, such as multiple topics that satisfy a selection criteria or threshold metric (e.g., the tour and the game in the previous example). In some examples, a content platform or business associated with the UI can provide inputs that can be used as weights, preferences, filters, and/or blacklists for selecting a topic from multiple topics or excluding a topic.

In some examples, UI management system 130 can receive a request or instruction (e.g., from media device(s) 104) for a customized UI (or UI data used to generate, render, and/or display the customized UI). UI management system 130 can use input data 902 to determine a topic(s) (e.g., an event, cue, scene, activity, condition, context, location or landmark, scenario, content, subject, content item, activity, tournament, competition, object, celebration, etc.) for a theme(s) of the UI, and identify the theme(s) based on the topic(s). For example, if the UI is being displayed on a holiday or a celebrated event in a region where media device(s) 104 is located (and thus where the UI is displayed), UI management system 130 may select the holiday or the celebrated event as a topic for the theme(s). To illustrate, if the UI is being displayed on Saint Patrick's Day, UI management system 130 can determine that Saint Patrick's Day is a relevant topic on that day and select a Saint Patrick's Day topic for the theme(s). This way, the UI generated based on the theme(s) can be relevant (e.g., culturally relevant) and have an appearance (e.g., artwork, look, design, content, etc.) that the user(s) 140 associates with Saint Patrick's Day. For example, the UI can include green-colored elements, a green background, content (e.g., movies, videos, shows, etc.) related to Saint Patrick's Day, a design (e.g., artwork/imagery, logos, visual elements, etc.) related to Saint Patrick's Day such as a green background and Sain Patrick's Day artwork (e.g., leprechauns, shamrocks, etc.), and thus appear customized for Saint Patrick's Day.

As another example, if input data 902 indicates that the World Cup final is on the day when the UI is displayed, UI management system 130 can determine that soccer, the World Cup, the World Cup final, and/or soccer teams in the final are relevant, candidate, or high-scoring/ranking topics for a theme of the UI displayed that day. UI management system 130 can select the World Cup, World Cup final, soccer, and/or soccer teams in the final as the topic(s) for the theme(s), and select such theme(s) for the UI. The theme(s) can be used to customize the UI to provide a UI appearance and/or experience that relates to, celebrates, and/or promotes the World Cup, the World Cup final, soccer, and/or the soccer teams in the final.

The UI can include features associated with the theme(s), such as colors and/or symbols/logos of the teams playing in the final, soccer and/or World Cup artwork (e.g., an image of the World Cup trophy, an image of the stadium where the final is being played, interface objects shaped like or resembling soccer balls, flags of the countries playing in the final, etc.), content related to soccer and/or the World Cup (e.g., World Cup replays, World Cup highlight videos/clips, a soccer documentary, etc.), content related to the teams in the final and/or associated countries (e.g., previous games of the teams, video highlights of the teams or specific players, documentaries of any of the teams/players or countries, movies based on any of the teams/countries playing in the final, etc.), a UI container(s) (e.g., UI container 702, UI container 734, UI container 760, UI container 802, UI container 822, UI container 852, UI container 870, etc.) incorporating relevant features (e.g., content, UI components, animations, background, visual attributes, artwork, graphics, visual effects, content experiences, etc., related to soccer, the World Cup, the World Cup final, the teams playing in the final and/or associated countries, any player in the final, a host country/city of the World Cup, the World Cup trophy, etc.), and/or any other relevant details.

In some cases, the theme(s) can be additionally or alternatively selected by or based on a sponsor. For example, a sponsor can pay for a theme of any (or certain) UIs of a content platform that are presented on a particular day or period of time (e.g., week, month, etc.). As another example, a sponsor can provide a preference for a theme that can be used as a theme-selection metric such as a weight or factor.

In some cases, the theme(s) can be customized for the user(s) 140. For example, if input data 902 indicates that the user(s) 140 is a fan of one of the teams in the World Cup final or follows one of the teams, the theme(s) can be tailored based on that team. The UI customized for the user(s) 140 based on the theme(s) can include, highlight, and/or promote UI features (e.g., content, UI elements, UI containers, UI design features, UI attributes, visual elements, artwork, graphics, UI appearance, UI style, UI background, UI animations, UI experiences, etc.) related to that team.

As another example, if input data 902 indicates that a popular movie is being released on the day when the UI is being displayed, UI management system 130 can select that movie as a topic of the theme for the UI. The theme can be customized based on that topic (the movie). In some examples, the theme can include any characters, scenes, and/or content in the movie, a logo or background of the movie, a motif or mood of the movie (e.g., if the movie is a horror movie the theme can be a dark or horror theme, if the movie is a romance movie the theme can include features that invoke or convey a romantic mood, etc.), images from the movie, fonts and/or shapes from the movie, references to the movie, an activity in the movie, items related to the movie, etc. In some cases, the theme can promote the movie or an associated movie franchise, movies in the movie franchise (if any), related movies (e.g., movies with a same actor, movies based in a same country or region, movies associated with a same topic, etc.), relevant content or merchandise (e.g., merchandise from the movie, movie collections associated with the movie, etc.), etc.

The theme(s) can include or can be used to determine any features of the UI, such as UI content, UI elements, UI containers, a UI organization, an arrangement of UI elements, an organization of UI containers, a UI background, visual characteristics of the UI and/or UI elements (e.g., colors, patterns, visual effects, shapes, imagery, etc.), any scenes depicted in the UI, brands or products to depict or promote in the UI, UI artwork (e.g., images, logos, symbols, thumbnails, keyframes, shapes, graphics, etc.), a mood of the UI, a UI design, a UI style, information to include in the UI, a structure of the UI, promoted or highlighted content, design elements for the UI, a layout and/or configuration of the UI and/or any UI components (e.g., a UI container, a UI element, a UI content item, a UI background, a UI template, etc.), parameters for any UI elements (e.g., UI element types such as tiles/cards or thumbnails, arrangement of UI elements such as a tile or card row or column, a shape of UI elements such as a size or aspect ratio of tiles and/or UI containers, etc.), an appearance of the UI, an activity or game available from the UI (e.g., a type of activity or game, a topic of an activity or game, etc.), any animations displayed by the UI, a content experience provided by the UI, a behavior of the UI, and/or any other attributes of the UI.

In some cases, the theme(s) can include a UI container(s), such as the UI container 702 in FIG. 7A, the UI container 734 in FIG. 7B, the UI container 800 in FIG. 8A, the UI container 822 in FIG. 8B, the UI container 852 in FIG. 8C, etc. The UI container(s) may or may not be customized based on the theme(s). For example, in some cases, the UI container(s) can include a background, content, animation, visual elements, and/or any other features associated with the theme(s). In some cases, the theme(s) can specify or dictate what content, animations, visual elements, UI containers, UI elements, organization, style, design, appearance, attributes, experiences, and/or any other features are included or implemented by the UI.

Once UI management system 130 determines UI theme(s), UI management system 130 can generate the UI or UI data used to generate/configure the UI, as described below. UI management system 130 can optionally determine a UI experience(s) provided by the UI, as described below with respect to step 906. For example, rather than proceeding from step 904 to step 908, UI management system 130 can optionally perform step 906 in addition to step 904 before proceeding to step 908.

At step 906, UI management system 130 can optionally determine a UI experience(s) for the UI based on input data 902 and/or the theme(s) determined at step 904. The UI experience(s) can include, for example and without limitation, any animations that may displayed by the UI, CTAs that may be included in the UI, user and/or content interactions (and/or types of interactions) that may be supported and/or enabled by the UI, activities that may be displayed and/or supported by the UI, behaviors and/or actions that may be configured on or performed by the UI, outputs of the UI, games that may be displayed/provided and/or configured on the UI, challenges that may be configured on the UI, content item references (e.g., hidden messages or clues pertaining to specific content items such as movies or TV shows), and/or any other interactions between the user(s) 140 and the UI (and/or content/features thereof).

For example, if UI management system 130 selects to promote a particular feature of the UI, UI management system 130 can determine whether to promote the feature by using an animation, as previously described, by configuring the UI (or aspects thereof) or the feature to have a certain appearance used to promote or highlight the feature (e.g., adjusting a size, placement, and/or visual attribute of the feature), by configuring the UI to provide a game or activity that may draw the user's attention to the feature, and/or by determining any other way to promote the feature. To illustrate, UI management system 130 can select to configure the UI to display content item references representing hidden messages/clues for a game or activity and invite the user(s) 140 to take part in the game/activity. UI management system 130 can display a content item reference(s) on or around (e.g., adjacent to, within a proximity of, etc.) the feature or hide the content item reference(s) within/behind the feature to try to draw the attention of the user(s) 140 to the feature via the content item reference(s) as part of the game/activity.

If UI management system 130 determines to use an animation to promote the feature, UI management system 130 can determine what animation and/or type of animation to use to promote the feature and/or how to configure such animation. For example, UI management system 130 can determine to configure the feature to be animated to draw the user's attention to the feature. As another example, to draw the user's attention to the feature in order to promote it, UI management system 130 can determine to configure an object to interact with the feature or move the feature to a UI location where the feature is then displayed, or animate other content in a way that draws the user's attention to the feature.

As another example, to promote the feature, UI management system 130 can select to configure the UI to invite, encourage, draw, or enable the user(s) 140 to explore the feature in the UI in exchange of a benefit to the user(s) 140 that incentivizes the user(s) 140 to use or explore the feature as a way to promote the feature. The benefit can include, for example, unlocking a clue for a challenge, such as a game or a puzzle, unlocking a content add-on, receiving a credit, receiving a discount or free/discounted content, receiving a subscription or a subscription a credit or discount, receiving access to paid content, being promoted within UIs displayed on devices of other users (e.g., having a user avatar of the user(s) 140 displayed on UIs presented to other users, being recognized in the UIs presented to other users, etc.), unlocking a feature/functionality, etc.

To illustrate, if the feature includes an advertisement, UI management system 130 can select to configure the UI to invite the user(s) 140 to watch the advertisement in exchange for a benefit, such as unlocking a clue for a puzzle or receiving an add-on. If the feature includes a control setting used to implement or adjust a functionality, to promote the control setting, UI management system 130 can select to configure an animated UI element, such as an object or content item, that interacts with a portion of the UI used to access the control setting (or that displays a control element used to adjust/manage the control setting) or that interacts with each UI element that the user(s) 140 would need to access to get to the control setting. For example, assume that, to reach the control element associated with the control setting, the user(s) 140 would need to navigate to a menu, within the menu navigate to a first submenu, within the first submenu navigate to a second submenu, and the control element can be found within the second submenu.

In this example, UI management system 130 can configure the UI to display an animation that draws the attention of the user(s) 140 to the menu to encourage the user(s) 140 to navigate to the menu (e.g., an animation that interacts with the menu, places or drops a visual element on or about the menu, animates the menu, etc.). Once the user(s) 140 navigates to the menu, the UI can display another animation that steers the user(s) 140 towards the first submenu. Once the user(s) 140 navigates to the first submenu, the UI can display another animation that steers the user(s) 140 to the second submenu. Finally, once the user(s) 140 navigates to the second submenu, the UI can display an animation that draws the attention of the user(s) 140 to the control element. This way, the animations can provide a journey or navigation experience that leads to the control element to push the user(s) 140 to explore or learn the control element. In this way, the animations can follow a journey or storyline and provide clues, signals, or “breadcrumbs” along a navigation path or journey that eventually lead the user(s) 140 to the feature being promoted.

In some cases, the UI experience(s) can include an immersive experience involving content, UI functionalities, activities, or games. For example, the UI experience(s) can include a puzzle on the UI and clues that the user(s) 140 can find by answering questions and use to solve the puzzle. The clues can be placed somewhere in the UI so as the user(s) 140 navigates the UI and performs an action, (e.g., selects a content item, watches a content item such as a movie or an advertisement, uses a part of the UI or a feature for a first time, etc.) the UI unlocks a corresponding clue that may appear in a game. In some examples, clues can be dispersed throughout UI pages, sections, contents, features, screens, UI containers, and/or any other locations. The UI experience(s) can include a game or journey where the user(s) 140 can uncover clues at specific destinations until the user(s) 140 finds the last clue (and/or all clues).

If the theme(s) of the UI and/or the UI includes content related to a contest, the UI experience(s) can include an option to vote on questions that a contestant may ask in the contest. If the theme(s) of the UI and/or a content of the UI is/are associated with food, such as a food-related theme or a baking show, the UI experience(s) can include a question to the user(s) 140 asking the user(s) 140 to identify the user's favorite celebrity chef, and using the answer from the user(s) 140 to update the theme(s) and/or a content of the UI. For example, the UI can be updated based on the answer to include content associated with the favorite celebrity chef or add a section or UI container with content items or tiles associated with content of the favorite celebrity chef. Alternatively or additionally, the answer can trigger an avatar of the user(s) 140 to be updated to display a visual attribute associated with the favorite celebrity chef. For example, if the favorite celebrity chef is known for wearing specific glasses and a specific chef hat, the avatar can be updated to show the user(s) 140 with the glasses and chef hat of the favorite celebrity chef.

The UI experience(s) can include interactions. For example, the UI experience(s) can include an option that allows the user(s) 140 to select a favorite team in a sport. The UI can receive an answer identifying a team and display a comparison of the team pick of the user(s) 140 with the teams picked by other users in the content platform to show the user(s) 140 how the team preference of the user(s) 140 compares to the team preferences of other users in a community of users. In some cases, the UI experience(s) can allow the user(s) 140 pick or suggest UI themes, UI theme changes, content item references to display in the UI or as part of a theme, hidden messages/clues or surprises (also referred to as “Easter eggs” herein) to display in the UI and/or a location in the UI to display them, etc. The Easter eggs can be placed or hidden anywhere in the UI. For example, an Easter egg can be hidden in a control element for a specific setting, such as a closed caption setting or a video setting, to encourage users to explore or discover the specific setting. If the user(s) 140 finds the Easter egg, the UI can display a celebration (e.g., a celebration that the user(s) 140 found the Easter egg or landed on a special UI destination) such as an image of the user(s) 140 or a name of the user(s) 140 being depicted in a background or screensaver associated with a UI theme.

If the UI is being displayed on a particular holiday or a celebrated day, such as Halloween, the UI experience(s) can provide a Easter egg hunt challenge/game where Easter eggs are placed throughout the UI or a background city theme. Users can try to find the Easter eggs to win the challenge/game. The challenge/game can help users become familiar with the UI, discover features on the UI, learn certain aspects of the UI, explore new locations of the UI, learn how to access certain features of the UI, become more proficient with the UI, among other benefits. Users can win awards or other benefits for winning the challenge/game as previously mentioned. In some cases, a behavior of an Easter egg can change dynamically based on one or more conditions. For example, assume that a weather balloon from a popular movie is depicted in the UI and used as an Easter egg that is hidden within a background of the UI. As the number of users who find the weather balloon (the Easter egg) increases, the weather balloon can grow or move. The weather balloon can be configured to eventually burst or disappear to provide a timeliness constraint so users are encouraged to find the weather balloon faster.

In some examples, the UI experience(s) can be configured to assist the user(s) 140 to setup a new device or profile. For example, the UI can display animations or highlight UI areas during a device or profile setup or activation/registration. The animations or highlighted UI areas can help the user learn the UI, discover UI features, etc. The UI can include Easter eggs that steer users to certain features and/or spaces, or engage in certain activities. To illustrate, to help the user(s) 140 calibrate microphone(s) 112 on remote control(s) 110 or a voice recognition feature based on audio recorded by microphone(s) 112, the UI can display interactive content that prompts or encourages the user(s) 140 to submit verbal commands or utterances through microphone(s) 112. This way, the UI can try to drive the user(s) 140 to provide more voice commands or utterances that can be used to calibrate microphone(s) 112 or the voice recognition feature and make the calibration process easier/seamless for the user(s) 140.

In some cases, the UI experience(s) can relate or be based on the theme(s) selected for the UI. For example, if the theme(s) includes a football theme, the UI experience(s) can involve football content, a football activity, a football game, and/or can be configured to have a visual appearance associated with football. Thus, UI management system 130 can take into account the theme(s) selected for the UI when determining a UI experience(s) for the UI (if any).

UI management system 130 can also use any portion of input data 902 to help determine the UI experience(s). For example, UI management system 130 can use input data 902 to determine that a movie is being released on a particular day and select the movie as a theme for the UI. UI management system 130 can use this information to determine a UI experience(s) used to promote the movie on that day. This way, the UI experience(s) relates to the theme(s) of the UI and the movie release. As another example, if input data 902 indicates that a sponsor has paid to have a channel of the sponsor promoted, UI management system 130 can select a UI experience(s) configured to promote the channel of the sponsor through the UI.

If input data 902 includes a blacklist of topics that should not be used for a theme, UI management system 130 can use the blacklist to avoid UI experiences related to such topics. If input data 902 includes preferences (e.g., user preferences, business preferences, etc.) or topic weights, UI management system 130 can use the preferences or topic weights to select a UI experience from multiple candidate UI experiences or rank the multiple candidate UI experiences.

At step 908, UI management system 130 can generate UI data 910 based on the theme(s) and optionally based on the UI experience(s) selected (if any). UI data 910 can include the UI and/or can be used to generate, render, and/or display the UI. The UI can be customized with the theme(s) and can optionally be customized to include the UI experience(s) (if any).

In some cases, UI data 910 can include parameters used to configure and customize the UI based on the theme(s) (and optionally the UI experience(s), if any). The parameters can specify any content, UI elements (e.g., tiles, cards, input elements, navigation elements, output elements, controls, etc.), UI containers (e.g., UI banners, UI sections, etc.), UI behaviors, an organization and/or arrangement of items in the UI (e.g., UI containers such as UI banners and/or UI sections, UI elements such as tiles/cards and/or input elements, visual content and/or attributes (e.g., images, animations, visual elements, colors, color schemes, artwork, thumbnails, a background(s), a screensaver(s), graphics, visual effects, logos, symbols, etc.), style parameters (e.g., UI style parameters, UI fonts, UI element/container shapes and/or sizes, UI element/container borders or frameless settings, UI element types, etc.), UI design parameters, a UI structure, UI experience information, UI activities, content groupings or categories, content items (e.g., movies, TV shows, video games, etc.), UI appearance parameters, user personalization parameters, content types, types of UI design elements, etc. The UI parameters can implement, convey, include, depict, and/or relate to the theme(s) and/or can be customized for and/or based on the theme(s). In some cases, the UI parameters can also be used to configure the UI experience(s) determined at step 906.

In some cases, UI data 910 can include a UI customized based on the theme(s). The customized UI can optionally include the UI experience determined at step 906 (if any). UI management system 130 can send UI data 910 to media device(s) 104 which can use UI data 910 to render/display the customized UI. In other cases, UI data 910 can include the data used to generate and/or render the UI, such as instructions, parameters, objects, code, UI components, a UI template, etc. UI data 910 can be used to customize/configure the UI to include the theme(s) and the UI experience(s) (if any), such as any of the user interfaces shown in FIGS. 3A through 8C.

In some cases, UI management system 130 can provide UI data 910 to display device(s) 106, which can use UI data 910 to display/render the UI. In other examples, UI management system 130 can provide UI data 910 to media device(s) 104, and media device(s) 104 can use UI data 910 to display the UI or trigger display device(s) 106 to display the UI. As previously noted, in some cases, UI data 910 can include the UI to be displayed/rendered at display device(s) 106. For example, in a server-side rendering scenario, UI data 910 can include the UI generated by UI management system 130. UI management system 130 can provide the UI (e.g., UI data 910 in this example) to media device(s) 104 or display device(s) 106 for display. Alternatively, in a client-side rendering scenario, UI data 910 may include the data used to generate/build the UI at the edge (e.g., locally). In this scenario, rather than UI management system 130 building the UI and providing the generated UI, UI management system 130 can provide data used by media device(s) 104 or display device(s) 106 to generate/build and/or render the UI for display.

In some cases, the UI can be automatically configured to apply, select, or implement a user or group profile based on presence detection information. For example, media device(s) 104 can detect a presence of one or more users within a scene that includes media device(s) 104 and select a user or group profile based on the one or more users detected within the scene. The user or group profile can be tailored to the one or more users detected. If a user detected does not have an existing user profile, media device(s) 104 and/or UI management system 130 can generate a user profile for such user. If the user already has a user profile, the user profile of the user can be automatically selected for the UI based on a presence detection result. If multiple users are detected in the scene, the user profiles of the users can be merged into a group profile for the users or otherwise used to generate the group profile. If some of the users have an existing user profile but one or more users do not have a profile, media device(s) 104 and/or UI management system 130 can generate a user profile for the one or more users and combine the user profile with the user profile(s) of the user(s) who do have an existing user profile.

FIG. 10A is a diagram illustrating an example scene 1000 with users 1004-1006 viewing a UI 1010 customized based on a group profile 1012 of the users 1004-1006 selected using presence detection. In this example, media device(s) 104 in the scene 1000 is connected to display device(s) 106 and presenting UI 1010 on display device(s) 106. The users 1004-1006 in the scene 1000 are viewing UI 1010 and associated content presented via display device(s) 106.

In this example, display device(s) 106 includes a camera sensor 1002. The camera sensor 1002 can capture one or more images of an area within the scene 1000 that is in front of the camera sensor 1002 and display device(s) 106. The area can include an area where users are typically located (and/or are expected to be located) when viewing content displayed on display device(s) 106. Thus, if the image data captured by the camera sensor 1002 includes one or more users, media device(s) 104 and/or UI management system 130 can detect a presence of the one or more users within the scene (or, more specifically, within an area where users are expected to be when viewing display device(s) 106), which can be used to determine or infer that the one or more users are viewing or interacting with display device(s) 106. If the image data captured by the camera sensor 1002 does not depict any users, media device(s) 104 and/or UI management system 130 may determine that no users are present within the scene 1000 (or within the area where users are expected to be when viewing display device(s) 106), and thus determine or infer that no users are viewing display device(s) 106.

In some cases, the camera sensor 1002 can capture image data when display device(s) 106 is turned on, is displaying content (e.g., a UI such as UI 1010), and/or is not in a lower-power mode such as a sleep mode/state, turned off, hibernating, etc. In some cases, display device(s) 106 can trigger the camera sensor 1002 to capture image data when display device(s) 106 is turned on or when display device(s) 106 is displaying content. Display device(s) 106 can trigger the camera sensor 1002 to capture image data periodically (e.g., at certain intervals, on a schedule) while display device(s) 106 is turned on (or actively displaying content) and/or in response to triggers, such as user inputs, content interactions, certain type of device activity, signals/instructions from another device (e.g., remote control(s) 110, media device(s) 104, a mobile phone of a user, an IoT device in the scene 1000, and/or any other device), etc.

In some cases, the camera sensor 1002 can include an “always-on” camera sensor that continuously captures image data even when display device(s) 106 is not in use, when a screen of display device(s) 106 is turned off or displaying a screensaver, and/or without explicit recording commands from a user or device. The “always-on” camera sensor can constantly run in the background (e.g., in a background process/service) in a lower-power mode than when the camera sensor is actively in use by a user or device to capture higher-resolution and/or quality image data. The “always-on” camera sensor functionality can be used to continuously obtain image data used to sense a presence of any users in the scene 1000 and optionally sense any other conditions or characteristics of the environment.

Media device(s) 104 and/or UI management system 130 can use the image data from the camera sensor 1002 (e.g., the image data captured by the camera sensor 1002 when running in a background/lower-power mode such as an “always-on” mode and/or the image data captured when running in a higher-power mode such as when triggered to capture the image data by a user, device, triggering event, or a defined interval) to detect a presence of any users in the scene 1000. For example, media device(s) 104 and/or UI management system 130 can use the image data to perform a presence detection operation. The presence detection operation can be performed using a presence detection algorithm such as, for example and without limitation, a facial recognition algorithm, an object detection algorithm configured to detect people, a motion detection algorithm configured to sense human motion used to detect a presence of a person(s), a video/image tracking algorithm, a gesture recognition or detection algorithm, a context awareness algorithm, and/or any other algorithm that can help detect a presence of users based on image data.

In some cases, media device(s) 104 and/or UI management system 130 can detect a presence of a user(s) if the image data depicts the user(s) in the scene 1000. In some cases, media device(s) 104 and/or UI management system 130 can use the image data to verify that a user(s) that is present in the scene 1000 (e.g., as depicted in the image data) is actually viewing display device(s) 106 and/or engaging with content displayed by display device(s) 106. For example, in addition to determining whether any users are present in the scene 1000, media device(s) 104 and/or UI management system 130 can determine a context of the users, a gesture of the users, a pose of the users, a behavior of the users, an attention of the users, and/or an activity of the users to verify whether the users are actually engaging with display device(s) 106 or simply present in the scene 1000 for other reasons.

For example, if media device(s) 104 and/or UI management system 130 determines that the image data depicts the users 1004-1006 in the scene 1000, media device(s) 104 and/or UI management system 130 can perform gesture detection to determine a respective gesture of the users 1004-1006. The gesture of the users can indicate whether the users 1004-1006 are actually engaged with display device(s) 106 (e.g., watching content on display device(s) 106) or otherwise present in the scene 1000 but engaged in something else and potentially not paying attention to display device(s) 106 (or the content thereof). To illustrate, if the gestures of the users 1004-1006 indicate that the users 1004-1006 are sleeping or painting a wall in the scene 1000, media device(s) 104 and/or UI management system 130 may determine that the users 1004-1006 are not paying attention to the content on display device(s) 106 and generate a negative presence detection result even though the users 1004-1006 are present in the scene 1000.

Media device(s) 104 and/or UI management system 130 can additionally or alternatively perform context awareness using the image data to verify whether the users 1004-1006 are paying attention to display device(s) 106 or not. For example, media device(s) 104 and/or UI management system 130 can determine whether the users 1004-1006 are sleeping (or one of the users is sleeping), looking out of a window in the scene 1000, or otherwise no paying attention to display device(s) 106, or can confirm that the users 1004-1006 are paying attention to display device(s) 106 based on a context of the users 1004-1006 (e.g., what the users 1004-1006 are looking at, what they are doing, etc.).

In some cases, media device(s) 104 and/or UI management system 130 can use the image data to perform pose estimation and use the pose estimation information to verify whether the users 1004-1006 are paying attention to display device(s) 106. For example, if the pose of the users 1004-1006 indicate that the users 1004-1006 are sleeping or not looking in a direction towards display device(s) 106, media device(s) 104 and/or UI management system 130 can determine that the users 1004-1006 are not present, even though the users 1004-1006 are technically present in the scene 1000. If instead the pose estimation information indicates that the users 1004-1006 have a certain pose indicative of the users 1004-1006 paying attention to and looking towards display device(s) 106, media device(s) 104 and/or UI management system 130 can confirm that the users 1004-1006 are in the scene 1000.

In some cases, media device(s) 104 and/or UI management system 130 can additionally or alternatively use tracking information to verify whether the users 1004-1006 are paying attention to display device(s) 106. For example, if the users 1004-1006 are within a certain region relative to display device(s) 106 for a threshold period of time, moving in certain patterns and/or within certain ranges, or are detected to have less than a threshold amount/range and/or frequency of motion for a threshold period of time (or at all), media device(s) 104 and/or UI management system 130 can use such information to determine whether the users 1004-1006 are paying attention to and/or engaging with display device(s) 106 or simply present in the scene 1000 but not engaging with or paying attention to display device(s) 106.

In some examples, media device(s) 104 and/or UI management system 130 can maintain a respective picture(s) of one or more users, such as any user who has used display device(s) 106, any user who lives in a home associated with the scene 1000, any user associated with a photo library, etc. Media device(s) 104 and/or UI management system 130 can use any pictures of users to help detect a presence of such users in the scene 1000. For example, if media device(s) 104 and/or UI management system 130 have a picture of the user 1004 and a picture of the user 1006 and information indicating which user is pictured in each picture, media device(s) 104 and/or UI management system 130 can compare the picture of the user 1004 and the picture of the user 1006 with image data captured by the camera sensor 1002 that depicts the user 1004 and the user 1006. Based on the comparison, media device(s) 104 and/or UI management system 130 can determine that the users depicted in the image data captured by the camera sensor 1002 are the users 1004-1006. Based on this determination, media device(s) 104 and/or UI management system 130 can then determine that the users 1004-1006 are present in the scene 1000.

In some cases, media device(s) 104 and/or UI management system 130 can use other data (e.g., in addition to the image data from the camera sensor 1002) to detect a presence of the users 1004-1006 in the scene or confirm that the users 1004-1006 are paying attention to and/or engaged with display device(s) 106 (and thus should be determined to be present in the scene 1000). For example, remote control(s) 110 can use microphone(s) 112 to record audio in the environment. Remote control(s) 110 can provide the audio recorded by microphone(s) 112 to media device(s) 104 and/or UI management system 130. Media device(s) 104 and/or UI management system 130 can use the recorded audio to determine whether the users 1004-1006 are present in the scene 1000 and determine (or verify) whether the users 1004-1006 are paying attention to and/or engaging with display device(s) 106.

For example, media device(s) 104 and/or UI management system 130 can use voice recognition to determine whether the recorded audio matches a voice of any users. In some cases, to perform the voice recognition, the recorded audio can be compared with any known voice signatures, such as voice signatures of the users 1004-1006. A match between the recorded audio and a voice signature can indicate that a user associated with the voice signature is present. In some cases, the voice signature can be generated by encoding one or more vocal attributes (e.g., tone, pitch, volume, intonation, harmonic structure, and/or any other voice features and/or vocal attributes) and/or speech characteristics (e.g., voice quality, rate of speech, rhythm, pronunciation, etc.) in a feature embedding(s) or generating a hash based on data encoding or describing one or more speech characteristics and/or vocal attributes. In some examples, human voices can be detected without known voice signatures. For example, the recorded audio can be analyzed to identify any speech. If any speech is detected, media device(s) 104 and/or UI management system 130 can determine that a user is present. The image data can be used to confirm such detection result and/or identify the specific user(s) in the scene 1000. In some cases, the vocal attributes and/or speech characteristics of any speech in the audio recording can be analyzed to distinguish between speech from different users and thereby determine that there are more than one user in the scene 1000, and/or to identify the specific user(s) in the scene associated with such vocal attributes and/or speech characteristics.

In some cases, media device(s) 104 and/or UI management system 130 can additionally or alternatively use the recorded audio to perform natural language processing (NLP) (e.g., speech recognition, natural language understanding (NLU), sentiment analysis, semantic analysis, discourse analysis, etc.). The NLP can be used to detect or confirm a presence of any users in the scene 1000 and/or determine whether any detected users are paying attention to or engaging with display device(s) 106. For example, speech recognition and/or NLU can be used to determine what any users in the scene 1000 are discussing. The speech content can indicate whether the users are paying attention to the content displayed at display device(s) 106 or engaged in an unrelated activity. To illustrate, if the speech recognized in the recorded audio includes comments from multiple users about a content being presented at display device(s) 106, media device(s) 104 and/or UI management system 130 can determine that multiple users are present in the scene 1000 and engaged with display device(s) 106.

If the speech content corresponds to an unrelated activity, such as snoring, media device(s) 104 and/or UI management system 130 can determine that the user(s) associated with that speech content is not engaged with display device(s) 106. If the speech content includes voice commands for media device(s) 104 and/or display device(s) 106, the voice commands can indicate that the user associated with the voice commands is indeed paying attention to display device(s) 106. If the speech content indicates that there are multiple users in the scene 1000 but the users are playing a game unrelated to the content being presented, the speech content can be used to determine that the users are present but not paying attention to the content (and thus a presence detection result should indicate that the users are not present or are present but inattentive). If the speech content indicates that the user(s) associated with the speech content is below a certain age (e.g., a toddler, an infant, etc.), media device(s) 104 and/or UI management system 130 can determine that a user is present but likely not engaged with display device(s) 106 (or that age-inappropriate content should not be displayed, which can trigger media device(s) 104 to block age-inappropriate content while the user below the certain age is present).

In some cases, the presence of the users 1004-1006 can be detected (and/or the detection results generated based on the image data and/or the recorded audio confirmed or supplemented) based on user activity. The user activity can include inputs provided via remote control(s) 110, inputs provided via voice commands, usage patterns of any of the devices in the scene 1000 (e.g., media device(s) 104, display device(s) 106, remote control(s) 110, a mobile phone, an IoT device, etc.), and/or sensor data from other sensors on remote control(s) 110. For example, in some cases, remote control(s) 110 can include one or more inertial sensors, such as an accelerometer or gyroscope. The one or more inertial sensors can be used to detect motion of remote control(s) 110. The motion of remote control(s) 110 can indicate whether a user is holding remote control(s) 110 and thus present in the scene 1000. In some cases, users can have different patterns of holding and using remote control(s) 110. Accordingly, the motion data from the one or more inertial sensors can be used to detect any motion patterns of remote control(s) 110, which can be used to identify a specific user holding remote control(s) 110.

As another example, inputs to remote control(s) 110 can be used to detect a presence of a user in the scene 1000. In some cases, the pattern of inputs and/or characteristics of the inputs to remote control(s) 110 (e.g., the input pressure, load/weight, magnitude, etc., as detected by a touch sensor on remote control(s) 110) can be used to identify a specific user. For example, different users may have different patterns of inputs and/or input characteristics (e.g., input pressure, magnitude, load/weight, etc.). Therefore, the patterns and/or characteristics of inputs at remote control(s) 110 can be used to identify or confirm an identify of a user present in the scene 1000 (e.g., a user using remote control(s) 110).

In other examples, the usage patterns of media device(s) 104 can be used to detect a presence of a user and potentially identify or confirm an identity of a user associated with the usage patterns. Thus, media device(s) 104 and/or UI management system 130 can analyze any usage patterns of media device(s) 104 (e.g., in addition to or instead of any usage patterns of remote control(s) 110) to detect a presence of a user and/or identify/confirm an identity of a user in the scene 1000.

In some cases, one or more signals from other devices in the scene 1000 can additionally or alternatively be used to detect a presence of a user(s) and/or identify a user(s) present in the scene 1000. For example, wireless signals from media device(s) 104, an access point in the scene 1000, an IoT device, a mobile phone(s) of a user, and/or any other wireless device in the scene 1000 can be used to detect a presence of a user and/or an identity of a user(s) in the scene 1000. In some cases, WIFI signals can be used to detect a presence of a user(s) in the scene 1000, such as users 1004-1006, using WIFI sensing. Other wireless signals, such as Bluetooth signals or any radio signal can be used to detect a presence of a user(s) in the scene 1000, such as users 1004-1006.

In some cases, the channel state information (CSI), a received signal strength indicator (RSSI), and/or an angle-of-arrival (AoA) of wireless signals from one or more wireless devices and/or wireless signal reflections can be analyzed to detect whether there are users in the scene 1000. If a user(s) is present, the CSI, RSSI, and/or AoA of wireless signals and/or signal reflections can have certain characteristics which can be used to determine whether there are any users in the scene. In this way, the CSI, RSSI, and/or AoA information can be used to detect a presence of the users 1004-1006 in the scene 1000.

If any of the users 1004-1006 have a mobile device, such as a mobile phone or a smartwatch, the mobile device can help detect a presence of such user(s). For example, media device(s) 104 can detect a presence of the mobile phones of the users 1004-1006 based on wireless signals from the mobile phones, a communication exchange with the mobile phones, and/or user inputs provided to media device(s) 104 through the mobile phones. In some cases, the users 1004-1006 can announce or confirm their presence in the scene 1000 using one or more client devices, such as their respective mobile phones. For example, the users 1004-1006 can use their mobile phones as remote controls to provide inputs to media device(s) 104. Media device(s) 104 can associate the mobile phones with the users 1004-1006 and thus the inputs with the users 1004-1006, and thereby determine that the users 1004-1006 are present in the scene 1000. In other examples, the users 1004-1006 can use an application on their device to confirm or announce their presence to media device(s) 104, such as an application paired with media device(s) 104 or configured to communicate presence information to media device(s) 104.

In some cases, the presence of a user in the scene 1000 can be detected based on a determination that a client device associated with the user is connected to a network in the scene 1000 or a device in the scene 1000. For example, if the users 1004-1006 have mobile phones and their mobile phones are connected to a wireless network or an access point in the scene 1000 (or in another room in a same house, office, building, etc.), the fact that their mobile phones are connected to the wireless network or the access point can be used to determine that the users 1004-1006 are present in the scene 1000.

In some cases, the users 1004-1006 can use the one or more mobile devices to scan a visual element depicted by display device(s) 106, such as a quick response (QR) code, and trigger the one or more mobile devices to send a notification to media device(s) 104 that the users 1004-1006 are present (e.g., within a proximity) in the scene 1000. Media device(s) 104 can implement the group profile 1012 customized for the users 1004-1006. The one or more mobile devices can optionally provide information to media device(s) 104 used to customize the group profile 1012 for the users 1004-1006, such as device data, user data, user history data, user activity, user preferences, user patterns, user inputs, user profile information, etc. In some cases, each of the one or more mobile devices can include an application that can communicate information to media device(s) 104 used to customize the group profile 1012, trigger implementation of the group profile 1012, trigger the group profile 1012 to be timed-out or terminated/closed, or enable any of the users 1004-1006 to interact with media device(s) 104 or the group profile 1012.

In some cases, the activity at display device(s) 106 can be used to detect a presence of the users 1004-1006 and potentially identify the users 1004-1006. For example, certain activity or frequency of activity (and/or inactivity) can indicate whether a user(s) is engaging with display device(s) 106, and thus present in the scene 1000. To illustrate, display device(s) 106 may detect a period of inactivity and generate a prompt requesting a user to confirm that they are still watching content in display device(s) 106. If display device(s) 106 does not receive an answer to the prompt (or does not receive an answer within a threshold period of time), the lack of an answer can indicate that no users are present in the scene 1000 or paying attention to display device(s) 106. Alternatively, if an answer is provided, the answer can indicate that a user(s) is present and paying attention to display device(s) 106, and thus used to detect a user presence.

Interactions with content can also be used to detect a presence of a user in the scene 1000 and potentially identify such user. For example, if a user logs into a site from a user account, the user account used to login can be used to identify the user and the act of login in can be used to confirm/detect a presence of the user. If a user interacts with content in display device(s) 106, the interactions can be used to detect or confirm a presence of a user in the scene 1000. As another example, users can have different navigation patterns when navigating user interfaces. A model, such as an AI/ML model, can learn the navigation patterns of different users, such as users who have used display device(s) 106 (and/or media device(s) 104). Accordingly, the model can detect a navigation pattern(s) of a user(s) interacting with UI 1010 and detect which user(s) is present in the scene 1000 based on the navigation pattern(s).

In some cases, the presence and/or identity of a user in the scene 1000 can be detected based on pose and/or motion characteristics of the user. For example, children typically walk different than adults and have certain patterns in the way they walk. The camera sensor 1002 can capture a video of a user in the scene 1000 that can be analyzed to identify any patterns in the movement of the user. The patterns in the movement in the user may be used to determine whether the user is a child or an adult, and thus can help identify the user in the scene 1000. The poses of children also often differ from the poses of adults. Thus, sensor data such as image data from the camera sensor 1002, WIFI sensing data, and/or inertial sensor measurements can be used to identify pose patterns of a user in the scene 1000. The pose patterns can be used to determine whether the user is a child or an adult, which can be used to or help identify the user in the scene 1000. For example, if the scene 1000 is a living room in a home with an adult and a child, a determination that the user in the scene 1000 is a child can be used to determine that the child in the home is present in the scene 1000. In some cases, such information can be combined with any other presence detection information described herein (e.g., presence detection based on image data from the camera sensor 1002, based on voice data recorded by microphone(s) 112 on remote control(s) 110, etc.) to formulate a more complete presence detection result.

In some cases, a device in the scene 1000 can include a presence detection sensor(s) used to detect a presence of any user in the scene 1000, such as a radio detection and ranging (RADAR) sensor, a light detection and ranging (LIDAR) sensor, an infrared sensor, a time-of-flight (ToF) camera sensor, a ultrasound sensor, a capacitive sensor, a photoelectric sensor, an acoustic sensor, an ambient light sensor, a thermal sensor, a proximity sensor, etc. For example, remote control(s) 110, media device(s) 104, display device(s) 106, a mobile device of the user 1004 or the user 1006, an IoT device in the scene 1000, and/or any other device in the scene 1000 can include one or more presence detection sensors can be used to detect a presence of the users 1004-1006, and/or verify a presence and/or identity of the users 1004-1006 in the scene 1000. The one or more presence detection sensors can be used for the presence detection described herein in addition to or instead of any other sensor device and/or sensing technique/technology described herein, such as camera sensor 1002, microphone(s) 112, presence detection based on usage patterns, etc.

Media device(s) 104 and/or UI management system 130 can use the presence detection and a user recognition/identification result to select a profile for the user(s) detected, customize the UI 1010 (and/or content/features thereof), recommend content, and/or customize the UI experience. For example, in FIG. 10A, a presence detection and user recognition/identification result that detects and identifies the users 1004-1006 in the scene 1000 (and paying attention or engaging with display device(s) 106) can be used to select a profile 1012 for the users 1004-1006. The profile 1012 can include a group profile for the users 1004-1006. The group profile can include a combination of a user profile (and/or data thereof) of the user 1004 (e.g., an existing user profile or a newly-generated user profile based on the detection of the user 1004 in the scene 1000) and a user profile (and/or data thereof) of the user 1006 (e.g., an existing user profile or a newly-generated user profile based on the detection of user 1006 in the scene 1000).

The group profile 1012 can be automatically selected for the users 1004-1006 based on the detection results, as previously described. The group profile 1012 can drive, influence, and/or determine (and/or can be used to determine) a configuration of UI 1010, a content of UI 1010, a theme of UI 1010, a UI experience(s), any recommended content, a customized UI experience, and/or any other details of UI 1010 and/or the user experience. For example, the group profile 1012 can be used to tailor UI 1010 for the users 1004-1006, recommend content to the users 1004-1006, and/or personalize a user experience(s) provided by UI 1010 for the users 1004-1006.

The group profile 1012 can provide a personalized experience for the users 1004-1006 based on customizations to UI 1010, the content (or a portion thereof) displayed and/or suggested in UI 1010, any UI experiences enabled or provided by UI 1010, etc. In some cases, the group profile 1012 can customize UI 1010 (e.g., including any content, theme, experience, and/or features associated with UI 1010) at least partly based on information about the users 1004-1006 associated with UI 1010. For example, the group profile 1012 can customize UI 1010 for the users 1004-1006 based on respective user profiles (and/or associated data such as preferences, content, statistics, content histories, user data, etc.) of the users 1004-1006 (e.g., if any user profiles exist or are created for the users 1004-1006).

In some cases, the group profile 1012 can customize UI 1010 for the users 1004-1006 additionally or alternatively based on data from and/or about the users 1004-1006 such as, for example, content histories (e.g., content watch histories, content interaction histories, etc.) of the users 1004 and/or 1006, user preferences of the users 1004 and/or 1006, statistics associated with the users 1004 and/or 1006, previous customizations received/accepted and/or requested/implemented by the users 1004 and/or 1006, social media data (e.g., posts, connections, subscriptions, likes, dislikes, etc.) of the users 1004 and/or 1006, device and/or content activities of the users 1004 and/or 1006, user inputs and/or feedback from the users 1004 and/or 1006, content (e.g., movies, TV shows, podcasts, music, audiobooks, media channels, media applications, etc.) previously purchased and/or rented by the users 1004 and/or 1006, user characteristics (e.g., demographics, contexts, locations, etc.) of the users 1004 and/or 1006, known and/or estimated interests of the users 1004 and/or 1006, and/or any other information about the users 1004 and/or 1006.

In some examples, UI management system 130 can use such information to identify preferences (e.g., content preferences, UI preferences, preferred UI experiences, preferred themes, preferred animations, preferred features, etc.) that are common to the users 1004-1006, and configure the group profile 1012 based on the common preferences (e.g., to apply the common preferences to UI 1010 provided to the users 1004-1006). This way, the group profile 1012 can be configured to personalize UI 1010 to the users 1004-1006 as well as the preferences, interests, tendencies/propensities, characteristics, and/or histories of the users 1004-1006 and ensure that the content suggested or provided based on the group profile 1012 is suitable, appropriate, and desirable to the users 1004-1006.

In some cases, UI management system 130 can also use such information to identify any UI features (e.g., content, animations, UI experiences, themes, configurations, content recommendations, etc.) that are inappropriate (e.g., based on one or more rules, content ratings, user ages, user sensitivities, user information, parental controls, etc.) for the user 1004 and/or the user 1006, are disliked (e.g., a known or estimated user interest is below a threshold or has a threshold likelihood of being below a threshold) by the user 1004 and/or the user 1006, are associated with a feedback from the user 1004 and/or the user 1006 that is classified as a negative feedback, are included in a blacklist or filter associated with the user 1004 and/or 1006, have less than a threshold match or similarity to a user preference or interest associated with the user 1004 and/or 1006, and/or are otherwise classified or estimated to be inappropriate or undesired to/by the user 1004 and/or 1006. The group profile 1012 can then be configured to exclude or filter any of those UI features so UI 1010 and associated content provided to the users 1004-1006 based on the group profile 1012 exclude anything that is inappropriate for either user, unsuitable for either users, undesirable to either users, disliked by either user, blacklisted by either users, of less than a threshold likelihood of interest to either user, has less than a threshold match or similarity to a user preference and/or history of either user, and/or otherwise selected to be filtered for either user. This way, when the group profile 1012 is selected/activated for UI 1010, the group profile 1012 can customize UI 1010 and user experience to include things that are suitable and selected for both users 1004-1006 but exclude anything that may be inappropriate, unsuitable or not selected for the user 1004 and/or 1006.

The group profile 1012 can drive (e.g., specify, apply, configure, select, etc.) the content and experience provided by UI 1010 to users 1004-1006. In some cases, the group profile 1012 can drive what content is provided or recommended to the users 1004-1006 in UI 1010, the theme(s) of UI 1010, the UI components (e.g., UI elements, UI containers, etc.) of UI 1010, the UI experience(s) provided by UI 1010, a design/style and/or appearance of UI 1010, an organization of UI 1010 and/or items in UI 1010, etc. In some cases, the group profile 1012 can additionally drive one or more settings configured on UI 1010 presented to the users 1004-1006. Non-limiting examples of such settings can include brightness levels of display device(s) 106 and/or UI 1010 (and/or associated content), resolution settings, language settings, accessibility settings, content type settings, volume settings, sleep settings, hibernation settings, operating modes, settings profiles (e.g., brightness themes such as light or dark themes, video settings, display settings, etc.), privacy settings, content restriction settings, interface configuration settings, output settings, device settings, aspect ratio settings, dynamic settings (e.g., brightness adjustments based on time of day or ambient light or environment brightness levels, different resolution settings for different contexts or content, volume settings based on noise levels in the scene 1000 as determined based on audio recorded by microphone(s) 112 and/or user inputs), display settings, input and/or output settings, etc.

In some cases, the group profile 1012 can be used to personalize a theme of UI 1010 for the users 1004-1006. For example, the group profile 1012 can add specific backgrounds, visual elements, Easter eggs, artwork, imagery, etc., tailored to and/or selected by the users 1004-1006. In some examples, the users 1004-1006 can make changes to the group profile 1012 and/or UI 1010 configured at least partly based on the group profile 1012, such as adjust one or more settings, adjust a UI layout, adjust a UI theme, adjust an appearance of UI 1010 and/or graphics displayed in UI 1010, etc. Adjustments made by any of the users 1004-1006 can be used to update the group profile 1012 such that those adjustments are applied/retained by the group profile 1012 in the future and/or the group profile 1012 can be further customized in view of such adjustments and/or determinations/inferences made based on such adjustments. In some examples, UI management system 130 can analyze any adjustments made by any of the users 1004-1006 to learn from such adjustments and use the learned information to update the group profile 1012 to provide a better experience to the users 1004-1006. In this way, the group profile 1012 can learn and improve over time.

The group profile 1012 can be associated with an avatar 1014. For example, the group profile 1012 can optionally include the avatar 1014 or select, configure, apply, and/or customize the avatar 1014 for the users 1004-1006. The avatar 1014 can include or provide a visual representation of the users 1004-1006. In some cases, the avatar 1014 can also include visual attributes used to indicate or identify the profile (group profile 1012) used by UI 1010 and/or active in the session associated with UI 1010, which user(s) (e.g., users 1004-1006) is/are associated with the active profile (e.g., group profile 1012). The avatar 1014 can include, represent, or be used as a profile image associated with the group profile 1012 and the users 1004-1006, as previously noted. In some cases, the avatar 1014 can include a picture of the users 1004-1006 (e.g., based on a picture showing both users or a respective picture of each user combined into a picture showing both users), a graphic representation or depiction of the users 1004-1006, or any other representation of the users 1004-1006. In some examples, the picture of the users 1004-1006 can include a real picture of the users 1004-1006. In other examples, the picture of the users 1004-1006 can include a picture generated and/or customized by a generative AI model of UI management system 130.

For example, the generative AI model can use data about the users 1004-1006, such as image data and/or user descriptions, to generate a picture of the users 1004-1006 for the avatar 1014. As another example, the generative AI model can modify a real picture of the users 1004-1006 to customize the picture. The generative AI model can customize a background of the picture, a theme of the picture, an appearance of the user 1004 and/or 1006, a behavior of the picture, and/or any other aspects of the picture. In some cases, the camera sensor 1002 can capture a picture of the users 1004-1006, which can be used as the avatar 1014 or modified/customized by the generative AI model to generate the avatar 1014. In other cases, the users 1004-1006 can provide UI 1010 access to pictures of the users 1004-1006. The generative AI model can use such pictures or one or more selected pictures to generate the avatar 1014.

In other cases, UI 1010 can display a picture picker that allows the users 1004-1006 to upload a picture(s) and/or pick a picture(s) from a source, such as a photo album or a storage. The uploaded and/or selected picture(s) can be used as the avatar 1014 or modified to generate the avatar 1014. In some examples, the avatar 1014 can display certain visual features to distinguish the avatar 1014 from other avatars so a user looking at UI 1010 can identify the avatar 1014 (e.g., identify which user(s) correspond/corresponds to the avatar 1014) and/or the group profile 1012 associated with the avatar 1014. For example, the avatar 1014 can include certain colors, backgrounds, titles, messages, themes, sizes, patterns, object depictions, etc., that can help users recognize the avatar 1014 and associated the avatar 1014 with the corresponding user(s) (e.g., users 1004-1006) and group profile 1012.

In some aspects, UI management system 130 can stylize the avatar 1014 based on visual attributes of UI 1010, a theme(s) of UI 1010, a content in UI 1010, and/or any other visual attributes associated with UI 1010. For example, any of the users 1004-1006 can upload, select, or share (e.g., grant access to) an image(s) of the users 1004-1006 (e.g., a real picture, a synthetic image, or any visual representation). UI management system 130 can apply any visual attributes from or generated based on UI 1010 to the image and use the modified image in the avatar 1014. In some examples, UI management system 130 (e.g., via an AI/ML model) can stylize an image(s) (e.g., real or fake/synthetic) of the users 1004-1006 based on UI 1010, a theme(s) of UI 1010 and/or visual attributes of the theme(s), a content or content item in UI 1010, a UI experience(s) associated with UI 1010, and/or any other aspect of UI 1010.

To illustrate, UI management system 130 (e.g., via an AI/ML model) can customize an image (or generate a customized image) of the users 1004-1006. UI management system 130 can apply or transfer a theme(s) (or visual attributes of a theme(s)) of UI 1010 (or aspects thereof) to the image, such as a color or color scheme(s), a background, a garment or shirt, an outfit, a head cover (e.g., hat, helmet, crown, etc.), an accessory, an object, a scene, and/or any other attribute. The modified image can be used as or depicted in/by the avatar 1014. UI management system 130 can additionally or alternatively modify or customize an image of the users 1004-1006 to depict one or more visual attributes of (and/or related to) UI 1010, a content of UI 1010, an animation of UI 1010, a UI experience(s) associated with UI 1010, etc., and use the modified image as the avatar 1014 (or display it in the avatar 1014). For example, UI management system 130 can transfer a background of UI 1010 to an image of the users 1004-1006 used for or as the avatar 1014, or apply a modified version of the background to the image. If UI 1010 includes a promoted movie or advertisement related to racing cars, UI management system 130 can generate a customized image depicting the users 1004-1006 (or a visual representation of the users 1004-1006) in a racing car and/or with car racing gear. If a UI experience(s) provided by the UI 1010 includes Las Vegas theme, UI management system 130 can transfer visual attributes from the Las Vegas theme or apply other visual attributes generated based on the Las Vegas theme to a customized image of the users 1004-1006 used as or for the avatar 1014.

The avatar 1014 can additionally or alternatively be stylized based on profile data (e.g., preferences, content history, etc.) from the group profile 1012. For example, if the group profile 1012 includes a watch history of the users 1004-1006 that indicates that the users 1004-1006 has watched horror movies, UI management system 130 (e.g., via an AI/ML model) can generate or modify an image or visual representation of the users 1004-1006 used for the avatar 1014 to apply a horror theme, such as a dark background, a scene from a horror movie, an outfit from a character in a horror movie, etc. If the group profile 1012 includes a purchase history indicating that the users 1004-1006 purchased a fishing show, UI management system 130 can customize an image or visual representation of the users 1004-1006 used for the avatar 1014 to depict the users 1004-1006 in a fishing scene, such as a fishing boat, or with fishing gear.

In some cases, UI management system 130 can suggest an avatar (or customization thereof) to users 1004-1006 based on a content viewing history of the users 1004-1006 (e.g., if the users 1004-1006 have a history of viewing sports content, UI management system 130 can suggest a customization to the avatar 1014 to implement a sports theme, show sports content, depict the users 1004-1006 with sports outfits, etc.), based on an input from the users 1004-1006 (e.g., a response to a question, an interaction with a content item, an input in a game, a user request, etc.), and/or user characteristics. In some examples, the avatar 1014 can change over time based on certain information, activity, preferences, rules, user interface locations, navigation states, and/or other factors. For example, if the users 1004-1006 navigate to sports content or a sports zone in UI 1010, the avatar 1014 can dynamically change to implement a sports theme and/or appear customized for sports (e.g., depict the users 1004-1006 with a sports outfit, with a helmet, with a ball, etc.).

Similarly, the avatar 1014 can change based on a content history of the users 1004-1006 and optionally progressively adapt to user interests and/or preferences. For example, if the users 1004-1006 increasingly watch more science content when together, the avatar 1014 can make adjustments based on the propensity of the users 1004-1006 to watch science content. Here, the avatar 1014 can be customized to include a science background, depict science objects, and/or tailor a view of the users 1004-1006 in the avatar 1014. For example, the avatar 1014 can show the users 1004-1006 with a science lab coat, a space suit, a microscope, a hairstyle resembling a hairstyle of a famous scientist such as Einstein, etc.

To create the group profile 1012, UI management system 130 can optionally merge a user profile of the user 1004 with a user profile of the user 1006 to generate a shared profile based on both user profiles. For example, if the users 1004-1006 already have individual profiles, UI management system 130 can merge the profiles into a shared profile used as the group profile 1012. If one of the users does not have a user profile, UI management system 130 can create a user profile as described herein and merge the profile with the user profile of the user who already has a profile. If none of the users 1004-1006 have a profile, UI management system 130 can create the group profile 1012 without using or merging existing user profiles.

In some cases, UI management system 130 can configure the UI 1010 to select a certain profile at certain times or locations, or when UI management system 130 is unsure which user(s) is/are present in the scene 1000. For example, if display device 106 is located in a family room and is shared between users in the family include children, UI management system 130 can configure UI 1010 to default to a family profile in cases where there is less than a threshold certainty of which user(s) is/are present in the scene 1000. The family profile can include a profile that filters any content that may not be suitable or appropriate for one or more users in the family such as the children (e.g., based on an age of one or more users such as the children and content ratings, based on parental controls, and/or based on any other factors) and/or only provide/keep content that is estimated to be suitable, appropriate, and/or of interest to all users in the family.

As another example, UI management system 130 can configure the default user profile applied at display device(s) 106 when the identity of a user(s) in the scene 1000 is/are not known (or not know with a threshold certainty) can change based on the time of the day or the day of the week. For example, during the day, the default profile can be a family profile and at a certain time at night, such as a time after a bedtime of the children in the family, the default profile can switch to a different profile, such as a profile tailored to the adults in the family.

In some cases, UI management system 130 can configure UI 1010 to display a profile picker that allows a user(s) in the scene 1000 to select a profile. UI 1010 can display the profile picker in cases where the identity of a user(s) in the scene 1000 is/are not known, for example. If the identity of a user(s) in the scene 1000 is/are not known, UI management system 130 can configure UI 1010 to apply a user profile that has a highest matching score with respect to any user profiles, preferences, and/or data such as content histories of any users in the household, or can apply a user profile that has the least likelihood of being inappropriate, unsuitable, and/or disliked by any users.

In some cases, control of remote control(s) 110 and/or the content played by UI 1010 can be gamified. For example, UI 1010 can surface a game for the users 1004-1006. The winner of the game can win control over remote control(s) 110 and/or the content played/displayed by UI 1010. As previously noted, the presence detection can be used to automatically detect any user(s) present in the scene and/or engaged with content displayed on display device(s) 106 in order to automatically select a profile for the detected user(s), customize a user interface for the detected user(s), customize and/or surface an avatar associated with the detected user(s), etc.

FIG. 10B is a diagram illustrating another example scene 1020 with a user 1004 viewing a UI 1030 customized based on a user profile 1022 of the user 1004 selected using presence detection. In this example, the scene 1020 represents the same physical location as the scene 1000 in FIG. 10A and includes the same devices shown in scene 1000 and described with respect to FIG. 10A. However, the scene 1020 in FIG. 10B only includes the user 1004, whereas the scene 1000 in FIG. 10A includes the user 1004 and the user 1006.

Here, media device(s) 104 and/or UI management system 130 can use presence detection as previously described, to automatically detect a presence of the user 1004 in the scene 1020. Media device(s) 104 and/or UI management system 130 can use the presence detection result to automatically select or generate a user profile 1022 for the user 1004. For example, media device(s) 104 and/or UI management system 130 can use presence detection as previously described to determine that the user 1004 is present in the scene 1020. Media device(s) 104 and/or UI management system 130 can then determine that the user profile used for the UI 1030 displayed at display device(s) 106 should be a user profile personalized for the user 1004, as opposed to a shared profile for users 1004-1006 as illustrated in FIG. 10A. UI 1030 can automatically apply, use, activate, and/or select the user profile 1022 of the user 1004.

The user profile 1022 can include a profile specific to the user 1004 (e.g., personalized/customized for the user 1004). The user profile 1022 can be generated and/or configured based on data associated with the user 1004 such as, for example and without limitation, user preferences, a content watch history (e.g., movies watched, TV shows watched, etc.), previous user interactions with user interfaces and/or user interface content (e.g., previous purchases, previous setting changes, previous requests, previous content selections, previous activities, etc.), previous user inputs, social media data (e.g., posts, connections, likes, dislikes, subscriptions, etc.), user characteristics (e.g., demographics, user interests, etc.), and/or any other information associated with the user 1004.

The user profile 1022 can be used to personalize, customize, configure, and/or adapt UI 1030 for the user 1004. For example, the user profile 1022 can be used to customize a theme of UI 1030, personalize content or recommendations in UI 1030, implement certain UI experiences for the user 1004, apply certain settings for UI 1030 (and/or a content thereof) and/or a device such as display device(s) 106, customize a visual appearance and/or a behavior of UI 1030, filter or blacklist certain content, personalize a background of UI 1030 (and/or any UI components thereof such as UI elements, UI containers, etc.), personalize any content item references or Easter eggs displayed in UI 1030, select and/or generate/customize a user avatar 1024 of the user 1004, customize activities/games and/or interactions associated with UI 1030, customize animations depicted in UI 1030, and/or customize any other aspects of UI 1030.

If another user where to enter the scene 1020 to watch content on UI 1030, media device(s) and/or UI management system 130 can use presence detection as previously described to detect that the other use is now present in the scene 1020, in addition to the user 1004. Media device(s) 104 and/or UI management system 130 can use the presence detection result to automatically select or generate a shared profile for the user 1004 and the other user, as previously described with respect to FIG. 10A. The shared profile can be used to customize UI 1030 as described herein, customize the avatar displayed on UI 1030, etc.

If the user 1004 leaves the scene and the other user remains on the scene 1020, media device(s) 104 and/or UI management system 130 can use presence detection to determine that the user 1004 is no longer in the scene 1020 and the other user is the only user present in the scene 1020. Media device(s) and/or UI management system 130 can then automatically implement a user profile for that user to customize UI 1030, the user avatar, and the UI experience for the other user. For example, media device(s) 104 and/or UI management system 130 can switch from the shared profile of the user 1004 and the other user to a user profile personalized to the other user, and update UI 1030 based on the user profile of the other user (e.g., such that UI 1030 is customized according to the user profile of the other user as opposed to the shared profile which may include settings that may not be included in the user profile of the other user).

The user avatar 1024 can be generated and/or customized as previously described. For example, the user avatar 1024 can be generated or customized based on an image of the user 1004 captured by the camera sensor 1002, one or more images of the user 1004 in a source with user photos such as a photo album, a photo uploaded by the user 1004, a photo selected by the user 1004 using a photo picker displayed by UI 1030, and/or other user data.

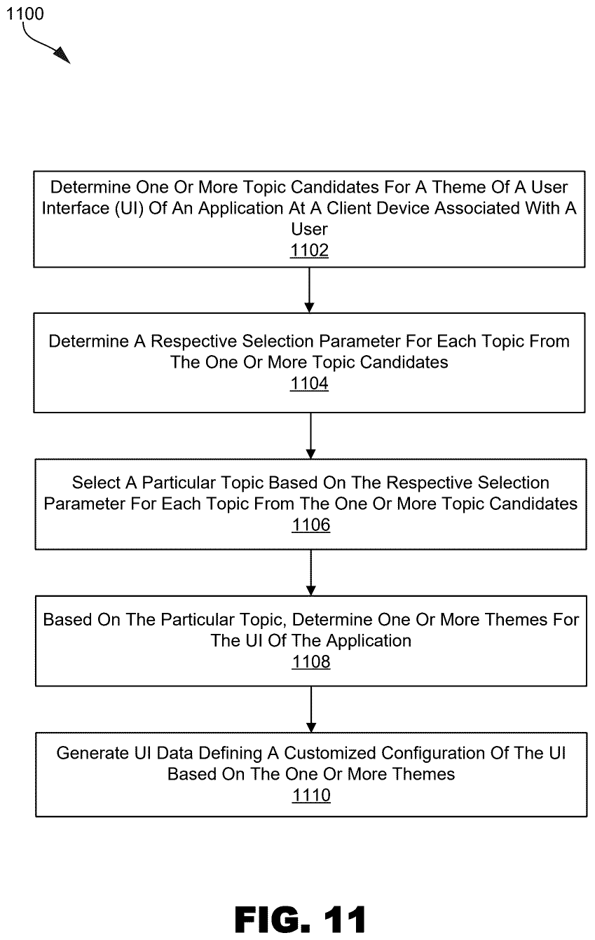

FIG. 11 is a flowchart illustrating an example method 1100 for customizing a UI based on one or more themes. Method 1100 can be performed by processing logic that can include hardware (e.g., circuitry, dedicated logic, programmable logic, microcode, etc.) and/or software (e.g., instructions executing on a processing device). It is to be appreciated that not all steps may be needed to perform method 1100. Some of the steps may be performed simultaneously, or in a different order than shown in FIG. 11, as will be understood by one of ordinary skill in the art. Method 1100 shall be described with reference to FIGS. 1 and 2. However, method 1100 is not limited to those examples.

At step 1102, UI management system 130 or media device(s) 104 can determine one or more topic candidates for a theme of a UI of an application at media device(s) 104. The one or more topic candidates can include, relate to, and/or be determined based on an event (e.g., game, competition, debate, birthday, holiday, tournament, informal holiday or commemorative day, content or product release, current event, social event, cultural event, etc.), preference (e.g., user preference, group preference, preference of a sponsor or business, etc.), team (e.g., sports team, science team, etc.), brand, product, content item, content franchise, person, sport, subject, context, geographic location or region, character, object, activity, landmark, scene, calendar data, profile data, and/or any other signal/data. UI management system 130 or media device(s) 104 can determine the one or more topic candidates based on one or more signals.

At step 1104, UI management system 130 or media device(s) 104 can determine a respective selection parameter for each topic from the one or more topic candidates. Each topic can have a respective selection parameter (or multiple selection parameters). The respective selection parameter of a topic can include, for example, a topic preference score, topic priority, topic metric, and/or topic relevance. The topic relevance can represent/measure a relevance of the topic with respect to a date when the UI is displayed (e.g., a current date) and/or with respect to user(s) 140, the application, content associated with the application, an event, a trend, a context, and/or any other cue (e.g., any other signal).

At step 1106, UI management system 130 or media device(s) 104 can select a particular topic from the one or more topic candidates based on the respective selection parameter of each topic from the one or more topic candidates. For example, UI management system 130 or media device(s) 104 can compare the respective selection parameter of each topic candidate with the respective selection parameter of each remaining topic candidate to identify the topic candidate that has the highest selection parameter. UI management system 130 or media device(s) 104 can select the topic candidate with the highest selection parameter, such as the particular topic.

In some cases, UI management system 130 or media device(s) 104 can select the particular topic based on a relevance of the particular topic as compared to the relevance of each of the remaining topic candidates. For example, UI management system 130 or media device(s) 104 can select the topic that has a highest relevance score and/or highest amount of relevant features (e.g., features related to the date, user(s) 140, the application, a content of the application, an event, etc.), a topic that has a threshold relevance and/or is associated with another selection parameter (e.g., a topic preference score or user preference, topic priority, topic metric, etc.), a topic that has a specific type of relevance (e.g., a type of relationship with or to the date, user(s) 140, the application, a content of the application, a content item, an event, etc.), etc.

In some examples, UI management system 130 or media device(s) 104 can compare the respective selection parameter of each of the one or more topic candidates and select the topic (e.g., the particular topic) determined to have (e.g., based on the comparison) the highest relevance (or relevance score), the best match for the date and/or a user preference, the highest number of relevant characteristics, a highest relevance ranking, a threshold relevance, a threshold relevance as well as one or more additional selection criteria or factors relative to other topics (e.g., a user preference, a rating or ranking, an additional relevance, a cultural significance relative to other topics, a celebration statistic, a relevance history, etc.).

In some cases, the topic relevance can include a relevance score, a match or matching score, a similarity value, a relationship or relationship metric, a comparison metric, a relevance value, etc. For example, to determine the topic relevance of each topic, UI management system 130 or media device(s) 104 can compare aspects of the topic with the date, user preferences, user activity, aspects of the content of the application associated with the UI, a content item, the application, an event, a context, etc., to determine whether the topic is related to the date, is of more significance on the date (or a period that includes the date) than other dates, is related to an item being released/presented or promoted, matches or has a similarity/relevance to an event or topic associated with the date, etc.

At step 1108, UI management system 130 or media device(s) 104 can determine, based on the particular topic, one or more themes for the UI. For example, UI management system 130 or media device(s) 104 can determine a theme(s) that is based on or relates to the particular topic and select that theme(s) for the UI. The particular topic can define the one or more themes and/or any aspect thereof. In some cases, the one or more themes can be based on one or more aspects or examples of the particular topic. For example, if the particular topic is football, the one or more themes can include a theme about a football team or a particular football game. In other words, the one or more themes can include a theme that relates generally to the particular topic and/or relates to a specific detail associated with the particular topic (e.g., football in general or a particular football team, player, game, etc.).

At step 1110, UI management system 130 or media device(s) 104 can generate UI data defining a customized configuration of the UI based on the one or more themes. For example, the UI data can define a UI configuration that customizes the UI to incorporate the one or more themes (or aspects thereof). In some examples, the customized configuration of the UI can include a user experience (UX) design that incorporates and/or is at least partly based on the one or more themes. The UX design can define a UI design customized based on the one or more themes, a configuration of the one or more themes, a user experience associated with the UI, a behavior of the UI, a UI background, a UI organization, an interaction design of the UI, an arrangement of items in the UI, UI parameters, and/or any other attributes of the UI.

In some cases, the UI design can include a visual design of the UI customized based on the one or more themes. The visual design can include a UI layout (e.g., a page layout, an UI structure, a grid layout, a container layout, a section layout, a banner layout, a tile layout, a content layout, UI sections, content areas, a placement of UI elements, etc.), a UI style, a background (e.g., a UI background, a background of any UI elements, a background of any UI containers, etc.), artwork, imagery, an animation depicted in the UI, UI graphics, one or more definitions of one or more UI elements, one or more UI containers, and/or any other UI settings/attributes. In some examples, the UI style can define or include visual attributes of the UI, such as a color and/or color scheme (e.g., a primary color, a secondary color, a color pattern, an accent color for one or more UI elements, a color palette, etc.), a typography (e.g., fonts or font families, sizes, weights, heading styles, etc.), one or more objects, a style (e.g., page style, UI element style, navigation style, design style, etc.), a visual property of the one or more UI elements (e.g., a background, an appearance, a label, a color, a shape, a size, a hover state, a placement, etc.), and/or any other visual attributes. In some examples, the color scheme can be based on the one or more themes. For example, if the one or more themes are associated with any specific color(s), the color scheme can include that specific color(s).

The UI design can optionally include the one or more UI elements and one or more UI containers. The one or more UI elements can include, for example, one or more navigation elements (e.g., a navigation bar, navigation drawer, navigation rail, bottom app bar, search element, tab, top app bar, scrolling element, next or back button, etc.), action or CTA elements (e.g., a button, selectable icon, selectable tile or card, link, input element, selectable content, etc.), selection and/or input elements (e.g., a checkbox, menu, date picker, button, slider, switch, picker, content selection element, etc.), text elements (e.g., a text field, label, section, input, etc.), interactive elements, control elements (e.g., control settings, buttons, command elements, etc.), menus, UI dividers, UI dialogue elements, a silhouette(s), a UI tile, a UI card, communication elements (e.g., a tooltip, badge, snackbar, progress indicator, notification or notification area, chat or message element, etc.), and/or any other UI element. The one or more UI containers can include, for example and without limitation, one or more UI banners, UI sections, UI spaces, UI frames, UI sheets (e.g., bottom sheets, side sheets, etc.), UI carousels, dialogs, dividers, toolbars, etc.

The one or more definitions of the one or more UI elements can include a definition of each UI element. In some examples, the definition of each UI element can specify, include, and/or define a UI element type (e.g., button, checkbox, field, icon, image, showcase banner, tile, search element, menu, date picker, content picker, slider, navigation bar, selectable image or video, etc.), a UI element position, a UI element size, a UI element appearance (e.g., color(s), pattern(s), background(s), style, visual attribute, etc.), a UI element shape, a UI element background, a UI element behavior, UI element data/content, a UI element hierarchy, and/or any other UI element characteristic. In some examples, the UI element appearance can include a UI element color(s) and/or color scheme(s), a UI element font, a UI element border setting (e.g., no border, a border, a border width/thickness, a border color, etc.), a UI element style, a UI element image, a UI element link, a UI element background, a UI element pattern, a UI element label, a UI element text, a visual attribute of the UI element, and/or any other characteristic.

In some cases, the customized configuration of the UI can include a UI design customized based on the one or more themes. The UI design can include, for example, a layout, UI element definitions, UI content (e.g., displayed and/or available content items, content selected for the one or more themes, etc.), a visual design of the UI customized based on and/or incorporating the one or more themes, a navigation design, a UI template, a UI container(s), one or more UI parameters customized based on the one or more themes, and/or any other characteristics. The one or more UI parameters can define, for example and without limitation, one or more UI properties, one or more content spaces, one or more UI behaviors, etc. The UI content can include one or more UI elements, images, thumbnails, icons, videos, movies, shows, interactive content, video games, podcasts, dynamic content, and/or any other content. The UI element definitions can specify UI element sizes, shapes, positions, appearances, backgrounds, styles, element types, behaviors, colors, color schemes, links, fonts, border settings, etc.

The visual design of the UI can include, for example, visual attributes of the UI customized based on the one or more themes and/or styling information based on the one or more themes. The styling information can include or specify a color(s) and/or color scheme, background, typography, artwork, graphics, imagery, fonts, styles, border settings, iconography of any UI elements, labels, spacing, content structures, formatting, visual patterns, etc. The UI elements can include, for example, a UI tile, card, silhouette, menu, form element, button, navigation element, search element, selection element, control element, display element, input element, and/or the like.

In some cases, UI management system 130 or media device(s) 104 can determine that the date corresponds to a scheduled event. The scheduled event can include, for example, a content release date or promotion, a formal or informal holiday (e.g., a commemorative day celebrated by users), a game, a competition, an announcement, a news event, a political event, a community event, and/or any other event. The particular topic can be associated with the scheduled event. For example, the particular topic can include, relate to, describe, and/or match the scheduled event (and/or any aspect thereof).

UI management system 130 or media device(s) 104 can then determine, based on the determining that the date corresponds to the scheduled event, that the particular topic associated with the scheduled event has a highest selection parameter from the respective selection parameter of each topic from the one or more topic candidates. The highest selection parameter can include, for example, a highest topic preference score from one or more respective topic preferences scores of the one or more topic candidates, a highest topic priority from one or more respective topic priorities of the one or more topic candidates, a highest topic metric from one or more respective topic metrics of the one or more topic candidates, and/or a highest topic relevance from one or more respective topic relevances of the one or more topic candidates. UI management system 130 or media device(s) 104 can then select the particular topic from the one or more topic candidates based on the highest selection parameter associated with the particular topic, and determine the one or more themes for the UI based on the particular topic. The one or more themes can be customized based on the particular topic associated with the scheduled event. The customized configuration of the UI can include the one or more theme customized based on the particular topic associated with the scheduled event.

In some examples, the topic preference score can be based on a preference of the user(s) 140, a group, the application, an entity, a sponsor, and/or any other preference. The topic priority can be based on a topic trend score, a topic popularity, a topic promotion associated with the sponsor (e.g., a topic promoted by the sponsor, a topic having a promotion priority from the sponsor, a topic that the sponsor paid for or paid a certain amount for, etc.), a count of references to the topic in one or more media sources and/or social media networks (e.g., how many times the topic was referenced in one or more media sources and/or social media networks), a topic interest score, and/or any other criteria. The topic metric can include, for example, a topic request count, a topic statistic, a topic weight (e.g., a topic weight defined or specified by the application, the user(s) 140, an entity associated with the application, a sponsor, etc.), a topic performance value, etc. The topic relevance can be based on, for example, a relationship between the topic and the date of presentation of the UI (e.g., a current date), a context associated with the user(s) 140, a trend associated with a trend score (e.g., a trend on social media, a community, a popular culture, a region, etc., that has a threshold trend score, a particular trend score or count, a popularity score, etc.), a location associated with the user(s) 140, a content of the UI, an event, etc.

In some aspects, UI management system 130 or media device(s) 104 can select, based on user data, a topic personalized to the user(s) 140 and/or one or more features of the one or more themes personalized to the user(s) 140. The user data can include, for example, a user preference, a user input, a user history (e.g., a content watch history, purchasing history, social media history, UI interaction history, user profile, input history, history of activities, etc.), a user interaction(s) with content and/or one or more UIs, a user purchase, a user characteristic (e.g., demographics, attributes, location, etc.), user activity, social media data (e.g., posts, connections, subscriptions, likes, dislikes, etc.), and/or any other user data. The topic personalized to the user and/or the one or more features personalized to the user can be associated with an activity, content, team, player, character, competition, genre, event, topic, etc. The particular topic can include the topic personalized to the user(s) 140. UI management system 130 or media device(s) 104 can determine the one or more themes further based on the topic personalized to the user(s) 140, and determine the customized configuration of the UI based on the one or more themes and the one or more features of the one or more themes personalized to the user.

In some cases, UI management system 130 or media device(s) 104 can determine that the date corresponds to a holiday, such as a formal holiday recognized by an entity (e.g., a federal or religious holiday, etc.) or an informal holiday such as a commemorative day celebrated by any users (e.g., “May The Fourth Be With You”). The particular topic can include the holiday and UI management system 130 or media device(s) 104 can determine a respective relevance of a holiday topic associated with the holiday. UI management system 130 or media device(s) 104 can determine the respective relevance of the holiday topic based on the determination that the date corresponds to the holiday, select the holiday topic from the one or more topic candidates based on the respective relevance of the holiday topic, and determine the one or more themes for the UI based on the holiday topic. The one or more themes can include a holiday theme and the customized configuration of the UI can be customized based on the holiday theme.

In some examples, UI management system 130 or media device(s) 104 can determine that the date matches a release date of a content item. The content item can include content scheduled to be released on the application, a movie, a TV show, a video, a podcast, a video game, live content, or any other content. UI management system 130 or media device(s) 104 can determine a respective relevance of a content topic associated with the content item (e.g., a topic of the content item, a topic related to the content item, a topic about the release of the content item, etc.). UI management system 130 or media device(s) 104 can determine the respective relevance of the content topic based on the determination that the date matches the release date of the content item. In this example, the content topic can be the particular topic, and UI management system 130 or media device(s) 104 can select the content topic from the one or more topic candidates based on the respective relevance of the content topic and determine the one or more themes for the UI based on the content topic. The one or more themes can be associated with the content topic (e.g., a theme based on the content topic, a theme including the content topic, etc.), and the customized configuration of the UI can be customized based on the content topic.

In some cases, UI management system 130 or media device(s) 104 can determine that the date matches a scheduled date of an event, such as a game, competition, announcement, cultural event, political event, social event, anniversary, annual event, celebration, holiday, activity, etc. UI management system 130 or media device(s) 104 can determine a respective relevance of an event topic associated with the event (e.g., a topic related to or based on the event). UI management system 130 or media device(s) 104 can determine the respective relevance of the event topic based on the determination that the date matches the scheduled date of the event. The event topic can include or represent the particular topic in this example. UI management system 130 or media device(s) 104 can select the event topic from the one or more topic candidates based on the respective relevance of the event topic and determine the one or more themes for the UI based on the event topic. The one or more themes can include an event theme associated with the event topic (e.g., a theme based on or related to the event or the event topic), and the customized configuration of the UI can be customized based on the event theme.

In some examples, UI management system 130 or media device(s) 104 can optionally determine a preferred topic of the user(s) 140. The preferred topic can include or be associated with a preferred activity, content, team, character, contest winner (e.g., contestant), genre, event, celebration, geographic location, etc. UI management system 130 or media device(s) 104 can determine a respective relevance of the preferred topic, which in this example can include or represent the particular topic. UI management system 130 or media device(s) 104 can select the preferred topic from the one or more topic candidates based on the respective relevance of the preferred topic and determine the one or more themes for the UI based on the preferred topic. The one or more themes can be associated with the preferred topic, and the customized configuration of the UI can be customized based on the one or more themes.

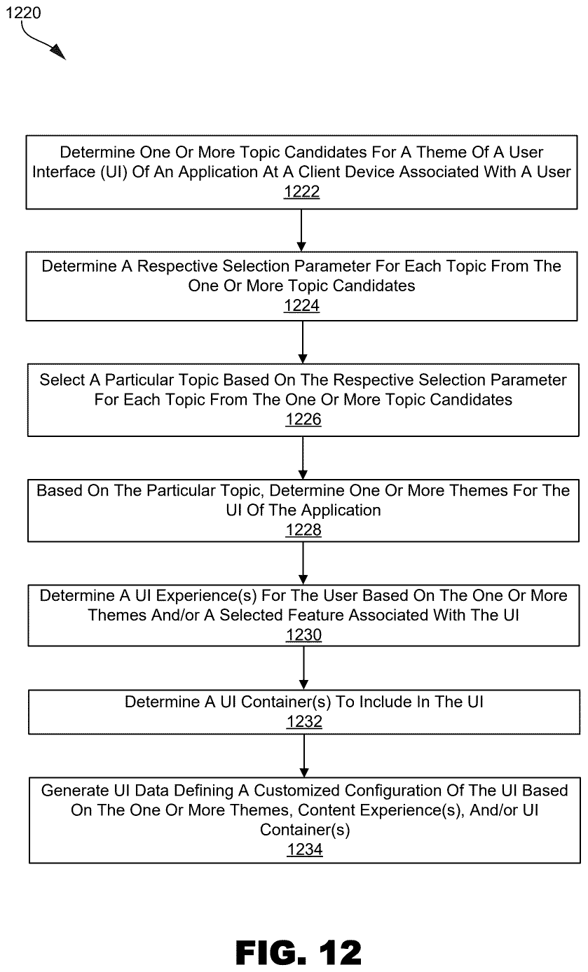

FIG. 12 is a flowchart illustrating an example method 1200 for customizing a user interface to include a UI container(s) and immersive experience based at least in part on a theme(s). Method 1200 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 1200. Some of the steps may be performed simultaneously, or in a different order than shown in FIG. 12, as will be understood by one of ordinary skill in the art. Method 1200 shall be described with reference to FIGS. 1 and 2. However, method 1200 is not limited to those examples.

At step 1202, UI management system 130 (e.g., running at system server(s) 126 and/or media device(s) 104) can determine one or more topic candidates for a theme of a UI of an application at media device(s) 104. The one or more topic candidates can include, relate to, and/or be determined based on an event, brand, product, content, franchise, person, sport, subject, context, geographic location or region, character, object, activity, landmark, and/or any other topic. In some cases, UI management system 130 can determine the one or more topic candidates based on one or more signals.

At step 1204, UI management system 130 can determine a respective selection parameter for each topic from the one or more topic candidates. Each topic can have a respective selection parameter (or multiple selection parameters). The respective selection parameter of a topic can include, for example and without limitation, a topic preference score, a topic priority, a topic metric, and/or a topic relevance. The topic relevance can include a relevance of the topic with respect to a date associated with a presentation of the UI (e.g., a current date), the user(s) 140, the application, content associated with the application, an event, a trend, a context, and/or any other cue (e.g., any other signal).

In some examples, the topic preference score can be based on a preference of the user(s) 140, a group of users, the application, an entity associated with the application, a sponsor associated with the application, a business, and/or any other preference. The topic priority can be based on a topic trend score, a topic popularity, a topic promotion associated with the sponsor, a count of references to the topic in one or more media sources and/or social media networks, a topic interest score, and/or any other priority score. The topic metric can include a topic request count, a topic statistic, a topic weight (e.g., a topic weight specified by the application, the entity associated with the application, a user, etc.), a topic performance value, etc. In some examples, the topic relevance can be based on a relationship between the topic and a date when the UI is displayed, a context associated with the user(s) 140, a trend associated with a trend score, a location associated with the user(s) 140, a content of the UI, an event, etc.

At step 1206, UI management system 130 can select a particular topic from the one or more topic candidates based on the respective selection parameter for each topic from the one or more topic candidates. For example, UI management system 130 can compare the respective selection parameter of each topic candidate with the respective selection parameter of each of the remaining topic candidates to identify the topic candidate that has the highest selection parameter. UI management system 130 can then select the topic candidate with the highest selection parameter, such as the particular topic.

In some examples, UI management system 130 can select the particular topic based on a determination that the particular topic has a highest topic preference score, a highest topic priority, a highest topic interest score, a highest topic metric, and/or a highest a topic relevance relative to other topic candidates. The topic preference score can be based on a preference of the user(s) 140, a group of users, the application, an entity associated with the application, a sponsor associated with the application, a business, and/or any other preference. The topic priority can be based on a topic trend score, a topic popularity, a topic promotion associated with the sponsor, a count of references to the topic in one or more media sources and/or social media networks, a topic interest score, and/or any other priority score. The topic metric can include a topic request count, a topic statistic, a topic weight (e.g., a topic weight specified by the application, the entity associated with the application, a user, etc.), a topic performance value, etc. In some examples, the topic relevance can be based on a relationship between the topic and a date when the UI is displayed, a context associated with the user(s) 140, a trend associated with a trend score, a location associated with the user(s) 140, a content of the UI, an event, etc.

At step 1208, UI management system 130 can determine, based on the particular topic, one or more themes for the UI. For example, UI management system 130 can determine a theme(s) that is based on or relates to the particular topic and select that theme(s) for the UI. The particular topic can define the one or more themes and/or can be used to select the one or more themes (and/or any aspect thereof).

At step 1210, UI management system 130 can determine a UI experience(s) for the user(s) 140 based on the one or more themes and/or a selected feature associated with the UI. The selected feature can include content (e.g., movie, TV show, video game, podcast, etc.) to be highlighted or promoted by the UI (e.g., based on a content release data of the content, a trend metric of the content, a content statistic, a request from a sponsor or payment from the sponsor, a relevance of the content to a current date, an event associated with the content, a campaign associated with the content, a rank or priority associated with the content, etc.), a menu, a toolbar, a control element, a setting, a UI control, a functionality, and/or any other aspects of the UI selected to be highlighted, promoted, and/or included in a UI experience for the user(s) 140.

The UI experience(s) can include, for example and without limitation, one or more animations displayed by the UI (e.g., to promote or highlight the selected feature, to draw the attention of the user(s) 140 to the selected feature, to help the user(s) 140 discover or explore the selected feature, to help the user(s) 140 learn the selected feature, etc.), CTAs, user/content interactions (and/or types of interactions), UI activities, UI behaviors and/or actions, UI outputs, games on the UI, challenges provided by the UI, content item references (e.g., hidden messages or clues pertaining to specific content items such as movies or TV shows), and/or any other interactions between the user(s) 140 and the UI (and/or content/features thereof).

For example, if UI management system 130 selects to promote a particular feature of the UI, UI management system 130 can determine whether to promote the feature by using an animation, configuring the UI (or aspects thereof) or the feature to have a certain appearance used to promote or highlight the feature (e.g., adjusting a size, placement, and/or visual attribute of the feature), configuring the UI to provide a game or activity that may draw the user's attention to the feature, determining any other way to promote the feature. To illustrate, UI management system 130 can select to configure the UI to display content item references representing hidden messages/clues (e.g., Easter eggs) for a game or activity and invite the user(s) 140 to take part in the game/activity. UI management system 130 can display a content item reference(s) on or around (e.g., adjacent to, within a proximity of, etc.) the feature or hide the content item reference(s) within/behind the feature to try to draw the attention of the user(s) 140 to the feature via the content item reference(s) as part of the game/activity.

If UI management system 130 determines to use an animation to promote the feature, UI management system 130 can determine what animation and/or type of animation to use to promote the feature and/or how to configure such animation. For example, UI management system 130 can determine to configure the feature to be animated to draw the user's attention to the feature. As another example, to draw the user's attention to the feature in order to promote it, UI management system 130 can determine to configure an object to interact with the feature or move the feature to a UI location where the feature is then displayed, or animate other content in a way that draws the user's attention to the feature.

As another example, to promote the feature, UI management system 130 can select to configure the UI to invite, encourage, draw, or enable the user(s) 140 to explore the feature in the UI in exchange of a benefit to the user(s) 140 that incentivizes the user(s) 140 to use or explore the feature as a way to promote the feature. The benefit can include, for example, unlocking a clue for a challenge, such as a game or a puzzle, unlocking a content add-on, receiving a credit, receiving a discount or free/discounted content, receiving a subscription or a subscription a credit or discount, receiving access to paid content, being promoted within UIs displayed on devices of other users (e.g., having a user avatar of the user(s) 140 displayed on UIs presented to other users, being recognized in the UIs presented to other users, etc.), unlocking a feature/functionality, etc.

To illustrate, if the feature includes an advertisement, UI management system 130 can select to configure the UI to invite the user(s) 140 to watch the advertisement in exchange for a benefit, such as unlocking a clue for a puzzle or receiving an add-on. If the feature includes a control setting used to implement or adjust a functionality, to promote the control setting, UI management system 130 can select to configure an animated UI element, such as an object or content item, that interacts with a portion of the UI used to access the control setting (or that displays a control element used to adjust/manage the control setting) or that interacts with each UI element that the user(s) 140 would need to access to get to the control setting. For example, assume that, to reach the control element associated with the control setting, the user(s) 140 would need to navigate to a menu, within the menu navigate to a first submenu, within the first submenu navigate to a second submenu, and the control element can be found within the second submenu.

In this example, UI management system 130 can configure the UI to display an animation that draws the attention of the user(s) 140 to the menu to encourage the user(s) 140 to navigate to the menu (e.g., an animation that interacts with the menu, places or drops a visual element on or about the menu, animates the menu, etc.). In some cases, the UI experience(s) can include an immersive experience involving content, UI functionalities, activities, or games. For example, the UI experience(s) can include a puzzle on the UI and clues that the user(s) 140 can find by answering questions to help the user(s) 140 solve the puzzle. The clues can be placed somewhere in the UI so as the user(s) 140 navigates the UI and performs an action, (e.g., selects a content item, watches a content item such as a movie or an advertisement, uses a part of the UI or a feature for a first time, etc.) the UI unlocks a corresponding clue that may appear in a game. In some examples, clues can be dispersed throughout UI pages, sections, contents, features, screens, UI containers, and/or any other locations. The UI experience(s) can include a game or journey where the user(s) 140 can uncover clues at specific destinations until the user(s) 140 finds the last clue (and/or all clues).

If the one or more themes selected for the UI includes content related to a contest, the UI experience(s) can include an option to vote on questions that a contestant may ask in the contest. If the one or more themes of the UI is/are associated with food, such as a food-related theme or a baking show, the UI experience(s) can include a question to the user(s) 140 asking the user(s) 140 to identify the user's favorite celebrity chef, and using the answer from the user(s) 140 to update the one or more themes and/or a content of the UI. For example, the UI can be updated based on the answer to include content associated with the favorite celebrity chef or add a section or UI container with content items or tiles associated with content of the favorite celebrity chef. Alternatively or additionally, the answer can trigger an avatar of the user(s) 140 to be updated to display a visual attribute associated with the favorite celebrity chef. For example, if the favorite celebrity chef is known for wearing specific glasses and a specific chef hat, the avatar can be updated to show the user(s) 140 with the glasses and chef hat of the favorite celebrity chef.

The UI experience(s) can optionally include certain interactions. For example, the UI experience(s) can include an option that allows the user(s) 140 to select a favorite team in a sport. The UI can receive an answer identifying a team and display a comparison of the team pick of the user(s) 140 with the teams picked by other users in the content platform to show the user(s) 140 how the team preference of the user(s) 140 compares to the team preferences of other users in a community of users. In some cases, the UI experience(s) can allow the user(s) 140 pick or suggest UI themes, UI theme changes, content item references to display in the UI or as part of a theme, Easter eggs to display in the UI and/or a location in the UI to display them, etc. The Easter eggs can be placed or hidden anywhere in the UI. For example, an Easter egg can be hidden in a control element for a specific setting, such as a closed caption setting or a video setting, to encourage users to explore or discover the specific setting. If the user(s) 140 finds the Easter egg, the UI can display a celebration (e.g., a celebration that the user(s) 140 found the Easter egg or landed on a special UI destination) such as an image of the user(s) 140 or a name of the user(s) 140 being depicted in a background or screensaver associated with a UI theme.

If the UI is being displayed on a particular holiday or a celebrated day, such as Halloween, the UI experience(s) can provide a Easter egg hunt challenge/game where Easter eggs are placed throughout the UI or a background city theme. Users can try to find the Easter eggs to win the challenge/game. The challenge/game can help users become familiar with the UI, discover features on the UI, learn certain aspects of the UI, explore new locations of the UI, learn how to access certain features of the UI, become more proficient with the UI, among other benefits. Users can win awards or other benefits for winning the challenge/game as previously mentioned. In some cases, a behavior of an Easter egg can change dynamically based on one or more conditions. For example, assume that a weather balloon from a popular movie is depicted in the UI and used as an Easter egg that is hidden within a background of the UI. As the number of users who find the weather balloon (the Easter egg) increases, the weather balloon can grow or move. The weather balloon can be configured to eventually burst or disappear to provide a timeliness constraint so users are encouraged to find the weather balloon faster.

In some examples, the UI experience(s) can be configured to assist the user(s) 140 to setup a new device or profile. For example, the UI can display animations or highlight UI areas during a device or profile setup or activation/registration. The animations or highlighted UI areas can help the user learn the UI, discover UI features, etc. The UI can include Easter eggs that steer users to certain features and/or spaces, or engage in certain activities. To illustrate, to help the user(s) 140 calibrate microphone(s) 112 on remote control(s) 110 or a voice recognition feature based on audio recorded by microphone(s) 112, the UI can display interactive content that prompts or encourages the user(s) 140 to submit verbal commands or utterances through microphone(s) 112. This way, the UI can try to drive the user(s) 140 to provide more voice commands or utterances that can be used to calibrate microphone(s) 112 or the voice recognition feature and make the calibration process easier/seamless for the user(s) 140.

In some cases, the UI experience(s) can relate or be based on the one or more themes selected for the UI. For example, if the one or more themes includes a football theme, the UI experience(s) can involve football content, a football activity, a football game, and/or can be configured to have a visual appearance associated with football. Thus, UI management system 130 can take into account the one or more themes selected for the UI when determining a UI experience(s) for the UI.

When determining the UI experience(s) (and/or to help determine the UI experience(s)), UI management system 130 can use content information, sponsor information, campaign information, event information, user information, application information, statistics, social media data, historical data, topic information, and/or any other data described herein. For example, UI management system 130 can use information indicating that a movie is being released on a particular day and select the movie as the feature for the UI experience(s). UI management system 130 can determine a UI experience(s) used to promote the movie on the day of release. This way, the UI experience(s) relates to the movie release. As another example, if a sponsor has paid to have a channel promoted, UI management system 130 can select the channel for the UI experience, and configure a UI experience(s) to promote the channel of the sponsor via the UI.

At step 1212, UI management system 130 can optionally determine a UI container(s) to include in the UI. UI management system 130 can also determine a configuration of the UI container(s) such as, for example, a type of UI container(s) (e.g., UI banner, UI section, UI sheet, UI carousel, UI toolbar, UI space, UI box, etc.), a size and/or shape of the UI container(s), a UI container style and/or design (e.g., row, column, circle, etc.), a UI container appearance, a UI container behavior, a UI container placement, a UI container animation, a UI container background, a UI container customization (e.g., based on the one or more themes, etc.), a type of UI elements (e.g., UI cards, UI tiles, UI boxes, UI navigation elements, UI input elements, UI display elements, UI spaces, UI menus, etc.), a UI content, an arrangement of items in the UI container(s) (e.g., row arrangement, column arrangement, etc.), a number of UI containers, and/or any other attributes of the UI container(s).

UI management system 130 can determine the UI container(s) to include in the UI in order to organize and/or host content, UI elements, animations, and/or any other features. UI container(s) can, in some cases, be customized based on the one or more themes. In some examples, UI management system 130 can generate configuration data for configuring the UI container(s) and/or a specification of the UI container(s) defining how to configure the UI container(s). In some cases, the configuration data can include code configured to render/generate and/or configure the UI container(s). In some examples, the configuration data can be used to build, configure, and/or render the UI container(s). In some examples, the configuration data can include a UI container template, a specification of the UI container(s), a design of the UI container(s), UI elements in the UI container(s), content items and/or animations in the UI container(s), definitions of any UI elements of UI container(s), code or definitions of a behavior of the UI container(s), UI parameters associated with the UI container(s), parameters for integrating the UI container(s) into the UI, and/or any other content and/or configuration data for the UI container(s).

In some examples, the UI container(s) can implement the one or more themes and/or visual components thereof. For example, the UI container(s) can display content related to the one or more themes. The content can include imagery, UI elements, text, videos, interactive content, metadata, logos, icons, and/or any other content. In some cases, the content can include tiles. The tiles can be positioned within the UI container(s) according to any arrangement or grouping. For example, the UI container(s) can depict the tiles in a row, a column, a cloud, a grid, or any other arrangement. The tiles can depict content (e.g., text, an image or thumbnail, a logo, a color, a pattern, a symbol, visual effects, etc.) related to or based on the one or more themes. To illustrate, if the one or more themes includes a basketball theme, the tiles can depict basketball content, such as basketball images, visual content related to one or more basketball teams and/or games (e.g., images of the one or more basketball teams, colors of the one or more basketball teams, team logos of the basketball teams, team mascots of the one or more basketball teams, text labels/titles and/or content with names and/or information of the one or more basketball teams, image covers of one or more videos of the one or more basketball teams, etc.), a visual design or pattern associated with a basketball team or conference, images of basketball players, etc.

In some cases, the tiles can be selectable to access associated content or navigate to associated content or pages. For example, the tiles can represent videos related to the one or more themes. The user(s) 140 can select the tiles to watch or initiate playback of the videos associated with the tiles. To illustrate, in the previous example where the one or more themes include a basketball theme, the tiles can be selected to access or play corresponding basketball videos or access streams or live channels showing basketball games.

In some cases, the tiles can be selected to access related pages or interface views. For example, if a tile depicts a basketball player, the user(s) 140 can select the tile to access more information about the basketball player, update a view of the UI container(s) to display an updated tile or content associated with the basketball player, load a page displaying additional details about the basketball player, etc.

The UI container(s) (and/or tiles) can include or incorporate the one or more visual attributes of the UI or anu additional attributes that are based on, related to, or have a similarity to the one or more visual attributes of the UI. For example, if the one or more visual attributes of the UI include a background and imagery depicting a city theme, the UI container(s) (and/or the tiles) can also include the background (or a portion thereof) and/or the imagery (or a portion thereof) depicting the city theme, or can include other visual attributes that depict the city theme or another city theme (e.g., a theme of another city, a theme of the same real or fictitious city with modifications or from a different view, etc.). The UI container(s) (and/or the tiles) can include the background and/or imagery or the other visual attributes in addition to any other visual details or components configured or selected based on the one or more themes selected (e.g., in addition to other visual content and/or attributes configured to reflect the one or more themes).

At step 1214, UI management system 130 can generate UI data defining a customized configuration of the UI based on the one or more themes, the content experience(s), and/or the UI container(s). In some cases, the UI data can include the UI customized based on the one or more themes, the content experience(s) and/or the UI container(s). UI management system 130 can provide the UI data to media device(s) 104 which can render/display the UI.

In other cases, the UI data can include data used to generate, build, render, configure, and/or customize the UI based on the one or more themes, the content experience(s), and/or the UI container(s). For example, the UI data can include a description and/or specification of the customized UI, instructions for generating/customizing and/or rendering/displaying the UI, UI objects (e.g., UI elements, UI container(s), etc.), UI content, UI parameters, and/or any other data. Media device(s) 104 can use such data to generate, build, customize, and/or render/display the customized UI. The displayed UI can include the one or more themes and the UI container(s). Moreover, the displayed UI can provide the UI experience(s). The UI can provide the UI experience(s) when loaded/rendered, at a specific time, in response to a certain trigger or event, and/or based on an instruction.

In some cases, the UI can be customized further based on a profile of the user(s) 140. The profile of the user(s) 140 can be selected by the user(s) 140 or automatically selected by UI management system 130. In some examples, UI management system 130 can detect a presence of the user(s) 140 as previously described with respect to FIGS. 10A-10B, and select the profile of the user(s) 140 based on the presence detection results. For example, UI management system 130 can detect a presence of the user(s) 140 within a scene of media device(s) 104 (and/or a display displaying the UI) or within a proximity of the device displaying the UI. UI management system 130 can use image data from a camera sensor, measurements from one or more inertial sensors, touch input characteristics (e.g., pressure, touch patterns, etc.) determined based on touch inputs, usage patterns/statistics of a remote control(s) 110, proximity measurements (e.g., from WIFI sensing, a RADAR sensor, a LIDAR sensor, an ultrasound sensor, a ToF camera sensor, etc.), recorded speech, content interactions, and/or any other sensor data and/or content/usage patterns to detect a presence of the user(s) 140 within a scene or proximity associated with a device displaying or used to display the UI. Based on the detected presence of the user(s) 140, UI management system 130 can select a user profile of the user(s) 140 or generate a profile for the user(s) 140 if one is not already available.

UI management system 130 can use the profile to collect data associated with the user(s) 140, which UI management system 130 can use when customizing the UI. If the profile is an existing profile with data, UI management system 130 can customize any aspects of the UI based on the profile data (e.g., based on user preferences, a watch/content history, user statistics, user content purchases, user subscriptions, user inputs, user histories, etc.), such as the theme(s), a background, the UI experience(s), the UI container(s), any UI elements, any visual elements, a content of the UI, promoted items in the UI, etc.

In some examples, UI management system 130 can generate an avatar for the profile. The avatar can be used as a profile image. UI management system 130 can customize and/or stylize the profile image (e.g., the avatar) based on the user profile data and/or any aspect of the UI, such as the theme(s), a background, a content, the UI experience(s), visual elements, etc. For example, the user(s) 140 can upload, select, or share (e.g., grant access to) an image of the user(s) 140 (e.g., a real picture, a synthetic image, or any visual representation), or UI management system 130 can generate an image of the user(s) 140. UI management system 130 can apply any visual attributes from or generated based on the UI to the image of the user(s) 140 and use the modified image as the profile image (e.g., avatar). UI management system 130 (e.g., via an AI/ML model) can stylize the image based on the UI, the theme(s) of the UI, visual elements of the UI, a content of the UI, the UI experience(s), and/or any other visual attributes of the theme(s), a content of the UI, the UI experience(s), and/or any other aspect of the UI.

For example, UI management system 130 (e.g., via an AI/ML model) can customize an image (or generate a customized image) of the user(s) 140 for the profile image. UI management system 130 can apply or transfer a theme(s) (or visual attributes of a theme(s)) of the UI (or aspects thereof) to the image, such as a color or color scheme(s), a background, a garment or shirt, an outfit, a head cover (e.g., hat, helmet, crown, etc.), an accessory, an object, a scene, and/or any other attribute. UI management system 130 can additionally or alternatively modify or customize an image to depict one or more visual attributes of (and/or related to) the UI, a content of the UI, an animation of the UI, the UI experience(s), etc. To illustrate, UI management system 130 can transfer a background of the UI to the image used for or as the profile image (e.g., the avatar) or apply a modified version of the background to the image. If the UI includes a UI experience that includes a medical trivia challenge associated with a medical show for example, UI management system 130 can generate a customized image depicting the user(s) 140 (or a visual representation of the user(s) 140) with a doctor robe, a surgeon hat, a nurse outfit, a medical tool (e.g., a stethoscope, a blood pressure monitor, an IV drip, etc.), or in a medical setting such as a hospital bed. If an animation displayed in the UI is used to steer the user(s) 140 to a control setting used to configure a screen magnification setting (e.g., to show the user(s) 140 how to access such setting or teach the user(s) 140 how to access or configure such setting), UI management system 130 can customize a profile image of the user(s) 140 to show a visual representation of the user(s) 140 with a magnifying loupe or a monocle such that visual features of the profile image correlate to the animation displayed by the UI.

In some aspects, UI management system 130 can identify the user(s) 140 associated with the UI of an application and select one or more visual attributes from a set of visual attributes of the UI. The one or more visual attributes can be selected based on the theme(s) of the UI and/or a respective selection parameter associated with each content item from a set of content items of the UI. The respective selection parameter can define a content preference, a content priority, a content metric, and/or a content relevance to a date associated with a presentation of the UI, the user, the application, an event, and/or content topic. UI management system 130 can then generate, via an AI/ML model, a profile image of the user(s) 140 customized based on the one or more visual attributes of the UI, and provide the profile image of the user(s) 140 to the UI and/or media device(s) 104.

In some examples, the content preference can based on a preference of the user(s) 140, a group of users, the application, an entity associated with the application, a sponsor associated with the application, etc. In some cases, the content priority can be based on a content trend score, a content popularity, a content promotion associated with a sponsor, a content interest score, and/or a respective count of references in one or more sources to a respective topic associated with a content item from the set of content items of the UI. The one or more sources can include, for example, a media source, a social media network, the UI, etc.

In some examples, the content metric can include a content request count, a content statistic, a content selection weight specified by the application and/or an entity associated with the application, a content performance value, and/or any other metric. The content relevance can be based a relationship between each content item and the date, a context associated with the user(s) 140, a trend associated with a trend score, a location associated with the user(s) 140, a user input, an event, and/or a topic.

The visual attributes can be based on a background of the UI, animated content in the UI, UI content, one or more visual elements of the UI, artwork depicted in the UI, an object depicted in the UI, a UI graphic, UI imagery, a UI color or color scheme, a character depicted in the UI, a content associated with the theme, a UI banner, a UI page, and/or any UI feature. In some examples, the one or more visual attributes can include a color, a text, a font, a thumbnail, an icon, an image, a shape, a visual object, a graphic, a scene, a background, an animation, a garment, a landmark, a device, a facial feature, a costume, head covering, an accessory, a depicted activity, a property or prop, artwork, and/or any other visual features.

In some aspects, UI management system 130 can determine that the date corresponds to a scheduled event. The scheduled event can include, for example, a content release date or promotion, a formal holiday recognized by one or more entities, an informal holiday including a commemorative day celebrated by one or more users, a game, a competition, an announcement, a news event, a political event, a community event, and/or any other event. UI management system 130 can determine based on the determination that the date corresponds to the scheduled event, that a particular content item from the set of content items of the UI has a highest selection parameter from the respective selection parameter of each content item. The highest selection parameter can include a highest content preference score, a highest content priority, a highest content metric, and/or a highest content relevance. UI management system 130 can select the particular content item based on the highest selection parameter associated with the particular content item and determine the one or more visual attributes based on the particular content item.

In some cases, UI management system 130 can select, based on user data, content personalized to the user(s) 140 and/or one or more features of the theme personalized to the user(s) 140. The user data can include a user preference, input, history, interaction, purchase, characteristic, and/or activity. The content and/or features personalized to the user(s) 140 can be associated with an activity, content, team, character, competition, genre, event, and/or topic. UI management system 130 can determine the one or more visual attributes based on the content and/or one or more features personalized to the user(s) 140.

In some cases, UI management system 130 can determine a presence of the user(s) 140 within a scene. The presence of the user(s) 140 can be determined based on image data captured by an image sensor, a first usage pattern of a remote control(s) 110 determined based on inertial sensor measurements and/or remote control inputs, a second usage pattern of the UI determined based on user inputs, an audio recording including a voice or speech of the user(s) 140, motion of the user(s) 140 detected based on one or more sensors, a gesture of the user(s) 140 detected based on the image sensor and/or the one or more sensors, and/or any other presence detection cues described herein.

### Example Computer System

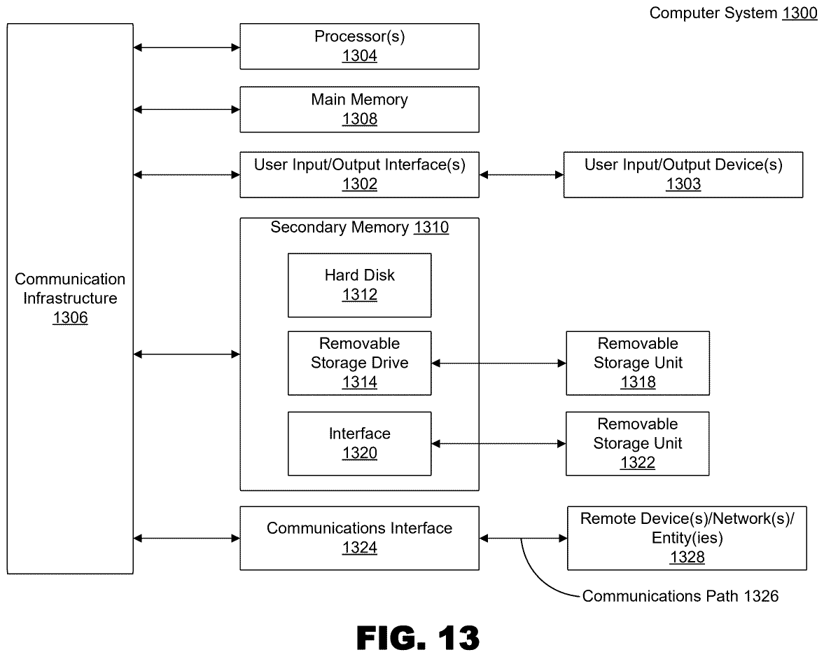

Various aspects and examples may be implemented using one or more computer systems, such as computer system 1300 shown in FIG. 13. For example, media device(s) 104, display device(s) 106, content server(s) 120, system server(s) 126, UI management system 130, and/or any other device may be implemented using combinations or sub-combinations of computer system 1300. Also or alternatively, computer system 1300 may be used, for example, to implement any of the aspects and examples discussed herein, and combinations and sub-combinations thereof.

Computer system 1300 may include one or more processors (e.g., central processing units or CPUs), such as processor 1304. Processor 1304 may be connected to a communication infrastructure 1306 (or communication bus). Computer system 1300 may also include user input/output device(s) 1303, such as monitors, keyboards, pointing devices, etc., which may communicate with communication infrastructure 1306 through user input/output interface(s) 1302.

In some examples, the one or more processors 1304 may include a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc. In other examples, the one or more processors 1304 may additionally or alternatively include or be part of a digital signal processor (DSP), an image signal processor (ISP), an application-specific integrated circuit (ASIC), a field-programmable gate array (FPGA), an integrated circuit, a microcontroller, and/or any other processing device.

Computer system 1300 may also include a main or primary memory 1308, such as random access memory (RAM). Main memory 1308 may include one or more levels of cache. Main memory 1308 may have stored therein control logic (e.g., computer software) and/or data.

Computer system 1300 may also include one or more secondary storage devices or memory 1310. Secondary memory 1310 may include, for example, a hard disk drive 1312 and/or a removable storage device or drive 1314. Removable storage drive 1314 may be a floppy disk drive, a magnetic tape drive, a compact disk drive, an optical storage device, tape backup device, and/or any other storage device/drive.

Removable storage drive 1314 may interact with a removable storage unit 1318. Removable storage unit 1318 may include a computer usable or readable storage device having stored thereon computer software (control logic) and/or data. Removable storage unit 1318 may be a floppy disk, magnetic tape, compact disk, DVD, optical storage disk, /d/ any other computer data storage device. Removable storage drive 1314 may read from and/or write to removable storage unit 1318. Secondary memory 1310 may include other means, devices, components, instrumentalities or approaches for allowing computer programs, instructions, and/or data to be accessed by computer system 1300. Such means, devices, components, instrumentalities or other approaches may include, for example, a removable storage unit 1322 and an interface 1320. Examples of the removable storage unit 1322 and the interface 1320 may include a program cartridge and cartridge interface (such as that found in video game devices), removable memory chip (e.g., EPROM, PROM, etc.) and associated socket, memory stick and USB or other port, memory card and associated card slot, and/or any removable storage and associated interface.

Computer system 1300 may include a communication or network interface 1324. Communication interface 1324 may enable computer system 1300 to communicate and interact with any combination of external devices, external networks, external entities, etc. (individually and collectively referenced by reference number 1328). For example, communication interface 1324 may allow computer system 1300 to communicate with external or remote devices 1328 over communications path 1326, which may be wired and/or wireless (or a combination thereof), and which may include any combination of LANs, WANs, the Internet, etc. Control logic and/or data may be transmitted to and from computer system 1300 via communication path 1326.

Computer system 1300 may also be any of a personal digital assistant (PDA), desktop workstation, laptop or notebook computer, netbook, tablet, mobile phone (e.g., smartphone), smart watch or other wearable, appliance, part of the Internet-of-Things, and/or embedded system, to name a few non-limiting examples, or any combination thereof. Computer system 1300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Proprietary data structures, formats or schemas may be used, either exclusively or in combination with known or open standards.

In some cases, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1300, main memory 1308, secondary memory 1310, and removable storage units 1318 and 1322, as well as tangible articles of manufacture embodying any combination of the foregoing. Such control logic, when executed by one or more data processing devices (such as computer system 1300 or processor(s) 1304), may cause such data processing devices to operate as described herein.

Based on the teachings in this disclosure, it will be apparent to persons skilled in the relevant art(s) how to make and use embodiments of this disclosure using data processing devices, computer systems and/or computer architectures other than that shown in FIG. 13. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way. While this disclosure describes exemplary embodiments for exemplary fields and applications, it should be understood that the disclosure is not limited thereto. Other embodiments and modifications thereto are possible, and within the scope and spirit of this disclosure. For example and without limiting the generality of this paragraph, embodiments are not limited to the software, hardware, firmware, and/or entities in the figures and/or described herein. Embodiments (whether or not explicitly described herein) have significant utility to fields and applications beyond the examples described herein.

Embodiments have been described herein with the aid of functional building blocks illustrating implementations of specified functions and relationships thereof. The boundaries of these functional building blocks have been defined herein for the convenience of the description. Alternate boundaries can be defined as long as the specified functions and relationships (or equivalents thereof) are appropriately performed. Alternative embodiments can perform functional blocks, steps, operations, methods, etc. using orderings different than those described herein.

References to “one embodiment,” “an embodiment,” “an example embodiment,” or similar phrases indicate that the embodiment may include a particular feature, structure, or characteristic, but every embodiment may not necessarily include that feature, structure, or characteristic. Such phrases are not necessarily referring to the same embodiment. When a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described examples, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. A system comprising: memory; and one or more processors are coupled to the memory and configured to perform operations comprising: identifying a user associated with a user interface (UI) of an application; selecting one or more visual attributes from a set of visual attributes of the UI, the one or more visual attributes being selected based on at least one of a theme of the UI and a respective selection parameter associated with each content item from a set of content items of the UI, the respective selection parameter defining at least one of a content preference, a content priority, a content metric, and a content relevance to at least one of a date associated with a presentation of the UI, the user, the application, and a topic; generating, via an artificial intelligence (AI) model, a profile image of the user customized based on the one or more visual attributes of the UI; and providing the profile image of the user to at least one of the UI and a device associated with the user.
Aspect 2. The system of Aspect 1, wherein the content preference is based on a preference of at least one of the user, a group of users, the application, an entity associated with the application, and a sponsor associated with the application.
Aspect 3. The system of any of Aspects 1 or 2, wherein the content priority is based on at least one of a content trend score, a content popularity, a content promotion associated with a sponsor, a content interest score, and a respective count of references in one or more sources to a respective topic associated with at least one content item from the set of content items of the UI, the one or more sources comprising at least one of a media source, a social media network, and the UI.
Aspect 4. The system of any of Aspects 1 to 3, wherein the content metric comprises at least one of a content request count, a content statistic, a content selection weight specified by at least one of the application and an entity associated with the application, and a content performance value.
Aspect 5. The system of any of Aspects 1 to 4, wherein the content relevance is based on at least one of a relationship between each content item and at least one of the date, a context associated with the user, a trend associated with a trend score, a location associated with the user, a user input, and an event.
Aspect 6. The system of any of Aspects 1 to 5, wherein the one or more visual attributes are based on at least one of a background of the UI, animated content in the UI, UI content, one or more visual elements of the UI, artwork depicted in the UI, an object depicted in the UI, a UI graphic, UI imagery, a color or color scheme associated with the UI, a character depicted in the UI, a content associated with the theme, a UI banner, and a UI page.
Aspect 7. The system of any of Aspects 1 to 6, wherein the one or more visual attributes comprise at least one of a color, a text, a font, a thumbnail, an icon, an image, a shape, a visual object, a graphic, a scene, a background, an animation, a garment, a landmark, a device, a facial feature, a costume, head covering, an accessory, a depicted activity, a property or prop, and artwork.
Aspect 8. The system of any of Aspects 1 to 7, wherein the one or more processors are configured to perform operations comprising: determining that the date corresponds to a scheduled event, the scheduled event comprising at least one of a content release date or promotion, a formal holiday recognized by one or more entities, an informal holiday comprising a commemorative day celebrated by one or more users, a game, a competition, an announcement, a news event, a political event, and a community event; based on the determining that the date corresponds to the scheduled event, determining that a particular content item from the set of content items of the UI has a highest selection parameter from the respective selection parameter of each content item, the highest selection parameter comprising at least one of a highest content preference score, a highest content priority, a highest content metric, and a highest content relevance; selecting the particular content item based on the highest selection parameter associated with the particular content item; and determining the one or more visual attributes based on the particular content item.
Aspect 9. The system of any of Aspects 1 to 8, wherein the one or more processors are configured to perform operations further comprising: selecting, based on user data, at least one of a content personalized to the user and one or more features of the theme personalized to the user, the user data comprising at least one of a user preference, a user input, a user history, a user interaction, a user purchase, a user characteristic, and a user activity, the at least one of the content and one or more features personalized to the user being associated with at least one of an activity, a content, a team, a character, a competition, a genre, and an event; and determining the one or more visual attributes further based on the at least one of the content and the one or more features personalized to the user.
Aspect 10. A computer-implemented method comprising: identifying a user associated with a user interface (UI) of an application; selecting one or more visual attributes from a set of visual attributes of the UI, the one or more visual attributes being selected based on at least one of a theme of the UI and a respective selection parameter associated with each content item from a set of content items of the UI, the respective selection parameter defining at least one of a content preference, a content priority, a content metric, and a content relevance to at least one of a date associated with a presentation of the UI, the user, the application, and a topic; generating, via an artificial intelligence (AI) model, a profile image of the user customized based on the one or more visual attributes of the UI; and providing the profile image of the user to at least one of the UI and a device associated with the user.
Aspect 11. The computer-implemented method of Aspect 10, wherein the content preference is based on a preference of at least one of the user, a group of users, the application, an entity associated with the application, and a sponsor associated with the application.
Aspect 12. The computer-implemented method of any of Aspects 10 or 11, wherein the content priority is based on at least one of a content trend score, a content popularity, a promotion associated with a sponsor, a content interest score, and a respective count of references in one or more sources to a respective topic associated with at least one content item from the set of content items of the UI, the one or more sources comprising at least one of a media source, a social media network, and the UI.
Aspect 13. The computer-implemented method of any of Aspects 10 to 12, the content metric comprising at least one of a content request count, a content statistic, a content selection weight, and a content performance value.
Aspect 14. The computer-implemented method of any of Aspects 10 to 13, wherein the content relevance is based on at least one of a relationship between each content item and at least one of the date, a user context, a trend associated with a trend score, a user location, a user input, and an event.
Aspect 15. The computer-implemented method of any of Aspects 10 to 14, wherein the one or more visual attributes are based on at least one of a background of the UI, animated content in the UI, UI content, one or more visual elements of the UI, artwork depicted in the UI, an object depicted in the UI, a UI graphic, UI imagery, a color or color scheme associated with the UI, a character depicted in the UI, a content associated with the theme, a UI banner, and a UI page.
Aspect 16. The computer-implemented method of any of Aspects 10 to 15, wherein the one or more visual attributes comprise at least one of a color, a text, a font, a thumbnail, an icon, an image, a shape, a visual object, a graphic, a scene, a background, an animation, a garment, a landmark, a device, a facial feature, a costume, head covering, an accessory, a depicted activity, a property or prop, and artwork.
Aspect 17. The computer-implemented method of any of Aspects 10 to 16, further comprising: determining that the date corresponds to a scheduled event; based on the determining that the date corresponds to the scheduled event, determining that a particular content item from the set of content items of the UI has a highest selection parameter from the respective selection parameter of each content item; selecting the particular content item based on the highest selection parameter associated with the particular content item; and determining the one or more visual attributes based on the particular content item.
Aspect 18. The computer-implemented method of Aspect 17, the scheduled event comprising at least one of a content release date or promotion, a formal holiday recognized by an entity, an informal holiday comprising a day celebrated by users, a game, competition, announcement, and news or current event.
Aspect 19. The computer-implemented method of Aspect 17 or 18, wherein the highest selection parameter comprises at least one of a highest content preference score, a highest content priority, a highest content metric, and a highest content relevance
Aspect 20. The computer-implemented method of any of Aspects 10 to 19, further comprising: selecting, based on user data, at least one of a content personalized to the user and one or more features of the theme personalized to the user, the at least one of the content and one or more features personalized to the user being associated with at least one of an activity, a content, a team, a character, a competition, a genre, and an event; and determining the one or more visual attributes further based on the at least one of the content and the one or more features personalized to the user.
Aspect 21. The computer-implemented method of Aspect 20, wherein the user data comprises at least one of a user preference, input, history, interaction, purchase, characteristic, and activity
Aspect 22. The computer-implemented method of any of Aspects 10 to 21, further comprising: determining a presence of the user within a scene associated with a device used to display the UI, the presence of the user being determined based on at least one of image data captured by an image sensor, a first usage pattern of a remote control determined based on at least one of inertial sensor measurements and remote control inputs, a second usage pattern of the UI determined based on user inputs, an audio recording comprising a voice or speech of the user, motion of the user detected based on one or more sensors, and a gesture of the user detected based on at least one of the image sensor and the one or more sensors.
Aspect 23. A non-transitory computer-readable medium having instructions stored thereon that, when executed by one or more processors, cause the one or more processors to perform a method according to any of Aspects 10 to 22.
Aspect 24. A system comprising means for performing a method according to any of Aspects 10 to 2.

What is claimed is:

1. A system comprising:
memory; and
one or more processors are coupled to the memory and configured to perform operations comprising:
identifying a user associated with a user interface (UI) of an application;
selecting one or more visual attributes from a set of visual attributes of the UI, the one or more visual attributes being selected based on at least one of a theme of the UI and a respective selection parameter associated with each content item from a set of content items of the UI, the respective selection parameter defining at least one of a content preference, a content priority, a content metric, and a content relevance to at least one of a date associated with a presentation of the UI, the user, the application, and a topic;
generating, via an artificial intelligence (AI) model, a profile image of the user customized based on the one or more visual attributes of the UI; and
providing the profile image of the user to at least one of the UI and a device associated with the user.

2. The system of claim 1, wherein the content preference is based on a preference of at least one of the user, a group of users, the application, an entity associated with the application, and a sponsor associated with the application.

3. The system of claim 1, wherein the content priority is based on at least one of a content trend score, a content popularity, a content promotion associated with a sponsor, a content interest score, and a respective count of references in one or more sources to a respective topic associated with at least one content item from the set of content items of the UI, the one or more sources comprising at least one of a media source, a social media network, and the UI.

4. The system of claim 1, wherein the content metric comprises at least one of a content request count, a content statistic, a content selection weight specified by at least one of the application and an entity associated with the application, and a content performance value.

5. The system of claim 1, wherein the content relevance is based on at least one of a relationship between each content item and at least one of the date, a context associated with the user, a trend associated with a trend score, a location associated with the user, a user input, and an event.

6. The system of claim 1, wherein the one or more visual attributes are based on at least one of a background of the UI, animated content in the UI, UI content, one or more visual elements of the UI, artwork depicted in the UI, an object depicted in the UI, a UI graphic, UI imagery, a color or color scheme associated with the UI, a character depicted in the UI, a content associated with the theme, a UI banner, and a UI page.

7. The system of claim 1, wherein the one or more visual attributes comprise at least one of a color, a text, a font, a thumbnail, an icon, an image, a shape, a visual object, a graphic, a scene, a background, an animation, a garment, a landmark, a device, a facial feature, a costume, head covering, an accessory, a depicted activity, a property or prop, and artwork.

8. The system of claim 1, wherein the one or more processors are configured to perform operations further comprising:
determining that the date corresponds to a scheduled event, wherein the scheduled event comprises at least one of a content release date or promotion, a formal holiday recognized by one or more entities, an informal holiday comprising a commemorative day celebrated by one or more users, a game, a competition, an announcement, a news event, a political event, and a community event;
based on the determining that the date corresponds to the scheduled event, determining that a particular content item from the set of content items of the UI has a highest selection parameter from the respective selection parameter of each content item, the highest selection parameter comprising at least one of a highest content preference score, a highest content priority, a highest content metric, and a highest content relevance;
selecting the particular content item based on the highest selection parameter associated with the particular content item; and
determining the one or more visual attributes based on the particular content item.

9. The system of claim 1, wherein the one or more processors are configured to perform operations further comprising:
selecting, based on user data, at least one of a content personalized to the user and one or more features of the theme personalized to the user, the user data comprising at least one of a user preference, a user input, a user history, a user interaction, a user purchase, a user characteristic, and a user activity, the at least one of the content and one or more features personalized to the user being associated with at least one of an activity, a content, a team, a character, a competition, a genre, and an event; and
determining the one or more visual attributes further based on the at least one of the content and the one or more features personalized to the user.

10. A computer-implemented method comprising:
identifying a user associated with a user interface (UI) of an application;
selecting one or more visual attributes from a set of visual attributes of the UI, the one or more visual attributes being selected based on at least one of a theme of the UI and a respective selection parameter associated with each content item from a set of content items of the UI, the respective selection parameter defining at least one of a content preference, a content priority, a content metric, and a content relevance to at least one of a date associated with a presentation of the UI, the user, the application, and a topic;
generating, via an artificial intelligence (AI) model, a profile image of the user customized based on the one or more visual attributes of the UI; and
providing the profile image of the user to at least one of the UI and a device associated with the user.

11. The computer-implemented method of claim 10, wherein the content preference is based on a preference of at least one of the user, a group of users, the application, an entity associated with the application, and a sponsor associated with the application.

12. The computer-implemented method of claim 10, wherein the content priority is based on at least one of a content trend score, a content popularity, a content promotion associated with a sponsor, a content interest score, and a respective count of references in one or more sources to a respective topic associated with at least one content item from the set of content items of the UI, the one or more sources comprising at least one of a media source, a social media network, and the UI.

13. The computer-implemented method of claim 10, wherein the content metric comprises at least one of a content request count, a content statistic, a content selection weight specified by at least one of the application and an entity associated with the application, and a content performance value.

14. The computer-implemented method of claim 10, wherein the content relevance is based on at least one of a relationship between each content item and at least one of the date, a context associated with the user, a trend associated with a trend score, a location associated with the user, a user input, and an event.

15. The computer-implemented method of claim 10, wherein the one or more visual attributes are based on at least one of a background of the UI, animated content in the UI, UI content, one or more visual elements of the UI, artwork depicted in the UI, an object depicted in the UI, a UI graphic, UI imagery, a color or color scheme associated with the UI, a character depicted in the UI, a content associated with the theme, a UI banner, and a UI page.

16. The computer-implemented method of claim 10, wherein the one or more visual attributes comprise at least one of a color, a text, a font, a thumbnail, an icon, an image, a shape, a visual object, a graphic, a scene, a background, an animation, a garment, a landmark, a device, a facial feature, a costume, head covering, an accessory, a depicted activity, a property or prop, and artwork.

17. The computer-implemented method of claim 10, further comprising:
determining that the date corresponds to a scheduled event, the scheduled event comprising at least one of a content release date or promotion, a formal holiday recognized by one or more entities, an informal holiday comprising a commemorative day celebrated by one or more users, a game, a competition, an announcement, a news event, a political event, and a community event;
based on the determining that the date corresponds to the scheduled event, determining that a particular content item from the set of content items of the UI has a highest selection parameter from the respective selection parameter of each content item, the highest selection parameter comprising at least one of a highest content preference score, a highest content priority, a highest content metric, and a highest content relevance;
selecting the particular content item based on the highest selection parameter associated with the particular content item; and
determining the one or more visual attributes based on the particular content item.

18. The computer-implemented method of claim 10, further comprising:
selecting, based on user data, at least one of a content personalized to the user and one or more features of the theme personalized to the user, the user data comprising at least one of a user preference, a user input, a user history, a user interaction, a user purchase, a user characteristic, and a user activity, the at least one of the content and one or more features personalized to the user being associated with at least one of an activity, a content, a team, a character, a competition, a genre, and an event; and
determining the one or more visual attributes further based on the at least one of the content and the one or more features personalized to the user.

19. The computer-implemented method of claim 10, further comprising:
determining a presence of the user within a scene associated with a device used to display the UI, the presence of the user being determined based on at least one of image data captured by an image sensor, a first usage pattern of a remote control determined based on at least one of inertial sensor measurements and remote control inputs, a second usage pattern of the UI determined based on user inputs, an audio recording comprising a voice or speech of the user, motion of the user detected based on one or more sensors, and a gesture of the user detected based on at least one of the image sensor and the one or more sensors.

20. A non-transitory computer-readable medium having instructions stored thereon that, when executed by one or more processors, cause the one or more processors to perform operations comprising:
identifying a user associated with a user interface (UI) of an application;
selecting one or more visual attributes from a set of visual attributes of the UI, the one or more visual attributes being selected based on at least one of a theme of the UI and a respective selection parameter associated with each content item from a set of content items of the UI, the respective selection parameter defining at least one of a content preference, a content priority, a content metric, and a content relevance to at least one of a date associated with a presentation of the UI, the user, the application, and a topic;
generating, via an artificial intelligence (AI) model, a profile image of the user customized based on the one or more visual attributes of the UI; and
providing the profile image of the user to at least one of the UI and a device associated with the user.
